(19) United States
(12) Patent Application Publication
(10) Pub. No.: US 2002/0165912 A1
(43) Pub. Date: Nov. 7, 2002

(54) Secure certificate and system and method for issuing and using same

(75) Inventors: Michael L. Wenocur, Palo Alto, CA (US); Robert W. Baldwin, Palo Alto, CA (US); Daniel H. Illowsky, Cupertino, CA (US)

Correspondence Address: FLEHR HOHBACH TEST ALBRITTON & HERBERT, LLP, Suite 3400, Four Embarcadero Center, San Francisco, CA, 94111, US

(73) Assignee: Storymail, Inc.

(21) Appl. No.: 09/912,941

(22) Filed: Jul. 25, 2001

Related U.S. Application Data
(60) Provisional application No. 60/271,455, filed on Feb. 25, 2001.

(51) Int. Cl. G06F 15/16

(52) U.S. Cl. 709/203

(57) ABSTRACT

System, method, signal, operating model, and computer program for electronic messaging. Systems and method for providing security for communication of electronic messages, interactive sessions, software downloads, software upgrades, and other content from a source to a receiving device as well as signals used for such communications. Systems, methods, signals, device architectures, data formats, and computer program structures for providing authentication, integrity, confidentiality, non-repudiation, replay protection, and other security properties while minimizing the network bandwidth, computational resources, and manual user interactions required to install, enable, deploy and utilize these security properties. System, device, method, computer program, and computer program product for searching and selecting data and control elements in message procedural/data sets for automatic and complete portrayal of message to maintain message intent. System, device, method, computer program, and computer program product for adapting content for sensory and physically challenged persons using embedded semantic elements in a procedurally based message file.

### RELATED APPLICATIONS

This application claims the benefit of priority under 35 U.S.C. Sections 119(e) and/or 120 and incorporates by reference each of the following U.S. Patent Applications:

U.S. Provisional Application Serial No. 60/271,455 (Attorney Docket No. P-70322/RMA) filed Feb. 25, 2001, entitled Hardware Architecture, Operating System And Network Transport Neutral System, Method And Computer Program Product For Secure Communications And Messaging;

U.S. Utility application Ser. No. ______ (Attorney Docket No. A-70553/RMA) filed ______, entitled Hardware Architecture, Operating System And Network Transport Neutral System, Method And Computer Program Product For Secure Communications And Messaging;

U.S. Utility application Ser. No. ______ (Attorney Docket No. A-70554/RMA) filed ______, entitled System and Method for Authorization of Access to a Resource;

U.S. Utility application Ser. No. ______ (Attorney Docket No. A-70555/RMA) filed ______, entitled System, Method, and Structure for Generating and Using A Compressed Digital Certificate,

U.S. Utility application Ser. No. ______ (Attorney Docket No. A-70556/RMA) filed ______, entitled Common Security Protocol Structure and Mechanism and System and Method for Using;

U.S. Utility application Ser. No. ______ (Attorney Docket No. A-70557/RMA) filed ______, entitled System and Method for Conducting A Secure Interactive Communication Session;

U.S. Utility application Ser. No. ______ (Attorney Docket No. A-70558/RMA) filed ______, entitled System and Method for Secure Unidirectional Messaging;

U.S. Utility application Ser. No. ______ (Attorney Docket No. A-70559/RMA) filed ______, entitled Secure Certificate and System and Method for Issuing and Using Same;

U.S. Utility application Ser. No. ______ (Attorney Docket No. A-70560/RMA) filed ______, entitled System and Method for Conducting a Secure Response Communication Session;

U.S. Utility application Ser. No. ______ (Attorney Docket No. A-70561/RMA) filed ______, entitled System and Method for Communicating A Secure Unidirectional Response Message;

U.S. Utility application Ser. No. ______ (Attorney Docket No. A-70562/RMA) filed ______, entitled System, Method And Computer Program Product For Device, Operating System, And Network Transport Neutral Secure Interactive Multi-Media Messaging; each of which is hereby incorporated by reference

U.S. patent application Ser. No. 09/627,357, filed Jul. 28, 2000, entitled Method for Cooperatively Executing a Plurality of Code Threads in a Processor Using Instruction Retry upon Resource Constraints;

U.S. patent application Ser. No. 09/627,645, filed Jul. 28, 2000, entitled Business Method to Generate and Electronically Distribute Rich Media E-mail Messages to People with Physical Disabilities;

U.S. patent application Ser. No. 09/627,358, filed Jul. 28, 2000, entitled Business Method for Generating and Electronically Distributing Targeted Author-Once Architecture Independent Rich Media Content,

U.S. patent application Ser. No. 09/628,205, filed Jul. 28, 2000, entitled Method to Generate and Electronically Distribute Highly Targeted Rich Media E-mail Messages;

U.S. patent application Ser. No. 09/706,661 filed Nov. 4, 2000, entitled Hardware Architecture Neutral Computer Program Language And Structure And Method For Execution;

U.S. patent application Ser. No. 09/706,621 filed Nov. 4, 2000, entitled System and Method for Autonomous Generation of Customized File Having Procedural and Data Elements from Non-procedural Flat-File Descriptors;

U.S. patent application Ser. No. 09/706,664, filed Nov. 4, 2000, entitled System and Method for Intelligently Scaling Procedure/Data Sets to Adapt the Procedure/data Sets to Receiver Attributes and Maintain Message Intent;

U.S. patent application Ser. No. 09/706,609 filed Nov. 4, 2000, entitled Intent Preserving Message Adaptation and Conversion System and Method for Communicating with Sensory And/or Physically Challenged Persons;

U.S. patent application Ser. No. 09/706,612 filed Nov. 4, 2000, entitled System and Method for Searching and Selecting Data and Control Elements in Message Procedural/data Set for Automatic and Complete Portrayal of Message to Maintain Message Intent;

U.S. patent application Ser. No. 09/706,617 filed Nov. 4, 2000, entitled System and Method for Adapting Content for Sensory and Physically Challenged Persons Using Embedded Semantic Elements in a Procedurally Based Message File;

U.S. patent application Ser. No. 09/706,615 filed Nov. 4, 2000, entitled System and Method for Forward and Backward Content Based Version Control for Automated Autonomous Playback on Client Devices Having Diverse Hardware and Software;

U.S. patent application Ser. No. 09/706,611 filed Nov. 4, 2000, entitled System and Method for Reducing Unauthorized Access by Procedural Messages Executing in a Computer System to Computer System or Memory or Programs or Data Stored Therein;

U.S. patent application Ser. No. 09/706,614 filed Nov. 4, 2000, entitled System and Method for Self-directed Loading of an Input Buffer with Procedural Messages from a Stream of Sub-files Containing Sets of Logical Files;

U.S. patent application Ser. No. 09/706,610 filed Nov. 4, 2000, entitled System and Method for Device-Neutral Procedurally-Based Content Display Layout and Content Playback;

U.S. patent application Ser. No. 09/706,616 filed Nov. 4, 2000, entitled System and Method for Thin Procedural Multi-Media Player Run-Time Engine Having Application Program Level Cooperative Multi-threading and Constrained Resource Retry with Anti-Stall Features;

U.S. patent application Ser. No. 09/706,613 filed Nov. 4, 2000, entitled System and Method for Streaming Multimedia-Rich Interactive Experiences Over a Communications Channel; and

U.S. patent application Ser. No. 09/706,606 filed Nov. 4, 2000, entitled System and Method for Cooperative Application-Level Multi-Thread Execution Including Instruction Retry Feature Upon Identifying Constrained System Resource; each of which is hereby incorporated by reference.

### FIELD OF INVENTION

This invention pertains generally to systems and methods for providing security for communication of electronic messages, interactive sessions, software downloads, software upgrades, and other content from a source to a receiving device as well as signals used for such communications; and more particularly to systems, methods, signals, device architectures, data formats, and computer program structures for providing authentication, integrity, confidentiality, non-repudiation, replay protection, and other security properties while minimizing the network bandwidth, computational resources, and manual user interactions required to install, enable, deploy and utilize these security properties.

### BACKGROUND

Numerous security protocols has been proposed in the academic literature and many have been deployed in commercial products. Currently the most popular protocol for secure sessions between a client machine and a server machine is SSL/TLS, which provides an interactive two-way connection that has at least one party authenticated using a digital certificate issued by a mutually trusted third party. Secure browser-based electronic commerce is almost always performed with the help of the SSL protocol. The most popular secure protocols for unidirectional messaging (e.g., e-mail) are S/MIME and PGP, which provide encryption and/or digital signatures based on digital certificates. The most popular protocols for secure downloads and upgrades are Authenticode and Signed JAR files, which also use digital certificates The most popular systems for requesting and issuing digital certificates are PKCS-7&10 and the S/MIME CMS protocol.

Each of these protocols requires a large amount of software code and data memory to implement and the steps needed to enroll or register to use these systems are time consuming and in other ways annoying to users. A system that needed to implement all of these protocols would be very difficult to implement on a device with limited memory and computing resources, and very annoying to the users These protocols do not provide solutions to the problem of securely authorizing a specific user the right to access a specific resource, such as a web page or software upgrade, in a manner that cannot be spoofed by a third party.

The need for appropriate security protocols, procedures, and methods are particularly problematic for electronic messaging in general, and for electronic mail or email in particular.

Electronic mail, commonly referred to as e-mail, is broadly acknowledged as the “killer” application of the Internet and is a major contributor to its growth, but in a number of ways e-mail is stuck in the past. Most e-mail messages, particularly in a business or other commercial environment but also frequently in personal or non-commercial environments as well, have a predetermined intent, goal, or other purpose directed at achieving some particular result or response from the e-mail receiver. Once a message is composed and published, it is generally expected that the intent and quality of presentation of the message will be preserved. In the past, when e-mail was exclusively or primarily symbol or text based, maintaining the goal or intent of the message was relatively strait forward. If the message was well authored so as to present the desired intent and the message was received, it was likely that the receiver would having sufficient intelligence, appreciate the intent of the message. As e-mail has evolved, it may frequently include non-symbolic or non-textual information, for example, digital images or pictures, graphics, digital audio, video, and the like. Usually, these non-symbolic content enhancements are provided as attachments to the basic message. Frequently, the intent of the message or the reason for sending the message will be partially or even entirely lost unless the non-symbolic portion, such as a video attachment, is also viewed by the receiver. Whether the content enhancements are ever seen or heard by the e-mail recipient may be functions of the recipients hardware, software, programmed preferences, sophistication, as well as other tangible and intangible factors. The e-mail author, sender, or forwarder may typically not know these tangible or intangible factors for any particular recipient.

For these and other reasons that will be described in greater detail herein, conventional procedures for generating and distributing e-mail unfortunately do not typically preserve either the intent of the message or the quality of the presentation when sending messages to a broad range of e-mail client devices (the types and sophistication of which are nearly unlimited) unless concerted efforts are made to maintain the intent and quality. As a result, conventional approaches used to generate and distribute e-mail severely restrict the impact that e-mail could have on recipients and mainstream e-commerce applications.

One problem, for example, with conventional approaches used to generate and distribute e-mail is related to the fact that content in e-mail messages is typically not adjusted to the hardware capabilities of an e-mail client that will actually receive the content. If the content of the e-mail is not generated to be compatible with the hardware capabilities of a particular e-mail client, the desired intent of the message may be completely lost. Such hardware and/or software capabilities include, for example, audio capabilities, motion video capabilities, microprocessor type, the amount of memory that is available to store and/or execute the e-mail content, display monitor screen size, and display monitor characteristics, which in turn depend on both the logical circuitry (provided by a video adapter) of the display monitor and display monitor screen size, and the like.

Consider an example where an e-mail publisher sends an e-mail advertisement message that consists of a color motion video of a diamond ring. If the message is received by an e-mail client that does not have required hardware for computing graphical transformations, for example, a graphics accelerator card, the recipient of the message will not be able to view the motion video portion of the message, and a necessary component of the message will have been lost, the motion video.

Clearly, some client device types will be able to receive, format, and display or present each and every one of the information items included in an e-mail message. Equally clearly, other client device types would be unable to present any but the minimum set of information items, and likely none of the information items unless only the minimum compatible information items was actually communicated. For example, a cellular telephone having only one or a few lines of monochrome display, a low-end Personal Data Assistant (PDA), or the like information appliance having limited display and/or limited multimedia presentation capabilities would only be able to display small amounts of text or limited monochrome graphics. Therefore, while it would be desirable to generate and distribute optimized e-mail messages that include content that is compatible with all e-mail enabled client hardware configurations, this has not been achieved in practice.

Heretofore, e-mail is not typically authored to take into account the hardware, software, and user preference attributes of the e-mail recipient. Only where a user has subscribed to some service where the content is authored specifically for a particular intended recipient or group of recipients may the content sometimes be tailored to match these attributes. For electronic messages sent to a large number of intended recipients, such as for a mass consumer advertising campaign, where no knowledge of the users' hardware, software, or preference attributes is available, conventional systems and methods do not facilitate providing an optimized e-mail communication that maintains the intent of the message. Therefore, it has been necessary to rely on a least common denominator approach for such e-mailings where the impact of the communication must frequently be sacrificed so that the message may be received and viewed by a maximum number of the intended recipients.

If the publisher in this example above for the diamond ring generated the e-mail content with a least common denominator approach that incorporated only that content that is compatible with the hardware of all e-mail clients, for example, textual content, the level of quality that may have been desired to show the advertisers products in a positive light would also be lost with respect to an e-mail client that does have the necessary hardware capability to view the motion video. All recipients would merely receive a text message saying for example, “Three Carat Diamond Ring, $1595.00 at Joe's Jewelry Store”, rather than at least some potential buyers viewing a multi-media presentation on the ring and other attributes of Joe's Jewelry Store. Therefore, it is also desirable to substantially optimize e-mail to take significant advantage of those respective capabilities and attributes that are known or may be knowable either before sending the message or after the message is received. Related to these ideals is the fact that e-mail messages often include extra information that while compatible with the hardware capabilities of an e-mail client, cannot or will not be used by the e-mail client.

For example, there is no need to include color image data in a message that is being sent to a device that only has a monochrome monitor. A monochrome monitor cannot display a color image no matter how fancy a video card the device may have. To make matters even worse, there are a number of undesirable side effects of sending such extra information. For example, the extra information may take up a significant amount of limited memory resources of the receiving device, and/or, depending on the communication channel connection characteristics of the client device, may slow down the speed at which the message is received by the device. In addition, in spite of the fact that a user's device may be capable of receiving a rich-media message, the user may simply prefer not to receive advertisements or other e-mail having multi-media or rich media content.

Another problem with conventional techniques for generating and exchanging e-mail, is that e-mail messages are not typically generated such that an e-mail client's network connection characteristics are considered. As a result, the presentation of the e-mail message may be compromised. Such network connection characteristics include, for example, nominal speed or bandwidth of network connections, latencies, throughput, and other contemporaneous communication link/channel attributes. This is a problem because, even though a client device may be capable of receiving a very rich message, if the then prevailing communication channel is only supporting low speed or low bandwidth communication, the conventional systems and methods do not provide procedure to reduce the richness of the message while maintaining the goal or intent of the message. In fact, conventional streaming techniques for rich media tend to do just the opposite, that is to permit any reduction in quality so that the content is received within a real-time or near-real-time time constraint. In some instances, the content may be so degraded as not to offer any useful information at all.

Another problem with conventional techniques for generating and exchanging e-mail, is that e-mail messages are typically generated in a manner that is insensitive to individual user preferences. Such preferences include, for example, preferred language, security level, physical disability requirements, content layout, demographic information, and the like. For example, a user may be a predominantly Spanish-speaking individual who prefers to receive information, for example, text and audio, in the Spanish-language where possible, rather than in for example the English language. If a message is generated in a language that is not understood by the recipient, the recipient will not be able to understand the message without additional assistance, for example, with assistance by a language interpreter. Even if the message might be understood by the recipient, it may fail to make the desired impression on the recipient. Additionally, if the message does not comply with the recipient's physical disabilities, for example, blindness or deafness, the recipient also may not be able to fully understand the message without additional assistance, for example, having the message translated into a Braille or an audio format. As illustrated in both of these example, if the e-mail is generated in a manner that is insensitive to individual user preferences, the full impact and intent of the message is generally lost.

To complicate matters, an e-mail client device that has received an e-mail may forward the e-mail to additional e-mail enabled devices, and they in turn may forward the message to other e-mail clients, and the like. Each of these additional e-mail clients may have similar, narrower, or broader hardware capabilities, network connection characteristics, and corresponding user preferences as compared to the capabilities, characteristics and preferences of a forwarding e-mail client. Desirably, e-mail messages are generated in a manner such that the respective content of the e-mail is optimized and compatible with the respective hardware capabilities, connection characteristics, and user preferences associated with all e-mail clients, regardless of whether the e-mail client received the message directly from the publisher or from an intermediary by way of forwarded e-mail.

Yet another problem with conventional e-mail is that it provides poor navigational and procedural control for e-commerce applications, and conventional e-mail has little or no capability for rich graphics, audio, video, or interactive controls. As a result, conventional e-mail severely restricts the ease of use of e-mail and the impact that e-mail could have on recipients and mainstream e-commerce applications. Such applications include, for example, business-to-consumer (B2C) e-commerce and business-to-business e-commerce (B2B). This problem becomes more apparent every day, because increasingly, communications between suppliers and customers is being accomplished via e-mail. Customers are inquiring about products and orders via e-mail, and suppliers are alerting existing and potential customers about new products and services.

To illustrate this problem, refer to Table 1, where there is illustrated a targeted promotion in the form of an e-coupon from an on-line business or retailer (sometimes referred to as an “etailer”) to a consumer (this is an example of a business to consumer or B2C transaction) that offers the consumer a gift certificate.

To take advantage of the retailer's targeted promotion, a recipient must perform an number of time consuming navigational and procedural steps. For example, at step 1, the recipient must point her browser to the on-line retailer's web site on the world wide web (www). At step 2, the recipient must select the items of interest and be sure not to use a particular payment method (1-click), but instead place the selected items in the shopping cart. At step 3, the recipient must select a “checkout” button. Finally, at step 4, the recipient must wait until prompted by the retailer's web site to type in the numbers of the provided gift certificate claim code to generate an order form to complete the transaction. These procedures are time consuming and require complicated navigation for the recipient of a targeted promotion to generate an order in response to the promotion.

TABLE 1
EXAMPLE OF AN E-COUPON FROM AN ON-LINE RETAILER

To: dan_i@pacbell.net
Amount. U.S. $10.00
From: on-line retailer.com
Claim code (YOU'LL NEED THIS WHEN ORDERING!):
2AUH_RX8A7G_RE73YL
Expiration date: December 3, 1999
Using your gift certificate is easy. Just follow these steps:
1. Visit our Toys & Video Games store at http://www.on-line retailer.com/
toys.
2. Select the items you want. Please use our Shopping Cart rather
than our 1_Click^{SM} ordering to pay for your order with a gift certificate.
3. Hit the ‘Proceed to Checkout’ button.

To make matters even worse, the recipient of a targeted promotion must be connected to the Internet to respond to the promotion. Often an e-mail recipient will download e-mail from an internet connected device to a non-internet connected device for example, a handheld PDA, for later perusal at a location that may not have convenient internet access. However, it can be appreciated from the foregoing discussion, that to perform the procedural and navigational steps required for the recipient to respond to the promotion, the recipient must be connected to the internet because there are no procedures for the recipient to navigate the steps outlined in the promotion without connecting to the retailer's web site Desirably a targeted promotion would include interactive controls and content that is generated such that it is optimized and compatible with the respective hardware capabilities, connection characteristics, and user preferences associated with all e-mail clients. Such interactive controls would allow a recipient of a targeted promotion to respond to it without needing to undertake time consuming navigational and procedural steps either to generate an order or to obtain additional information that relates to the promotion. Additionally, it is desirable to have a procedure which will allow the recipient to respond to the promotion without having to respond from a device connected to the internet.

There are a number of problems that must be solved to overcome the above discussed limitations of traditional procedures used to generate and distribute e-mail. For example, it is rare that an author knows the respective hardware capabilities, connection characteristics, and user preferences of each e-mail enabled device to which a message is targeted. Even if the author did know of such capabilities, characteristics, and preferences, the author would typically be required to perform a number of laborious, time consuming procedures to generate such messages. For example, for each respective device, the author would typically need to manually compose each respective message based on each respective e-mail client's respective capabilities, characteristics, and associated preferences. But, as discussed above, these labors will be moot if the targeted message is forwarded to a device that has different such capabilities, characteristics, and preferences than the device for which the original e-mail message was composed. It is also advantageous that the message be composed automatically without human intervention, and that the message ultimately received by a recipient substantially match hardware, software, and user preference attributes of each individual client device and user.

Additionally, if an author desires to compose a message, for example, with a similar intent but that is targeted to a different audience than a prior targeted message, the author would typically be required to generate individual messages that not only conform to the different audience, but that also conform to the such capabilities, characteristics and preferences discussed above. For example, it may frequently be desirable to alter the content of an e-mail message to take advantage of a particular cultural context or to avoid particular language or stereotypes that may be detrimental to the intent of the message. For example, if it is known that the receiver identifies themselves with the Armenian-American community it may be advantageous to frame an advertisement so that it is well received by that member of the Armenian-American community and uses for example video images showing Armenian-American's enjoying the product and Armenian music as the background. By the same token, when marketing the same products to an individual identifying himself or herself with the Irish-American community, it may be advantageous to show Irish-Americans enjoying the product and traditional Irish music in the background.

In light of the above, what is needed is a procedure for generating and exchanging optimized e-mail that conveys the intent of the e-mail publisher across a wide variety of audiences within the boundaries of the hardware capabilities, and connection characteristics of all e-mail enabled devices. Ideally, such optimized e-mail will be generated in a manner that is sensitive to any user preferences of an end user for whom the message is directed. Desirably, a receiver of an e-mail message would be able to access and respond to the message with interactive graphical user interface controls in a manner that does not depend on whether the e-mail client is on-line or off-line. It is also desirable that the e-mail not only be optimized for the user's normal hardware, software, communications channel and other attributes if such are known to the e-mail author, but most desirably to the actual attributes at the time the e-mail message is received by the recipient.

Also needed are system architectures and program and data structures coupled or used together with appropriate security protocols, procedures, methods, and that provide the desired functionality in a secure manner and desirably do so in an architecture-neutral operating-system neutral, and transport layer neutral environment.

### SUMMARY

The invention provides numerous innovations and enhancements over conventional systems and methods, and where implemented in whole or in part as a computer program (for example, as software, firmware, a combination of software, firmware and/or hardware) also provides computer program and computer program product as well as various articles of manufacture.

In one aspect, the invention provides a system, device, method, computer program and computer program product for a hardware architecture neutral and operating system neutral and network transport neutral method for authorizing a specific user the right to access a specific resource such as an e-mail message or a promotional coupon.

In another aspect, the invention provides a system, device, method, computer program and computer program product for a hardware architecture neutral and operating system neutral and network transport neutral method for representing a digital certificate that enables at least encryption and digital signatures using substantially less storage and bandwidth than conventional digital certificates.

In another aspect, the invention provides a system, device, method, computer program and computer program product for a hardware architecture neutral and operating system neutral and network transport neutral method for implementing two or more security protocols such as 1) secure interactive sessions, 2) secure unidirectional messaging, 3) secure software downloading, 4) secure software upgrading, and 5) secure issuing of digital certificates, using a common set of data formats, algorithms, subroutines, and methods.

In another aspect, the invention provides a system, device, method, computer program and computer program product for a hardware architecture neutral and operating system neutral and network transport neutral method for secure interactive sessions using less software code and network bandwidth than conventional systems.

In another aspect, the invention provides a system, device, method, computer program and computer program product for a hardware architecture neutral and operating system neutral and network transport neutral method for secure unidirectional messaging using less software code and network bandwidth than conventional systems.

In another aspect, the invention provides a system, device, method, computer program and computer program product for a hardware architecture neutral and operating system neutral and network transport neutral method for secure certificate issuing using less software code and network bandwidth than conventional systems.

In another aspect, the invention provides a system, device, method, computer program and computer program product for a hardware architecture neutral and operating system neutral and network transport neutral method for secure response session using less software code and network bandwidth than conventional systems.

In yet another aspect, the invention provides a system, device, method, computer program and computer program product for a hardware architecture neutral and operating system neutral and network transport neutral method for secure unidirectional response message using less software code and network bandwidth than conventional systems.

The invention provides numerous innovations and enhancements over conventional systems and methods, and where implemented in whole or in part as a computer program (for example, as software, firmware, a combination or software, firmware, and/or hardware) also provides computer program and computer program product as well as various articles of manufacture. Furthermore each of the innovations provides and/or supports one or more business models and methods of during business particularly when the innovations contribute to a generated revenue stream (either directly or indirectly) and fosters relationships between consumers and/or businesses.

For example, the invention provides a system, device, method, computer program, and computer program product for a hardware architecture neutral computer program language and structure and method for execution.

The invention further provides a system, device, method, computer program, and computer program product for autonomous generation of customized file having procedural and data elements from non-procedural flat-file descriptors.

The invention further provides a system, device, method, computer program, and computer program product for intelligently scaling message procedural/data sets to adapt the procedural/data sets to receiver attributes and maintain message intent.

The invention further provides a system, device, method, computer program, and computer program product for an intent preserving message adaptation and conversion system and method for communicating with sensory and/or physically challenged persons.

The invention further provides a system, device, method, computer program, and computer program product for searching and selecting data and control elements in message procedural/data sets for automatic and complete portrayal of message to maintain message intent.

The invention further provides a system, device, method, computer program, and computer program product for adapting content for sensory and physically challenged persons using embedded semantic elements in a procedurally based message file.

The invention further provides a system, device, method, computer program, and computer program product for forward and backward content based version control for automated autonomous playback on client devices having diverse hardware and software.

The invention further provides a system, device, method, computer program, and computer program product for reducing unauthorized access by procedural messages executing in a computer system to computer system or memory or programs or data stored therein.

The invention further provides a system, device, method, computer program, and computer program product for self-directed loading of an input buffer with procedural messages from a stream of sub-files containing sets of logical files.

The invention further provides a system, device, method, computer program, and computer program product for device-neutral procedurally-based content display layout and content playback.

The invention further provides a system, device, method, computer program, and computer program product for thin procedural multi-media player run-time engine having application program level cooperative multi-threading and constrained resource retry with anti-stall features.

The invention further provides a system, device, method, computer program, and computer program product for streaming multimedia-rich interactive experiences over a communications channel.

The invention further provides a system, device, method, computer program, and computer program product for cooperative application-level multi-thread execution including instruction retry feature upon identifying constrained system resource.

These and other aspects of the system, device, method, computer program, and computer program product are provided by the invention and each may be utilized separately or in various combinations to provide a broad range of structures, functions, and capabilities.

In still another aspect, the invention provides various signals, such as signals in the form of digital bit sequences, for providing such communication either with or without security features.

### BRIEF DESCRIPTION OF DRAWINGS

FIG. 1 is a diagrammatic illustration showing a block diagram that illustrates aspects of an exemplary system, according to one embodiment of the present invention;

FIG. 2 is a diagrammatic illustration showing block diagram that illustrates aspects of an exemplary sender/publisher of content, according to one embodiment of the present invention;

FIG. 3 is diagrammatic illustration showing an enumerated list that illustrates aspects of an exemplary Extensible Markup Language (XML) document from a sender/publisher, according to one embodiment of the present invention;

FIG. 4 is a diagrammatic illustration showing block diagram that illustrates aspects of an exemplary sending story server, according to one embodiment of the present invention;

FIG. 5 is a diagrammatic illustration showing block diagram that illustrates aspects of an exemplary story enabled client, according to one embodiment of the present invention;

FIG. 6 is a diagrammatic illustration showing block diagram that illustrates aspects of an exemplary procedure, according to one embodiment of the present invention;

FIG. 7 is a diagrammatic illustration showing block diagram that illustrates aspects of an exemplary procedure, according to one embodiment of the present invention;

FIG. 8 is a diagrammatic illustration showing block diagram that illustrates aspects of an exemplary Story Compiler implemented on a computer, according to one embodiment of the present invention;

FIG. 9 is a diagrammatic illustration showing block diagram that illustrates aspects of an exemplary procedural layout of rectangles on a virtual display screen, according to one embodiment of the invention.

FIG. 10 shows an exemplary embodiment of a Message ID according to the invention; and,

FIG. 11 is a diagrammatic illustration illustrating steps for creating an embodiment of a message tag from a message ID.

### DETAILED DESCRIPTION OF EMBODIMENTS OF THE INVENTION

Aspects of the inventive system, system architecture, and method are now described so that the security features which may advantageously be used with such system, system architecture, and method will be more readily understood. It will be apparent to those workers having ordinary skill in the art in conjunction with the description provided herein, that the inventive security apparatus, data structures, instructions, codes, methods and other aspects may be utilized with StoryMail™ type features as well as with other non-StoryMail systems and methods. Exemplary system architectures and methods are therefore described first, followed by a more detailed description of other security features of the invention. Other aspects of the invention are described in the related applications which are hereby incorporated by reference. While the term storymail or StoryMail may be used to conveniently describe certain types of structures, files, or operations, it will be appreciated that structures, files, or operations that do not formally or exactly satisfy the Storymail criteria but that provide Storymail-like or would otherwise operate with the inventive element may also or alternatively be used.

Exemplary System Architecture and Method Embodiments

We first provide a top-level description of some of the key technology components of the invention called a story or other content and systems and methods for authoring, communicating, securing, and rendering such content, along with a description of some of the advantages provided by stories. This description is then followed by several sections that describe the manner in which certain functional and procedural capabilities and/or advantages are achieved in the inventive system. Section headers when provided are provided merely as a convenience to the reader as a guide to portions of the description addressing certain aspects of the invention; however, it will be appreciated that various aspects of the invention are described throughout the description and certain aspects are best described in several portions of the description rather than in a single portion to that relationships may be better understood. Therefore, the description should be considered as a whole with respect to the characteristics or attributes of any structure, system, device, method, procedure, computer program, or other aspect of the invention.

For purposes of an initial working definition and in somewhat simplified terms, a story as the term is used in this description generally refers to a single, author once, play everywhere file or data/command structure that is interactive either on-line or off-line and that can be used to distribute rich multimedia messages or other rich-media content to all e-mail enabled clients. (More complete as well as alternative definitions of “stories” are described elsewhere in the detailed description.) Next, aspects of an exemplary system to generate, transfer and play stories, according to one embodiment of the present invention, are described. Once this top level description has been provided, the detailed operation of the respective business or operating models and methods of the invention will be described and more readily understood.

The term e-mail is used here because it represents a form of electronic communication that is known in the art, but it will be appreciated that the inventive system, method, software, business and operating model pertain to much more than what is normally envisioned for conventional e-mail systems and methodologies. The inventive e-mail enhancement, extension, or replacement contemplates some generalized electronic content that is directed to one, a plurality, or a multitude of recipients.

Recall that in greatly simplified terms, a story is a single, author once, play everywhere file or data/command structure that is interactive either on-line or off-line that can be used to distribute rich multimedia messages or other rich-media content to all e-mail enabled clients. Stories can be used to distribute and coordinate e-commerce transactions, order fulfillment, meeting scheduling, advertisements, catalog item descriptions, customized catalogs and brochures, holiday greeting cards, electronic storybooks, driving directions, vacation slide and picture shows, surveys, real-estate walk thru, medical care pamphlets, pharmaceutical information pamphlets, recipes, business presentations, party invitations, instructional manuals, entertainment, and numerous other applications, particularly where the message consists of more than merely a text or symbolic message. Several of such exemplary applications include, for example, surveys, forms, contracts.

Story content creation is advantageously automated and dynamically adaptive, because a story is optimized over a plurality of variables to selectively communicate elements of an e-mail message to e-mail client devices and users. Such variables include, for example, client device hardware capabilities, network connection characteristics and user preferences. This is accomplished from a standpoint, for example, of CPU speed, display type, screen size, the existence of and or attributes of audio and/or video capabilities, data scalability, language, use of or not use of audio or visual content, nominal speed or bandwidth of all of the communication links and protocols, and the like.

In preferred though not all embodiments, a final story is not generated until substantially all such relevant e-mail client information is determined during the time of connection of the client device. In a sense, the system and procedure of the present invention is contrary to other prevailing trends (which attempt to pre-form content so that is available as early as possible) in that StoryMail actually delays composition of the final message until it is ready to be received. For example, if it is determined that an e-mail client cannot view motion video but can display text and play audio, the story will be generated such that it does not include motion video, but rather textual and/or audio elements that communicate the intent of the e-mail publisher within the capabilities of the e-mail client.

In yet another example, even though a client device may be capable of receiving and rendering a very rich message, if the then prevailing communication channel is only supporting low-speed or low-bandwidth communication, a story is generated such that the richness of the message is reduced so that the message is optimized for the attributes of the client device and the user preferences at that moment in time.

Sometimes, the message may be optimized or nearly optimized to be received within any time constraints that may be imposed, however, unlike systems and methods that must satisfy real-time or near real time constraints, the story need not provide real-time delivery, as it is intended to be a messaging and communication system, method, and operating model, rather than a real-time rich-media broadcast or streaming system. In this regard, a story is a fully aware e-mail message that is optimized to substantially deliver the intent of an e-mail publisher across the broad range of all e-mail client architectures.

A story may further be optimized to comply with a predefined set of user defined preferences, making each story beneficially configurable for physically challenged individuals. This is because for every logical element (either text, sound, images, video, or the like logical elements) there is an underlying textual description of that logical element. In addition, there are contextual logical elements included as may be needed to insure that the intent of the message may be easily understood in text or audio only representations. An example of such contextual logical element would be a text element that provides an overview of what is on the screen to be rendered as text or audio in cases where some or all of the screen's visual elements can not be seen by the recipient on the receiving device.

In a preferred embodiment, all logical elements have corresponding semantic information so that it can be known or determined which elements to use under varying circumstances. For example, the aforementioned contextual logical text element would have associated semantic flags packaged with it inside a story indicating that the element contains text providing an overview of the elements displayed on a screen for use when it is known that the recipient cannot view the screen. Such a case might be when a story player application is used to render and control a rich media message for someone whose only means of communication to the rich media message playing application is over a voice only telephone connection. In other embodiments, an audio representation, either recorded or generated by a text to speech engine may provide audio information backup—contextual information, or semantic information rather than text. In this manner an individual can read text and the text can automatically be articulated for a blind individual.

In one embodiment, the inventive system, method, and operating model are designed to interface with a peripheral device that generates a Braille or other tactilely sensible indicia corresponding to the story. This peripheral device may either be linked to a conventional client device, such as a computer, or integrated within the device. Using semantics, there is always an alternative sensory presentation mode.

Stories are self contained and lightweight, meaning that stories have relatively small memory and processor requirements and can be played on client devices the types and sophistication of which are virtually unlimited. A story is self contained because in at least one embodiment, a story is actually a single file that is made up of a number of component logical files. Each component file encapsulates, for example, one or more of computer program instructions, control information, user input forms, validation procedures, and/or multimedia content. Each component logical file is respectively compressed and all of the component logical files are combined, packaged, compressed again to generate the single story file.

A story is lightweight not only because when it is executed, or played, a story's contents are selectively and sequentially decompressed. But also because a story only includes those elements that are optimized and compatible with the e-mail client's hardware capabilities and network connection characteristics, making stories lightweight (thin) enough to run on inexpensive information appliances or other devices. In fact one of the great advantages of the StoryMail system is its ability to support the hardware capabilities and network connection characteristics of virtually any client device. In fact, a story can even be played on a client device that is not multimedia enabled because a story always has a set of text that describes, or narrates any non-textual element of the story. The story also contains semantic flags indicating the circumstances under which to render all text or non-textual elements.

A story according to embodiments of the invention is reliable because it is played in a novel run-time environment, wherein, unlike an HTML Web page where there may be links to other servers to provide further information, a story is a self-contained unit. The novel run-time environment is largely deterministic because of the self contained cooperative multitasking system employed in the playback engine and the explicit input buffer coding instructions with fixed size memory buffers. So if it runs correctly one time on one device it will almost certainly run correctly most of the time on all devices.

A run-time environment such as this is more reliable than, for example a pre-emptive multitasking system using the device's threading mechanism, or an architecture which allows for variable size buffering. Also in story messaging all content is present on the target device before the story is run. So unreliable connections to other devices or content on a network are unnecessary and part of a story cannot be missing since they are packaged together in a single logical file.

Because a story is self contained and reliable, creation of story content can be completely automated, devices made today will be able to handle future content without upgrades. This provides for intelligent content specific scaling and compression, it is easily stored and exchanged between e-mail clients as a single file, for example, that can be: embedded in a Web page, embedded in an e-mail attachment, stored in ROM, streamed from a server, run as a MIME type, run as an ActiveX component, run as a plug-in, and/or run as an ActiveX component.

Most story enabled devices will run or play a story in a window, or in a non-windowed operating environment such as occur on in basic or thin client devices, on a display device screen. Such devices include, for example, a desktop computer, notebook computer, personal data assistant (PDAs), telephone, set-top box, movie marquee, informational kiosk, Internet e-mail appliances, billboard, microwave oven, point-of-sale displays, gasoline pump, vending machine, instructional appliance, automobile display device, global positioning system (GPS), point-of-sale display, and myriad of other device types are supported. In fact, a story can even be played on a client device that is not multimedia enabled because preferred embodiments of the inventive story always have a set of text that describes, or narrates any non-textual element of the story, along with semantic information describing the role of each logical element. In one embodiment, a device may play a story entirely with voice commands and automatically articulated responses.

It is noted that although applicant describes embodiments of the inventive structure, method, computer program, operating model, and structure and organization of content used in or in conjunction with other aspects of the invention, the underlying inventive concept and indeed many embodiments of the invention do not require all features described here. Many such structures and procedures though advantageous and desirable are optional. Including text behind each logical element of the story is a preferred embodiment. Therefore, with respect to the structure and content of a story described here, it should be understood for example, that not all stories must contain underlying text behind each logical element of the story.

These optimizations make a story very flexible, scalable, and powerful. Unlike some conventional systems and methods, a story maintains a focus on the intent of the message and preserves that message intent in spite of its ability to selectively communicate elements to client devices and users.

For example, in conventional video streaming systems the primary goal has been to maintain real-time transmission of the video stream and to relax quality to the point where almost all picture quality has been lost if necessary to maintain continuous operation. For an advertiser promoting a high-end product, such as example a diamond ring, it is very important to maintain the quality and clarity of the product image. If the transmitted image(s) of the diamond ring make the ring appear undesirable, the entire purpose for the advertisement is lost. Therefore, attempts should be made to customize composition of the message so that where possible the bright high-resolution image of the diamond ring is presented to the receiver, and if such presentation is not possible then to provide an alternative possibly textual description of the ring which creates the same desire to own product as the bright clear image would. This particular example really illustrates the notion of selecting or substituting content to maintain the intent all of the StoryMail™ message independent of the device hardware capabilities or network connection characteristics and even to some extent independently of user preferences.

The inventive structure and method may be applied to on-line auctions as well and provide significant benefits here. For example, a story message provides rich product descriptions complete with BID forms; bid limit exceed notifications providing a bidder a chance to upgrade a bid from a form embedded in the message without requiring the bidder to go to the action web site; and, bid accepted notification with transaction completion automation.

Traditionally, on-line auctions require composing a product description that may not scale up and down depending on the device. Traditional on-line auctions typically require repeated visits the site to determine if a bid is accepted. Furthermore, traditional on-line auctions generally require further visits to a Web site or the placement of a phone call to complete a transaction.

It can be appreciated that stories can be used at point of sale to provide looping demonstrations and/or advertisements of a product. For example, a story can be embedded in read-only-memory (ROM) of microwaves, stereos, set top boxes, and the like. Playback of such a story can be in the store that displays the story 180 enabled product for sale. The manner in which the story is played back may be modified by each viewer according to view preferences. For example the underlying content may have English, French, Spanish, and Russian audio and text content that may be selected by the viewer. Such input may be buttons on the playback device, a touch screen device, voice input, or other input devices as are known in the art. Additionally, story enabled devices, for example, soda machines, can be implemented to play media rich advertisement stories that can be updated using only a phone line to upload a different story. The content of such story may be communicated, for example overnight to a large variety of different device types, yet will be playable by all such device types.

There are other exemplary applications for stories, for example, stories can also be used for meeting scheduling, advertising, catalog item descriptions, holiday greeting cards, electronic storybooks, driving directions, vacation slide and picture shows, surveys, real-estate walk throughs, medical care pamphlets, pharmaceutical information pamphlets, cooking or production recipes, business presentations, instructional manuals, entertainment, and numerous other applications where the message consists of more than merely the text message.

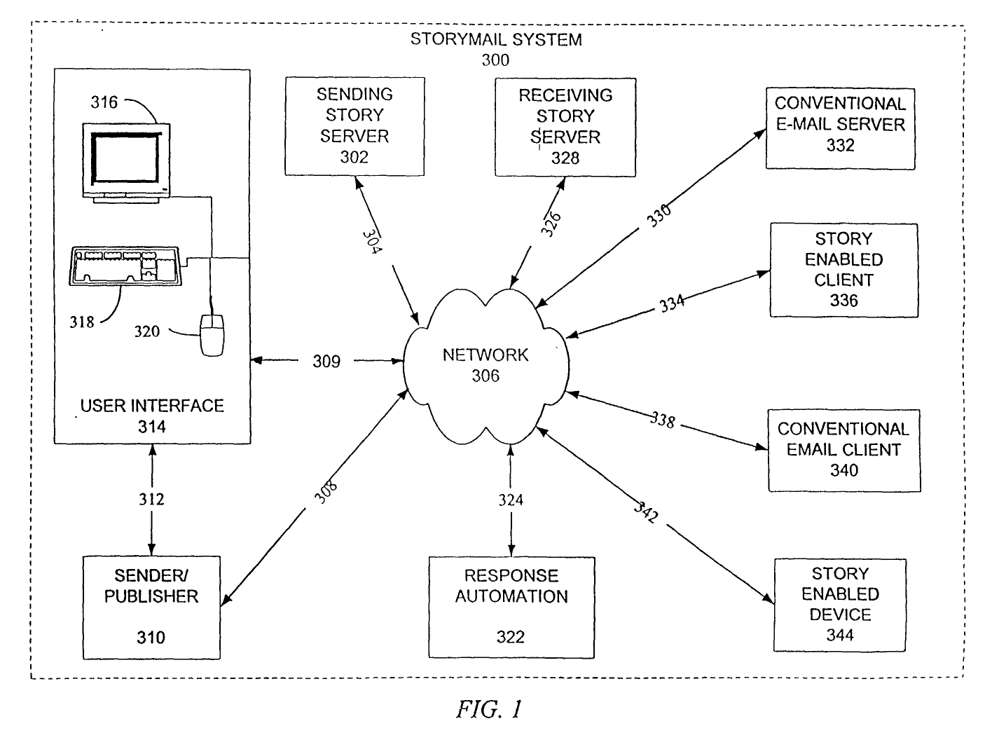

We now describe aspects of an inventive next generation e-mail system that is used to generate, distribute, and play stories. In one embodiment, a story that is sent as a message from a server to a client device is called StoryMail. Referring to FIG. 1, there is a block diagram that illustrates aspects of an exemplary embodiment of a StoryMail system 300. StoryMail System 300 (also referred to simply as system 300) is a distributed client/server system with server peering.

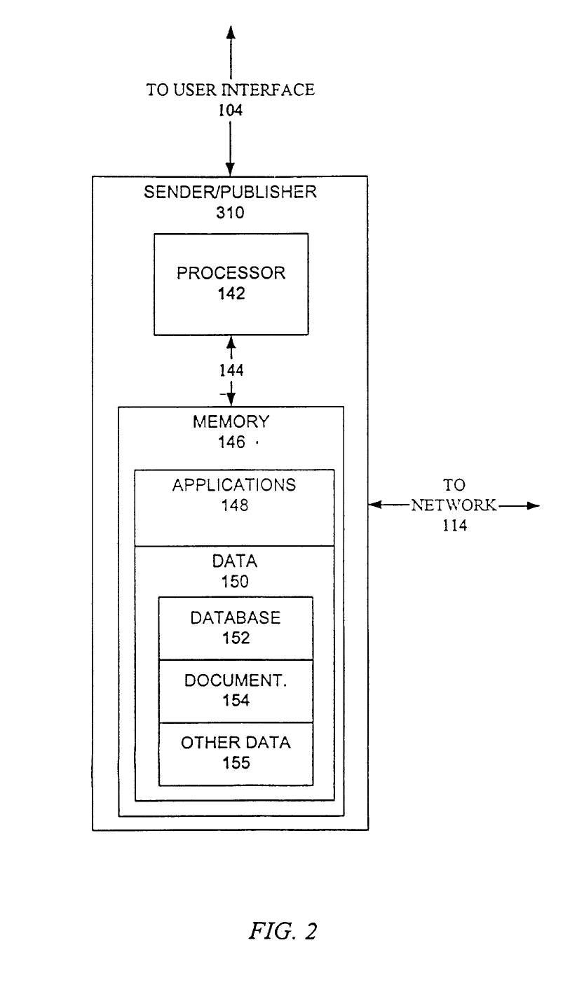

Sender/publisher 310 is connected across I/O interface 312 to user interface 314. Sender/publisher 310, for example, can be a general-purpose computer, provides at least a subset of the information and content used to generate and transmit a story to sending story server 302. In other words, parts of a story may reside on any server anywhere or computer that can be addressed, that is connected to network 306. In this case, sender/publisher 310 provides links, for example, a Uniform Reserve Locator (URL) address of the document or other resource to be included in the story. Sender/publisher 310 includes a number of components which are described in greater detail below in reference to FIG. 2.

I/O interface 312 can be any type of I/O interface, for example, a peripheral component interconnect (PCI) bus interface, a SCSI interface, or the like. Sender/publisher 310 is also connected across I/O interface 308 to network 306. As an alternative to 312, I/O interfaces 308 and 309 can be used if information is passed through network 306. I/O interfaces 308 and 309 can be any type of I/O interface, for example, a modem connected to a public telephone network, a leased line, or a wireless radio wave or optical interface. Network 306, for example, can be a local area network (LAN) or a wide area network (WAN).

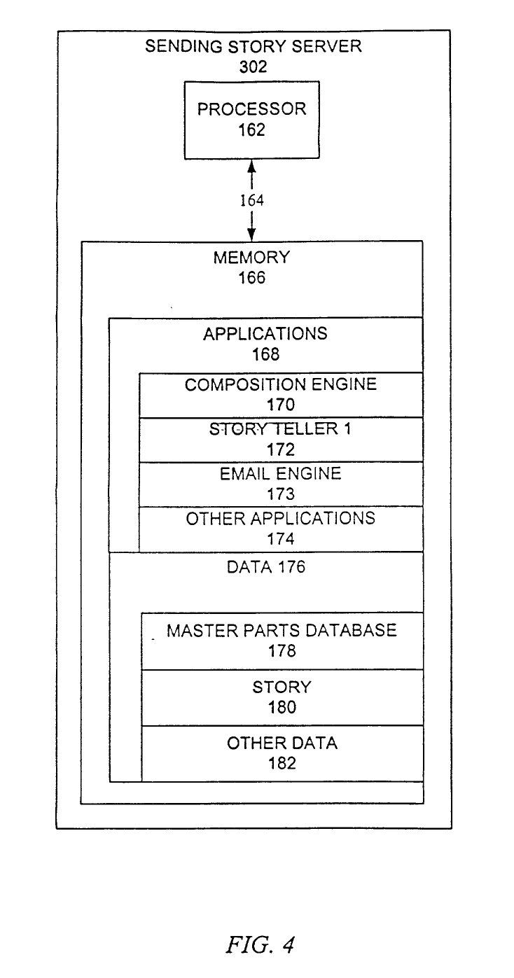

Network 306 is connected across I/O interface 304 to sending story server 302. Sending story server 302, for example, is a general-purpose computer or device for generating and transmitting stories to client devices, such as conventional e-mail server 332, story enabled client 336, conventional e-mail client 340, and story enabled device 344. A greater detailed description including aspects of an exemplary embodiment of sending story server 302 is provided below in reference to FIG. 4. I/O interfaces 304, 308, 309, 324, 326, 330, 334, 338, and 342 can be any type of I/O interface, for example, a modem connected to a public telephone network, a leased line, or a wireless radio wave interface.

In one embodiment, the system of the invention includes receiving story server 328, for example, is a general-purpose computer or device for transmitting stories to client devices, such as those client devices listed above. One difference between receiving story server 328 and sending story server 302, for example, is that sending story server 302 is able to generate stories and distribute stories, whereas receiving story server 328 is not able to generate stories but is able to distribute already generated stories. Receiving story server 328 is beneficial because it may contain functionality which can be used to eliminate the need for providing that same functionality in story enabled clients 336 and story enabled devices 344. This is advantageous because the computation and/or memory capacity of such devices is normally more limited than that of the servers 328. In addition, since there are likely to be many more story enabled clients 336 and story enabled devices 344, the implementation costs are lower if the functionality is contained on the servers 328 rather than on the story enabled clients 336 and story enabled devices 344. Examples of such functionality include proxy server functions, placing stories into in-boxes, and security features such as decryption, authentication and digital signature verification.

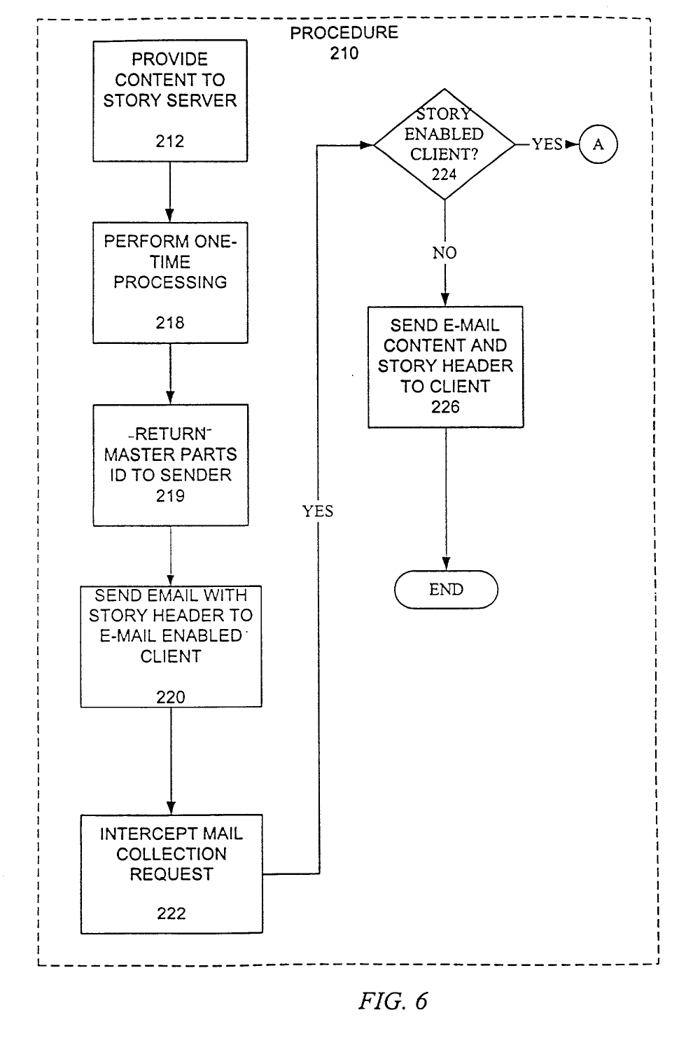

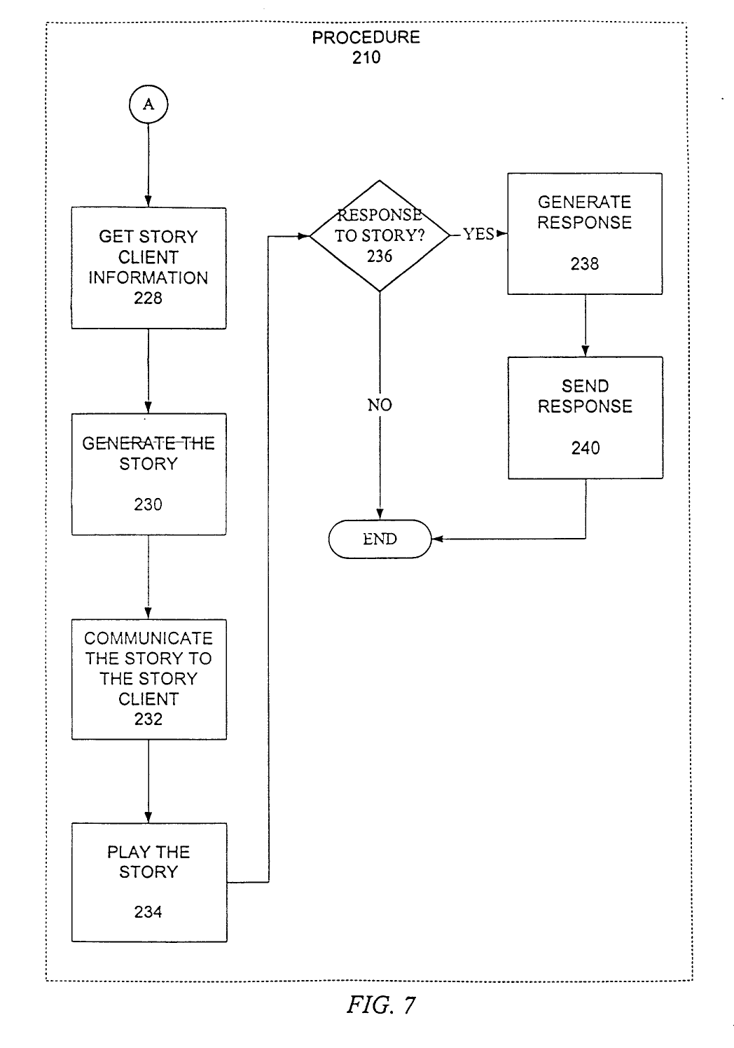

In one embodiment, network 306 is connected to conventional e-mail server 332 which is a traditional e-mail server used by a number of machines connected to network 306 to distribute and collect e-mail messages. Procedures for a machine to distribute and collect e-mail messages are known in the art. Conventional e-mail server 332 provides story messages to both non-story enabled devices, for example, conventional e-mail client 340, as well as story enabled clients and devices, for example, story enabled client 336 and story enabled device 344. As will be described in greater detail below, the presence of conventional e-mail server 332 is not necessary for story enabled client 336 or story enabled device 344 to receive stories. However, the presence of conventional e-mail server 332 is necessary for conventional e-mail client 340 to receive a story enabled message. In one embodiment, a story enabled message will not include a story, but rather includes information indicating that a richer message, or story underlies the story enabled message. This embodiment is described in greater detail below in reference to FIG. 6 and FIG. 7.

Story enabled client 336 includes, for example, computer program applications and data for playing a story received from a story server, for example, sending story server 302 and/or receiving story server 328 Story enabled client 336 is, for example, a general-purpose computer, a notebook computer, a personal digital assistant, a telephone, a set-top box, an Internet e-mail appliance, a movie marquee, an informational kiosk, a billboard, a gasoline pump, a vending machine, an instructional appliance, an automobile display device, a GPS system, a point-of-sale display, and the like. Story enabled client 336 starts life as a conventional email client 340. It becomes story email client 336 when story enabling software is downloaded or installed from a network or direct connection to another device. Story device 344 has the story enabling software built in by the manufacturer.

Conventional e-mail client 340 is a typical e-mail client, for example, a general-purpose computer that is not able to execute, or play a story. However, conventional e-mail client 340 is able to receive e-mail messages that include information indicating that a richer content message, or story is behind the e-mail message. In one embodiment, besides including information that a story underlies the e-mail message, the e-mail also includes, for example, an e-mail message that delivers the publisher's 310 message in a traditional e-mail format. Such traditional e-mail formats include, for example, text, HTML and/or attachments. Such an embodiment is advantageous for a number of reasons. For example, while conventional e-mail client 340 will not be able to play a story without upgrading its computer program applications, it will still receive content that corresponds to publisher's 310 message or promotion. Additionally, the message can be forwarded to another e-mail client device, for example, story enabled client 336, wherein the richer message will be available to the other client device.

In one embodiment, conventional e-mail client 340 upgrades its capabilities to enable it to play a story. In a situation where conventional e-mail client 340 upgrades its computer program applications to enable it to play a story, conventional e-mail client 340 would become a story enabled client 336. In one embodiment, conventional e-mail client 340 can perform such upgrades, for example, by downloading a story player from a web site or an FTP site, or by loading a story player from a CD-ROM or diskette. In a preferred embodiment, conventional email client 340 upgrades by responding to a link provided in the email message, wherein the link points to a download image or site.

Story enabled device 344 is manufactured with story functionality built in. Such devices include networked household appliances, cell phones, smart cards, and pagers.

Each client device 336, 340, and 344 includes, for example, an e-mail program (not shown) that respectively receives and/or delivers e-mail respectively from/to one machine connected to network 306 from/to another machine connected to network 306. To facilitate such reception and delivery, an email program utilizes Internet email protocols, for example, known POP3 or IMAP protocols. In one embodiment, such an e-mail program is a conventional e-mail program, such as Microsoft Outlook Express®. In another embodiment, the e-mail program is a special e-mail program designed specifically to receive and/or transmit stories to another client or device across network 306.

Referring to FIG. 2, there is a block diagram that illustrates aspects of an exemplary sender/publisher 310, according to one embodiment of the present invention. Sender/publisher 310 includes processor 142 connected across local bus 144 to memory 146. Processor 142 is used to execute computer program applications 148 and fetch data 150 from memory 146. Local bus 144 can be any type of bus, for example a peripheral component interconnect (PCI) bus, as long as local bus 144 has a set of signal lines that can be used by processor 142 to transfer information respectively to and from memory 146.

Data 150 includes, for example, database 152 representing any combinations of textual information, motion video, audio, forms, automation scripts, a story recipient list and any other message content, communication, or the like, that may be sent in an electronic format. A form can be any type of form or document, for example, a purchase order form, a registration or an application form. Typically a form provides an inquiry and provides some instructions for answering or responding to the inquiry. Database 152 is a standard database that can be created and managed using any of a number of conventional database tools.

In one embodiment, database 152 includes, for example, textual descriptions in more than one language of a number of products, digital or binary images of the products, motion videos to advertise and illustrate the products, product identification numbers, audio clips to advertise and describe the products, and/or recipient information, such as a list of e-mail addresses to which to send a story. Desirably, for every non-textual item of data in database 152, a textual description of that item of data is available. For example, if database 152 includes a color photo of a particular toy, there will be a corresponding text description of that toy.

In a preferred embodiment, a digital or binary image can have a set of scaled and color depth versions of the binary image. For example, if database 152 includes a 300 dots per inch (dpi) 24-bit color binary image of the cover of a book, database 152 will also include a 1-bit black and white representation of the image, an 8-bit and 16-bit gray scale representation of the image, and various resolutions of each of the resolutions, such as 100 bit and 200 bit resolutions.

In a preferred embodiment, scaling of logical story elements can occur at three different times: (1) when generating the message; (2) when executing the procedural elements of the message; and, (3) while the message elements are being rendered by the hardware specific functions (e.g., the HAL functions) that connect a portable story playback engine to actual device specific hardware.

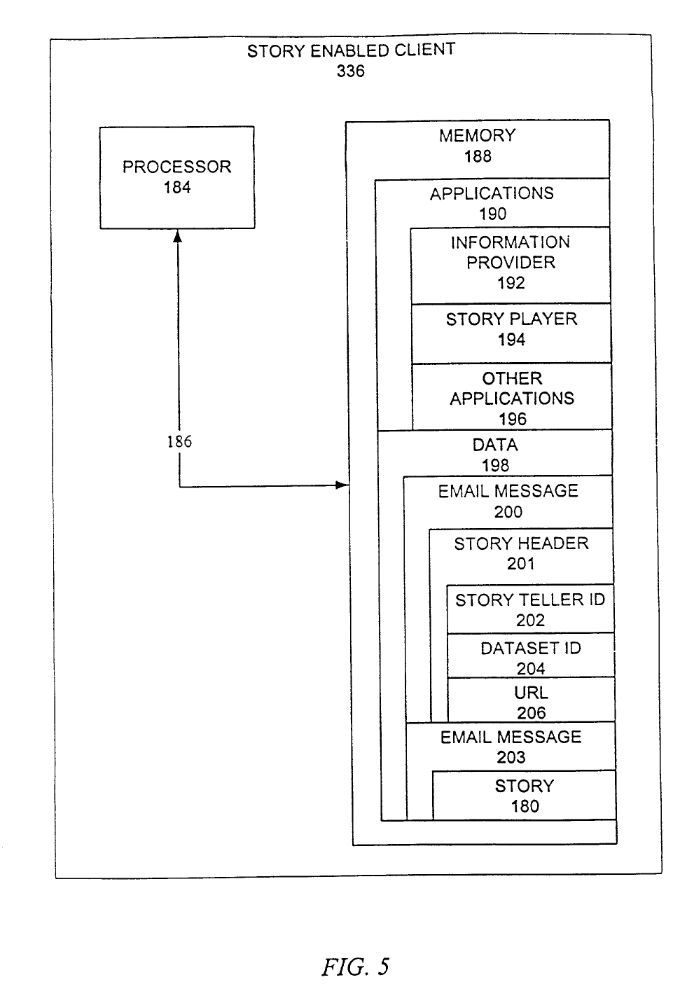

For example, in one preferred embodiment, sending story server (see FIG. 1) scales the story content when generating the message to conform to the story enabled clients' 336 hardware capabilities, network connection characteristics, and specified user preferences at the time that such information are determined (see FIG. 7, step 228). In yet another preferred embodiment, story player 194 (see FIG. 5) scales the content of the story when the procedural elements of the story are executed, or played. For example, a digital image may be scaled from 300 dpi to 200 dpi while the digital image is being displayed. In yet another embodiment, story players 194 HAL may scale the story to fit into a particular display screen size and/or add scroll bars to the display so that an entire story can be viewed.

Document 154 is author once information created by using a number of structured document languages, for example, extensible markup language (XML), and Excel spreadsheet format, database records extracted with SQL, and the like. In a preferred embodiment, Document 154 is an XML document. Document 154 can be created in a number of different ways. For example, Document 154 can be created using any of a number of known XML Editors, Word processors, device drivers, and the like.

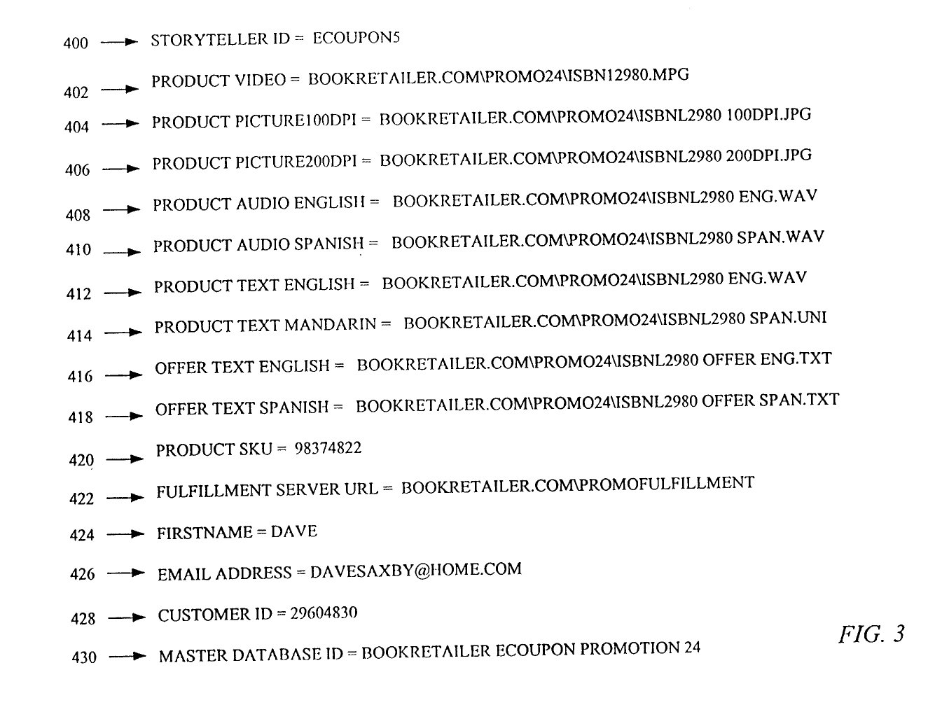

Referring to FIG. 3, there is a block diagram that illustrates aspects of an exemplary Document 154 used by sending story server 302 (see FIG. 1) to generate a message/promotional story 180, according to one embodiment of the invention. FIG. 3 uses a structured document syntax pseudocode that does not conform to any one particular structured document syntax, but is rather used only for purposes of illustrating the invention In a preferred embodiment, XML document 154 includes a tag that identifies a particular storyteller 172 (see FIG. 4) and a unique identifying attribute of the particular storyteller 172.

The pseudocode describes a set of tags that each respectively in turn describes an element, wherein each tag is followed by an equals sign (“=”) and a corresponding textual description that defines some other property of the element. The property can be either an absolute description string, an embedded document, or a string that includes a URL and a document name. If a descriptive property is a URL and document name, the URL will be accessed and the identified document downloaded when document 154 is parsed by story server 302 (see FIG. 4) during one time processing of document 154, as described in greater detail below in reference to FIG. 4.

Line 400 includes a tag that identifies a “STORYTELLER ID” element, which is followed by an attribute of the element, “ecoupon 5”. “Ecoupon 5” identifies a unique storyteller 172 (see FIG. 4) in story server 302 (see FIG. 1). In this example, ecoupon 5 storyteller 172 will be used to generate a form and a user interface to be used by a sender/publisher 310 (see FIG. 1) to generate and distribute one or more ecoupon stories 180 (see FIG. 4) to distribute to one or more customers as dictated by sender/publisher 310 (see FIG. 1). Storytellers 172 are described in greater detail below in reference to FIG. 4.

Line 402 includes a tag that identifies a “PRODUCT VIDEO” element, which is followed by an attribute of the element that identifies a particular MPEG motion video, “BOOKRETAILER.COM\PROMO24\ISBN12980.MPG” that is to be distributed in a story 180 (see FIG. 4). In this example, the motion video is identified by a URL link to the author's database 152 (see FIG. 2) and a corresponding motion video document.

Lines 404 and 406 include tags that identify respective product picture elements, wherein each respective tag identifies a specific binary image (or other digital image or graphic) that has a respective different pixel resolution. For example, line 404 includes a tag that identifies a “PRODUCT PICTURE 100DPI” element, which is followed by an attribute of the element that identifies a 100 dpi binary image, such as the JPEG image “BOOKRETAILER.COM\PROMO24\ISBNL2980 100DPI.JPG”. Whereas, line 406 includes a tag that identifies a “PRODUCT PICTURE 200DPI” element, which is followed by an attribute of the element that identifies a 200 dpi binary image, such as the JPEG image “BOOKRETAILER.COM\PROMO24\ISBNI2980 200DPI.JPG”. Both binary image files are identified by respective URL links to the author's database 152 (see FIG. 2) and a corresponding JPEG document.

Lines 408 and 410 include tags that identify respective audio file elements, wherein each respective tag identifies a specific audio file that is implemented in a different language. In particular, line 408 includes a tag that identifies a “PRODUCT AUDIO ENGLISH” element, which is followed by an attribute of the element that identifies an audio file that is implemented in English (“BOOKRETAILER.COM\PROMO24\ISBNL2980 ENG.WAV”). Whereas, line 410 includes a tag that identifies a “PRODUCT AUDIO SPANISH” element, which is followed by an attribute of the element that identifies an audio file that is implemented in Spanish (“BOOKRETAILER.COM\PROMO24\ISBNL2980 SPAN.WAV”). Both audio files are identified by respective URL links to the author's database 152 (see FIG. 2) and a corresponding WAV document. These tags are merely illustrative and not exhaustive of the type of tags, file elements, and/or identifiers that may be used.

Lines 412 through 418 include tags that identify respective text file elements, wherein each respective tag identifies a specific text file with analogous intent written in a different language. In particular, line 412 includes a tag that identifies a “PRODUCT TEXT ENGLISH” element, which is followed by an attribute of the element that identifies an ASCII text file that is implemented in English (“BOOKRETAILER COM\PROMO24\ISBNL2980 ENG.TXT”). Whereas, line 414 includes a tag that identifies a “PRODUCT TEXT MANDARIN” element, which is followed by an attribute of the element that identifies a unicode text file that is written in Mandarin (“BOOKRETAILER.COM\PROMO24\ISBNL2980 MANDARIN.UNI”) and the like. Each text file of these examples is identified by respective URL links to the authors database 152 and a corresponding text or unicode document.

Line 420 includes a tag that identifies a respective “PRODUCT SKU” (stocking unit) number element, which is followed by an attribute of the element, in particular an absolute value that identifies the promotion's targeted product's SKU. Line 422 includes a tag that identifies a respective “FULFILLMENT SERVER URL” element, which is followed by an attribute of the element, in particular a URL for the promotion's fulfillment server. A procedure for using such a fulfillment server is described in greater detail below in reference to FIG. 7.

Lines 424-428 includes tags that identify story 180 (see FIG. 4) recipient or customer information. For example, Line 424 includes a tag that identifies a “FIRST NAME” element, which is followed by an attribute of the element, in particular, the name “DAVE”. Line 426 includes a tag that identifies an “EMAIL ADDRESS” element, which is followed by an attribute of the element, in particular an e-mail address, such as for example to “someone @ somewhere . com” that identifies the recipient's e-mail address, and the like.

Line 430 includes a tag that identifies a respective “MASTERDATABASE ID” that is used by sending story server 302 (see FIG. 1) to identify those portions of a master parts database to use for a particular message/promotion. In one embodiment of the invention, sending story server 302 returns the message/promotion ID 430 to sender/publisher 310 (see FIG. 1), such that the message/promotion ID 430 is unique to any other message/promotion IDs in a master parts database. Such a message/promotion ID can be used by publisher 310 to modify and/or delete the information that corresponds to a message/promotion in a corresponding master parts database. Such a master parts database is described in greater detail below in reference to FIG. 4. In one embodiment, such a message/promotion ID is used by publisher 310 to send a corresponding message/promotion to recipients in batches, each batch job referencing the message/promotion ID.

It can be appreciated that document 154 can include any number of user defined elements and respective attributes of such defined elements. As will be discussed in greater detail below, recipient information, for example, that information illustrated in lines 424-428, can be supplied to sending story server 302 (see FIG. 1 and FIG. 4) at any time through a number of different mechanisms.

In a preferred embodiment, for at least a subset of the non-textual data in Document 154, a textual description of that non-textual data is identified in Document 154. In yet another embodiment, for every textual description, there is a corresponding text description identified in more than one language, for example, English and Spanish text descriptions. In yet another embodiment, if Document 154 identifies an audio file in a particular language, Document 154 also identifies other audio files that have analogous content to the audio file in different languages. It may also provide a textual transcription and/or a summary of the audio files for presentation when the receiving device does not provide audio playback or the recipient chooses not to receive the content in an audio format. In yet another embodiment, if document 154 includes a binary image (either embedded or via a URL) having a particular resolution, document 154 also includes other resolutions of the binary image. Including such multiple resolutions of a binary image is beneficial for the reasons discussed in greater detail above. Furthermore, not only may the binary or digital images be different resolution, they may be different types of files, such as for example, a bit-mapped image (*.bmp), a TIFF format image (*.tif), a JPEG compressed image (*.jpg), or the like.

Applications 148 includes, for example, one or more of the following computer program applications: (a) a Web browser (not shown) such as Netscape Navigator® or Microsoft Internet Explorer®, for accessing a Web page served from sending story server 302; (b) any of a number of commercially available XML Editors for creating document 154. Other applications may also be stored or provided, for example, multimedia authoring systems, story mail applications, templates for other applications such as spreadsheets, multimedia and/or XML database managers.

Sender/publisher 310 also includes, for example, a database stored or referenced which includes at least a subset of the content necessary to represent the information and data in a story.

Referring to FIG. 4, there is a block diagram that illustrates aspects of an exemplary sending story server 302, according to one embodiment of the invention. Server 302, includes processor 162 connected across local bus 164 to memory 166. Processor 162 is used to execute computer program applications 168 and fetch information from data 170. Local bus 164 can be any type of bus, for example, a peripheral component interconnect (PCI) bus, as long as local bus 164 has a set of signal lines that can be used by processor 162 to transfer information respectfully to and from memory 166.

There may be any number of sending story servers 302 and receiving story servers 328 (see FIG. 1). In such a system 300, each server 302 and 328 will respectively communicate directly with another respective server 302 and 328, or with one or more conventional e-mail servers 332 (see FIG. 1) using one or more communication protocols, for example, SMTP/ESMTP/MIME/HTTP communication protocols. (For purposes of this description, wherever SMTP is used, ESMTP is also applicable). Sending story server 302, using information that is provided both by sender 302 and story enabled client 336, generates and distributes stories 180 as e-mail, or StoryMail. Such information can be provided to sending story server 302 through a number of different mechanisms. For example, the information may be provided if sender/publisher 310 (see FIG. 1) sends document 154 across I/O interface 308 to server 302. (The contents of document 154 are described in greater detail above).

In one embodiment, sending story server 302 also serves one or more documents on the World Wide Web (WWW) identified by a unique Uniform Resource Locator (URL) that allows a user of sender 302 to input information through network 306 into server 302 that will be translated into document 154. There are a number of known computer programs that are used to translate information into a structured file format, for example, XML. Aspects of an exemplary procedure used by sending story server 302, sender/publisher 310, and story enabled client 336 to exchange information to generate, distribute and play story 180 are described in greater detail below in reference to FIG. 5 and FIG. 6.

Applications 168 includes, for example, composition engine 170, storyteller 172, e-mail engine 173, and other applications 174. Each of these applications 168, and in particular, composition engine 170, storyteller 172, and e-mail engine 173 work cooperatively to build story 180. Composition engine 170 provides, for example, a framework of data structures, a run-time model, a compiler, an application programming interface (API), and conventions for building an almost endless variety of different stories 180 that conform to a story run-time model. The story run-time model is designed such that a story playback engine on a story client can be simple in complexity and fast. The run time model provides a lightweight cooperative multitasking multimedia and central application framework. (Such a run-time model described in greater detail below).

Composition engine 170 passes information provided by sender/publisher 310 (see FIG. 1), such that the information is represented in a procedural data format that is not a flat data format. Advantageously the technologies are designed for the procedural content to be fully computer-generated, that is, without manual user intervention. (Manual building is possible but it is not preferred or even desirable.) In one embodiment of the invention, industry standard XML interfaces are used to completely automate one time processing of such provided information, such that existing authoring tools and content formats, for example, JPEG, AVI, MPEG, MP3, and the like, are supported through a simple yet powerful transcoding mechanism of the invention.

To accomplish this, composition engine 170 performs one-time processing of the provided information such that the resulting procedural format of the information for example, is a sequenced set of data, for example, computer program instructions or operation codes (op codes), control information, parameters and media parts. The phrase “sequenced set” means that the data is organized into a time line that dictates the rendering and navigational characteristics of a story 180. This time line may include procedural tests, branches, jumps, conditional statements, and the like so that the rendering may not ultimately be perfectly linear or sequential.

For example, such a sequenced set of data may include a first set of computer program instructions to display a graphic. The first set of computer program instructions is followed, for example, data used by a story player to display navigational buttons on the story receiving devices display. Desirably, each media part is assigned an absolute priority that controls when and if a particular media part will be rendered.

The computer program instructions specify operations to render graphical user interface (GUI) components, media parts, and provide procedural control to user interaction with the GUI components. The control information, for example, provides offsets into the sequenced set of data that indicate where particular media parts are located. In one embodiment, control information also provides a set of semantics and flags for each logical element of a story to maintain the intent of the message on all receiving devices.

In yet another embodiment, control information, for example, includes an array of hot spots, one hot spot for every logical element. Such logical elements include, for example, button controls, text input controls, bitmaps, areas wherein motion video will be displayed, text boxes, decorative elements, and the like. Each hot spot is associated with a rectangular region of the receiving devices' screen display (if one is available). The rectangular region facilitates event identification. Such event identification is associated with user instantiated events. For example, if a user selects, for example, with a mouse device, a region identified by the rectangle associated with a particular hotspot, the operating system will generate a button click event which, as will be described in greater detail below is processed by a story player in the context of the logical element selected.

Each hot spot is further identified as being either active or inactive. An active hotspot is a hotspot that generates an event when a user selects a region within the rectangular area associated with the hotspot. In contrast, an inactive hotspot does not generate an event when a user selects a region within the rectangular area.

In a preferred embodiment, each hotspot area is implemented as a bitmap. Aspects of an exemplary procedure for a story player to use an array of hot spots to play a story is described in greater detail below in reference to FIG. 6.

In addition to areas the hotspot array may also contain semantic and alternative rendering element identifiers (ids) for logical elements other than areas For example, a hotspot's semantic flags may indicate that there is overview test available that describes the overall purpose of a screen of information, and the hotspot may also contain the id of the overview text element of the story.

Aspects of control and control information include memory buffer creation, memory buffer loading, branching, condition or searching, layout, subroutines, linkage between different sequences of instructions, decompression and compression and file packaging, e-mail access for sending messages, requests for subfiles.

In one embodiment, each opcode, parameter and offset is a 32-bit word. This is beneficial for a number of reasons. For example, portability and adaptability are supported by the use of fixed size 32-bit words A 32-bit fixed size word is advantageously used for representing a large dynamic range of value and is highly compressible because both instructions and parameters are designed to have mostly small integer values. The fixed size makes things very scalable and processor words are always aligned along the word boundary.

Because of this suitably chosen fixed size, the playback code, or the story 180 is also small and reusable. Parameters and opcodes can be processed by the same code and operation, for example, addition operations can be performed without the need for size conversion of the code An additional advantage is that the opcodes and data are aligned in memory for fast access. Aspects of an exemplary procedure to use such a procedural data layout to play story 180 are described in greater detail below in reference to FIG. 5 and FIG. 6.

Such one-time processed information is stored by composition engine 170 as a set of master parts data into master parts database 178. Desirably, each set of master parts data is identified by a unique identifier that can later be used by sender/publisher 310 to access, modify, and delete the contents of a particular set of master parts data. in master parts database 178. The set of master parts data can be used by sender/publisher 310 (see FIG. 1 and FIG. 2) to generate and distribute any number of stories 180 to targeted e-mail enabled clients.

In one embodiment, composition engine 170 is eminently portable, meaning that it may also be embedded in other devices besides sending story server 302. For example, composition engine 170 may be embedded, for example, into a digital camera. A single global data structure allows the implementation of composition engine 170 code as a set of C++ objects, composition engine 170 code is reusable and can be instantiated more than one time. An additional advantage of this is that applications including composition engine 170 will be easy to build. Furthermore sizes of all program variables are explicitly defined and there is built-in support for little-endian and big-endian systems. A thin hardware extraction layer (HAL) and the ability for all text to be represented in ASCII or Unicode also supports portability. In combination, all of these aspects make a story quickly and easily portable to a broad range of devices, able to handle nearly all the computer programming instruction sets or languages.

Story teller 172 includes, for example, a set of programmed logic that will select at least a subset of a particular set of master parts data in master parts database 178 to build story 180. Because composition engine 170 represents the provided information in a procedural format, a story 180 is just one big procedural language/data/environment. In a preferred embodiment, a story 180 is part of the same procedural language including the content, decompression, rendering, layout, hotspot responses and navigation. In some aspects, a story 180 may be viewed as a self-contained ultra-low overhead multi-threaded run-time system. For example, a story 180 generates video frames by executing sequences of instructions. This allows for mixing of different video decompression/reconstruction algorithms within a single frame. For example, a motion compensation vector equivalent for a whole frame can be applied using a single instruction which moves rectangular parts of one picture into another.

In one embodiment, storyteller 172 builds a story 180 from the master parts database 178 in response to a message from StoryMail enabled client 336 (see FIGS. 1 and 4). (Such a message is described in greater detail below in reference to FIGS. 5 and 6). In this embodiment, the message will include a unique identifier, such as the unique identifier discussed above, to determine which set of master parts data to use to build a story. The particular master parts that a storyteller 172 will select to piece together story 180 together depends on the purpose of storyteller 172 and the particular hardware capabilities, network connection characteristics, and user preferences associated with a targeted story enabled client 336 (see FIG. 1 and FIG. 4). Aspects of an exemplary procedure to send server 302 such capabilities, characteristics, and preferences are described in greater detail below in reference to FIG. 5 and FIG. 6.

The purpose of storyteller 172 can include any one of the exemplary applications of a story 180 that were discussed in greater detail above or other purposes. In one embodiment, sending story server 302 includes any number of pre-configured storytellers 172, wherein each storyteller 172 will have a unique such purpose. For example, a first storyteller 172-1 may be used to build an e-coupon story 180, a second storyteller 172-2 may be used to build a parts catalog story 180, and the like.

In yet another embodiment, the invention contemplates that sending story server 302 will serve a Web page interface (not shown) whereby publisher/sender 310 creates and modifies storytellers 172. For example, in one embodiment, such a Web interface provides a set of button controls that when selected by a user allows the user to: (1) add logical story elements, for example, an MPEG file, to master parts database 178; (2) select portions of such logical story elements, for example, a user selects a particular picture and a particular video to include in a story 180; (3) specify the dimensions of portions of the story, for example, a user may specify that the dimensions of a particular sequence of logical story elements are to be of a particular width and height; (4) order the logical story elements on a time line, and take into consideration any user navigation; and, (5) define a set of templates, wherein a particular template specifies, for example, the particular operating parameters and rules used to scale the logical story elements to optimally play on a particular story enabled client 336 (see FIG. 1).

E-mail engine 173 is used to both send and receive e-mail respectively to from sender/publisher 310, story enabled client 336 and conventional e-mail client 340. Conventional e-mail engines are known in the art of internet e-mail messaging. Aspects of such e-mail messages are discussed in greater detail below in reference to FIG. 5 and FIG. 6.

Referring to FIG. 5, there is a block diagram that illustrates aspects of an exemplary story enabled client 336 (client 336), according to one embodiment of the present invention. Client 336 receives and plays stories 180. Client 336 can also forward story 180 to other e-mail enabled clients, for example, another story enabled client 336 and/or conventional e-mail client 340 (see FIG. 1). To accomplish these tasks, client 336 includes processor 184 connected across local bus 186 to memory 188. Processor 184 is used to execute computer program applications 190 and fetch data 198 from memory 188. Local bus 186 can be any type of bus, for example, a peripheral component interconnect (PCI) bus, as long as local bus 186 has a set of signal lines that can be used by processor 184 to transfer information respectfully to and from memory 188.

Data 198 includes, for example, e-mail message 200, which is sent to story enabled client 336 by sending story server 302 (see FIG. 1). Aspects of an exemplary procedure for sending story enabled client 336 e-mail message 200 are described in greater detail below in reference to FIG. 5 and FIG. 6. In one embodiment, e-mail message 200 includes, for example, novel story e-mail, which indicates to story enabled client 336 that a richer content story 180 is behind e-mail message 200. Story enabled client 336 receives a mail message 200 before it receives story 180. As will be described in greater detail below in reference to FIG. 5 and FIG. 6, in a preferred embodiment of the invention, story 180 is only received by story enabled client 336 after story enabled client 336 collects its e-mail from an e-mail server, for example, conventional e-mail server 332 (see FIG. 1).

In one embodiment, story header 201 includes, for example, story teller ID 202, data set ID 204, and a URL 206. Story teller ID 202 identifies a particular story teller 172 (see FIG. 4) used by sending story server 302 (see FIG. 1) to build story 180. Aspects of exemplary procedure for sending story server 302 to build story 180 are described in greater detail above in reference to FIG. 2, FIG. 5 and FIG. 6.

Data set ID 204 is used to identify a data set that corresponds to at least a subset of the information in master parts database 178 (see FIG. 4) that will be used by sending story server 302 to generate story 180. URL 206 identifies the URL of the particular sending story server 302 that sent client 336 e-mail message 200 Although a conventional mandatory return path e-mail header (not shown) may also identify the particular story server 302, the URL information is beneficial because story messages may come from different servers belonging to different service providers or sender/publishers 310 (see FIG. 1).

Although, embodiments of the invention contemplate that story 180 may be forwarded by story enabled client 336 to another device, in a preferred embodiment, story enabled client 336 does not forward story 180 to another device, but rather e-mail message 200 is forwarded to another device. Such other devices include, for example, another story enabled client 336, a conventional e-mail client 340, and/or a story enabled device 344. After a targeted device receives the forwarded e-mail message 200, any corresponding collection request by the targeted device associated with e-mail message 200 is redirected to sending story server 302, such that sending story server 302 determines whether the target device is story enabled or not.

If the targeted device is story enabled, sending story server 302 determines, for example, the particular hardware characteristics, network connection characteristics, and any user preferences associated with the targeted device before sending story 180 to the targeted device. Aspects of an exemplary procedure to make such a determination are described in greater detail below in reference to FIG. 5 and FIG. 6. This level of indirection ensures that an optimized story 180 will be forwarded to story enabled clients 336 and story enabled devices 344. This level of indirection also ensures that if the targeted device is not story enabled, that the targeted device, although not receiving story 180, receives conventional content associated with the mail message 200 along with the novel story header 201 information. As described in greater detail above, in one embodiment, such conventional content is determined by sender/publisher 310 (see FIG. 1) and storyteller 172 (see FIG. 2) upon creation of a message or promotion that corresponds to story 180.

E-mail message 203, includes, for example, story 180. In a preferred embodiment, e-mail message 203 is received by story enabled client 336 after sending story server 302 has determined story enabled client's 336 particular hardware characteristics and any user preferences. In a preferred embodiment, story 180 is scaled to story enabled client's 336 particular hardware characteristics, network connection characteristics, and user preferences.

Applications 190 includes, for example, information provider 192, story player 194, and other applications 196. Information provider 192, for example, sends story enabled client's 336 hardware capabilities, network connection characteristics and any user preferences to sending story server 302 (see FIG. 4). Such capabilities and characteristics (discussed in greater detail above) are typically obtained by querying operating system software (not shown) that controls the execution of computer programs and provides such services as hardware management, computer resource allocation, input/output control, and file management in story enabled client 336.

Information provider 192 determines any user preferences in a number of ways. In one embodiment, information provider 192 displays a GUI onto a display device (not shown) connected to story enabled client 336. The GUI will have one or more user interface controls, for example, a dialog box, an edit control, and/or a combination box, to the end-user for end-user selection and input with respect to a predefined number of preference categories. Such categories include, for example, a preferred language, message size limits, message download time limits, message filters (for example, no e-coupons), data encryption requirements, and security requirements. (Either limits may be greater or less than a default set of time limits). In one embodiment, if there are a number of preferences, certain preferences will be given a higher priority than other preferences. In a preferred embodiment, such preferences are stored in data 198 as a text file (not shown) in a structured file format, for example, XML, that can be edited by a user with using a text editor.

Story player 194, for example, executes, or plays story 180. As described in greater detail above in reference to FIG. 4, story 180 includes one or more of op codes, parameters, offsets and media parts. To play story 180, player 194 sequentially parses story 180 to extract these op codes, control information (parameters and offsets), and media parts. As each op code is extracted, player 194 will match the op code to a particular computer program instruction, or procedure, which is a logical set of computer program instructions. There are a number of known procedures that can be used to map such opcodes to computer program instructions procedures. For example, a simple C programming language case statement can be used to perform such mapping.

Story player 194 will jump to a procedure that corresponds to the opcode and begin a set of corresponding computer program instructions. In a preferred embodiment, such computer program instructions are C instructions. If the computer program instruction requires corresponding parameters, the required parameters are extracted on an as needed basis from story 180. In one embodiment, parameters can signal the parsing of other parameters from the stack. There are a number of well known ways that a specific number and specific type of parameter can be mapped to a computer program instruction. For example, the number and types of parameters can be hard wired in the implementation of a computer program instruction. If a parameter is an offset to a media part of story 180, the offset is used when playing story 180 to extract the data for the particular media part when necessary. After a procedure returns a status code to story player 194, an instruction pointer points to the next opcode to be executed as described above.

Story player 194 advantageously implements cooperative multithreading and synchronization through resource constrained retry at the instruction level. To provide such advantages, each procedure in story 180 returns one of a number of possible status codes, for example, success, retry, and yield status codes. In one embodiment, story player 194 executes sequences of instructions for a thread as long as the instruction functions return a status code of “success”. Upon receiving a status code of success, a next thread is executed by story player 194 under similar constraints. Any instruction that takes a predetermined amount of time to complete will return a “yield” status code, indicating to story player 194 that other threads should be executed. Upon receiving a yield status code, story player 194 stops executing the thread and places it onto a queue for later execution. Such yield status codes are inserted at appropriate places in story 180 by story teller 172 when story teller 172 creates story 180.

Certain story 180 instructions are executed on a time line as described in greater detail above in reference to FIG. 4. Such instructions are so tagged with a “wait until time” instruction by storyteller 172 (see FIG. 4) before being placed into a master parts database 178. Story player 194 will wait until the indicated time to execute such instructions. If story player 194 encounters such an instruction and it is not time to execute the instruction, story player 194 will retry the instruction at another time.

Any instruction encountered by story player 194 that requires a memory buffer, wherein the memory buffer is not available, is placed on a queue such that story player 194 will retry the instruction at a later time wherein such memory resources may be available. In one embodiment, story player 194 identifies “wait for event” flags to synchronize story 180 instructions.

In one embodiment, story player 194 presents a purchase button to a user that is used to provide a response to the story 180. To implement such an embodiment, the HAL identifies a user selection in the rectangular area defined by a particular hotspot associated with the button. (Hot spots are described in greater detail above in reference to FIG. 4). Upon such a selection story player 194 executes a story procedure or story thread associated with the selection.

Other applications 196 include, for example, an optional e-mail client application, for example, Microsoft Outlook Express®, that provides e-mail receipt and delivery capabilities to story enabled client 336 using Internet e-mail protocols. In one embodiment, such Internet e-mail protocols include, for example, POP3 and IMAP protocols. In one embodiment such e-mail receipt and delivery capabilities are provided by story player 194.

Referring to FIG. 6, there is a block diagram that illustrates aspects of an exemplary procedure 210 to generate and distribute StoryMail messages 200 (see FIG. 4) to e-mail enabled clients, for example, StoryMail enabled client 336 (see FIGS. 1 and FIG. 5) or conventional e-mail client 340 (see FIG. 1). To better describe procedure 210, the following description references structure that are respectively illustrated in FIG. 1, FIG. 2, FIG. 3, and FIG. 4.

Step 212 provides, for example, multimedia content and/or message parameters to story server 302 (see FIG. 4). Such message parameters correspond to the multimedia content. For example, a message parameter is a discount rate. With respect to a targeted promotion story, which were described in greater detail above, such multimedia content includes, for example, product descriptions, promotional information, customer specific information and/or pictures to the story server 302 (see FIG. 1 and FIG. 4).

As described above, in one embodiment, sender/publisher 310 (see FIG. 1 and FIG. 2) sends such content in Document 154 (see FIG. 2). In yet another embodiment, sender/publisher 310 (see FIG. 1) accesses a URL that corresponds to a Web page (not shown) served by sending story server 302, whereby a user could input such content to sending story server 302. Such content is described in greater detail above in referent to FIG. 2. However, such content also includes, for example, the identity of a specific storyteller 172 to be used to generate a story 180 (see FIGS. 3 and 4). As described above, there can be a number of different storytellers 172, wherein each respective storyteller generates a story 180 with a specific predetermined intent.

For example, if sender/publisher 310 is an Internet book, music and video retailer that offers music CDs, video, DVD, computer games and other products, the specific storyteller 172 may be used to build a parts catalog story 180 to be distributed to retailers, or the specific storyteller 172 may be selected to generate a holiday card story 180 to be distributed to customers.

Step 218 performs one time processing of the content as described in greater detail above in reference to composition engine 170 as illustrated in FIG. 4. Step 220 returns a unique master parts identification to sender/publisher 310. As described above, such an identification is used to identify the particular set of master parts data that corresponds to the one time processed content. This identification can be used by sender/publisher 310 to access, modify and delete the one time processed information from sending story server 302, as well as to send new messages using the same master information as default content.

Step 220 sends e-mail message 200 (see FIG. 5) to each recipient that is identified in the provided content (step 212). As described in greater detail above in reference to FIG. 5, e-mail message 200 is an e-mail message that includes story header 201. In this step, a recipient can be either a story enabled client 336 (see FIG. 1), a conventional e-mail client 340, or a story enabled device 344.

Step 222 intercepts an e-mail collection request from the e-mail message 200 receiver. Step 224 evaluates whether the e-mail message 200 receiver is story enabled, for example, a story enabled client 336. If not, step 226 sends the contents of e-mail message 200 to the non-story enabled device, for example, conventional e-mail client 340 (see FIG. 1). Otherwise, procedure 210 continues as illustrated in FIG. 7.

Referring to FIG. 7, there is a block diagram that illustrates aspects of an exemplary procedure to generate and distribute StoryMail, according to one embodiment of the present invention.

Step 228 gets story enabled client 336 information. As described above, such information includes corresponding hardware capabilities, network connection characteristics, and any user preferences. In a preferred embodiment, such capabilities, characteristics and preferences are represented by story enabled client 336 in a structured file format, for example, as an XML document. In a preferred embodiment, quick communication protocols are used between story servers 302 and 328 and story enabled client 336 respectively for intra-server and server client communications, for example, HTTP communication protocols.

For purposes of illustration, story enabled client 336 could represent its particular capabilities characteristics and preferences in a structured file format as follows. “CPUSpeed=300” indicates that in the client 336 CPU speed is equal to 300 MHz. CPU or processor speed criteria may be used to influence the generation of an optimized story in that the CPU may not be fast enough to process large video clips in real time. A video clip with small dimensions (width and height) might be used instead. Or a signal picture may repress the video content instead of a video stream. “ScreenColor=yes” indicates that the client 336 display device can display color binary images. “Sound=yes” indicates that the client 336 includes a sound card, chip, or other sound or audio regeneration or playback means and that the data element that includes audio can be used to create a story 180. “LanguagePreference=English” indicates that the user of client 336 prefers to receive content in the English language. “CommunicationsSpeed=28800” indicates that the client 336 is connected to a 28.8 K-baud internet connection and is able to receive, for example, single pictures but not rich media such as motion video without incurring undue transmission delay. In one embodiment, such capabilities, characteristics and preferences are sent to the URL of sending story server 302, which was included in the story header 201 (see FIG. 5).

Step 230 generates the story 180 (see FIG. 4 and FIG. 5) using a particular storyteller 172 identified by story teller ID 202 (see FIG. 5) in e-mail message 200. To accomplish this, the specific storyteller 172 selects, or strings together only those portions of the set of master parts (identified by the date set ID 204, see step 219) in the master parts database 178 (see FIG. 4) that are compatible with each of the following: the capabilities, characteristics and preferences identified in step 228; and, the content which is compatible with the purpose of the specific storyteller. While stringing together such information, the specific storyteller 172 may create several original logical files, compress them, and compress each of the compressed logical files into a final single file. The logical order of the data in the each respective original single file is maintained in the headers of a sequence of sub-files that are automatically generated from each respective original logical file. Such a logical order is advantageously used by sending story server 302 (see FIG. 1) when transferring a story 180 to a story enabled client 336 (see also, step 232).

For example, the opcodes representing computer program instructions and parameters may be placed in a first logical file, text and parameters in a second logical file, all motion video may be placed in a third logical file, all audio data may be placed in a fourth logical file, and the like. Alternatively, the computer program, control information, audio data, motion video, and the like may be interspersed. In a preferred embodiment, the elements which are best compressed using the same compression algorithms are combined together so as to achieve a more optimal compression level.

Notice that system 300 (see FIG. 1) cooperates in collecting all relevant information and data first, such as for example, the capabilities, characteristics, and preferences described above, before generating a story 180 (step 230). This makes system 300, and in particular story 180 generation advantageously automated and dynamically adaptive. Having obtained all this information, system 300 then generates the optimum story 180 after a connection has been made with recipient. This is because only at the time of connection will story server 302 know for certain the particular characteristics of the recipient's client device, communication channel, and user preferences.

In some conventional systems, a user may register with a server characteristics of a registered device as well as registered user preferences. However, these conventional systems do not generally test or otherwise take into account the hardware capabilities of the device or network connection characteristics used by the device to communicate with the server at that moment of time.

The StoryMail system 300 (see FIG. 1) and procedure 210, on the other hand, take all such factors into account after connecting to a recipient's device to generate the optimal story 180 from a standpoint of story size, language, use or not use of audio or visual content, and the like. In a sense, the StoryMail procedure 210 is contrary to other prevailing trends which attempts to pre-form content so that is available as early as possible in that StoryMail 300 actually delays composition of an e-mail message until these capabilities, characteristics and preferences are known. In this manner, a story 180 sent to any device will be experienced in a manner that is optimal for that device and user.

Step 232 communicates a second StoryMail message 200 to story enabled client 336. The second e-mail message 203 (see FIG. 5) includes that generated story (step 230) and the corresponding story header 201 (see FIG. 5). In one embodiment, storyteller 172 encrypts generated story 180 (step 230) so that it cannot be read by any intervening process after it is sent to story enabled client 336 and before it reaches its destination. In such an embodiment, if public key encryption is used, there is no need to have a central repository of public keys because the public keys of the center and receiver client can be exchanged after connection time when the story 180 is being generated (step 230).

As discussed above in reference to step 230, each logical sub-file of story 180 includes, for example, a startup sequence of instructions that can be used to start the transfer of the following sub-files in the sequence. Such segmentation of the files is beneficial for a number of reasons. For example, while transferring a story 180 to a story enabled client 336 (see FIG. 1), if the bandwidth is too small, a sub-file will not arrive in time. In one embodiment, story player 194 (see FIG. 5) pauses until each respective sub-file transfer is complete. In this manner, quality of story 180 presentation will be constant, even if receipt of story 180 content is intermittent. In yet another embodiment of the invention, real-time transmission of story 180 is not required so that the recipient may never be aware that transmission was delayed, suspended, or intermittent for a particular portion of story 180.

Step 234 executes, or plays the story. Aspects of an exemplary procedure to play a story 180 are described in greater detail above in reference to FIG. 4. In the preferred embodiments of the invention, a custom story 180 is generated for each receiving device, such that a story 180 can be generated to play on all types of story enabled devices and compatibility is maintained for all stories 180 even as story enabled devices may change or evolve. Even the rich media stories 180 will play on non-rich media enabled devices because, in preferred embodiments of the invention, there is always some text or other simplified content behind more complex elements such as sound or video clips to fall back on This is because the master parts database 178 (see FIG. 4) includes information to create new stories that will play on all story players because there will always be the old instruction alternative to fall back on. Likewise in at least some embodiments of the invention, even rich media stories are able to playback on conventional e-mail clients 340 having rudimentary e-mail applications because of the fall back text provided in the master parts database 178.

As discussed in greater detail above in reference to FIG. 4, each logical element of a story 180 includes, for example, associated semantic information that respectively indicates a set of logical elements of story 180 that are to be displayed, or played on the recipients device. In one embodiment, such semantic information also indicates when story player 194 should substitute an alternative logical element for another particular logical element.

Step 236 determines whether there is a response to the played story 180. Such a response can be provided, for example, by a user selecting a button control that the story 180 causes to be displayed. If there is such a response, step 238 generates a response to the story 180. For example, if the story is an e-coupon that promotes the purchase of a particular book, story player 194 (see FIG. 5) will create a structured format purchase order form, for example, an XML purchase order form. Such a form includes, for example, the customer ID, the product SKU (stocking number) that was included in story 180 (parsed from document 154 (see FIG. 2, FIG. 3, and FIG. 4), and any preferences. Such preferences include, for example, an indication of whether the book is to be received in electronic format instead of a physical format, the language that the book is to be written in, payment information, and the like.

Step 240 communicates the response (step 238) to the fulfillment server that was identified in the story 180 (parsed from document 154 (see FIGS. 2, 3, and 4). Such communication can be implemented by using a number of different protocols, for example, the HTTP protocols or SMTP protocols.

The invention offers a number of strengths as compared to the closest competing technologies. A story 180 plays off line as well as online and is lightweight (thin) enough to run on inexpensive information appliances or other devices. When so desired, a story includes, for example, user navigational aids, user forms, and can automate a transaction fulfillment process. A story is instantly interactive, self-contained and reliable. Creation of a story's 180 content can be completely automated, such that devices made today will be able to handle future content without upgrades. The invention facilitates publishing messages that are meaningful to individuals with physical disabilities and provides for intelligent content specific scaling and compression. A story 180 is easily stored and exchanged as a single file, and the same content runs in Web pages in its own window and on low-power device screens.

Exemplary Security Features and Embodiments

Embodiments of the invention are now described with reference to the figures. It will be understood that although the invention is described with respect to a particular StoryMail messaging and communication environment (See description in Related Applications and in the Appendix), the methods, systems, procedures, and computer programs and instructions while advantageously used in such environment are not so limited to the StoryMail messaging and communication environment.

Due to the many structural and methodological features described, various headings and subheadings have been provide to assist the reader of this specification. These headings and subheads as listed below are merely a convenience device and are not to be interpreted in any way as limiting or restricting the invention in any way. Those workers having ordinary skill in the art in light of the description provided here that the various aspects and elements of the invention are described throughout the specification and that an indication of a header or subheader merely indicates a particular focus on a feature of element of the invention or embodiment of the invention.

The description of aspects of the inventive security features are conveniently described according to the following outline. It is understood that where section headers are provided, such provision is merely for purposes of convenience to the reader, and that aspects of the invention are described throughout the specification.

Section

1.1 StoryMail Message Tags

1.1.1 Format of Message IDs

1.1.2 Creating of Message Tags

1.1.3 Notes on Message Tag Algorithm

1.1.4 Checking Message Tags

1.2 StoryMail Compact Certificates

1.3 StoryMail Common Protocol Elements

1.3.1 Format and Algorithms for EncryptedData Primitive

1.3.2 Format and Algorithms for SignedInsideEnveloped Primitive

1.4 StoryMail Secure Socket Layer

1.4.1 Data Maintained by Each Party

1.4.2 Format of a Record

1.4.3 Types of Records

1.4.4 Overview of New Master Key Setup

1.4.5 Overview of Reuse Master Key Setup

1.4.6 Format and Algorithms for Hello-Reuse-MK Record

1.4.7 Format and Algorithms for Accept-Reuse-MK Record

1.4.8 Format and Algorithms for Reject-Reuse-MK Record

1.4.9 Format and Algorithms for Hello-New-MK Record

1.4.10 Format and Algorithms for Accept-New-MK Record

1.4.11 Format and Algorithms for Client-Finish Record

1.4.12 Format and Algorithms for Server-Finish Record

1.4.13 Format and Algorithms for Client-Data Record

1.4.14 Format and Algorithms for Server-Data Record

1.5 StoryMail™ Secure Certificate Issuing

1.6 StoryMail™ Secure Response Session

1.7 StoryMail™ Secure Unidirectional Message

1.8 Selected Methodological and Procedural Embodiments

1.1 StoryMail™ Message Tags

A StoryMail Message Tag (MT) is assigned by the Story Server and sent to the Client (either conventional e-mail client or story enabled client or device) in the e-mail header. This tag is used in the subsequent interactions between the Client and the Story Server and optionally with the Response Automation system and optionally with the StoryMail Certificate Authority (SMCA). The security properties of the tag are:

1. Message Tags (MTs) are globally unique. More precisely, it is statistically unlikely that two servers will ever produce the same message tag.

2. MTs are specific to a given server. Another server will very likely reject the tag created by one server.

3. Valid MTs are chose sparsely from a large space, so the chance of guessing a valid Message Tag is very small. For the design given below, this chance is one in 2**48 (2⁴⁸).

4. MTs include a bit field that can be chosen by the server software in any way that it likes. For example, this field could be a simple counter that starts at zero for all servers. This field is 48-bits in the design given below.

5. The MTs are specific to a given recipient E-Mail address. The server is very likely to detect an attempt to fetch a story using an MT that was sent to a different user.

6. The client software cannot distinguish valid from invalid MTs. There may be some benefit to adding a simple checksum character to the encoded MT, but this does not influence the basic algorithm.

7. The algorithm can be scaled to produce different size MTs.

The following paragraphs describe one preferred embodiment of the format of MTs, how the MTs are created and checked by the StoryMail Server.

1.1.1 Format of Message IDs

A Message ID (MID) is the unscrambled form of a Message Tag (MT). An MID contains a Redundancy Field, which could be 48-bits wide as shown below, and a Message Number, which could be 48-bits wide as shown below. The exact layout of the MID does not matter, though the diagram shows the Redundancy Field appearing to the left of the Message Number. The bits of these fields can be interspersed in any fixed way known to the StoryMail Server.

The Redundancy Field (RF) allows the server to detect bogus MTs or MTs that were intended for a different user or server. In one possible embodiment it could be is computed as follows:

RF=Left_{—}48_Bits (SHA1 (ServerName || RecipientEmailAddress))

The ServerName is the domain name of the StoryMail server, or the name of the primary server when there is a collection of servers. It could be any unique character string, and it does not have to be kept secret. The RecipientEmailAddress is the ASCII representation of the recipient's email address. The operator “||” means concatenation. The function SHA1 means a FIPS-180-1 SHA1 digest. The function Left_{—}48_Bits truncates its argument to the left 48 bits. Actually, any 48 bits will do for this algorithm.

Notice that when the client attempts to fetch the story, they will need to present proof that they hold the private key for a digital certificate that was issued to the RecipientEmailAddress. This proof shows that they are entitled to the story with the specified Tag value.

The RF could also be a function of a secret known only to the StoryMail Server, or an indication of the date range when the MT was created, or other information from the Client's digital certificate, or other information sent by the Client before sending the Message Tag.

The SHA1 digest function shown above can be replaced with any cryptographically secure compression or hash or digest function including but not limited to MD2, MD4, MD5, RIPE160, SHA-256, SHA-384, SHA-512, DES-CBC-MAC, 3DES-CBC-MAC, IDEA-CBC-MAC, AES-CBC-MAC, DES-MDC, and DES-MDC2.

1.1.2 Creating of Message Tags

The following algorithm creates Message Tags from Message IDs. It is shown operating on 12-byte (96-bit) values, though it can be extended to operate on lengths from 9 to 16 bytes. We assume that some mechanism outside of the scope of this document, like Base64 encoding, will translate the 96-bit binary MT into a printable string suitable for sending in an email message.

This algorithm performs three block encryption algorithms using a secret key, called Kmt, chosen by the server during installation. If this key is compromised, then the attacker can create and decode Message Tags. This is not considered to be a big security risk. The current cryptographic architecture calls for using a 64-bit block cipher called XTEA, which has a 128-bit key.

If the server needs to change the Kmt secret key, it will not be able to recognize MTs created by the old key However, if the server wants to have a policy of changing the key periodically, they could keep a history of keys, and simply try each one to see if the MT unscrambles into a valid MID If the server is willing to try three different keys, then chances of a random MT appearing valid will be three out of 2**48 (2⁴⁸)

The steps for creating the MT from the MID are listed below. During installation the Kmt key is chosen. The following steps can be conveniently performs using a single 12-byte buffer that is used as the input and output of the encryption function. The buffer starts with the 12-byte MID and ends up with the 12-byte MT. The algorithm operates on different eight-byte windows of the 12-byte buffer with xor operations used to link the windows.

1. P1=Left_{—}64_bits (MID)

2. C1=Enc (Kmt, P1)

3. P2left=Right_{—}32_bits (C1)

4. P2right=Left_{—}32_bits (C1) xor Right_{—}32_bits (MID)

5. P2=P2left || P2right

6. C2=Enc (Kmt, P2)

7. P3right=Right_{—}32_bits (C2)

8. MTright=Right_{—}32_bits (C2)

9. P3left=Right_{—}32_bits (C2) xor Left_{—}32_bits (C1)

10. P3right=Left_{—}32_bits (C2)

11. P3=P3left || P3right

12 MTleft=Enc (Kmt, P3)

13. MT=MTleft || MTright

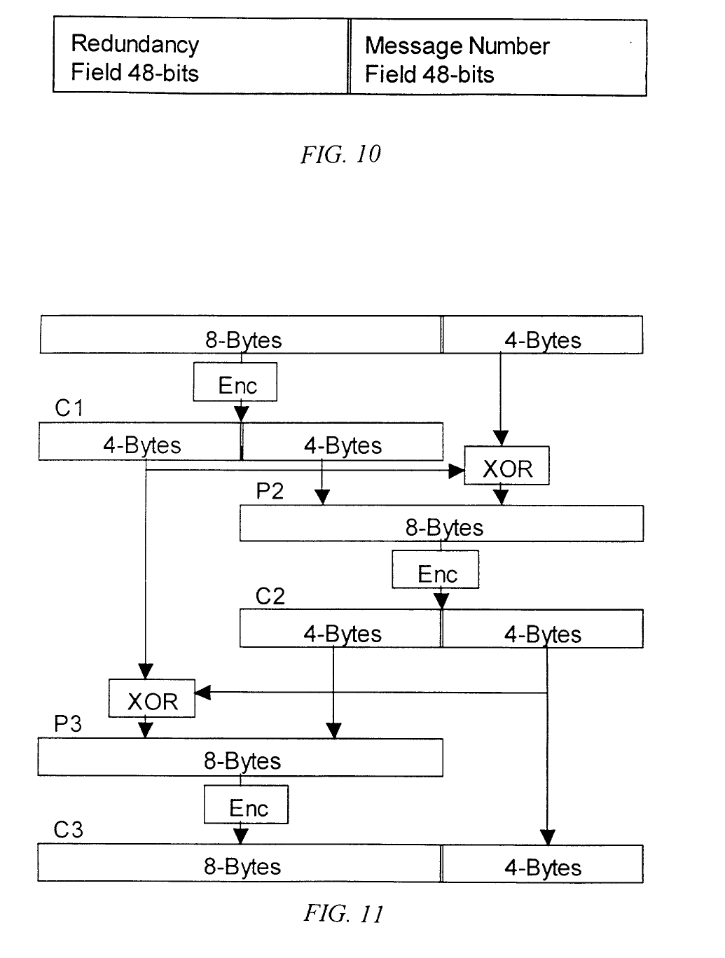

These steps are illustrated in FIG. 10 which provides a diagrammatic illustration illustrating steps for creating an embodiment of a message tag from a message ID.

1.1.3 Notes on Message Tag Algorithm

The algorithm to create the message tag can be viewed as a modified Cipher Block Chaining (CBC) mode that first processes the data from left to right and then again from right to left. This two-pass approach guarantees that each output bit is dependent on each input bit. The plaintext blocks contain both overlap data and data xor'ed in from the previous blocks. If some of the bits of the MID were hard to predict, then it would be possible to get by with just two encryption operations, but given the small performance benefit, this strong three step algorithm is used because it is easy to argue that it is secure.

1.1.4 Checking Message Tags

The server checks the message tag when the client software attempts to fetch a story. When the client connected to the server via the lightweight SSL protocol, they will have sent their digital certificate, which includes their email address, and will have proven that they have current access to the private key that went with that certificate. The email address in the certificate becomes the RecipientEmailAddress that is used to compute the Redundancy Field in the MID. The steps are:

1. Unscramble the Message Tag to recover the Message ID using the Kmt key to reverse the steps used to create the tag.

2 Combine the server name and the RecipientEmailAddress from the client's certificate to create the Redundancy Field (RF).

Check that the expected RF matches the one in the Message ID.

1.2 StoryMail Compact Certificates

Secure communications and message is established between the various components of the StoryMail system with the aid of digital certificates. For example, the Story Server and Story Enabled Client both have digital certificates that are used to establish a secure session between them to communicate Story Messages. The Story Servers each have a unique certificate, and the Clients can have either unique or shared certificates. If there client has a unique certificate, then strong security properties, such as client authentication based on access to a unique private key, are possible.

Traditional digital certificates such as X.509 are large and often two certificates must be transmitted to enable both encryption and authentication. The StoryMail system includes an innovation that makes the certificates smaller and carry both the encryption and authentication keys, so the architecture is simpler and fewer round trip messages are required to establish strong security properties. The certificates have the following format:

Type—1 byte=SM-Certificate

Version—1 byte=Zero (high 4 bits reserved as extra length bits)

Content-Length—2 bytes, MSB first=number of bytes in remaining content

Subject-Signing-Key—128 bytes, MSB first=RSA Public Key Modulus. The exponent is 3 when the Version field is zero.

Subject-Enveloping-Key—128 bytes, MSB first=RSA Public Key Modulus. The exponent is 3 when the Version field is zero.

Tag—4 bytes=Device number for certificate. Zero first device enrolled. MSB first.

Subject-Name-Length—2 bytes, MSB first=length of following characters in bytes (i.e., Unicode characters count as 2 bytes if they are ever adding to this design).

Subject-Name—zero or more bytes, leftmost character first.

Issuer-Name-Length—2 bytes, MSB first=length of following characters in bytes.

Issuer-Name—zero or more bytes, leftmost character first.

Issuer-Signature—128 bytes=signature from StoryMail CA on this certificate. The signature covers all the fields above this one, including the Type, Version and Content-Length.

Notice that all the fixed length fields appear first, which improves the performance of certificate processing software. Also, notice that the certificate includes both the signing key for authentication and the enveloping key for encryption. The format can be extended to include more than two public keys for the subject.

Notice further, that the Type and Version fields encode all the information that is carried in several different fields of a traditional X.509 certificate. It encodes, the selection of cryptographic algorithms for 1) the keys belonging to the subject, and 2) for the signature produced by the issuer. These two fields also encode 1) the length of the keys belonging to the subject, 2) the exponents for the public keys, and 3) the length of the signature block created by the issuer.

1.3 StoryMail Common Protocol Elements

The StoryMail protocols for secure sessions, secure one-way messaging, secure downloading, secure upgrading, secure enrollment and secure auditing, are all based on a small common set of cryptographic methods (also called primitives in this description) and common data formats used for sending information between and within StoryMail components (Server, Client, Response Automation, Certificate Authority, and the like).

1.3.1 Format and Algorithms for EncryptedData Primitive

The following encryption primitive provides privacy and tamper detection and is used for example in the LW SSL Data and Finish packets. This primitive can be expressed functionally as shown below. When used with the LW SSL protocol this primitive covers the entire record including the 4-byte header. That is, after the handshake all the data in the TCP stream is protected by encryption and cryptographic checksums. The encryption can be viewed as existing in the layer between the TCP socket and the parsing of data records.

The primitive: SealEncryptedData (Key, CBC-Chain, Data-To-Protect, Protected-Data, Output-CBC-Chain) performs the following steps:

1. Let Crypto-Checksum=HMAC (Key, Data-To-Protect).

2. Let Plaintext=Data-To-Protect || Crypto-Checksum.

3. Let Ciphertext=CBC-Pad-Encrypt (Key, CBC-Chain, Plaintext).

4. Set Protected-Data=Ciphertext.

5. Set Output-CBC-Chain =Last 8 bytes of Ciphertext.

The primitive: UnSealEncryptedData(Key, CBC-Chain, Protected-Data, Data-To-Protect, Output-CBC-Chain) performs the following steps:

1. Let Ciphertext=Protected-Data

2. Let Data-To-Protect || Crypto-Checksum=CBC-Pad-Decrypt (Key, CBC-Chain, Ciphertext)

3 Let Actual-Checksum=HMAC (Key, Data-To-Protect).

4. Error if Actual-Checksum is not equal to Crypto-Checksum.

5 Set Output-CBC-Chain=Last 8 bytes of Ciphertext.

The CBC-Pad algorithms can be based on any block cipher, and is illustrated above for block ciphers that have 8-byte block sizes. Other block sizes, such as 16-bytes are implemented in a similar manner.

The specific cipher used in the preferred embodiment is the XTEA 64-bit block cipher with a 128-bit key running in CBC mode with PKCS #5 padding (i.e., one to eight pad bytes where each byte has the same value which is equals the number of padding bytes). The XTEA cipher has the advantage of requiring a very small size of software code to implement. Other ciphers such as triple-DES, DES, RC5, RC6, IDEA, Twofish, AES, could be used in other embodiments.

1.3.2 Format and Algorithms for SignedInsideEnveloped Primitive

The handshake records and the lightweight S/MIME protocol both use a security primitive that sends an encrypted and signed data block to a recipient using the recipient's public key and senders private key to ensure the privacy and authenticity of the message. The same key pair is used for signing and enveloping, so the recipient can send a secure message back to the sender. In these messages the sender always includes his certificate, though this could be removed if the send knows that the recipient already has it.

The primitive can be expressed as a function as show immediately below. In one embodiment, the Data-Encryption-Key is the first 128-bits of the 160-bit OAEP-Seed.

SealSignedInsideEnveloped (Recipient-Public-Key, Sender-Private-Key, Sender-Certificate, Data-Encryption-Key, OAEP-Seed, Data-To-Seal, Protected-Data) This function performs the following steps.

1. Let Envelope-Block=RSA-Public-Encrypt-OAEP (Recipient-Public-Key, Data-Encryption-Key, OAEP-Seed)

2. Let Envelope-Recipient=SHA1 (Recipient-Public-Key) The Recipient-Public-Key is passed to SHA1 with the MSB first. The exponent is assumed to be 3 and it not passed to SHA1.

3. Let Digest=SHA1 (Data-To-Seal).

4. Let Signature-Block=RSA-Private-Encrypt (Sender-Private-Key, Digest).

5. Let Sender-Cert-Chain be an array of bytes where the first byte is the number of certificates in the chain, and the remaining bytes are the concatenation of the certificates. Recall that certificates include length information, so the start of each certificate can be identified.

6. Let Data-To-Protect=Sender-Cert-Chain || Signature-Block || Data-To-Seal. Notice that the length of the Data-To-Seal is implied by the length of the record that contains this primitive.

7. Let CBC-Chain=8 bytes of zero.

8. Perform SealEncryptedData (Data-Encryption-Key, CBC-Chain, Data-To-Protect, Protected-Data, Output-CBC-Chain)

9. Let Envelope-Body=Protected-Data.

10. Discard Output-CBC-Chain.

11. Protected-Data=Envelope-Recipient || Envelope-Block || Envelope-Body.

Notice that the RSA-Private and RSA-Public operations could be replaced with any asymmetric encryption system such as Elliptic Curve or NTRU. Notice also, that the order of the fields within blocks of data can be changed without effecting the security of this primitive. For example, the Protected-Data field could have the Envelope-Body block appearing first Notice further, that the SHA1 function in step 2 (Let Envelope-Recipient=SHA1 (Recipient-Public-Key)) above can be replaced with any cryptographic digest function such as MD2, MD4, MD5, RIPEMD, RIPEMD-160, MD6, SHA-256, SHA-384, or SHA-512, by adjusting the size of the related data fields according to the output size of the digest function. Notice that the Data-Encryption-Key and the OAEP-Seed can be proper or improper subsets of each other. For example, the Data-Encryption-Key could be the first 128 bits of the OAEP-Seed, or the OAEP-Seed could be generated from the Data-Encryption-Key by adding a fixed padding or by adding bits that are a simple function (such as bit-selection or rolling-exclusive-or) of the Key.

1.4 StoryMail Secure Socket Layer

The LW SSL protocol runs on top of a reliable bidirectional byte stream such as TCP. The byte stream is assumed to be insecure in the sense that bytes can be modified, recorded, replayed, inserted or deleted. The protocol turns this byte stream into a record stream by sending blocks of information preceded by a header that identifies the type of the record and its length. Implementations of this protocol will want to organize the transmission of records to fall within a single IP packet that makes up the TCP byte stream The protocol assumes that the byte stream will deliver any bytes that are sent so there is no need to handle retransmissions or acknowledgements at the LW SSL layer (these are done at the TCP layer). The protocol does however detect deleted data. If an application needs an acknowledgement that some piece of data is received, it will do that at a higher layer (e.g., the StoryMail reader expects to fetch a story and will keep trying until it gets the whole story).

The protocol begins with a handshake phases that sends two records in each direction. The two records sent by the server can be combined into a single TCP/IP packet, so the total overhead is three packets. These records can be used to setup a new master key (MK) for parties that have not communicated with each other recently, or reuse an existing MK that is cached to improve performance (reducing computation overhead and communication bandwidth). At the end of this phase the parties will be mutually authenticate to each other.

After the handshake phase, the parties send data records that carry higher layer information such as a story message. They close the session using the normal TCP close mechanism. Notice that this means an attacker can close the TCP session as part of a denial of service attack. Such attacks are too hard to prevent to be worth preventing at this time.

Different keys are used by the client and server for sending data. This avoids possible replay attacks such as sending the client a message that it had originally sent to the server in order to trick the client into thinking that the message came from the server. The SSL protocol has this mechanism also.

1.4.1 Data Maintained by Each Party

The client and server maintain the following information.

Client Long Term State

Client's own RSA Private and Public Key Pair

Digital Certificate with Client's Public Key

This is issued by StoryMail's CA, and is verifiable with the StoryMail root public key.

State of Pseudo Random Number Generator

Client Per-Server State

Table of Server-Name and Master-Key values

The KID for the MK is the hash of the MK itself, so there is no need to store it separately.

Client Per-Session State

128-bit Client-Write key

64-bit CBC chain value for Client-Write

128-bit Server-Write key

64-bit CBC chain value for Server-Write

During session handshake the hash of Hello message that was sent.

Server Long Term State

Server's own RSA Private and Public Key Pair

Digital Certificate with Server's Public Key

This is issued by StoryMail's CA, and is verifiable with the StoryMail root public key.

State of Pseudo Random Number Generator

Server Per-Client State

Cache Table of KID and Master Key values

The KID for the MK is the hash of the MK itself, but it is the index to this table, so it must be kept as a column. Rows can be deleted when they have not been used for some time or when space is needed.

Cache table of hash values for client certificates that have been validated.

This table reduces the effort required to validate a client certificate.

Server Per-Session State

128-bit Client-Write key

64-bit CBC chain value for Client-Write

128-bit Server-Write key

64-bit CBC chain value for Server-Write

During session handshake the hash of Hello and Accept message

1.4.2 Format of a Record

In a preferred embodiment, all of the StoryMail data items that are transmitted (called records as they are called in the SSL specification) have the same header format show below. The header bytes are never encrypted, though they are included in cryptographic checksums.

Type—1 byte

Version—1 byte=0 (high 4 bits reserved as extra length bits)

Length—2 bytes, MSB first=number of bytes in remaining content not including the four header bytes. If more than 65536 bytes are to be sent, then up to 4 bits of the version byte can be used to represent lengths up to 1 Mbyte. The preferred way to send a large data item is to place it in several smaller records.

Content bytes.

1.4.3 Types of Records

The Type byte of a record can have the following meanings. For the first release the version byte will be zero.

SM-Certificate=a certificate.

SM-Hello-New-MK=a new master key request.

SM-Accept-New-MK=response to new master key request.

SM-Hello-Reuse-MK=reuse master key request.

SM-Accept-Reuse-MK=response to reuse master key request.

SM-Reject-New-MK=negative response to reuse master key request.

SM-Client-Finish=last client handshake step. Authenticates client to server.

SM-Server-Finish=last server handshake step. Authenticates server to client.

SM-Client-Data=info sent from client to server.

SM-Server-Data=info sent from server to client.

1.4.4 Overview of New Master Key Setup

The protocol for setting up a new master key assumes that the client has the digital certificate for the server. It would get this through the email header information or request it via an unsecured request protocol (e.g., HTTP get and response exchange). At a minimum it needs to know the server's public key, and during the setup it will be given the server's certificate, which is then verified to ensure that the server is a valid member of the StoryMail system.

The exchange is based on a digital enveloping mechanism that is shared with the lightweight S/MIME protocol. The steps are listed below. Notice that the client certificate is encrypted inside a digital envelop that can only be opened by the server. This helps improve the privacy of communication since the sender's identity is not exposed at this layer, though of course some IP source address information will be exposed by the lower layers, but that IP address might belong to a firewall/proxy rather than to the sender.

1. C→S:

Hello-New-MK

SealSignedInsideEnveloped (Server-Public-Key, Client-Private-Key, Client-Certificate, Client-Message-Key, Client-Message-Key, Client-Nonce)

2. S→C:

Accept-New-MK

SealSignedInsideEnveloped (Client-Public-Key, Server-Private-Key, Server-Certificate, Client-Message-Key, Client-Message-Key, Server-Nonce)

It is possible for the server to respond with a different certificate than the client used to in step 1, but the server name in the certificate must match the expected value.

3. Both client and server compute the new Master Key (MK).

MK=HMAC (Server-Nonce || Client-Nonce, SHA1 (Hello-New-K) || SHA1 (Accept-New-MK)).

Notice that the entire records for the first two steps are feed into the HMAC.

Client-Write Key=HMAC (MK, Client-Subject-Name)

Server-Write Key=HMAC (MK, Server-Subject-Name)

1. S →C: Server-Finish

Same format as Data message, with the contents being the 160-bit value SHA1(Server None || Client-Nonce). This is encrypted with the Server-Write key, which is derived from the master key. Notice that this record can be sent together with the Accept-Reuse-MK record to avoid round-trip delays.

2. C→S: Client-Finish

Same format as Data message, with the contents being the 160-bit value SHA1 (Client None || Server-Nonce). This is encrypted with the Client-Write key, which is derived from master key.

3. Both sides confirm that the Finish records have the expected contents, and then send data records. In fact, the first data record can be appended to the Finish record to be sent in the same TCP/IP packet.

Notice that an important innovation of this protocol is that the signed portion of the Accept-New-MK record does not include any value generated by the Client, so the Server can precomputed this value and avoid the performance penalty of performing an RSA private key operation to start each new MK session. In fact, the Server can reuse the same signed value with multiple Clients with little worry about weakening the resulting session keys.

Notice that the Client-Message-Key is used as both the message key and the OAEP-Seed value in the embodiment shown above. Other embodiments could use a different value for the Client-Message-Key and the OAEP-Seed.

1.4.5 Overview of Reuse Master Key Setup

The protocol for reusing the master key is tried whenever possible to avoid the computational overhead of RSA. The server will send a reject message if the MK is no longer cached or if it has been used for too long The client responds to a reject by initiating the New MK protocol.

1. C →S: Hello-Reuse-MK

Key-ID, Client-Nonce

These value are both sent in the clear.

2. S →C: Accept-Reuse-MK

Key-ID, Client-Nonce, Server-Nonce

These values are sent in the dear.

3. Both client and server compute the new keys from the Master Key (MK).

Client-Write Key || HMAC (MK, SHA1(Hello-Reuse-MK) || SHA1(Accept-Reuse-MK)).

Server-Write Key || HMAC (MK, SHA1 (Accept-Reuse-MK) || SHA1 (Hello-Reuse-MK)).

The whole records from the first two steps are used to create the keys. This includes the 4-byte record headers.

4. S→C: Server-Finish

Same format as Data message, with the contents being the 160-bit value SHA1(Server None || Client-Nonce). This is encrypted with the Server-Write key, which is derived from the master key. Notice that this record can be sent together with the Accept-Reuse-MK record to avoid round-trip delays.

5. C →S: Client-Finish

Same format as Data message, with the contents being the 160-bit value SHA1 (Client

None || Server-Nonce). This is encrypted with the Client-Write key, which is derived from master key.

6. Both sides confirm that the Finish records have the expected contents, and then send Data records. In fact, the first data record can be appended to the Finish record to be sent in the same TCP/IP packet.

Notice that the SHA1 cryptographic digest show in the embodiment above can be replaced with any other cryptographically strong digest function such as MD5, RIPEMD-160, SHA-256, and the like.

1.4.6 Format and Algorithms for Hello-Reuse-MK Record

This Hello-Reuse-MK Record record has a standard header followed by two fixed length fields. All the Reuse-MK records have a very similar formats. This reduce the amount of code needed to implementation them.

Type—1 byte.

Version—1 byte=0.

Length—2 bytes, MSB first=number of bytes in remaining content.

Key-ID—20 bytes=SHA1 (MK).

Client-Nonce—20 bytes=Output of pseudo random number generator.

1.4.7 Format and Algorithms for Accept-Reuse-MK Record

This Accept-Reuse-MK Record record has a standard header followed by three fixed length fields The Client-Nonce is included to make replay attacks that use TCP stream insertion techniques harder to perform.

Type—1 byte.

Version—1 byte=0.

Length—2 bytes, MSB first=number of bytes in remaining content.

Key-ID—20 bytes=SHA1 (MK).

Client-Nonce—20 bytes=Copied from Hello message.

Server-Nonce—20 bytes=Output of pseudo random number generator, or hardware random number generator.

1.4.8 Format and Algorithms for Reject-Reuse-MK Record

This Reject-Reuse-MK Record record has a standard header followed by two fixed length fields. The Client-Nonce is included to make denial of service attacks that use TCP stream insertion techniques harder to perform. The client should respond to this record by attempting a Hello-New-MK handshake.

Type—1 byte.

Version—1 byte=0.

Length—2 bytes, MSB first=number of bytes in remaining content.

Key-ID—20 bytes=SHA1 (MK).

Client-Nonce—20 bytes=Copied from Hello message.

1.4.9 Format and Algorithms for Hello-New-MK Record

The Hello-New-MK record has the standard header followed by a nonce that is wrapped up for the Server. It includes the client's certificate, so the server does not need a database of client certificates. The server checks the signature on the client certificate, or checks that the hash of the certificate is in its database of previously validated certificates. See the section on cryptographic primitives for the data produced by SignedInsideEnveloped.

Type—1 byte.

Version—1 byte=0.

Length—2 bytes, MSB first=number of bytes in remaining content.

SignedInsideEnveloped (Server-Public-Key, Client-Private-Key, Client-Certificate, Message-Key, Client-Nonce).

The Client-Nonce and Message-Key come from the client's pseudo random number generator, the Server-Public-Key comes from the Email header, the Client-Private-Key and Client-Certificate comes from the client's protected storage.

1.4.10 Format and Algorithms for Accept-New-MK Record

The Accept-New-MK record has the standard header followed by a nonce that is wrapped up for the Client It includes the server's certificate since the client may only have the server's public key. The client verifies the certificate to ensure that it is speaking to an authorized server. See the section on cryptographic primitives for the data produced by SignedInsideEnveloped.

Type—1 byte.

Version—1 byte=0.

Length—2 bytes, MSB first=number of bytes in remaining content.

SignedInsideEnveloped (Client-Public-Key, Server-Private-Key, Server-Certificate, Message-Key, Server-Nonce).

The Server-Nonce and Message-Key come from the server's pseudo random number generator, the Client-Public-Key comes from the Client-Certificate received in the Hello-New-MK message. The Server-Private-Key and Client-Certificate comes from the server's protected storage.

The Client-Nonce is not included in this record to allow the server to reduce the number of private key operations that it must perform. The server can send the same signed Server-Nonce to multiple clients as long as they all have different Client-Nonce values, thus it does not need to do a private key operation to create each Accept-New-MK message, just a public key operation to sent it to the client. However, the server does need to perform a private key operation to Unseal the Hello-New-MK message.

Since the Client-Nonce in not included in the Accept-New-MK record, an attacker could replay an old message and the client will not immediately detect the replay. The client will discover the replay when it validates the Server-Finish record. Only a current Accept-New-MK record will produce the correct validation for the Server-Finish, since it requires knowledge of the new Client-Nonce as well as the possibly replayed Server-Nonce. An old Server-Finish record will not validate.

1.4.11 Format and Algorithms for Client-Finish Record

This record appears inside the EncryptedData primitive. The first block of encryption must be stripped off to find the 4-byte record header in order to find the length of the record contents. See the section on cryptographic primitives for details. For the Finish records, the CBC-Chain is zero.

EncryptedData (Client-Write-Key, Data-To-Protect) where Data-To-Protect is the following:

Type—1 byte.

Version—1 byte=0.

Length—2 bytes, MSB first=number of bytes in remaining content.

SHA1(Client-Nonce || Server-Nonce)).

1.4.12 Format and Algorithms for Server-Finish Record

This Server-Finish Record record is similar to Client-Finish.

EncryptedData (Server-Write-Key, Data-To-Protect) where Data-To-Protect is the following.

Type—1 byte.

Version—1 byte=0.

Length—2 bytes, MSB first=number of bytes in remaining content.

SHA1(Server-Nonce || Client-Nonce)).

1.4.13 Format and Algorithms for Client-Data Record

This record appears inside the EncryptedData primitive. The first block of encryption must be stripped off to find the 4-byte record header in order to find the length of the record contents. See the section on cryptographic primitives for details. For the first Data record, the CBC-Chain value comes from the last ciphertext block of the encrypted Finish record. Subsequent CBC-Chain values come from the last ciphertext block of the previous Data record.

EncryptedData (Client-Write-Key, Data-To-Protect) where Data-To-Protect is the following:

Type—1 byte.

Version—1 byte=0.

Length—2 bytes, MSB first=number of bytes in remaining content.

Data-To-Send.

1.4.14 Format and Algorithms for Server-Data Record

This Server-Data Record record is similar to the Client-Data record.

EncryptedData (Server-Write-Key, Data-To-Protect) where Data-To-Protect is the following:

Type—1 byte.

Version—1 byte=0.

Length—2 bytes, MSB first=number of bytes in remaining content.

Data-To-Send.

1.5 StoryMail Secure Certificate Issuing

The primary features of this enrollment and certificate issuing process are:

1. The enrollment can take place automatically without any user interaction.

2. For baseline security it is not necessary to issue individual certificates to the clients. The SSSL protocol will ensure privacy, integrity, and server-side authentication even if all clients share the same private keys that are built into the Reader program.

3. The enrolling device receives a digital certificate that is specific to the user's email address.

4. The certificate is issued by a global StoryMail Certificate Authority (SMCA). There may be half a dozen of these in the world and they maintain a loosely synchronized database.

5. As explained in [SSSL] the digital certificate is in a proprietary format (not X.509) and it includes both a public key from signing and a public key for enveloping (encrypting) data.

6. The key-pairs are generated by the SMCA using a strong random number generator and the private keys are forgotten. This documents includes notes on a future feature that would allow client devices to generate their own private keys.

It is possible to embody this invention without having an SMCA issuing certificates, so the Story Enabled Client software will not have key-pairs and certificates that are specific to each given email address. The LW SSL protocol ensures privacy, integrity, and server-side authentication even if an attacker knows the private key of the client. The attacker must know the private key for both the client and the server to be able to compute the session key. In this case, the server's private key is not known. The Reader programs can all share the same private keys and use self-signed certificates that include each client's email address.

1.5.1 Overview of Design

Every StoryMail SMTP message includes an invitation to download a StoryMail reader so the user can see the Story content as its author intended. If the device already has a reader, then information in the header of the SMTP message will be processed by the reader and the SMTP message will be replaced with the Story that is fetched from a StoryMail server via the SSSL protocol. Thus, only users who do not have the Reader see the body of the SMTP message. Somewhere in that message body will be a URL that the user can click on to download the reader and play the Story.

When the user clicks on the download URL, their browser will launch and eventually the desired Story will play. This document describes the security relevant actions that take place between clicking the URL and the playing the first Story.

The download proceeds in two phases. The first phase uses the browser's own security mechanisms to fetch a Loader program, and during the second phase the Loader uses StoryMail protocols to securely fetch the StoryMail Reader and perform the enrollment protocol to get a digital certificate and key-pairs from the StoryMail Certificate Authority (SMCA).

During the first phase, this design assumes that data transferred has good enough integrity and authenticity for the user, but that an attacker will be able to record all of this data for later analysis or replay. For example, the browser may be able to perform strong authentication of the source of information using SSL, but the SSL encryption used by the browser may be weak enough for the attacker to easily break (e.g., 40-bit keys). It might even happen that no SSL capability is present, but the user trusts the address resolution process of the Internet to navigate to the correct host when data is downloaded In this case, the data is not encrypted. Basically, the user assumes that the attacker is not able to actively intercept and modify downloaded data.

The result of the first phase is that a small Loader program begins to run on the client device. Based on information sent to the server during the HTTPS or HTTP GET request generated by clicking the download URL, the server will send an Internet Explorer (IE) ActiveX control or a Netscape plug-in.

The Loader comes from the StoryMail server that sent the SMTP message to the user, and it will include information that came from the download URL. That URL includes:

1. The name of the StoryMail server.

2. The client email address.

3 The message tag (see [Mtag]).

The StoryMail server can verify that the message tag and client email address match using an algorithm described in [Mtag] that is based on a server specific secret key. This means that the attackers cannot forge new download URLs, they can only replay ones that have been recorded from the SMTP messages or Loader requests.

The StoryMail server modifies the Loader program for each download request by including a the client's email address, which will be used when requesting a digital certificate, or for baseline security (before the SMCA exists) this address will be placed in a self-signed certificate. The Loader also includes the URL for the regional SMCA.

During the second phase, this design assumes that the Loader program will be able to create a private, encrypted, tamperproof and server-authenticated data pipe between the client device and the SMCA. The Loader uses the SSSL protocol to achieve this security. The Loader is configured to use fixed private keys, which the attacker can know without compromising the security properties of this protocol The certificate in the Loader which goes with these keys indicates that they are Loader keys, and thus they do not uniquely identify an email address, and the matching private keys may be known to the attacker.

The Loader connects to the SMCA using a compiled in URL and the SSSL protocol with the compiled in certificate and private keys. The SSSL implementation will generate a random pre-master key value that is sent to the SMCA encrypted with the SMCA's public key (which is also compiled into the Loader). Notice that an attacker would need to know the SMCA's private key to recover this value. The SMCA sends back a different random pre-master key value encrypted with the Loader's public key and signed by the server's private key. An attacker will be able to recover this value, since the Loader's private key is known, but the attacker cannot create these values, only replay them. However, the session master key is a cryptographic function of both random pre-master key values, so the attacker will not be able to compute it, and therefore will not be able to read the subsequent traffic.

The Loader then requests the correct Reader program for the client platform, and if the SMCA is issuing client specific certificates, the Loader (or Reader) requests a certificate for the client. The request includes the client's email address which is put in the certificate. The SMCA generates the key-pairs for singing and encrypting data. The public keys go into the certificate, and the private keys are passed to the Loader along with the certificate. The SMCA deletes the private keys after they has been sent to the Loader.

1.5.2 Data Maintained by the SMCA

There are a small number SMCA sites (which could be server farms) that maintain a common database. The entries in this database are updated between the SMCA sites using some protocol that is beyond the scope of this document. The security of this system does not rely on tight coupling between the databases on different SMCA sites. This design assumes that the sites are synchronized at least once per day

The following data is maintained by the SMCA sties.

1. For each email address:

a. Security flags set by the user.

b. Number of certificates issued with this address.

2. For each pairing of email address and certificate number

a. Date, time, and other context information.

b. Platform information for device that requested this certificate. This could include CPU, OS and Network-Bandwidth information.

c. Flag indicating whether this certificate is revoked.

d. Actual certificate, and optionally parsed-out values for:

i. Format/Version number.

ii. Signing Public Key.

iii. Encrypting Public Key.

iv. Certificate tag number (32-bit value)

3. For each SHA1 digest of a certificate:

a Cross reference to certificate table above.

1.5.3 Reader Download Request and Response

The format of the messages sent between the Loader and the SMCA to download the appropriate Reader program for the client platform is beyond the scope of this document. The security relevant consideration is that this download must take place over a channel secured by SSSL.

1.5.4 Certificate Request and Response

The certificate request is separate from the Reader download request. This protocol could be executed by the Loader, or later by the Reader. However, it does require that the requester know the client's email address.

This protocol uses a record structure (like the one used by the SSSL protocol) to send the request and the response, though these records are transported as ordinary Data records of the SSSL protocol. The request includes the email address of the client. The first part of the response will be the private keys. The second part of the response will be a certificate chain that starts with the user certificate and chains up to and including the StoryMail root certificate. Other versions of this protocol have the client generating the key-pairs, so the request will include the public keys and the response will not include the private keys. The format of the Certificate Request is shown below. In the first release, the public key lengths and exponents are zero since the SMCA is generating the key-pairs.

Type—1 byte=SM-Certificate-Request

Version—1 byte=Zero

Content-Length—2 bytes, MSB first=number of bytes in remaining content

Email-Address-Length—2 bytes, MSB first=length of following characters in bytes.

Email-Address—Zero or more bytes=Client Email Address.

Signing-Public-Key-Exponent—2 bytes, MSB first.

Signing-Public-Key-Length—2 bytes, MSB first=length of following field in bytes

Signing-Public-Key—n bytes, MSB first=Modulus.

Enveloping-Public-Key-Exponent—2 bytes, MSB first.

Enveloping-Public-Key-Length—n bytes, MSB first=length of following field in bytes.

Enveloping-Public-Key—n bytes, MSB first=Modulus.

The format of the Certificate Response is shown below. In another preferred embodiment, the private key length and exponent fields will be zero if the client chooses the key-pairs itself and simply sends the public keys in the request message.

Type—1 byte=SM-Certificate-Response

Version—1 byte=Zero

Content-Length—2 bytes, MSB first=number of bytes in remaining content

Signing-Private-Key-Exponent—2 bytes, MSB first.

Signing-Private-Key-Length—2 bytes, MSB first=length of following field in bytes.

Signing-Private-Key—tbd bytes, MSB first=all the parts of the private key in an order to be determined (e.g., P, Q, and CRT parameters).

Enveloping-Private-Key-Exponent—2 bytes, MSB first.

Enveloping-Private-Key-Length—2 bytes, MSB first=length of following field in bytes.

Enveloping-Private-Key—tbd bytes, MSB first=all the parts of the private key in an order to be determined (e.g., P, Q, and CRT parameters).

Cert-Chain—n bytes=an array of bytes where the first byte is the number of certificates in the chain, and the remaining bytes are the concatenation of the certificates. Recall that certificates include length information, so the start of each certificate can be identified. The client's certificate will be the first one in the chain.

The Loader will put the received key-pairs and certificates in a place that can be located by the Reader program. When the Reader program is first launched, it should validate that the public keys in the certificate match the private keys.

1.5.5 Client Generated Key-Pairs

In another preferred embodiment, the client could download a special program that generates key-pairs and performs the certificate request process. If the certificate request requires a message tag, then requesting a certificate would have to be integrated with the mail filter software that sees the message tags. If only the Email Address is required, this can run separately, though there would need to be some mechanism that proves that the requester has current access to an Address.

The key generation program could be downloaded separately from the SMCA site by clicking on URLs that are part of documentation or online help pages. The key generation software will need to be audited by an independent cryptography consultant to convince security conscious users that it is secure.

One class of users that are extremely concerned with security will want to use their own software to generate private keys. To cater to them, the software could have an option of reading a PKCS #12 file that has been exported by browsers from Netscape or Microsoft, or other PKI software.

An other class or security conscious users will want the StoryMail Reader to access private keys stored on a physical or virtual smart card. This type of security feature may also be provided.

1.6 StoryMail Secure Response Session

As part of playing a Story message, the Story Enabled Client can establish a secure Response Session between the client machine and a Response Server machine using the Secure Response Protocol. For example, the an advertisement message could include a button that the user presses to connect to the a merchant server that is acting as the Response Server or to a server that is shared among two or more merchants called the Response Automation Server to send and receive further information. The case of sending a unidirectional response message is described below. This section is describing the establishment of a secure bi-directional link.

1.6.1 Overview of Secure Response Session

A valuable feature of the Secure Response Session protocol is that it is nearly identical to the LW SSL protocol. The difference is that the URL of the Response Server and the public key for the Response Server are both embedded in the Story message, instead of, for example, appearing in the regular e-mail header as it does with LW SSL.

1.6.2 Steps to Step Up Secure Response Session

In one embodiment, the Secure Response Session is set up by the following steps:

Extract the URL of the Response Server and public key of the Response Server from the currently playing Story message.

a. These two values can appear separately in the Story message.

b. One or both of these two values can appear inside a Compact Certificate that appears in the Story. In this case, the digital signature on the certificate is verified to confirm that this is an authorized certificate.

c. Additional security checks may optionally be performed on these two values, such as checking that the URL of the Response Server matches part of a URL that appears elsewhere in the story such as the identity of the author of this story.

2. Check for a cached Master-Key related to the Response Server's URL.

a. If a Master-Key is found, perform the LW SSL protocol starting with a Hello-Reuse-MK record.

b. If a Master-Key is not found, perform the LW SSL protocol starting with a Hello-New-MK record.

Notice that even if the client does not have a unique certificate, the Response Server can authenticate the Client using unique information, which could be the Message Tag, that was placed in the Story sent to the Client.

1.7 StoryMail Secure Unidirectional Message

This protocol can be used when a Story Enabled Client wants to send a Secure Unidirectional Message to a Response Server. This might be initiated by the Client in response to the user clicking on some active area of the Story display or other user interface action. For example, an advertisement message could include a “buy-it” button that the user will click on to initiate a purchase transaction with the Response Server operating on behalf of the merchant offering the advertised good or service.

This protocol can also be used to send secure unidirectional messages between any two Story Enabled Clients or from Servers to Clients.

1.7.1 Overview of Secure Unidirectional Message

Outside of the scope of the protocol the Sender of the message receives the Compact Certificate for the Recipient of the message. For example, a Story message played by a Story Enabled Client might include the Compact Certificate for the Recipient as part of the data associated with an active region of the display or other user interface component.

The Sender gathers together the data it wants to send and then creates a record using the common SealSignedInsideEnveloped cryptographic primitive. The Type field identifies the purpose of this record and the format field identifies its structure. The Recipient can use the common UnsealSignedInsideEnveloped cryptographic primitive to extract the data and verify the authenticity of its source.

Notice that if the Sender does not have a unique Compact Certificate, the authenticity of the Sender can be attested to by the presence of a data value that was uniquely sent to the Sender, such as a Message Tag or other token or cookie that was created with the story or exists on the Sender's machine (e.g., Microsoft Global Unique ID, Product ID, CPU ID, or Story Reader Registration ID).

1.7.2 Steps in Secure Unidirectional Message Protocol

In accordance with one embodiment, the steps in sending a Secure Unidirectional Message are

1. Extract the URL of the Response Server and public key of the Response Server from the currently playing Story message, or from a repository of values like an address book.

a. These two values can appear separately in the message or repository.

b. One or both of these two values can appear inside a Compact Certificate that appears in the Story. In this case, the digital signature on the certificate is verified to confirm that this is an authorized certificate.

c. Additional security checks may optionally be performed on these two values, such as checking that the URL of the Response Server matches part of a URL that appears elsewhere in the message such as the identity of the author of this story.

2. Use the common cryptographic primitive, SealSignedInsideEnveloped to produce a message body record and add appropriate Type and Format fields to indicate the purpose and format of the record.

3. Transmit record to the Recipient using information derived from the Recipient's URL extracted earlier.

The step in receiving a Secure Unidirectional Message are:

1. Receive the message body record from the Sender.

2. Check the Type and Format fields to confirm that this message has an acceptable purpose and format for the Recipient.

3. Use the common cryptographic primitive, UnsealSignedInsideEnveloped to extract the data in the message and to verify the authenticity of the Sender and the integrity of the message (to confirm that it was not modified in transit).

4. Optionally examine the extracted Data to confirm that an acceptable message tag or other client unique identifier is contained in the message, and that its value is appropriate given the Type and Format fields and other fields in the Data.

Notice that this protocol reuses the same cryptographic primitives and data structures as the other protocols. Notice also, that either or both of the Sender and Recipient can have non-unique Compact Certificates, though the security properties available in those cases are less strong than if both parties have unique certificates.

1.8 Further Description of Selected System, Method, Protocol, Computer Program, Methodological and Procedural Embodiments

Having described various aspects and structures of StoryMail Message Tags, StoryMail Compact Certificates, StoryMail Common Protocol Elements, StoryMail Secure Socket Layer, StoryMail Secure Certificate Issuing, StoryMail Secure Response Session, and StoryMail Secure Unidirectional Messaging, attention is now focused on the description of various methods and procedures that provide or contribute to secure communication or messaging under various operational scenarios. These illustrative methods and procedure are described by way of illustration and not by limitation.

It will also be understood that these methods may advantageously be implemented as sets of instructions, with appropriate data or parameters where appropriate, on either general purpose or specialized computers or other information appliances. In general, such computers will have a processor, microprocessor, or CPU with a coupled memory. The instructions are stored in the memory and executed by the processor. Such computers or information appliances will also typically include a connection to a networks, such as the Internet. Frequently, the messaging or other secure communication will take place between two (or more) such computers or information appliances over the Internet.

1.8.1 Embodiment of Method for Secure Communications and Messaging

In a one aspect, the invention provides a hardware architecture neutral and operating system neutral and network transport neutral method for secure messaging and communications. In one embodiment this method includes the following procedures and steps with options or variations.

An authorization procedure is provided for authorizing any particular user the right to access a specific resource. A digital certificate procedure is provided that enables at least encryption and digital signatures having lower storage and bandwidth requirements than conventional digital certificates. A security protocol implementation procedure for implementing two or more security protocols using a common set of data formats, algorithms, subroutines, and procedures. A secure session interaction procedure having reduced software/firmware computer code/instructions and reduced network bandwidth than conventional secure session interaction procedures. A unidirectional messaging procedure using less software/firmware code and reduced network bandwidth than conventional unidirectional messaging procedures. A secure certificate issuing procedure using less software/firmware code and reduced network bandwidth than conventional secure certificate issuing procedures. A secure response procedure using less software/firmware code and reduced network bandwidth than conventional secure response procedures. A secure unidirectional response messaging procedure using less software/firmware code and reduced network bandwidth than conventional secure unidirectional messaging procedures.

While embodiments of the inventive system, method, and computer program may include all of the procedures described above and elsewhere in this specification, it is understood that many of the component procedures are optional and are not required in all implementations or embodiments of the systems, methods, computer programs, computer program products of the invention, or not required for particular messaging or communication schemes or situations within a system or method.

Although aspects of the invention are described throughout the specification and drawings, certain selected aspects and embodiments and/or combinations of features are now highlighted. In a first aspect, the invention provides a hardware architecture neutral and operating system neutral and network transport neutral method for communicating or messaging. Embodiments are conveniently referenced and listed using a number surrounded by parenthesis for convenient reference.

(1) A hardware architecture, operating system, and network transport neutral method secure communications, the method comprising: an authorization procedure for authorizing any particular user the right to access a specific resource; a digital certificate procedure that enables at least encryption and digital signatures having lower storage and bandwidth requirements than conventional digital certificates; a security protocol implementation procedure for implementing two or more security protocols using a common set of data formats, algorithms, subroutines, and procedures; a secure session interaction procedure having reduced software/firmware computer code/instructions and reduced network bandwidth than conventional secure session interaction procedures; a secure unidirectional messaging procedure using less software/firmware code and reduced network bandwidth than conventional unidirectional messaging procedures; a secure certificate issuing procedure using less software/firmware code and reduced network bandwidth than conventional secure certificate issuing procedures; a secure response session procedure using less software/firmware code and reduced network bandwidth than conventional secure response procedures; and a secure unidirectional response messaging procedure using less software/firmware code and reduced network bandwidth than conventional secure unidirectional messaging procedures.

(2) A system for secure communications comprising: an authorization module for authorizing any particular user the right to access a specific resource; a digital certificate encryption module that enables at least encryption and digital signatures having lower storage and bandwidth requirements than conventional digital certificates; a security protocol module for implementing two or more security protocols using a common set of data formats, algorithms, subroutines, and procedures; a secure session interaction module having reduced software/firmware computer code instructions and reduced network bandwidth than conventional secure session interaction procedures; a secure unidirectional messaging module using less software/firmware code and reduced network bandwidth than conventional unidirectional messaging procedures; a secure certificate issuing module using less software/firmware code and reduced network bandwidth than conventional secure certificate issuing procedures; a secure response session module using less software/firmware code and reduced network bandwidth than conventional secure response procedures; and a secure unidirectional response messaging module using less software/firmware code and reduced network bandwidth than conventional secure unidirectional messaging procedures.

(3) A computer program product for use in conjunction with a computer system having a server and a client, the computer program product comprising a computer readable storage medium and a computer program mechanism embedded therein, the computer program mechanism, comprising: a program module that directs the computer system and/or components thereof including at least one or the client or server, to function in a specified manner to provide message communications, the message communications occurring in a computer system hardware architecture neutral and operating system neutral and network transport protocol neutral manner for secure communications, the program module including instructions for: an authorization procedure for authorizing any particular user the right to access a specific resource; a digital certificate procedure that enables at least encryption and digital signatures having lower storage and bandwidth requirements than conventional digital certificates; a security protocol implementation procedure for implementing two or more security protocols using a common set of data formats, algorithms, subroutines, and procedures; a secure session interaction procedure having reduced software/firmware computer code/instructions and reduced network bandwidth than conventional secure session interaction procedures; a secure unidirectional messaging procedure using less software/firmware code and reduced network bandwidth than conventional unidirectional messaging procedures; a secure certificate issuing procedure using less software/firmware code and reduced network bandwidth than conventional secure certificate issuing procedures; a secure response session procedure using less software/firmware code and reduced network bandwidth than conventional secure response procedures; and a secure unidirectional response messaging procedure using less software/firmware code and reduced network bandwidth than conventional secure unidirectional messaging procedures.

(4) A hardware architecture, operating system, and network transport neutral method secure communications, the method comprising: an authorization procedure for authorizing any particular user the right to access a resource; a digital certification procedure for encryption and digital signing; a security protocol procedure for implementing a plurality of security protocols using a single common set of policies and parameters; a secure session interaction procedure; a secure unidirectional messaging procedure; a secure certificate issuing procedure; a secure response session procedure; and a secure unidirectional response messaging procedure; the procedures using less software/firmware/computer code and reduced network bandwidth than conventional procedures to accomplish analogous functionality.

1.8.2 Embodiment of Method for Authorization of Access to Resource

In a second aspect, the invention provides a hardware architecture neutral and operating system neutral and network transport neutral method for authorizing a specific user the right to access a specific resource such as an e-mail message or a promotional coupon. In one embodiment this method includes the following steps and options or variations.

A Resource Owner sends to the Specified User a Resource Tag (e.g., Message Tag or Coupon Tag), where the Resource Tag is the result of a reversible cryptographic transformation of a Redundancy Field and Resource Identifier Field (e g., Message Number) and optionally other information. The Resource Tag may be sent by regular e-mail, Story Enabled e-mail, by display on a web page, or by hardcopy or other media The cryptographic transformation of the fields of a Resource Tag can be based on one or more secret keys known to the Resource Owner using series of block encryption steps on portions of the fields in a manner that allows the transformation to be reverse by an entity that knows the one or more secret keys.

For a 9 to 16 byte Resource Tag, the cryptographic transformation can be performed by three or more applications of 8-byte block encryption using a cipher such as triple-DES or XTEA or RC5, where a portion of the output bits from each block encryption are xor'ed with a portion of the input bits to the next block encryption.

For a Resource Tag of any length, the cryptographic transformation can be performed by a block cipher operating in Cipher-Block-Chaining mode with an initialization vector of zero or some fixed value that is applied in two passes, first from left to right across the bytes of the fields and then from right to left across those resulting bytes, with the end result being that each Resource Tag bit depends strongly on each bit of the input fields, and only an entity who knows the one or more keys can reverse this transformation.

The Redundancy Field can be a cryptographic hash (e.g. SHAL) of 1) some or all of the User Credential and 2) one or more parts of the Server's Credential, and 3) optionally of the other input fields of the Resource Tag. The User's Credential could include that user's e-mail address. The Server's Credential could include that server's domain name, or the domain name associated with the Resource Owner. The optional fields from the Resource Tag could include the Resource Identifier.

At a later time, the Specified User presents the Resource Tag and User Credential Information to the Resource Owner in a manner that allows the Resource Owner to verify the User's Credential Information. The verification of the User's Credential can be based on a challenge-response authentication protocol that proves that the User (client) communicating with the Resource Owner (server) has current access to a private key (e.g., RSA or Elliptic Curve or NTRU private key) associated with a public key that appears as one field of the User Credential Information which is digitally signed along with other credential information by an entity that is trusted by the Resource Owner. The verification of the User's Credential can be based on a challenge response authentication protocol that proves that the User (client) communicating with the Resource Owner (server) has current access to a secret key (e.g., triple-DES or XTEA or RC5 or AES key) associated with a key identifier that appears as one field of the User Credential Information where the key identifier allows the server to lookup the same secret key known to the client, and other fields in the User Credential Information are verified using a cryptographic checksum based on that same secret key.

The Resource Owner determines whether to grant access to the Resource (e.g., e-mail message) by comparing a first cryptographic transformation of the Resource Tag to a second cryptographic transformation of some or all of the User Credential Information and one or more parts of the Server's (Resource Owner's) Credential Information, and optionally, one or more of the input fields to the Resource Tag, and then granting access if they are equal, otherwise denying access. The first cryptographic transformation is the reverse of the one applied to create the tag from its input fields followed by an operation that extracts the Redundancy Field. The second cryptographic transformation follows the same steps used to create the Redundancy Field based on verified User Credential Information, the Server Credential Information, and optionally one or more of the input fields to the Resource Tag Some particular embodiments relating to these aspects are highlighted below.

(5) A computer program product for use in conjunction with a computer system having a server and a client, the computer program product comprising a computer readable storage medium and a computer program mechanism embedded therein, the computer program mechanism, comprising: a program module that directs the computer system and/or components thereof including at least one or the client or server, to function in a specified manner to provide message communications, the message communications occurring in a computer system hardware architecture neutral and operating system neutral and network transport protocol neutral manner for a resource owner authorizing a specific user the right to access a particular resource, the program module including instructions for: A. sending a resource tag to a specified user; B. receiving, back from the specified user, the resource tag sent earlier and a user credential information; C. verifying the user credential information; D. comparing a first cryptographic transformation of a first information item to a second cryptographic transformation of a second information item; and E. granting access to the particular resource only if the first cryptographic transformation of the first information item has a predetermined relationship with the second cryptographic transformation of the second information items, and otherwise denying access to the particular resource.

(6) A hardware architecture neutral and operating system neutral and network transport neutral method for a resource owner authorizing a specific user the right to access a particular resource, the method comprising: A. sending a first information item to a specified user; B. receiving, back from the specified user, the resource tag sent earlier and a user second information item; C. verifying the user second information item; and D. comparing a first cryptographic transformation of the first information item to a second cryptographic transformation of the second information item; and E. granting access to the particular resource only if the first cryptographic transformation of the first information item has a predetermined relationship with the second cryptographic transformation of the second information items, and otherwise denying access to the particular resource.

(7) The method in embodiment (6), wherein the particular resource comprises an e-mail message. (8) The method in embodiment (6), wherein the particular resource comprises a promotional coupon. (9) The method in embodiment (6), wherein the particular resource comprises an information item in electronic form (10) The method in embodiment (6), wherein the particular resource comprises a storymail story. (11) The method in embodiment (6), wherein the resource tag comprises a message tag or a coupon tag. (12) The method in embodiment (6), wherein the resource tag is generated as the result of a reversible cryptographic transformation. (13) The method in embodiment (6), wherein the first information item comprises a redundancy field and the second information item comprises a resource identifier field and the transformation comprises a transformation of one or more of the Redundancy Field and the Resource Identifier Field. (14) The method in embodiment (13), wherein at least one of the redundancy field and resource identifier field include a message number. (15) The method in embodiment (6), wherein the transformation comprises a transformation of a Redundancy Field, a Resource Identifier Field, and other information. (16) The method in embodiment (6), wherein the resource tag comprises a message tag or a coupon tag and is generated as the result of a reversible cryptographic transformation, the transformation comprising a transformation of at least a Redundancy Field and a Resource Identifier Field, at least one of the redundancy field and resource identifier field including a message number. (17) The method in embodiment (6), wherein the resource tag is sent by any one of conventional e-mail, Story Enabled e-mail, display on a web page, or hardcopy media. (18) The method in embodiment (16), wherein the fields of a Resource Tag are based on one or more secret keys known to the Resource Owner. (19) The method in embodiment (18), wherein the one or more secret keys known to the resource owner use one or a series of block encryption steps on portions of the fields in a manner that allows the transformation to be reversed by an entity that knows the one or more secret keys. (20) The method in embodiment (19), wherein the resource tag comprises a nine-byte to sixteen-byte tag, and the cryptographic transformation is performed by three or more applications of eight-byte block encryption using a cipher. (21) The method in embodiment (20), wherein a portion of the output bits from each of the applications of eight-byte block encryption are exclusively OR'ed with a portion of the input bits to the next one of the applications of eight-block encryption. (22) The method in embodiment (20), wherein the cipher is selected from the group of ciphers consisting of a triple-DES based cipher, a XTEA based cipher, a RC5 based cipher, and combinations thereof. (23) The method in embodiment (19), wherein the resource tag has an arbitrary length and the cryptographic transformation is performed by a block cipher. (24) The method in embodiment (23), wherein the block cipher is operating in Cipher-Block-Chaining mode. (25) The method in embodiment (24), wherein: the Cipher-Block-Chaining mode operates with an initialization vector, and said initialization vector has a fixed value. (26) The method in embodiment (25), wherein the initialization vector has a fixed value. (27) The method in embodiment (25), wherein the initialization vector is applied in two passes, a first pass in a first direction (from left to right) across the bytes of the fields and then a second pass in the opposite direction to the first pass (from right to left) across those resulting bytes, with the end result being that of generating resource tag bits which together form the resource tag, and wherein each resource tag bit depends strongly on bits of the input fields, so that only an entity who knows the one or more keys can reverse this cryptographic transformation. (28) The method in embodiment (16), wherein the Redundancy Field comprises a cryptographic hash. (29) The method in embodiment (28), wherein the redundancy field cryptographic hash comprises SHA1 of (i) some or all of a User Credential, and (ii) one or more parts of a Server Credentials. (30) The method in embodiment (29), wherein the redundancy field cryptographic hash further comprises SHA1 of (iii) one or more other of the optional other input fields of the Resource Tag. (31) The method in embodiment (30), wherein the optional fields from the Resource Tag include the Resource Identifier. (32) The method in embodiment (29), wherein the User's Credential includes that user's e-mail address. (33) The method in embodiment (29), wherein the User's Credential includes an attribute identifying a user or an information appliance, computer, or network interface card address, associated with the user. (34) The method in embodiment (29), wherein the Server's Credential includes either one or both of the server's internet domain name, or the domain name associated with the Resource Owner. (35) The method in embodiment (29), wherein the User's Credential includes an attribute identifying a user, a user's e-mail address, or an information appliance associated with the user or email address; and the Server's Credential includes either one or both of the server's internet domain name or the domain name associated with the Resource Owner. (36) The method in embodiment (6), wherein the verification of the User's Credential is based on a challenge-response authentication protocol. (37) The method in embodiment (36), wherein the challenge-response authentication protocol is a protocol that proves that the User (client) communicating with the Resource Owner (server) has current access to a private key associated with a public key (38) The method in embodiment (37), wherein the private key comprises a RSA private key, an Elliptic Curve private key, or a NTRU private key. (39) The method in embodiment 32 (37), wherein the public key appears as one field of the User Credential Information. (40) The method in embodiment (39), wherein the User Credential Information is digitally signed along with other credential information by an entity that is trusted by the Resource Owner. (41) The method in embodiment (36), wherein the challenge-response protocol indicates that the User (client) communicating with the Resource Owner (server) has current access to a secret key associated with a key identifier. (42) The method in embodiment (41), wherein the secret key comprises a triple-DES based secret key, a XTEA based secret key, a RC5 based secret key, or a AES based secret key. (43) The method in embodiment (41), wherein the key identifier appears as one field of the User Credential information. (44) The method in embodiment (41), wherein the key identifier allows the server to look up the same secret key known to the client. (45) The method in embodiment (43), wherein the key identifier allows the server to look up the same secret key known to the client, and other fields in the User Credential Information are verified using a cryptographic checksum based on that same secret key. (46) The method in embodiment (6), wherein the first information comprises the Resource Tag, and the second information item comprises some portion or all of the User Credential Information and one or more portions of the Server's or Resource Owner's Credential Information. (47) The method in embodiment 41 (46), wherein the second information item optionally comprises one or more of the input fields to the Resource Tag. (48) The method in embodiment (6), wherein the comparison comprises a logical operation. (49) The method in embodiment (48), wherein the comparison comprises a logical operation performed on a bit, byte, multi-bit, or multi-byte basis. (50) The method in embodiment (6), wherein the comparison comprises an algorithm based comparison operation. (51) The method in embodiment (6), wherein the comparison comprises a mathematical operation. (52) The method in embodiment (6), wherein the first information comprises the Resource Tag, and the second information item comprises some portion or all of the User Credential Information and one or more portions of the Server's or Resource Owner's Credential Information, and the comparison comprises at least one of a logical operation and a mathematical operation. (53) The method in embodiment (6), wherein the predetermined relationship is equality. (54) The method in embodiment (6), wherein the comparison comprises at least one of a logical operation and a mathematical operation and the predetermined relationship is equality. (55) The method in embodiment (6), wherein the first information item comprises a redundancy field and the second information item comprises a resource identifier field; and the first cryptographic transformation comprises a process that is the reverse of the process applied to create the resource tag from its input fields followed by an operation that extracts the Redundancy Field (56) The method in embodiment (55), wherein the second cryptographic transformation includes substantially the same steps used to create the Redundancy Field based on at least one of the verified User Credential Information and the Server Credential Information. (57) The method in embodiment (55), wherein the second cryptographic transformation includes substantially the same steps used to create the Redundancy Field based on at least one of the verified User Credential Information and the Server Credential Information, and one or more of the input fields to the Resource Tag. (58) The method of embodiment (40), wherein the trusted entity comprises a Compact Certificate as explained earlier, or chain of Compact Certificates leading to a trusted root public key.

(59) A method for authorizing a user access a resource, the method comprising: sending a resource tag to the user; receiving the resource tag and a user credential information from the user; verifying the user credential information; comparing a first cryptographic transformation of the resource tag to a second cryptographic transformation of some portion or all of the User Credential Information and one or more selected portions of the Server's or Resource Owner's Credential Information; and granting access to the resource only if the first cryptographic transformation of the resource tag matches with the second cryptographic transformation of the selected portion or all of the User Credential Information and one or more portions of the Server's or Resource Owner's Credential Information, and otherwise denying access to the resource.

1.8.3 Embodiment of Method for Compressed Digital Certificate

In a third aspect, the invention provides a hardware architecture neutral and operating system neutral and network transport neutral method for representing a digital certificate that enables at least encryption and digital signatures using substantially less storage and bandwidth than conventional digital certificates. In one embodiment, this method includes the following steps and options or variations.

A common data object header is used that includes fields called Type, Version, and Content-Length, in all communicated data including certificates. In one embodiment, there is used a single byte to represent Type and Version, and 3 bytes to represent Content-Length, or one byte each for Type and Version and 2 bytes to represent the Content-Length. The type field may be used to identify that this object is a Certificate. The Version number may be used to represent four of more of the following attributes: Algorithm used by Certificate Issuer to sign the certificate, Algorithm to be used with the Subject's first public key, Algorithm to be used the Subject's second or subsequent public key, Length of each public key, Length of Certificate Issuer's signature, Parameters for each of the algorithms such as the exponent to use with RSA public key, Subject Name and/or Character Set of Subject Name, and Issuer Name and/or Character Set of Issuer Name.

Two or more (a plurality of) public keys are contained in a single certificate, each with its own purpose such as encrypting message or session keys, or signing messages, or signing and encrypting data. In one embodiment, include at least two public keys that have the same size (length) and algorithm parameters such as RSA Exponent or Diffie-Helman Generator.

A Tag Field is included that functions as a discriminator of different Certificates issued to the same Subject. The Tag Field may be treated as an unsigned integer (e.g., a four byte value) that is incremented with each Certificate issued to the Subject, so given two Certificates with the same Subject Name, it is easy to tell which on is more recent. This replaces the validity dates found with X.509 Certificates. The Tag Field may for example, be treated as four ASCII characters to represent the expiration date of the Certificate as a two digit month number and a two digit year number (e.g., MMDD or DDMM, etc.).

The Subject Name and Certificate Issuer Name are represented in one fixed character set determined by the Version Field. For example, represent the Subject Name and Certificate Issuer Name as two-byte Unicode characters.

The Version Field is used to indicate any additional fields that are present in the certificate.

Some particular embodiments relating to these aspects are highlighted below.

(60) A computer program product for use in conjunction with a computer system having a server and a client, the computer program product comprising a computer readable storage medium and a computer program mechanism embedded therein, the computer program mechanism, comprising: a program module that directs the computer system and/or components thereof including at least one or the client or server, to function in a specified manner to provide message communications, the message communications occurring in a computer system hardware architecture neutral and operating system neutral and network transport protocol neutral manner for representing a digital certificate, the program module including instructions for: A. using a common data object header in substantially all communicated data including communicated certificates; B. providing a plurality of public keys including a first public key and a second public key in a single certificate, each of the at least first and second public keys being associated with its own purpose; C. providing a Tag Field that functions as a discriminator of different Certificates issued to the same Subject; and D. representing a Subject Name and a Certificate Issuer Name in one fixed character set determined by the Version Field.

(61) A hardware architecture neutral and operating system neutral and network transport neutral method for representing a digital certificate that enables at least encryption and digital signatures using substantially less storage and bandwidth than conventional digital certificates, the method comprising: A. using a common data object header in substantially all communicated data including communicated certificates; B. providing a plurality of public keys including a first public key and a second public key in a single certificate, each of the at least first and second public keys being associated with its own purpose; C. providing a Tag Field that functions as a discriminator of different Certificates issued to the same Subject; and D. representing a Subject Name and a Certificate Issuer Name in one fixed character set determined by the Version Field.

(62) The method in embodiment (61), wherein the common data object header includes a plurality of fields including a Type field, a Version field, and a Content-Length field. (63) The method in embodiment (61), wherein the purpose is selected from the group of purposes consisting of encrypting messages, encrypting session keys, signing messages, signing and encrypting data, and combinations thereof (64) The method in embodiment (62), wherein a single byte is used to represent a type and a version for the Type Field the Version Field; and three bytes are used to represent Content-Length in the Content-Length Field. (65) The method in embodiment (62), wherein a first single byte is used to represent a type in the Type Field and a second single byte is used to represent a Version in the Version Field; and two bytes are used to represent Content-Length in the Content-Length Field. (66) The method in embodiment (62), wherein each the byte has a length selected from the set of byte lengths consisting of 8 bits, 10 bits, 12 bits, 16 bits, 24 bits, 32 bits, 64 bits, 96 bits, and 128 bits. (67) The method in embodiment (62), wherein the Type field is used to identify that the object is a Certificate. (68) The method in embodiment (62), wherein the version number is used to represent at least one of the following attributes: (i) Algorithm used by Certificate Issuer to sign the certificate, (ii) Algorithm to be used with the Subject's first public key, (iii) Algorithm to be used the Subject's second or subsequent public key, (iv) Length of each public key, (v) Length of Certificate Issuer's signature, (vi) parameters for the algorithm, (vii) an exponent to use with RSA public key (viii) Character Set of Subject Name, and (ix) Character Set of Issuer Name. (69) The method in embodiment (63), wherein the version number is used to represent a plurality of attributes selected from the set of attributes consisting of: (i) Algorithm used by Certificate Issuer to sign the certificate, (ii) Algorithm to be used with the Subject's first public key, (iii) Algorithm to be used the Subject's second or subsequent public key, (iv) Length of each public key, (v) Length of Certificate Issuer's signature, (vi) parameter(s) for an algorithm, (vii) an exponent to use with RSA public key, (viii) Character Set of Subject Name, and (ix) Character Set of Issuer Name. (70) The method in embodiment (63), wherein the Version number is used to represent at least four attributes selected from the set of attributes consisting of: (i) Algorithm used by Certificate Issuer to sign the certificate, (ii) Algorithm to be used with the Subject's first public key, (iii) Algorithm to be used the Subject's second or subsequent public key, (iv) Length of each public key, (v) Length of Certificate Issuer's signature, (vi) parameter(s) for an algorithm, (vii) an exponent to use with RSA public key, (viii) Character Set of Subject Name, and (ix) Character Set of Issuer Name. (71) The method in embodiment (62), wherein the plurality of public keys include at least two public keys that have the same size (same length) and system parameters. (72) The method in embodiment (62), wherein the system parameters include an RSA Exponent or Diffie-Helman Generator. (73) The method in embodiment (62), wherein the Tag Field is treated as an unsigned integer that is incremented with each Certificate issued to the Subject. (74) The method in embodiment (62), wherein the unsigned integer has a four byte value. (75) The method in embodiment (73), wherein the treatment as an unsigned integer providing a mechanism for identifying which of a plurality of certificates having the same Subject Name is more recent than another certificate having that Subject. (76) The method in embodiment (75), wherein this treatment and mechanism replaces the validity dates found with X.509 or X.509-type certificates. (77) The method in embodiment (62), wherein the Tag Field is treated as ASCII characters to represent the expiration date of the Certificate. (78) The method in embodiment (77), wherein the Tag Field is treated as four ASCII characters to represent the expiration date of the Certificate as a two digit month number and a two digit year number. (79) The method in embodiment (62), wherein the Subject Name and Certificate Issuer Name are represented as two-byte characters. (80) The method in embodiment (79), wherein the two-byte characters comprise two-byte Unicode characters. (81) The method in embodiment (62), wherein the Version Field is used to indicate any additional fields that are present in the certificate.

(82) A hardware architecture neutral and operating system neutral and network transport neutral method for representing a digital certificate that enables at least encryption and digital signatures using substantially less storage and bandwidth than conventional digital certificates, the method comprising the steps of: using a common data object header in substantially all communicated data including communicated certificates; providing a plurality of public keys including a first public key and a second public key in a single certificate, each of the at least first and second public keys being associated with its own purpose; providing a Tag Field that functions as a discriminator of different Certificates issued to the same Subject; and representing a Subject Name and a Certificate Issuer Name in one fixed character set determined by the Version Field; the common data object header includes a plurality of fields including a Type field, a Version field, and a Content-Length field; the purpose is selected from the group of purposes consisting of encrypting messages, encrypting session keys, signing messages, signing and encrypting data, and combinations thereof, at most two bytes are used to represent a type and a version for the Type Field the Version Field; and at most three bytes are used to represent Content-Length in the Content-Length Field; the Type field is used to identify that the object is a Certificate; the Version number is used to represent a plurality of attributes selected from the set of attributes consisting of: (i) Algorithm used by Certificate Issuer to sign the certificate, (ii) Algorithm to be used with the Subject's first public key, (iii) Algorithm to be used the Subject's second or subsequent public key, (iv) Length of each public key, (v) Length of Certificate Issuer's signature, (vi) exponent to use with RSA public key, (vii) Character Set of Subject Name, and (vii) Issuer Name; the plurality of public keys include at least two public keys that have the same size and the same system parameters; the Tag Field is treated as an unsigned integer that is incremented with each Certificate issued to the Subject; the treatment as an unsigned integer providing a mechanism for identifying which of a plurality of certificates having the same Subject Name is more recent than another certificate having that Subject; the Tag Field is treated as ASCII characters to represent the expiration date of the Certificate; the two-byte characters comprise two-byte Unicode characters; and the Version Field is used to indicate any additional fields that are present in the certificate.

(83) A method for representing a digital certificate, the method comprising: using a common data object header in all communicated data including communicated certificates; providing a plurality of public keys including a first public key and a second public key in a single certificate; providing a first field that functions as a discriminator of different certificates issued to the same subject; and representing a subject name and a certificate issuer name in one fixed character set determined by a second field.

1.8.4 Embodiment of Method for Using Common Security Protocol Mechanisms

In a fourth aspect, the invention provides a hardware architecture neutral and operating system neutral and network transport neutral method for implementing two or more security protocols such as 1) secure interactive sessions, 2) secure unidirectional messaging, 3) secure software downloading, 4) secure software upgrading, and 5) secure issuing of digital certificates, using a common set of data formats, algorithms, subroutines, and procedures. For example, in one embodiment, the method includes the following steps and options or variations.

Define cryptographic primitives (for formats and algorithms) for 1) Encrypted-Data, which provides privacy and data integrity based on a secret key and cipher algorithm (e.g., triple-DES, XTEA, RC4, AES, etc.), and for 2) Signed-Inside-Enveloped-Data, which provides transport of a secret key (sometimes called a message key or session key) from Sender to Recipient using a public key of the recipient and provides data privacy plus integrity using the Encrypted-Data primitive and provides data authenticity using a public key digital signature and provides the certificate chain of the Sender.

For block ciphers (e.g., triple-DES and XTEA) the primitive includes an Initialization Vector for Cipher-Block-Chaining mode that is an input to the primitive and appears in the data format of the output, and the primitive returns a new Initialization Vector to be used with the next block of Encrypted Data. The secret key to the cipher is one input to this primitive. For stream ciphers (e.g., RC4) there is no Initialization Vector, and the bytes of the key stream are never reused. The secret key to the cipher is one input to this primitive. In one embodiment, the integrity of the data, that is, tamper detection, is provided by a cryptographic message authentication code that is based on a secret key, which could be equal to or derived from the key used to encrypt the data, where the authentication code is computed by well known algorithms such as CBC-MAC or HMAC. The primitive can take as an optional input some data, such as Type, Version and Content-Length fields, that is protected by the cryptographic message authentication code, but not part of the output data; for example, the Type field may be transmitted first before the Encrypted-Data and not be part of the Encrypted-Data.

The method provides in one embodiment that only these two primitives are used to construct two or more protocols. When a protocol application does not have or does not need public keys and/or certificates for both the Sender and the Recipient, use fixed public keys and/or certificates. For example, a protocol application such as downloading signed software does not require that the data be encrypted, so such protocols often invent a third cryptographic primitive for signed-only data, in contrast this method calls for using Signed-Inside-Enveloped-Data to provide the software signing and encryption using a fixed Recipient public key to which all receiving software knows the private key.

The certificates used with this protocol include at least signing and encryption public keys, so it is possible for the Receiver to send an encrypted message back to the Sender of a message, since the Senders Certificate in the received message includes the Senders encryption public key.

The Signed-Inside-Enveloped-Data primitive provides all the security functions required for secure unidirectional messaging such as e-mail or a response to a promotional offer.

The Signed-Inside-Enveloped-Data primitive provides the critical piece for setting up a session key with a new entity for which the Sender knows the Recipient's public key, which could happened via a plaintext request of the certificate of the Recipient, by sending the Recipient a master secret from which the session keys will be derived, or by the Sender having received the Recipient's certificate in a previous communication.

The keys for the Encrypted-Data primitive can be derived from information exchanged either in the clear (i.e., insecure plaintext) and/or in the Signed-Inside-Enveloped-Data primitive. This provides a form of dual key determination and challenge-response authentication.

New secret session keys can be derived from old secret keys that where previously agreed to by the Sender and Recipient, and thus the overhead of public and private key operations can be avoided by just using the Encrypted-Data primitive with appropriate keys. Authentication for a session key can be provided by using the Encrypted-Data primitive with values that are produced by the cryptographic hash of some or all of the data transmitted before sending the authentication message. Including all of the prior data helps thwart various attacks on cryptographic protocols.

To avoid various protocol attacks, separate keys can be used by the Sender and Recipient by deriving the keys in different ways from shared information exchanged earlier in the protocol and/or fixed information known to the Sender and Recipient.

Certificate Issuing can be authenticated by sending a Resource Tag (e.g., Message Tag) to the Issuer after the session keys have been established using fixed public and private keys for a client device that wants to get a Certificate from the Issuer. The fixed keys are replaced with the newly generated keys (generated either on the client or by the Issuer) once the client has received the Certificate, and optionally the generated keys.

A Secure Response Session protocol can be implemented using the Signed-Inside-Enveloped-Data primitive with a public key of the Recipient that is included inside the promotional message to which this is a response session, perhaps inside a Certificate that is verified by the Sender of the Response, and the information contained in the Signed-Inside-Enveloped-Data, including possibly a portion of the information encrypted with the Recipient's public key, being used to derive privacy and integrity keys for a bidirectional session.

A Secure Response Message protocol can be implemented using the Encrypted-Data primitive with a secret key know to the Recipient that is included inside the promotional message that was received securely, and the Encrypted-Data primitive containing the Response Message. A Secure Response Message protocol can be implemented using the Signed-Inside-Enveloped-Data primitive with a public key of the Recipient that is included inside the promotional message to which this is a response, for example, it may be included inside a Certificate that is verified by the Sender of the Response Message, and the primitive containing the Response Message. Some particular embodiments relating to these aspects are highlighted below.

(84) A computer program product for use in conjunction with a computer system having a server and a client, the computer program product comprising a computer readable storage medium and a computer program mechanism embedded therein, the computer program mechanism, comprising: a program module that directs the computer system and/or components thereof including at least one or the client or server, to function in a specified manner to provide message communications, the message communications occurring in a computer system hardware architecture neutral and operating system neutral and network transport protocol neutral manner for implementing a plurality of separate security protocols using a common set of criteria, the program module including instructions for: A. defining two cryptographic primitives; and B. using only the two cryptographic primitives to construct the plurality of separate security protocols. (85) A hardware architecture neutral and operating system neutral and network transport neutral method for implementing a plurality of separate security protocols using a common set of criteria, the method comprising the steps of: A. defining two cryptographic primitives; and B. using only the two cryptographic primitives to construct the plurality of separate security protocols. (86) The method in embodiment (85), wherein the two cryptographic primitives are sued to construct a greater plurality of security protocols. (87) The method in embodiment (85), wherein the cryptographic primitives including formats and algorithms. (88) The method in embodiment (85), wherein the cryptographic primitives consist of only formats and algorithms. (89) The method in embodiment (85), wherein the cryptographic primitives being for: (i) Encrypted-Data, and for (ii) Signed-Inside-Enveloped-Data. (90) The method in embodiment (89), wherein the cryptographic primitives for Encrypted-Data providing privacy and data integrity based on a secret key and a cipher algorithm. (91) The method in embodiment (90), wherein the cipher algorithm being selected from the group of cipher algorithms consisting of triple-DES, XTEA, RC4, AES, block cipher algorithms, stream ciphers, and combinations thereof. (92) The method in embodiment (89), wherein the cryptographic primitives for Signed-Inside-Enveloped-Data providing transport of a secret key from Sender to Recipient using a public key of the recipient. (93) The method in embodiment (92), wherein the secret key being selected from the set comprising a message key and a session key. (94) The method in embodiment (92), wherein the signed-inside-enveloped-data further providing data privacy plus integrity using the Encrypted-Data primitive and providing data authenticity using a public key digital signature and provides the certificate chain of the Sender. (95) The method in embodiment (89), wherein the cryptographic primitives for Encrypted-Data providing privacy and data integrity based on a secret key and a cipher algorithm; and the cryptographic primitives for Signed-Inside-Enveloped-Data providing transport of a secret key from Sender to Recipient using a public key of the recipient. (96) The method in embodiment (85), wherein the security protocols are selected from the group consisting of: (i) secure interactive sessions, (ii) secure unidirectional messaging, (iii) secure software downloading, (iv) secure software upgrading, (v) secure issuing of digital certificates, and/or (vi) combinations thereof. (97) The method in embodiment (85), wherein the common set of criteria are selected from the set consisting of data formats, algorithms, subroutines, procedures, and combinations thereof. (98) The method in embodiment (89), wherein the cryptographic primitives for Encrypted-Data providing privacy and data integrity based on a secret key and a cipher algorithm. (99) The method in embodiment (90), wherein the cipher comprise a block cipher; the primitive includes an Initialization Vector for Cipher-Block-Chaining mode that is an input to the primitive and appears in the data format of the output; and, the primitive returns a new Initialization Vector to be used with the next block of Encrypted Data. (100) The method in embodiment (99), wherein the secret key to the cipher is one input to this primitive. (101) The method in embodiment (99), wherein the block cipher is a cipher selected from the set consisting of a triple-DES based cipher, and a XTEA based cipher. (102) The method in embodiment (90), wherein the cipher comprise a stream cipher without an Initialization Vector, the bytes of the key are not reused, and the secret key to the cipher is one input to this primitive. (103) The method in embodiment (102), wherein the stream cipher comprises a RC4 type cipher. (104) The method in embodiment (85), wherein the integrity of the data and associated data tamper detection, is provided by a cryptographic message authentication code that is based on a secret key. (105) The method in embodiment (104), wherein the secret is equal to or derived from the key used to encrypt the data. (106) The method in embodiment (105), the authentication code is computed by a CBC-MAC based algorithm and/or a HMAC based algorithm. (107) The method in embodiment (85), wherein the primitive takes as an optional input some other data that is protected by the cryptographic message authentication code, but not part of the output data. (108) The method in embodiment (107), wherein such other data is selected from the set of data identified as data in a Type Field, Version Field, Content-Length field, and combinations thereof. (109) The method in embodiment (108), wherein the cryptographic primitives include primitives for Encrypted-Data and for Signed-Inside-Enveloped-Data; and the Type field is transmitted first before the Encrypted-Data and not be part of the Encrypted-Data. (110) The method in embodiment (85), wherein the using only the two primitives to construct a plurality of separate security protocols further comprises using fixed public keys and/or certificates when a protocol application does not have, does not use, or does not require public keys and/or certificates for both the Sender and the Recipient. (111) The method in embodiment (110), wherein for a protocol application that does not require that the data be encrypted, using Signed-Inside-Enveloped-Data to provide the software signing, and using a fixed Recipient public key to which all receiving software knows the private key for the encryption, rather than providing a special third cryptographic primitive for signed-only data as is done in some conventional systems is such circumstances. (112) The method in embodiment (111), wherein the protocol application includes downloading signed software. (113) The method in embodiment (85), wherein the using only the two primitives to construct a plurality of separate security protocols further comprise including both signing and encryption public keys in the certificates used with this protocol so it is possible to send an encrypted message back to the Sender of a message. (114) The method in embodiment (85), wherein the Signed-Inside-Enveloped-Data primitive provides all the security functions required for secure unidirectional messaging. (115) The method in embodiment (114), wherein the unidirectional messaging includes electronic mail (e-mail). (116) The method in embodiment (89), wherein the Signed-Inside-Enveloped-Data primitive provides a component for setting up a session key with a new entity for which the Sender knows the Recipient's public key. (117) The method in embodiment (116), wherein the Sender knows the recipient's public key by any one of: (i) a plain text request of the certificate of the Recipient, (ii) by sending the Recipient a master secret from which the session keys are derived, or (iii) by the Sender having received the Recipient's certificate in a previous communication. (118) The method in embodiment (89), wherein the keys for the Encrypted-Data primitive are derived from exchanged information. (119) The method in embodiment (118), wherein the exchanged information is information exchanged either in the clear, or information exchanged in the Signed-Inside-Enveloped-Data primitive. (120) The method in embodiment (119), wherein the information exchanged in the clear comprises non-secure plain text. (121) The method in embodiment (118), wherein the keys for the Encrypted-Data primitive derived from exchanged information provides a form of dual key determination and challenge-response authentication. (122) The method in embodiment (89), wherein new secret session keys are derived from old secret keys that where previously agreed to by the Sender and Recipient thereby avoiding all or a component of overhead of public and private key operations by just using the Encrypted-Data primitive with the appropriate keys. (123) The method in embodiment (89), wherein authentication for a session key is provided by using the Encrypted-Data primitive with values that are produced by the cryptographic hash of some or all of the data transmitted before sending the authentication message. (124) The method in embodiment (123), wherein all of the prior data transmitted is included to help thwart attacks on cryptographic protocols. (125) The method in embodiment (89), wherein, to avoid various protocol attacks, separate keys are used by the Sender and Recipient by deriving the keys in different ways from shared information exchanged earlier in the protocol and/or fixed information known to the Sender and Recipient. (126) The method in embodiment (96), wherein certificate issuing is authenticated by sending a Resource Tag to the Issuer after the session keys have been established. (127) The method in embodiment (126), wherein the fixed public and private keys are replaced with the newly generated keys once the client has received the Certificate keys. (129) The method in embodiment (127), wherein the newly generated keys being generated either on the client or by the Issuer. (130) The method in embodiment (126), wherein the fixed public and private keys are replaced with the newly generated keys once the client has received the Certificate and the keys. (131) The method in embodiment (126), wherein the Resource Tag comprises a Message Tag or a Coupon Tag. (132) The method in embodiment (96), wherein the certificate issuing is further authenticated using fixed public and private keys for the client device that wants to get a Certificate from the Issuer. (133) The method in embodiment (89), wherein a Secure Response message protocol is implemented using the Signed-Inside-Enveloped-Data primitive with a public key of the Recipient that is included inside the message to which this is a response. (134) The method in embodiment (133), wherein the message is a promotional message. (135) The method in embodiment (133), wherein the message includes a Certificate and the Signed-Inside-Enveloped-Data primitive with a public key of the Recipient is inside the Certificate that is verified by the Sender of the Response. (136) The method in embodiment (133), wherein this Secure Response message protocol is either a unidirectional response message or the set up portion of a bi-directional messaging session. (137) The method in embodiment (133), wherein the Secure Response message protocol is implemented using the Encrypted-Data primitive with a secret key know to the Recipient that is included inside the message that was received securely. (138) The method in embodiment (133), wherein the Secure Response message protocol is implemented using the Encrypted-Data primitive with a secret key know to the Recipient that is included inside the message that was received securely and the Encrypted-Data primitive containing the Response Message. (139) The method in embodiment (137), wherein this Secure Response message protocol is either a unidirectional response message or the set up portion of a bi-directional session. (140) The method in embodiment (138), wherein this Secure Response message protocol is either a unidirectional response message or the set up portion of a bi-directional session.

1.8.5 Embodiment of Method for Secure Interactive Session

In a fifth aspect, the invention provides a hardware architecture neutral and operating system neutral and network transport neutral method for secure interactive sessions using less software code and network bandwidth than conventional systems. In one embodiment, the method includes the following steps and options or variations.

The Client sends to the Server a first message and the Server sends to the Client a second message, where the first message and second message have substantially the same content, format and cryptographic processing, and the first message includes a Client-Nonce, and the second message contains a copy of the Client-Nonce extracted from the first message, and the second message has a value, sometimes called the Server-Nonce, that was chosen by the Server that is not predictable by the Client and is highly unlikely to be previously chosen by the Server.

The first and second message may or may not have any cryptographic processing, and in particular may have no cryptographic processing when the protocol is attempting to reuse cryptographic master keys that were established in a previous session, and these messages will have substantially the same format, and the Server verifies the existence of the Key-ID from the first message in its cache of pairs of Key-ID and Master Key values.

The first and second message have a common header that includes fields for Type, Version, and Content-Length, and the first message contents containing a Key-ID and a Client-Nonce, and the second message contents containing the same Key-ID, same Client-Nonce, and a new Server-Nonce.

The Key-ID may be a cryptographic hash (e.g., MD5, SHA-1, SHA-256) of a previously set up Master Key. The Client-Nonce and Server-Nonce have the same length, which may for example be 16, 20, 32 bytes, or other length long.

The first and second messages can be cryptographically processed using public key operations such as RSA, and these messages will have substantially the same format and cryptographic processing, and the Client and Server verify the certificate chain in the received second and first message respectively. In one embodiment, the first and second messages are created using the Signed-Inside-Enveloped-Data cryptographic primitive defined earlier, and the Client-Nonce (respectively Server-Nonce) is sent to the Server (Client) encrypted by the Server's (Client's) public key in the field of the public key encryption block that is normally associated with a data encryption key or with an OAEP padding seed, and this nonce is used as the encryption key for the Encrypted-Data primitive, and each one contains copy of the message Sender's certificate chain. The benefit of transmitting a nonce in the field normally used for a data encryption key or an OAEP padding seed is that a single cryptographic primitive (e.g., Signed-Inside-Enveloped-Data) can be used for secure session setup and for secure unidirectional messaging and for other secure protocol applications. Also, the Data carried in the first message is a Client-Nonce and the data carried in the second message is the Server-Nonce. An important benefit of this design is that the digitally signed portion of the second message can be pre-computed or even reused with different sessions, and thus the Server does not need to perform a computationally expense private key operation to initiate a secure session.

Next, the Client sends to the server a third message and the Server sends to the Client a fourth message, where these two messages can be sent in either order, and they have substantially the same format, contents, and cryptographic processing as each other and as with subsequent data transfer messages, and the Data contents of the third and fourth message include a cryptographic transformation of at least the Client-Nonce and Server-Nonce, where the transformation is slightly different in the third and fourth messages.

The cryptographic transformation in the third and fourth messages can be different by exchanging the roles of the Client-Nonce and the Server-Nonce. The cryptographic transformation can be a hash (e g, MD5, SHA-1, SHA-256) of the concatenation of the two nonce values. The cryptographic transformation can be an encryption (e.g., triple-DES, XTEA, RC5, AES) of one nonce value using the other nonce value as the key.

The third and fourth messages may be created using the Encrypted-Data cryptographic primitive described earlier, where the Encrypted-Data key for the third message is different than the one for the fourth message, and both keys are derived from a Master Key that is computed with the aid of one or more applications of a cryptographic hash function applied to the Client-Nonce and the Server-Nonce and some or all of the information in the previously send or received messages.

For example, the Master Key (MK) may be defined by the relationship: MK=HMAC (Server-Nonce || Client-Nonce, SHA1 (First-Message) || SHA1 (Second-Message)), where the “||” operator indicates concatenation, and HMAC is a well known cryptographic primitive based on the hash functions, such as the MD5 and/or SHA1 hash functions.

Alternatively, the Encrypted-Data key for the third message equals HMAC (MK, Client-Subject-Name), where Client-Subject-Name is one or more fields extracted from the Client's certificate.

In another alternative, the Encrypted-Data key for the fourth message equals HMAC (MK, Server-Subject-Name), where Server-Subject-Name is one or more fields extracted from the Server's certificate.

The Client and Server then verify the received fourth and third messages respectively to confirm that they have the expected contents and thus were created by an entity that knew both the Client-Nonce and the Server-Nonce.

Optionally, the Client and Server send subsequent data messages that have substantially the same format and cryptographic processing as the third and fourth messages. The Client and Server data messages may be created using the Encrypted-Data cryptographic primitive defined earlier.

Advantageously, the protocol does not have (or require) a separate session termination message because it uses the signals termination by closing the underlying network connection (e.g., closes the TCP socket). Some particular embodiments relating to these aspects are highlighted below.

(141) A computer program product for use in conjunction with a computer system having a server and a client, the computer program product comprising a computer readable storage medium and a computer program mechanism embedded therein, the computer program mechanism, comprising: a program module that directs the computer system and/or components thereof including at least one or the client or server, to function in a specified manner to provide message communications, the message communications occurring in a computer system hardware architecture neutral and operating system neutral and network transport protocol neutral manner for secure interactive communication sessions, the program module including instructions for: A. sending to a server, by a client, a first message containing a Client-Nonce; B. receiving the first message including the Client-Nonce by the server; C. sending to the client, by the server in response to the received first message and Client-Nonce, a second message containing a copy of the Client-Nonce extracted from the first message, and a value in the form of a Server-Nonce that was chosen by the Server that is not predictable by the Client and is unlikely to have been previously chosen by the Server; the first message and second message having substantially the same content, format and cryptographic processing; D. exchanging third and fourth messages between the client and the server (client to server message) and the server and the client (server to client message) respectively, where the order that the third and fourth messages are sent and received is not material; the third and fourth messages including a content portion that is substantially the same though not necessarily identical and having substantially the same format and cryptographic processing as each other and as with subsequent data transfer messages; the data contents portions of the third and fourth message include a cryptographic transformation of at least the Client-Nonce and Server-Nonce, where the cryptographic transformation is slightly different in the third and fourth messages; and E. each of the server and client examining the respective received third and fourth messages to confirm that they have the expected contents and thus were created by an entity that knew both the Client-Nonce and the Server-Nonce.

(142) A hardware architecture neutral and operating system neutral and network transport neutral method for secure interactive communication sessions using less software code and network bandwidth than conventional systems, the method comprising: A. sending to a server, by a client, a first message containing a Client-Nonce; B. receiving the first message including the Client-Nonce by the server; C. sending to the client, by the server in response to the received first message and Client-Nonce, a second message containing a copy of the Client-Nonce extracted from the first message, and a value in the form of a Server-Nonce that was chosen by the Server that is not predictable by the Client and is unlikely to have been previously chosen by the Server; the first message and second message having substantially the same content, format and cryptographic processing; D. exchanging third and fourth messages between the client and the server (client to server message) and the server and the client (server to client message) respectively, where the order that the third and fourth messages are sent and received is not material; the third and fourth messages including a content portion that is substantially the same though not necessarily identical and having substantially the same format and cryptographic processing as each other and as with subsequent data transfer messages; the data contents portions of the third and fourth message include a cryptographic transformation of at least the Client-Nonce and Server-Nonce, where the cryptographic transformation is slightly different in the third and fourth messages; and E. each of the server and client examining the respective received third and fourth messages to confirm that they have the expected contents and thus were created by an entity that knew both the Client-Nonce and the Server-Nonce.

(143) The method in embodiment (142), further comprising after the sever and the client have examined and confirmed that the third and fourth messages were created by entities that knew both the Client-Nonce and the Server-Nonce; F. the Client and Server optionally sending subsequent data messages that have substantially the same format and cryptographic processing as the third and fourth messages. (144) The method in embodiment (142), further comprising after a last message has been communicated between the client and the server or between the server and the client; (G) terminating the session without a separate session termination message by closing the underlying network connection. (145) The method in embodiment (143), further comprising after a last message has been communicated between the client and the server or between the server and the client, (G) terminating the session without a separate session termination message by closing the underlying network connection. (146) The method in embodiment (144), wherein the underlying network connection is a TCP based connection, by closing the TCP socket. (147) The method in embodiment (145), wherein the underlying network connection is a TCP based connection, by closing the TCP socket. (148) The method in embodiment (142), wherein the first and second message have no cryptographic processing when the protocol used for the messages is attempting to reuse one or more cryptographic master keys that were established in a previous messaging session, and the first and second messages have substantially the same format, and the Server verifies the existence of a Key-ID from the first message in a server cache of pairs of Key-ID and Master Key values. (149) The method in embodiment (148), wherein the first and second message have a common header that includes fields for Type, Version, and Content-Length; the first message contents containing a Key-ID and a Client-Nonce; and the second message contents containing the same Key-ID, the same Client-Nonce, and a new Server-Nonce. (150) The method in embodiment (148), wherein the Key-ID is a cryptographic hash of a previously set up Master Key. (151) The method in embodiment (150), wherein the cryptographic hash is a MD5 based hash, a SHA-1 based hash, or a SHA-256 based hash. (152) The method in embodiment (142), wherein the Client-Nonce and Server-Nonce have the same length. (153) The method in embodiment (142), wherein the Client-Nonce and the Server-Nonce have a length of 8 bytes, 10 bytes, 16 bytes, 20 bytes, 24 bytes, 32 bytes, 64 bytes, 96 bytes, or 128 bytes. (154) The method in embodiment (142), wherein the first and second messages are cryptographically processed using public key operations and these messages have substantially the same format and cryptographic processing, and the Client and Server verify the certificate chain in the received second and first message respectively. (155) The method in embodiment (142), wherein the public key operation comprises an RSA operation or an RSA based operation. (156) The method in embodiment (142), wherein: the first and second messages are created using a Signed-Inside-Enveloped-Data cryptographic primitive; the Client-Nonce is sent to the Server encrypted by the Server's public key in the field of the public key encryption block that is normally associated with a data encryption key or with an OAEP padding seed, and this Client-nonce is used as the encryption key for the Encrypted-Data primitive, and each one contains copy of the message Sender's certificate chain; the Server-Nonce is sent to the Client encrypted by the Client's public key in the field of the public key encryption block that is normally associated with a data encryption key or with an OAEP padding seed, and this Server-nonce is used as the encryption key for the Encrypted-Data primitive, and each one contains copy of the message Sender's certificate chain; and transmission of the Sever-Nonce and Client-Nonce in the field normally used for a data encryption key or an OAEP padding seed enabling a single cryptographic primitive to be used for secure session setup and for secure unidirectional messaging and for other secure protocol applications.

(157) The method in embodiment (156), wherein the cryptographic primitives for Signed-Inside-Enveloped-Data provide transport of a secret key from Sender to Recipient using a public key of the recipient. (158) The method in embodiment (156), wherein the single cryptographic primitive comprises a Signed-Inside-Enveloped-Data primitive. (159) The method in embodiment (142), wherein the Data carried in the first message is a Client-Nonce and the data carried in the second message is the Server-Nonce. (160) The method in embodiment (142), wherein a digitally signed portion of the second message can be pre-computed and/or reused with different messaging sessions, and so that the Server need not perform a computationally expense private key operation to initiate a secure session. (161) The method in embodiment (142), wherein a digitally signed portion of the second message is pre-computed for different messaging sessions and no session specific private key operation is performed to initiate a secure session. (162) The method in embodiment (142), wherein a digitally signed portion of the second message is reused from an earlier session for a subsequent messaging session and no session specific private key operation is performed to initiate the subsequent secure session. (163) The method in embodiment (142), wherein the cryptographic transformation in the third and fourth messages are the same (164) The method in embodiment (142), wherein the cryptographic transformation in the third and fourth messages are different by exchanging the roles of the Client-Nonce and the Server-Nonce. (165) The method in embodiment (142), wherein the cryptographic transformation is a hash of the concatenation of the client-nonce and server-nonce values. (166) The method in embodiment (142), wherein the hash is selected from the set consisting of MD5, SHA-1, and SHA-256. (167) The method in embodiment (142), wherein the cryptographic transformation is an encryption of one of either the client-nonce value or the server-nonce value using the other nonce value as the key. (168) The method in embodiment (142), wherein the cryptographic transformation encryption is selected from the set consisting of triple-DES, XTEA, RC5, and AES. (169) The method in embodiment (142), wherein the third and fourth messages are created using an Encrypted-Data cryptographic primitive, and wherein the Encrypted-Data key for the third message is different than the Encrypted-Data key for the fourth message, and both Encrypted-Data keys are derived from a Master Key that is computed with the aid of one or more applications of a cryptographic hash function applied to at least the Client-Nonce and the Server-Nonce. (170) The method in embodiment (169), wherein the Master Key is computed with the aid of one or more applications of a cryptographic hash function applied to the Client-Nonce and the Server-Nonce and to some or all of the information in the previously send or received messages. (171) The method in embodiment (170), wherein the Master Key (MK) is computed as the concatenation of at least a portion of the server-nonce, a portion of the client-nonce, and a portion of the first and second messages (172) The method in embodiment (170), wherein the Master Key (MK) is computed as a concatenation as follows: MK=HMAC (Server-Nonce || Client-Nonce, SHA1 (First-Message) || SHA1 (Second-Message)). (173) The method in embodiment (169), wherein the Encrypted-Data key for the third message equals HMAC (MK, Client-Subject-Name), where a Client-Subject-Name is generated from one or more fields extracted from the Client's certificate. (174) The method in embodiment (169), wherein the Encrypted-Data key for the fourth message equals HMAC (MK, Server-Subject-Name), where Server-Subject-Name is one or more fields extracted from the Server's certificate. (175) The method in embodiment (169), wherein: the Encrypted-Data key for the third message equals HMAC (MK, Client-Subject-Name), where a Client-Subject-Name is generated from one or more fields extracted from the Client's certificate; and the Encrypted-Data key for the fourth message equals HMAC (MK, Server-Subject-Name), where Server-Subject-Name is one or more fields extracted from the Server's certificate.

(176) A method for conducting secure interactive communication sessions between a server and a client, the method comprising: sending a first message containing a first token chosen by the client; receiving the first message including the first token by the server; sending a second message containing a copy of the first token extracted from the first message, and a second token that was chosen by the server, by the server; exchanging third and fourth messages between the client and the server, the third and fourth messages including a content portion having substantially the same format and cryptographic processing as each other, the contents portions of the third and fourth messages including a cryptographic transformation of at least the first token and second token; and each of the server and client examining the respective received third and fourth messages to confirm that they were created by an entity that knew both the first token and the second token.

(177) The method in embodiment (176), wherein the cryptographic transformation is slightly different in the third and fourth messages. (178) The method in embodiment (176), wherein the first token comprises a client-nonce and the second token comprises a server-nonce.

(179) A computer program product for use in conjunction with a computer system having a server and a client, the computer program product comprising a computer readable storage medium and a computer program mechanism embedded therein, the computer program mechanism, comprising: a program module that directs the computer system and/or components thereof including at least one of the client or server, to function in a specified manner to conduct secure interactive communication sessions between a server and a client, the communications occurring in a computer system hardware architecture neutral and operating system neutral and network transport protocol neutral manner for secure interactive communication sessions, the program module including instructions for: sending a first message containing a first token chosen by the client; receiving the first message including the first token by the server; sending a second message containing a copy of the first token extracted from the first message, and a second token that was chosen by the server, by the server; exchanging third and fourth messages between the client and the server, the third and fourth messages including a content portion having substantially the same format and cryptographic processing as each other, the contents portions of the third and fourth messages including a cryptographic transformation of at least the first token and second token; and each of the server and client examining the respective received third and fourth messages to confirm that they were created by an entity that knew both the first token and the second token. (180) The computer program in embodiment (179), wherein the cryptographic transformation is slightly different in the third and fourth messages.

1.8.6 Embodiment of Method for Secure Unidirectional Messaging

In a sixth aspect, the invention provides a hardware architecture neutral and operating system neutral and network transport neutral method for secure unidirectional messaging using less software code and network bandwidth than conventional systems. In one embodiment, the method includes the following steps and options or variations.

The Sender extracts the appropriate public key (e.g. RSA public key) and matching destination address (e.g., e-mail address or URL) of the Recipient from a storage means that is trusted and has been verified previously using a digital signature (e.g., verified with a trusted public key) or cryptographic checksum (e.g., verified with a trusted key derived from a Master Key or Session Key or Message Key).

The storage means in this or other aspects and embodiments, may for example, be a Compact Certificate as explained earlier, or chain of Compact Certificates leading to a trusted root public key. The storage means may also or alternatively be, for example, a previously received story enabled message that was securely received and verified by mechanisms that are trusted for that kind of message. In yet other embodiments, the storage means can be a normal e-mail message or web page, which the Sender trusts that has been copied into the Sender's computer memory via mechanisms that the Sender trusts.

Next, the Sender extracts their own private signing key and certificate chain from a trusted storage means, and then passes that extracted information, and the data of the message along with the Recipient's public enveloping key, and a fresh random data encryption key and fresh random OAEP padding seed to the Signed-Inside-Enveloped-Data cryptographic primitive to construct a secure unidirectional message.

The OAEP padding seed and the data encryption key can be the same value to avoid the overhead of generating multiple random values, or may be different values. The Sender's private key and certificate chain may be fixed values shared among many Senders or may differ and be unfixed. These values can be either widely known, or the Sender's software may employ mechanisms to make it difficult to discover these values through a process of reverse engineering.

The Recipient receives the message and extracts its own private key from a secure storage means to decrypt the public key encryption, extract the data encryption key, decrypts the data which is digitally signed, and verifies the signature of the data and the certificate chain of the Sender, and all of this is done using the same cryptographic primitive that is used with at least a secure session protocol. Some particular embodiments relating to these aspects are highlighted below.

(181) A computer program product for use in conjunction with a computer system having a server and a client, the computer program product comprising a computer readable storage medium and a computer program mechanism embedded therein, the computer program mechanism, comprising: a program module that directs the computer system and/or components thereof including at least one or the client or server, to function in a specified manner to provide message communications, the message communications occurring in a computer system hardware architecture neutral and operating system neutral and network transport protocol neutral manner for secure unidirectional messaging, the program module including instructions for: A. extracting, by the sender, an appropriate public key and matching destination address of a Recipient from a storage means that is trusted and has been verified; B. extracting, by the sender, the sender's own private signing key and certificate chain from a trusted storage means; C. passing, by the sender, that extracted public key and matching destination address and private signing key and certificate chain information, and the data of the message along with the Recipient's public enveloping key, and a fresh random data encryption key and fresh random OAEP padding seed to the Signed-Inside-Enveloped-Data cryptographic primitive to construct a secure unidirectional message; D. sending, by the sender, the constructed secure unidirectional message; E. receiving, by the Recipient, the message; F. extracting, by the Recipient, its own private key from a secure storage means and decrypting the public key encryption; G. extracting, by the Recipient, the data encryption key, and decrypting the data which is digitally signed; and H. verifying the signature of the data and the certificate chain of the Sender; I. wherein this is done using the same cryptographic primitive that is the same as the cryptographic primitive used with at least a secure session protocol.

(182) A hardware architecture neutral and operating system neutral and network transport neutral method for secure unidirectional messaging using less software code and network bandwidth than conventional systems, the method comprising: A. extracting, by the sender, an appropriate public key and matching destination address of a Recipient from a storage means that is trusted and has been verified; B. extracting, by the sender, the sender's own private signing key and certificate chain from a trusted storage means; C. passing, by the sender, that extracted public key and matching destination address and private signing key and certificate chain information, and the data of the message along with the Recipient's public enveloping key, and a fresh random data encryption key and fresh random OAEP padding seed to the Signed-Inside-Enveloped-Data cryptographic primitive to construct a secure unidirectional message; D. sending, by the sender, the constructed secure unidirectional message; E. receiving, by the Recipient, the message; F. extracting, by the Recipient, its own private key from a secure storage means and decrypting the public key encryption; G. extracting, by the Recipient, the data encryption key, and decrypting the data which is digitally signed; and H. verifying the signature of the data and the certificate chain of the Sender; I. wherein this is done using the same cryptographic primitive that is the same as the cryptographic primitive used with at least a secure session protocol.

(183) The method in embodiment (182), wherein the appropriate public key comprises an RSA based public key. (184) The method in embodiment (182), wherein the matching destination address is selected from the set consisting of an e-mail address and a URL. (185) The method in embodiment (182), wherein the storage means is trusted and has been previously verified using a digital signature or cryptographic checksum. (186) The method in embodiment (182), wherein the digital signature provides verification with a trusted public key. (187) The method in embodiment (182), wherein the cryptographic checksum provides verification with a trusted key derived from a Master Key, a Session Key, or a Message Key. (188) The method in embodiment (182), wherein the storage means is selected from the group consisting of a Compact Certificate, a chain of Compact Certificates leading to a trusted root public key, or combinations thereof. (189) The method in embodiment (182), wherein the storage means is a previously received Storymail story enabled message that was securely received and verified by mechanisms that are trusted for that kind of message. (190) The method in embodiment (182), wherein the storage means is any conventional e-mail message or web page which the Sender trusts that has been copied into the Sender's messaging platform memory via mechanisms that the Sender trusts. (191) The method in embodiment (190), wherein the messaging platform is a messaging platform selected from the set consisting of: a computer, a server, a PDA, a telephone, an appliance, an information appliance, a pager, or any other device supporting such messaging. (192) The method in embodiment (182), wherein the OAEP padding seed and the data encryption key are different values. (193) The method in embodiment (182), wherein the OAEP padding seed and the data encryption key are the same value to avoid the overhead of generating multiple random values. (194) The method in embodiment (182), wherein the Sender's private key and certificate chain comprise fixed values shared among a plurality of Senders. (195) The method in embodiment (182), wherein the Senders private key and certificate chain fixed values are widely known. (196) The method in embodiment (182), wherein the Sender's private key and certificate chain fixed values are not widely known and the Sender's software employs mechanisms to make it difficult to discover these values through a process of reverse engineering.

(197) A method for secure unidirectional messaging from a sender to a recipient, the method comprising: obtaining, by the sender, a public key and destination address of a message recipient and the sender's own private signing key and certificate chain from one or more trusted source; passing, by the sender, the extracted public key and matching destination address and private signing key and certificate chain information, and the data of an intended message along with the recipient's public enveloping key and a random data encryption key and random padding seed to a cryptographic primitive; and constructing, by the sender, a secure unidirectional message there from.

(198) The method of embodiment (197), further comprising: sending, by the sender, the constructed secure unidirectional message to the recipient. (199) The method of embodiment (198), further comprising: receiving the secure unidirectional message by the recipient; extracting, by the Recipient, the recipient's own private key from a secure source and decrypting the public key encryption, and the data encryption key and decrypting the data which is digitally signed; and verifying the signature of the data and the certificate chain of the sender. (200) The method of embodiment (198), wherein the message is an e-mail message. (201) The method of embodiment (198), wherein the message is a Storymail story message. (202) The method of embodiment (198), wherein the trusted source or storage means comprises a Compact Certificate as explained earlier, or chain of Compact Certificates leading to a trusted root public key.

1.8.7 Embodiment of Method for Secure Certificate Issuing

In a seventh aspect, the invention provides a hardware architecture neutral and operating system neutral and network transport neutral method for secure certificate issuing using less software code and network bandwidth than conventional systems. In one embodiment this method includes the following steps with options and variations.

The Client (or other entity), which is requesting a certificate, extracts a network address (e.g., URL) for the Issuer from a trusted storage means. For example, the trusted storage means can be data compiled into the Client software, or the trusted storage means can be data received from communicating with a Server via a secure session.

The Client extracts a Resource Tag (e.g., message tag) related to its own Subject Name (e.g., e-mail address) from a message that was received from a Server.

The Client then extracts a fixed public and private key and certificate chain from a trusted storage means and uses that information along with the previously extract network address to create a secure session with the Issuer. The secure session authenticates the issuer using the same protocol as described elsewhere in this specification. The public and private key operations, may for example, be performed by any asymmetric cryptosystems such as RSA, Elliptic Curve, or NTRU.

The Client sends, as its first Data message (after the session setup messages, if any) structure that has a common header with fields for Type, Version and Content-Length, and the contents include the Resource Tag, the Client's Subject Name, and optionally one or more public keys that the Client has generated

The Issuer verifies that a valid Server issued the Resource Tag and that the tag is valid for the given received Subject Name. The Issuer creates a Compact Certificate with one or more public keys and with the Client's Subject Name and digitally signs the certificate with the Issuers private key, where the public key(s) could be generated by the Issuer or sent to the Issuer by the Client who generated them. The Issuer sends a message back to the Client over the secure channel where the message includes the Compact Certificate and if the Issuer generated the public key(s), the message includes the matching private key(s). Finally, the Client places the Compact Certificate and keys into a trusted storage means for later use.

Some particular embodiments relating to these aspects are highlighted below. (203) A computer program product for use in conjunction with a computer system having a server and a client, the computer program product comprising a computer readable storage medium and a computer program mechanism embedded therein, the computer program mechanism, comprising: a program module that directs the computer system and/or components thereof including at least one or the client or server, to function in a specified manner to provide message communications, the message communications occurring in a computer system hardware architecture neutral and operating system neutral and network transport protocol neutral manner for secure certificate issuing by an Issuer to a Client requesting the certificate, the program module including instructions for: A. extracting, by a certificate requesting client, a network address for the Issuer from a trusted source or storage means; B. extracting, by the client, a Resource Tag related to its own Subject Name from a message that was received from a Server, C. extracting, by the client, a public and private key and certificate chain from a trusted source; D. using the extracted information to create a secure session with the Issuer that authenticates the issuer using the same protocol; E. sending, by the client, as the client's first Data message after any session setup messages, a data structure that has a common header with fields for Type, Version and Content-Length, and contents that include the Resource Tag, the Client's Subject Name, and optionally one or more public keys that the Client has generated; F. verifying, by the certificate issuer, that a valid Server issued the Resource Tag and that the Resource Tag is valid for the given received Subject Name; G. creating, by the issuer, a Compact Certificate with one or more public keys and with the Client's Subject Name; H. digitally signing, by the issuer, the certificate with the Issuer's private key; and I. sending, by the certificate issuer, a message back to the Client over the secure channel, where the message includes the Compact Certificate and if the Issuer generated the public key(s), the message includes the matching private key(s).

(204) A hardware architecture neutral and operating system neutral and network transport neutral method for secure certificate issuing by an Issuer to a Client requesting the certificate using less software code and network bandwidth than conventional systems, the method comprising the steps of: A. extracting, by a certificate requesting client, a network address for the Issuer from a trusted source or storage means; B. extracting, by the client, a Resource Tag related to its own Subject Name from a message that was received from a Server; C. extracting, by the client, a public and private key and certificate chain from a trusted source; D. using the extracted information to create a secure session with the Issuer that authenticates the issuer using the same protocol; E. sending, by the client, as the client's first Data message after any session setup messages, a data structure that has a common header with fields for Type, Version and Content-Length, and contents that include the Resource Tag, the Client's Subject Name, and optionally one or more public keys that the Client has generated; F. verifying, by the certificate issuer, that a valid Server issued the Resource Tag and that the Resource Tag is valid for the given received Subject Name; G. creating, by the issuer, a Compact Certificate with one or more public keys and with the Client's Subject Name; H. digitally signing, by the issuer, the certificate with the Issuer's private key; and I. sending, by the certificate issuer, a message back to the Client over the secure channel, where the message includes the Compact Certificate and if the Issuer generated the public key(s), the message includes the matching private key(s).

(205) The method in embodiment (204), further comprising: the client placing the Compact Certificate and keys into its trusted source or storage means. (206) The method in embodiment (204), wherein the one or more public key(s) are generated by the Issuer or send to the Issuer by the Client who generated them. (207) The method in embodiment (204), wherein where the one or more public key(s) are sent to the Issuer by the Client who generated them. (208) The method in embodiment (204), wherein the trusted source or storage means is data compiled into the Client software. (209) The method in embodiment (204), wherein the trusted source or storage means is data received from communicating with a Server via a secure session. (210) The method in embodiment (204), wherein the trusted source comprises a trusted storage. (211) The method in embodiment (204), wherein the network address comprises a URL. (212) The method in embodiment (204), wherein the Resource Tag comprises a message tag. (213) The method in embodiment (204), wherein the Subject Name comprises an e-mail address. (214) The method in embodiment (204), wherein the public and private key operations are performed by any asymmetric cryptosystems. (215) The method in embodiment (214), wherein the asymmetric cryptosystem is selected from the group consisting of RSA, Elliptic Curve, and NTRU. (216) The method in embodiment (204), wherein the public and private key extracted by the client are fixed public and private keys. (217) The method in embodiment (204), wherein the public and private key and certificate chain extracted by the client are fixed public and private keys and certificate chain.

(218) A method for secure certificate issuing by an issuer to an entity requesting the certificate, the method comprising: extracting, by the entity, a network address for the certificate issuer from a trusted source; extracting, by the entity, information including a resource tag related to its own subject name from a message that was received from a server, and a public key and a private key and certificate chain from a trusted source; using, by the entity, the extracted information to create a secure session with the issuer that authenticates the issuer; and sending, by the entity, as a component of the entity's first data message after any session setup messages, a data structure that includes the resource tag and subject name.

(219) The method of embodiment (218), further comprising: verifying, by the issuer, that a valid server issued the resource tag and that the resource tag is valid for the given received subject name; creating, by the issuer, a certificate with one or more public keys and with the entity's subject name; digitally signing, by the issuer, the certificate with the issuer's private key; and sending, by the issuer, a message back to the entity over the secure channel, where the message includes the certificate. (220) The method of embodiment (219), further comprising: receiving the certificate by the requesting entity. (221) The method of embodiment (219), wherein the requesting entity comprises a requesting client. (222) The method of embodiment (218), wherein the requesting entity comprises a requesting client. (223) The method of embodiment (219), wherein if the issuer generated the public key(s), the message sent back to the entity includes the matching private key(s). (224) The method of embodiment (219), wherein the requesting entity comprises a requesting client. (225) The method of embodiment (219), wherein the data structure includes a common header with fields for type, version, and content-length, and contents that include the resource tag, the entity's subject name. (226) The method of embodiment (225), wherein the data structure further optionally includes one or more public keys that the entity has generated. (227) The method of embodiment (226), wherein the entity comprises a client. (228) The method of embodiment (204), wherein the trusted source or storage means comprises a Compact Certificate as explained earlier, or chain of Compact Certificates leading to a trusted root public key.

1.8.8 Embodiment of Method for Secure Response Session

In an eighth aspect, the invention provides a hardware architecture neutral and operating system neutral and network transport neutral method for secure response session using less software code and network bandwidth than conventional systems. In one embodiment, this method includes the following steps with options and variations.

The Client, who is establishing a secure response session to the Merchant in order to respond to a message from the Merchant, extracts the Merchant's public key (e.g. RSA public key) and matching destination address (e.g., URL) of the Merchant from a trusted storage means that has been verified previously using a digital signature (verified with a trusted public key) or cryptographic checksum (verified with a trusted key derived from a Master Key or Session Key or Message Key).

The trusted storage means can, for example, be data from a normal e-mail message or a non-secured web page, or a secured web page (e.g., secured by SSL, PCT, or TLS). Also or alternatively, the trusted storage means can be data received from communicating with a Server via a secure session.

Next, the Client extracts its public and private key and certificate chain from a trusted storage means and uses that information along with the previously extract destination address to create a secure session with the Merchant using the previously explained secure session protocol, and the Client's first Data message, which is sent after the session setup messages, contains a Resource Tag that was included in the message received from the Merchant to which this session is a response.

The Client's keys and certificate chain may be fixed values shared by more than one Client system, in which case, the Merchant will authenticate the Client based on this Resource Tag. The Client's keys and certificate chain can be unique to this Client, and the Merchant can authenticate the Client using this unique certificate and/or using a Resource Tag was included in the message received from the Merchant to which this session is a response.

After the Merchant has performed the session setup portion of the secure session protocol, it verifies the Client's certificate chain and verifies the Resource Tag that is received in the first Data message from the Client. The Client and Merchant optionally exchange additional data related to the application that is using this secure response protocol Advantageously, either the Client or the Merchant can terminate the session by closing the underlying network connection (e.g., TCP socket) so that a separate session termination is not required. Some particular embodiments relating to these aspects are highlighted below.

(229) A computer program product for use in conjunction with a computer system having a server and a client, the computer program product comprising a computer readable storage medium and a computer program mechanism embedded therein, the computer program mechanism, comprising: a program module that directs the computer system and/or components thereof including at least one or the client or server, to function in a specified manner to provide message communications, the message communications occurring in a computer system hardware architecture neutral and operating system neutral and network transport protocol neutral manner for conducting a secure response session, the program module including instructions for: A. extracting, by a Client who is establishing a secure response session to a Entity in order to respond to a message from the Entity, the Entity's public key and matching destination address of the Entity from a trusted source or storage means; B. extracting, by the Client, the Client's public and private key and certificate chain from a trusted source or storage means; C. using the extracted client public and private key and certificate chain information along with the previously extracted Entity destination address to create a secure session with the Entity using a secure session protocol; D. sending, by the Client, a first Data message after any session setup messages, that contains a Resource Tag that was included in the message received from the Entity to which this client initiated session is a response; E. setting up, by the Entity, the session setup portion of the secure session protocol; and F. verifying, by the Entity, the Client's certificate chain and the Resource Tag that is received in the first Data message from the Client.

(230) A hardware architecture neutral and operating system neutral and network transport neutral method for secure response session using less software code and network bandwidth than conventional systems, the method comprising the steps of: A. extracting, by a Client who is establishing a secure response session to a Entity in order to respond to a message from the Entity, the Entity's public key and matching destination address of the Entity from a trusted source or storage means; B. extracting, by the Client, the Client's public and private key and certificate chain from a trusted source or storage means; C. using the extracted client public and private key and certificate chain information along with the previously extracted Entity destination address to create a secure session with the Entity using a secure session protocol; D. sending, by the Client, a first Data message after any session setup messages, that contains a Resource Tag that was included in the message received from the Entity to which this client initiated session is a response; E. setting up, by the Entity, the session setup portion of the secure session protocol, and F. verifying, by the Entity, the Client's certificate chain and the Resource Tag that is received in the first Data message from the Client.

(231) The method in embodiment (230), further comprising: G. exchanging, between the Client and the Entity, additional data related to the application that is using the secure response protocol. (232) The method in embodiment (230), further comprising: H. terminating the session, by either the Client or the Entity, by closing the underlying network connection (233) The method in embodiment (232), wherein the underlying network connection is a TCP-based network connection. (234) The method in embodiment (232), wherein the public key and matching destination address has been verified previously using a digital signature (verified with a trusted public key) or cryptographic checksum (verified with a trusted key derived from a Master Key or Session Key or Message Key). (235) The method in embodiment (230), wherein the Entity's public key comprises a RSA or a RSA based public key. (236) The method in embodiment (230), wherein the matching destination address comprises a URL or URL based address. (237) The method in embodiment (230), wherein the trusted source or storage means comprises data selected from the set consisting of a normal conventional e-mail message, a non-secured web page, a secured web page, and combinations thereof. (238) The method in embodiment (230), wherein the secured web page is secured by any of SSL, PCT, or TLS. (239) The method in embodiment (230), wherein the trusted storage means comprises data received from communicating with a Server via a secure session. (240) The method in embodiment (230), wherein the Client's keys and certificate chain comprise fixed values. (241) The method in embodiment (230), wherein the Client's keys and certificate chain comprise fixed values shared by more than one Client system and wherein the Entity authenticates the Client based on this Resource Tag. (242) The method in embodiment (230), wherein the Client's keys and certificate chain are unique to this Client, and the Entity authenticates the Client using this unique certificate and/or using a Resource Tag was included in the message received from the Entity to which this session is a response. (243) The method in embodiment (230), wherein the Entity comprises a Merchant.

(244) A method for conducting a secure response session from a Client that is establishing a secure response session to an Entity in order to respond to a message from the Entity, the method comprising the steps of: extracting, by the Client, information including the Entity's public key and destination address and Client's public and private key and certificate chain from one or more trusted source; using, by the Client, the extracted information to create a secure session with the Entity using a secure session protocol; and sending, by the Client, a first data message that contains a resource tag that was included in the message received from the Entity to which this Client initiated session is a response.

(245) The method in embodiment (244), wherein the first data message is sent after one or more session setup message. (246) The method in embodiment (244), further comprising: setting up, by the Entity, the session setup portion of the secure session protocol; and verifying, by the Entity, the Client's certificate chain and the Resource Tag that is received in the first Data message from the Client. (247) The method in embodiment (244), wherein the Entity comprises a Merchant. (248) The method in embodiment (246), wherein the Entity comprises a Merchant. (249) The method of embodiment (230), wherein the trusted source or storage means comprises a Compact Certificate as explained earlier, or chain of Compact Certificates leading to a trusted root public key.

(250) A computer program product for use in conjunction with a computer system, the computer program product comprising a computer readable storage medium and a computer program mechanism embedded therein, the computer program mechanism, comprising: a program module that directs the computer system and/or components thereof, to function in a specified manner to conduct a secure response session from a Client that is establishing a secure response session to an Entity in order to respond to a message from the Entity and occurring in a computer system hardware architecture neutral and operating system neutral and network transport protocol neutral manner for conducting a secure response session, the program module including instructions for: extracting, by the Client, information including the Entity's public key and destination address and Client's public and private key and certificate chain from one or more trusted source; using, by the Client, the extracted information to create a secure session with the Entity using a secure session protocol; and sending, by the Client, a first data message that contains a resource tag that was included in the message received from the Entity to which this Client initiated session is a response.

1.8.9 Embodiment of Method for Secure Unidirectional Response Message

In a ninth aspect, the invention provides a hardware architecture neutral and operating system neutral and network transport neutral method for secure unidirectional response message using less software code and network bandwidth than conventional systems. In one embodiment, this method includes the following steps with options and variations.

The Client, who is sending a secure response message to the Merchant (or other entity) in order to respond to a message from the Merchant, such as a promotional offer, extracts the Merchant's public key (e.g. RSA public key) and matching destination address (e.g., e-mail address) of the Merchant from a trusted storage means that has been verified previously using a digital signature (verified with a trusted public key) or cryptographic checksum (verified with a trusted key derived from a Master Key or Session Key or Message Key).

For example, the trusted storage means can be data from a normal e-mail message or a non-secured web page, or a secured web page (e.g., secured by SSL, PCT, or TLS). Also, or alternatively, the trusted storage means can be data received from communicating with a Server via a secure session.

The Client then extracts its public and private key and certificate chain from a trusted storage means and uses that information along with the previously extracted destination address to create a secure unidirectional message to the Merchant using the previously explained secure unidirectional message protocol (e.g., using the Signed-Inside-Enveloped-Data cryptographic primitive), and the Data portion of the Client's message contains a Resource Tag that was included in the message received from the Merchant to which this message is a response.

In one embodiment, the Client's keys and certificate chain can be fixed values shared by more than one Client system, in which case, the Merchant will authenticate the Client based on this Resource Tag. The Client's keys and certificate chain can be unique to this client, and the Merchant can authenticate the Client using this unique certificate and/or using a Resource Tag was included in the message received from the Merchant to which this session is a response. The Merchant verifies the Client's certificate chain and verifies the Resource Tag that is included in the Data portion of the received message. Finally, the Merchant performs an appropriate application-level action for the received response message.

Some particular embodiments relating to these aspects are highlighted below. (251) A computer program product for use in conjunction with a computer system having a server and a client, the computer program product comprising a computer readable storage medium and a computer program mechanism embedded therein, the computer program mechanism, comprising: a program module that directs the computer system and/or components thereof including at least one or the client or server, to function in a specified manner to provide message communications, the message communications occurring in a computer system hardware architecture neutral and operating system neutral and network transport protocol neutral manner for secure unidirectional response message, the program module including instructions for: A. extracting, by a Client who is sending a secure response message to the Entity in order to respond to a message from the Entity, the Entity's public key and matching destination address of the Entity from a trusted storage means; B. extracting, by the Client, the Client's public and private key and certificate chain from a trusted source or storage means; C. using, the extracted Client's public and private key and certificate chain information along with the previously extracted Entity's destination address to create a secure unidirectional message to the Entity using the a secure unidirectional message protocol, a data portion of the Client's message containing a Resource Tag that was included in the message received from the Entity to which this message is a response; and D. verifying, by the Entity, the Client's certificate chain.

(252) A hardware architecture neutral and operating system neutral and network transport neutral method for secure unidirectional response message using less software code and network bandwidth than conventional systems, the method comprising the steps of: A. extracting, by a Client who is sending a secure response message to the Entity in order to respond to a message from the Entity, the Entity's public key and matching destination address of the Entity from a trusted storage means; B. extracting, by the Client, the Client's public and private key and certificate chain from a trusted source or storage means; C. using, the extracted Client's public and private key and certificate chain information along with the previously extracted Entity's destination address to create a secure unidirectional message to the Entity using the a secure unidirectional message protocol, a data portion of the Client's message containing a Resource Tag that was included in the message received from the Entity to which this message is a response; and D. verifying, by the Entity, the Client's certificate chain.

(253) The method in embodiment (252), further comprising: E. performing, by the Entity, an appropriate application-level action for the received response message. (254) The method in embodiment (252), wherein the Entity's public key comprises an RSA or RSA-based key. (255) The method in embodiment (252), wherein the matching destination address comprises an e-mail address. (256) The method in embodiment (252), wherein the public key and matching destination address have been verified previously using a digital signature (verified with a trusted public key) or cryptographic checksum (verified with a trusted key derived from a Master Key or Session Key or Message Key). (257) The method in embodiment (252), wherein the trusted source or storage means comprises data from a normal e-mail message, a non-secured web page, or a secured web page, or combination thereof. (258) The method in embodiment (252), wherein the web page is secured by one of the set consisting or SSL, PCT, or TLS. (259) The method in embodiment (252), wherein the trusted source or storage means comprises data received from communicating with a Server via a secure session. (260) The method in embodiment (252), wherein the Client's keys and certificate chain are fixed values shared by more than one Client system, and the Entity authenticates the Client based on this Resource Tag. (261) The method in embodiment (252), wherein the Client's keys and certificate chain are unique to this client, and the Entity authenticates the Client using this unique certificate and/or using a Resource Tag which was included in the message received from the Entity to which this session is a response. (262) The method in embodiment (252), wherein the Entity authenticates the Client using the certificate and/or using a Resource Tag which was included in the message received from the Entity to which this session is a response (263) The method in embodiment (252), wherein the verifying by the Entity, further includes optionally verifying the Resource Tag that is included in the Data portion of the received message. (264) The method in embodiment (252), wherein the secure unidirectional message protocol comprises using the Signed-Inside-Enveloped-Data cryptographic primitive. (265) The method in embodiment 2 (252), wherein the Entity comprises a Merchant.

(266) A method for communicating a secure unidirectional response message from a Client that is sending a secure response message to the Entity in order to respond to a message from the Entity, the method comprising the steps of: extracting, by the Client, information including the Entity's public key and matching destination address and the Client's public and private key and certificate chain from one or more trusted source; and using, by the Client, the extracted information to create a secure unidirectional message to the Entity using the a secure unidirectional message protocol, a data portion of the secure unidirectional message containing a resource tag that was included in the message received from the Entity to which the secure unidirectional message is a response.

(267) The method in embodiment (266), further comprising sending the secure unidirectional message to the entity. (268) The method in embodiment (267), further comprising verifying, by the Entity, the Client's certificate chain. (269) The method of embodiment (266), wherein the trusted source or storage means comprises a Compact Certificate as explained earlier, or chain of Compact Certificates leading to a trusted root public key. (270) The method of embodiment (252), wherein the trusted source or storage means comprises a Compact Certificate as explained earlier, or chain of Compact Certificates leading to a trusted root public key.

1.8.10 Other Embodiments

We first provide a top-level description of some of the key technology components of the invention called a story or other content and systems and methods for authoring, communicating, securing, and rendering such content, along with a description of some of the advantages provided by stories. This description is then followed by several sections that describe the manner in which certain functional and procedural capabilities and/or advantages are achieved in the inventive system. Section headers when provided are provided merely as a convenience to the reader as a guide to portions of the description addressing certain aspects of the invention; however, it will be appreciated that various aspects of the invention are described throughout the description and certain aspects are best described in several portions of the description rather than in a single portion to that relationships may be better understood. Therefore, the description should be considered as a whole with respect to the characteristics or attributes of any structure, system, device, method, procedure, computer program, or other aspect of the invention.

For purposes of an initial working definition and in somewhat simplified terms, a story as the term is used in this description generally refers to a single, author once, play everywhere file or data/command structure that is interactive either on-line or off-line and that can be used to distribute rich multimedia messages or other rich-media content to all e-mail enabled clients. (More complete as well as alternative definitions of “stories” are described elsewhere in the detailed description.) Next, aspects of an exemplary system to generate, transfer and play stories, according to one embodiment of the present invention, are described. Once this top level description has been provided, the detailed operation of the respective business or operating models and methods of the invention will be described and more readily understood.

The term e-mail is used here because it represents a form of electronic communication that is known in the art, but it will be appreciated that the inventive system, method, software, business and operating model pertain to much more than what is normally envisioned for conventional e-mail systems and methodologies. The inventive e-mail enhancement, extension, or replacement contemplates some generalized electronic content that is directed to one, a plurality, or a multitude of recipients.

Recall that in greatly simplified terms, a story is a single, author once, play everywhere file or data/command structure that is interactive either on-line or off-line that can be used to distribute rich multimedia messages or other rich-media content to all e-mail enabled clients. Stories can be used to distribute and coordinate e-commerce transactions, order fulfillment, meeting scheduling, advertisements, catalog item descriptions, customized catalogs and brochures, holiday greeting cards, electronic storybooks, driving directions, vacation slide and picture shows, surveys, real-estate walk throughs, medical care pamphlets, pharmaceutical information pamphlets, recipes, business presentations, party invitations, instructional manuals, entertainment, and numerous other applications, particularly where the message consists of more than merely a text or symbolic message. Several of such exemplary applications include, for example, surveys, forms, contracts.

Story content creation is advantageously automated and dynamically adaptive, because a story is optimized over a plurality of variables to selectively communicate elements of an e-mail message to e-mail client devices and users. Such variables include, for example, client device hardware capabilities, network connection characteristics and user preferences. This is accomplished from a standpoint, for example, of CPU speed, display type, screen size, the existence of and or attributes of audio and/or video capabilities, data scalability, language, use of or not use of audio or visual content, nominal speed or bandwidth of all of the communication links and protocols, and the like.

In preferred though not all embodiments, a final story is not generated until substantially all such relevant e-mail client information is determined during the time of connection of the client device. In a sense, the system and procedure of the present invention is contrary to other prevailing trends (which attempt to pre-form content so that is available as early as possible) in that StoryMail actually delays composition of the final message until it is ready to be received. For example, if it is determined that an e-mail client cannot view motion video but can display text and play audio, the story will be generated such that it does not include motion video, but rather textual and/or audio elements that communicate the intent of the e-mail publisher within the capabilities of the e-mail client.

In yet another example, even though a client device may be capable of receiving and rendering a very rich message, if the then prevailing communication channel is only supporting low-speed or low-bandwidth communication, a story is generated such that the richness of the message is reduced so that the message is optimized for the attributes of the client device and the user preferences at that moment in time.

Sometimes, the message may be optimized or nearly optimized to be received within any time constraints that may be imposed; however, unlike systems and methods that must satisfy real-time or near real time constraints, the story need not provide real-time delivery, as it is intended to be a messaging and communication system, method, and operating model, rather than a real-time rich-media broadcast or streaming system. In this regard, a story is a fully aware e-mail message that is optimized to substantially deliver the intent of an e-mail publisher across the broad range of all e-mail client architectures.

A story may further be optimized to comply with a predefined set of user defined preferences, making each story beneficially configurable for physically challenged individuals. This is because for every logical element (either text, sound, images, video, or the like logical elements) there is an underlying textual description of that logical element. In addition, there are contextual logical elements included as may be needed to insure that the intent of the message may be easily understood in text or audio only representations An example of such contextual logical element would be a text element that provides an overview of what is on the screen to be rendered as text or audio in cases where some or all of the screen's visual elements can not be seen by the recipient on the receiving device.

In a preferred embodiment, all logical elements have corresponding semantic information so that it can be known or determined which elements to use under varying circumstances. For example, the aforementioned contextual logical text element would have associated semantic flags packaged with it inside a story indicating that the element contains text providing an overview of the elements displayed on a screen for use when it is known that the recipient cannot view the screen. Such a case might be when a story player application is used to render and control a rich media message for someone whose only means of communication to the rich media message playing application is over a voice only telephone connection In other embodiments, an audio representation, either recorded or generated by a text to speech engine may provide audio information backup—contextual information, or semantic information rather than text. In this manner an individual can read text and the text can automatically be articulated for a blind individual.

In one embodiment, the inventive system, method, and operating model are designed to interface with a peripheral device that generates a Braille or other tactilely sensible indica corresponding to the story. This peripheral device may either be linked to a conventional client device, such as a computer, or integrated within the device. Using semantics, there is always an alternative sensory presentation mode.

Stories are self contained and lightweight, meaning that stories have relatively small memory and processor requirements and can be played on client devices the types and sophistication of which are virtually unlimited. A story is self contained because in at least one embodiment, a story is actually a single file that is made up of a number of component logical files. Each component file encapsulates, for example, one or more of computer program instructions, control information, user input forms, validation procedures, and/or multimedia content. Each component logical file is respectively compressed and all of the component logical files are combined, packaged, compressed again to generate the single story file.

A story is lightweight not only because when it is executed, or played, a story's contents are selectively and sequentially decompressed. But also because a story only includes those elements that are optimized and compatible with the e-mail client's hardware capabilities and network connection characteristics, making stories lightweight (thin) enough to run on inexpensive information appliances or other devices. In fact one of the great advantages of the StoryMail system is its ability to support the hardware capabilities and network connection characteristics of virtually any client device. In fact, a story can even be played on a client device that is not multimedia enabled because a story always has a set of text that describes, or narrates any non-textual element of the story. The story also contains semantic flags indicating the circumstances under which to render all text or non-textual elements.

A story according to embodiments of the invention is reliable because it is played in a novel run-time environment, wherein, unlike an HTML Web page where there may be links to other servers to provide further information, a story is a self-contained unit. The novel run-time environment is largely deterministic because of the self contained cooperative multitasking system employed in the playback engine and the explicit input buffer coding instructions with fixed size memory buffers. So if it runs correctly one time on one device it will almost certainly run correctly most of the time on all devices.

A run-time environment such as this is more reliable than, for example a pre-emptive multitasking system using the device's threading mechanism, or an architecture which allows for variable size buffering. Also in story messaging all content is present on the target device before the story is run. So unreliable connections to other devices or content on a network are unnecessary and part of a story cannot be missing since they are packaged together in a single logical file.

Because a story is self contained and reliable, creation of story content can be completely automated, devices made today will be able to handle future content without upgrades. This provides for intelligent content specific scaling and compression, it is easily stored and exchanged between e-mail clients as a single file, for example, that can be: embedded in a Web page, embedded in an e-mail attachment, stored in ROM, streamed from a server, run as a MIME type, run as an ActiveX component, run as a plug-in, and/or run as an ActiveX component.

Most story enabled devices will run or play a story in a window, or in a non-windowed operating environment such as occur on in basic or thin client devices, on a display device screen. Such devices include, for example, a desktop computer, notebook computer, personal data assistant (PDAs), telephone, set-top box, movie marquee, informational kiosk, Internet e-mail appliances, billboard, microwave oven, point-of-sale displays, gasoline pump, vending machine, instructional appliance, automobile display device, global positioning system (GPS), point-of-sale display, and myriad of other device types are supported. In fact, a story can even be played on a client device that is not multimedia enabled because preferred embodiments of the inventive story always have a set of text that describes, or narrates any non-textual element of the story, along with semantic information describing the role of each logical element. In one embodiment, a device may play a story entirely with voice commands and automatically articulated responses.

It is noted that although applicant describes embodiments of the inventive structure, method, computer program, operating model, and structure and organization of content used in or in conjunction with other aspects of the invention, the underlying inventive concept and indeed many embodiments of the invention do not require all features described here. Many such structures and procedures though advantageous and desirable are optional. Including text behind each logical element of the story is a preferred embodiment. Therefore, with respect to the structure and content of a story described here, it should be understood for example, that not all stories must contain underlying text behind each logical element of the story.

These optimizations make a story very flexible, scalable, and powerful. Unlike some conventional systems and methods, a story maintains a focus on the intent of the message and preserves that message intent in spite of its ability to selectively communicate elements to client devices and users. For example, in conventional video streaming systems the primary goal has been to maintain real-time transmission of the video stream and to relax quality to the point where almost all picture quality has been lost if necessary to maintain continuous operation. For an advertiser promoting a high-end product, such as example a diamond ring, it is very important to maintain the quality and clarity of the product image If the transmitted image(s) of the diamond ring make the ring appear undesirable, the entire purpose for the advertisement is lost. Therefore, attempts should be made to customize composition of the message so that where possible the bright high-resolution image of the diamond ring is presented to the receiver, and if such presentation is not possible then to provide an alternative possibly textual description of the ring which creates the same desire to own product as the bright clear image would. This particular example really illustrates the notion of selecting or substituting content to maintain the intent all of the StoryMailM message independent of the device hardware capabilities or network connection characteristics and even to some extent independently of user preferences.

The inventive structure and method may be applied to on-line auctions as well and provide significant benefits here. For example, a story message provides rich product descriptions complete with BID forms, bid limit exceed notifications providing a bidder a chance to upgrade a bid from a form embedded in the message without requiring the bidder to go to the action web site; and, bid accepted notification with transaction completion automation.

Traditionally, on-line auctions require composing a product description that may not scale up and down depending on the device. Traditional on-line auctions typically require repeated visits the site to determine if a bid is accepted. Furthermore, traditional on-line auctions generally require further visits to a Web site or the placement of a phone call to complete a transaction.

It can be appreciated that stories can be used at point of sale to provide looping demonstrations and/or advertisements of a product. For example, a story can be embedded in read-only-memory (ROM) of microwaves, stereos, set top boxes, and the like. Playback of such a story can be in the store that displays the story 180 enabled product for sale. The manner in which the story is played back may be modified by each viewer according to view preferences. For example the underlying content may have English, French, Spanish, and Russian audio and text content that may be selected by the viewer. Such input may be buttons on the playback device, a touch screen device, voice input, or other input devices as are known in the art. Additionally, story enabled devices, for example, soda machines, can be implemented to play media rich advertisement stories that can be updated using only a phone line to upload a different story. The content of such story may be communicated, for example overnight to a large variety of different device types, yet will be playable by all such device types.

There are other exemplary applications for stories, for example, stories can also be used for meeting scheduling, advertising, catalog item descriptions, holiday greeting cards, electronic storybooks, driving directions, vacation slide and picture shows, surveys, real-estate walk throughs, medical care pamphlets, pharmaceutical information pamphlets, cooking or production recipes, business presentations, instructional manuals, entertainment, and numerous other applications where the message consists of more than merely the text message.

We now describe aspects of an inventive next generation e-mail system that is used to generate, distribute, and play stories. In one embodiment, a story that is sent as a message from a server to a client device is called StoryMail. Referring to FIG. 1, there is a block diagram that illustrates aspects of an exemplary embodiment of a StoryMail system 300. StoryMail System 300 (also referred to simply as system 300) is a distributed client/server system with server peering.

Sender/publisher 310 is connected across I/O interface 312 to user interface 314. Sender/publisher 310, for example, can be a general-purpose computer, provides at least a subset of the information and content used to generate and transmit a story to sending story server 302. In other words, parts of a story may reside on any server anywhere or computer that can be addressed, that is connected to network 306. In this case, sender/publisher 310 provides links, for example, a Uniform Reserve Locator (URL) address of the document or other resource to be included in the story. Sender/publisher 310 includes a number of components which are described in greater detail below in reference to FIG. 2 I/O interface 312 can be any type of I/O interface, for example, a peripheral component interconnect (PCI) bus interface, a SCSI interface, or the like. Sender/publisher 310 is also connected across I/O interface 308 to network 306. As an alternative to 312,1/0 interfaces 308 and 309 can be used if information is passed through network 306. I/O interfaces 308 and 309 can be any type of I/O interface, for example, a modem connected to a public telephone network, a leased line, or a wireless radio wave or optical interface. Network 306, for example, can be a local area network (LAN) or a wide area network (WAN).

Network 306 is connected across I/O interface 304 to sending story server 302. Sending story server 302, for example, is a general-purpose computer or device for generating and transmitting stories to client devices, such as conventional e-mail server 332, story enabled client 336, conventional e-mail client 340, and story enabled device 344. A greater detailed description including aspects of an exemplary embodiment of sending story server 302 is provided below in reference to FIG. 4. I/O interfaces 304, 308, 309, 324, 326, 330, 334, 338, and 342 can be any type of I/O interface, for example, a modem connected to a public telephone network, a leased line, or a wireless radio wave interface.

In one embodiment, the system of the invention includes receiving story server 328, for example, is a general-purpose computer or device for transmitting stories to client devices, such as those client devices listed above. One difference between receiving story server 328 and sending story server 302, for example, is that sending story server 302 is able to generate stories and distribute stories, whereas receiving story server 328 is not able to generate stories but is able to distribute already generated stories. Receiving story server 328 is beneficial because it may contain functionality which can be used to eliminate the need for providing that same functionality in story enabled clients 336 and story enabled devices 344. This is advantageous because the computation and/or memory capacity of such devices is normally more limited than that of the servers 328. In addition, since there are likely to be many more story enabled clients 336 and story enabled devices 344, the implementation costs are lower if the functionality is contained on the servers 328 rather than on the story enabled clients 336 and story enabled devices 344. Examples of such functionality include proxy server functions, placing stories into in-boxes, and security features such as decryption, authentication and digital signature verification.

In one embodiment, network 306 is connected to conventional e-mail server 332 which is a traditional e-mail server used by a number of machines connected to network 306 to distribute and collect e-mail messages. Procedures for a machine to distribute and collect e-mail messages are known in the art. Conventional e-mail server 332 provides story messages to both non-story enabled devices, for example, conventional e-mail client 340, as well as story enabled clients and devices, for example, story enabled client 336 and story enabled device 344. As will be described in greater detail below, the presence of conventional e-mail server 332 is not necessary for story enabled client 336 or story enabled device 344 to receive stories. However, the presence of conventional e-mail server 332 is necessary for conventional e-mail client 340 to receive a story enabled message. In one embodiment, a story enabled message will not include a story, but rather includes information indicating that a richer message, or story underlies the story enabled message. This embodiment is described in greater detail below in reference to FIG. 6 and FIG. 7.

Story enabled client 336 includes, for example, computer program applications and data for playing a story received from a story server, for example, sending story server 302 and/or receiving story server 328 Story enabled client 336 is, for example, a general-purpose computer, a notebook computer, a personal digital assistant, a telephone, a set-top box, an Internet e-mail appliance, a movie marquee, an informational kiosk, a billboard, a gasoline pump, a vending machine, an instructional appliance, an automobile display device, a GPS system, a point-of-sale display, and the like. Story enabled client 336 starts life as a conventional email client 340. It becomes story email client 336 when story enabling software is downloaded or installed from a network or direct connection to another device. Story device 344 has the story enabling software built in by the manufacturer.

Conventional e-mail client 340 is a typical e-mail client, for example, a general-purpose computer that is not able to execute, or play a story. However, conventional e-mail client 340 is able to receive e-mail messages that include information indicating that a richer content message, or story is behind the e-mail message. In one embodiment, besides including information that a story underlies the e-mail message, the e-mail also includes, for example, an e-mail message that delivers the publisher's 310 message in a traditional e-mail format. Such traditional e-mail formats include, for example, text, HTML and/or attachments. Such an embodiment is advantageous for a number of reasons. For example, while conventional e-mail client 340 will not be able to play a story without upgrading its computer program applications, it will still receive content that corresponds to publisher's 310 message or promotion Additionally, the message can be forwarded to another e-mail client device, for example, story enabled client 336, wherein the richer message will be available to the other client device.

In one embodiment, conventional e-mail client 340 upgrades its capabilities to enable it to play a story. In a situation where conventional e-mail client 340 upgrades its computer program applications to enable it to play a story, conventional e-mail client 340 would become a story enabled client 336. In one embodiment, conventional e-mail client 340 can perform such upgrades, for example, by downloading a story player from a web site or an FTP site, or by loading a story player from a CD-ROM or diskette. In a preferred embodiment, conventional email client 340 upgrades by responding to a link provided in the email message, wherein the link points to a download image or site.

Story enabled device 344 is manufactured with story functionality built in. Such devices include networked household appliances, cell phones, smart cards and pagers.

Each client device 336, 340, and 344 includes, for example, an e-mail program (not shown) that respectively receives and/or delivers e-mail respectively from/to one machine connected to network 306 from/to another machine connected to network 306. To facilitate such reception and delivery, an email program utilizes Internet email protocols, for example, known POP3 or IMAP protocols. In one embodiment, such an e-mail program is a conventional e-mail program, such as Microsoft Outlook Express®. In another embodiment, the e-mail program is a special e-mail program designed specifically to receive and/or transmit stories to another client or device across network 306.

Referring to FIG. 2, there is a block diagram that illustrates aspects of an exemplary sender/publisher 310, according to one embodiment of the present invention. Sender/publisher 310 includes processor 142 connected across local bus 144 to memory 146. Processor 142 is used to execute computer program applications 148 and fetch data 150 from memory 146. Local bus 144 can be any type of bus, for example a peripheral component interconnect (PCI) bus, as long as local bus 144 has a set of signal lines that can be used by processor 142 to transfer information respectively to and from memory 146.

Data 150 includes, for example, database 152 representing any combinations of textual information, motion video, audio, forms, automation scripts, a story recipient list and any other message content, communication, or the like, that may be sent in an electronic format. A form can be any type of form or document, for example, a purchase order form, a registration or an application form. Typically a form provides an inquiry and provides some instructions for answering or responding to the inquiry. Database 152 is a standard database that can be created and managed using any of a number of conventional database tools In one embodiment, database 152 includes, for example, textual descriptions in more than one language of a number of products, digital or binary images of the products, motion videos to advertise and illustrate the products, product identification numbers, audio clips to advertise and describe the products, and/or recipient information, such as a list of e-mail addresses to which to send a story. Desirably, for every non-textual item of data in database 152, a textual description of that item of data is available. For example, if database 152 includes a color photo of a particular toy, there will be a corresponding text description of that toy.

In a preferred embodiment, a digital or binary image can have a set of scaled and color depth versions of the binary image. For example, if database 152 includes a 300 dots per inch (dpi) 24-bit color binary image of the cover of a book, database 152 will also include a 1-bit black and white representation of the image, an 8-bit and 16-bit gray scale representation of the image, and various resolutions of each of the resolutions, such as 100 bit and 200 bit resolutions.

In a preferred embodiment, scaling of logical story elements can occur at three different times: (1) when generating the message; (2) when executing the procedural elements of the message; and, (3) while the message elements are being rendered by the hardware specific functions (e.g., the HAL functions) that connect a portable story playback engine to actual device specific hardware.

For example, in one preferred embodiment, sending story server (see FIG. 1) scales the story content when generating the message to conform to the story enabled clients' 336 hardware capabilities, network connection characteristics, and specified user preferences at the time that such information are determined (see FIG. 7, step 228). In yet another preferred embodiment, story player 194 (see FIG. 5) scales the content of the story when the procedural elements of the story are executed, or played. For example, a digital image may be scaled from 300 dpi to 200 dpi while the digital image is being displayed. In yet another embodiment, story player's 194 HAL may scale the story to fit into a particular display screen size and/or add scroll bars to the display so that an entire story can be viewed.

Document 154 is author once information created by using a number of structured document languages, for example, extensible markup language (XML), and Excel spreadsheet format, database records extracted with SQL, and alike. In a preferred embodiment, Document 154 is an XML document. Document 154 can be created in a number of different ways. For example, Document 154 can be created using any of a number of known XML Editors, Word processors, device drivers, and the like.

Referring to FIG. 3, there is a block diagram that illustrates aspects of an exemplary Document 154 used by sending story server 302 (see FIG. 1) to generate a message/promotional story 180, according to one embodiment of the invention. FIG. 3 uses a structured document syntax pseudocode that does not conform to any one particular structured document syntax, but is rather used only for purposes of illustrating the invention. In a preferred embodiment, XML document 154 includes a tag that identifies a particular storyteller 172 (see FIG. 4) and a unique identifying attribute of the particular storyteller 172.

The pseudocode describes a set of tags that each respectively in turn describes an element, wherein each tag is followed by an equals sign (“=”) and a corresponding textual description that defines some other property of the element. The property can be either an absolute description string, an embedded document, or a string that includes a URL and a document name. If a descriptive property is a URL and document name, the URL will be accessed and the identified document downloaded when document 154 is parsed by story server 302 (see FIG. 4) during one time processing of document 154, as described in greater detail below in reference to FIG. 4.

Line 400 includes a tag that identifies a “STORYTELLER ID” element, which is followed by an attribute of the element, “ecoupon 5”. “Ecoupon 5” identifies a unique storyteller 172 (see FIG. 4) in story server 302 (see FIG. 1). In this example, ecoupon 5 storyteller 172 will be used to generate a form and a user interface to be used by a sender/publisher 310 (see FIG. 1) to generate and distribute one or more ecoupon stories 180 (see FIG. 4) to distribute to one or more customers as dictated by sender/publisher 310 (see FIG. 1). Storytellers 172 are described in greater detail below in reference to FIG. 4.

Line 402 includes a tag that identifies a “PRODUCT VIDEO” element, which is followed by an attribute of the element that identifies a particular MPEG motion video, “BOOKRETAILER.COM\PROMO24\ISBN12980.MPG” that is to be distributed in a story 180 (see FIG. 4). In this example, the motion video is identified by a URL link to the author's database 152 (see FIG. 2) and a corresponding motion video document.

Lines 404 and 406 include tags that identify respective product picture elements, wherein each respective tag identifies a specific binary image (or other digital image or graphic) that has a respective different pixel resolution. For example, line 404 includes a tag that identifies a “PRODUCT PICTURE 100DPI” element, which is followed by an attribute of the element that identifies a 100 dpi binary image, “BOOKRETAILER.COM\PROMO24\ISBNL2980 100DPI.JPG”. Whereas, line 406 includes a tag that identifies a “PRODUCT PICTURE 200DPI” element, which is followed by an attribute of the element that identifies a 200 dpi binary image, “BOOKRETAILER.COM\PROMO24\ISBNL980 200DPI.JPG”. Both binary image files are identified by respective URL links to the author's database 152 (see FIG. 2) and a corresponding JPEG document.

Lines 408 and 410 include tags that identify respective audio file elements, wherein each respective tag identifies a specific audio file that is implemented in a different language. In particular, line 408 includes a tag that identifies a “PRODUCT AUDIO ENGLISH” element, which is followed by an attribute of the element that identifies an audio file that is implemented in English (“BOOKRETAILER.COM\PROMO24\ISBNL2980 ENG.WAV”). Whereas, line 410 includes a tag that identifies a “PRODUCT AUDIO SPANISH” element, which is followed by an attribute of the element that identifies an audio file that is implemented in Spanish (“BOOKRETAILER.COM\PROMO24\ISBNL2980 SPAN.WAV”). Both audio files are identified by respective URL links to the author's database 152 (see FIG. 2) and a corresponding WAV document. These tags are merely illustrative and not exhaustive of the type of tags, file elements, and/or identifiers that may be used.

Lines 412 through 418 include tags that identify respective text file elements, wherein each respective tag identifies a specific text file with analogous intent written in a different language. In particular, line 412 includes a tag that identifies a “PRODUCT TEXT ENGLISH” element, which is followed by an attribute of the element that identifies an ASCII text file that is implemented in English (“BOOKRETAILER.COM\PROMO24\ISBNL2980 ENG.TXT”). Whereas, line 414 includes a tag that identifies a “PRODUCT TEXT MANDARIN” element, which is followed by an attribute of the element that identifies a unicode text file that is written in Mandarin (“BOOKRETAILER.COM\PROMO24\ISBNL2980 MANDARIN UNI”) and the like. Each text file of these examples is identified by respective URL links to the authors database 152 and a corresponding text or unicode document.

Line 420 includes a tag that identifies a respective “PRODUCT SKU” (stocking unit) number element, which is followed by an attribute of the element, in particular an absolute value that identifies the promotion's targeted product's SKU. Line 422 includes a tag that identifies a respective “FULFILLMENT SERVER URL” element, which is followed by an attribute of the element, in particular a URL for the promotion's fulfillment server. A procedure for using such a fulfillment server is described in greater detail below in reference to FIG. 7.

Lines 424-428 includes tags that identify story 180 (see FIG. 4) recipient or customer information. For example, Line 424 includes a tag that identifies a “FIRST NAME” element, which is followed by an attribute of the element, in particular, the name “DAVE”. Line 426 includes a tag that identifies an “EMAIL ADDRESS” element, which is followed by an attribute of the element, in particular an e-mail address, such as for example to “someone @ somewhere . com” that identifies the recipient's e-mail address, and the like.

Line 430 includes a tag that identifies a respective “MASTERDATABASE ID” that is used by sending story server 302 (see FIG. 1) to identify those portions of a master parts database to use for a particular message/promotion. In one embodiment of the invention, sending story server 302 returns the message/promotion ID 430 to sender/publisher 310 (see FIG. 1), such that the message/promotion ID 430 is unique to any other message/promotion IDs in a master parts database. Such a message/promotion ID can be used by publisher 310 to modify and/or delete the information that corresponds to a message/promotion in a corresponding master parts database. Such a master parts database is described in greater detail below in reference to FIG. 4. In one embodiment, such a message/promotion ID is used by publisher 310 to send a corresponding message/promotion to recipients in batches, each batch job referencing the message/promotion ID.

It can be appreciated that document 154 can include any number of user defined elements and respective attributes of such defined elements. As will be discussed in greater detail below, recipient information, for example, that information illustrated in lines 424-428, can be supplied to sending story server 302 (see FIG. 1 and FIG. 4) at any time through a number of different mechanisms.

In a preferred embodiment, for at least a subset of the non-textual data in Document 154, a textual description of that non-textual data is identified in Document 154. In yet another embodiment, for every textual description, there is a corresponding text description identified in more than one language, for example, English and Spanish text descriptions. In yet another embodiment, if Document 154 identifies an audio file in a particular language, Document 154 also identifies other audio files that have analogous content to the audio file in different languages. It may also provide a textual transcription and/or a summary of the audio files for presentation when the receiving device does not provide audio playback or the recipient chooses not to receive the content in an audio format. In yet another embodiment, if document 154 includes a binary image (either embedded or via a URL) having a particular resolution, document 154 also includes other resolutions of the binary image. Including such multiple resolutions of a binary image is beneficial for the reasons discussed in greater detail above. Furthermore, not only may the binary or digital images be different resolution, they may be different types of files, such as for example, a bit-mapped image (*.bmp), a TIFF format image (*.tif), a JPEG compressed image (*.jpg), or the like.

Applications 148 includes, for example, one or more of the following computer program applications (a) a Web browser (not shown) such as Netscape Navigator® or Microsoft Internet Explorer®, for accessing a Web page served from sending story server 302; (b) any of a number of commercially available XML Editors for creating document 154. Other applications may also be stored or provided, for example, multimedia authoring systems, story mail applications, templates for other applications such as spreadsheets, multimedia and/or XML database managers.

Sender/publisher 310 also includes, for example, a database stored or referenced which includes at least a subset of the content necessary to represent the information and data in a story Referring to FIG. 4, there is a block diagram that illustrates aspects of an exemplary sending story server 302, according to one embodiment of the invention. Server 302, includes processor 162 connected across local bus 164 to memory 166. Processor 162 is used to execute computer program applications 168 and fetch information from data 170. Local bus 164 can be any type of bus, for example, a peripheral component interconnect (PCI) bus, as long as local bus 164 has a set of signal lines that can be used by processor 162 to transfer information respectfully to and from memory 166.

There may be any number of sending story servers 302 and receiving story servers 328 (see FIG. 1). In such a system 300, each server 302 and 328 will respectively communicate directly with another respective server 302 and 328, or with one or more conventional e-mail servers 332 (see FIG. 1) using one or more communication protocols, for example, SMTP/ESMTP/MIME/HTTP communication protocols. (For purposes of this description, wherever SMTP is used, ESMTP is also applicable). Sending story server 302, using information that is provided both by sender 302 and story enabled client 336, generates and distributes stories 180 as e-mail, or StoryMail. Such information can be provided to sending story server 302 through a number of different mechanisms. For example, the information may be provided if sender/publisher 310 (see FIG. 1) sends document 154 across I/O interface 308 to server 302. (The contents of document 154 are described in greater detail above).

In one embodiment, sending story server 302 also serves one or more documents on the World Wide Web (WW) identified by a unique Uniform Resource Locator (URL) that allows a user of sender 302 to input information through network 306 into server 302 that will be translated into document 154. There are a number of known computer programs that are used to translate information into a structured file format, for example, XML. Aspects of an exemplary procedure used by sending story server 302, sender/publisher 310, and story enabled client 336 to exchange information to generate, distribute and play story 180 are described in greater detail below in reference to FIG. 5 and FIG. 6.

Applications 168 includes, for example, composition engine 170, storyteller 172, e-mail engine 173, and other applications 174. Each of these applications 168, and in particular, composition engine 170, storyteller 172, and e-mail engine 173 work cooperatively to build story 180. Composition engine 170 provides, for example, a framework of data structures, a run-time model, a compiler, an application programming interface (API), and conventions for building an almost endless variety of different stories 180 that conform to a story run-time model. The story run-time model is designed such that a story playback engine on a story client can be simple in complexity and fast. The run time model provides a lightweight cooperative multitasking multimedia and central application framework. (Such a run-time model described in greater detail below).

Composition engine 170 passes information provided by sender/publisher 310 (see FIG. 1), such that the information is represented in a procedural data format that is not a flat data format. Advantageously the technologies are designed for the procedural content to be fully computer-generated, that is, without manual user intervention. (Manual building is possible but it is not preferred or even desirable.) In one embodiment of the invention, industry standard XML interfaces are used to completely automate one time processing of such provided information, such that existing authoring tools and content formats, for example, JPEG, AVI, MPEG, MP3, and the like, are supported through a simple yet powerful transcoding mechanism of the invention.

To accomplish this, composition engine 170 performs one-time processing of the provided information such that the resulting procedural format of the information for example, is a sequenced set of data, for example, computer program instructions or operation codes (op codes), control information, parameters and media parts. The phrase sequenced set means that the data is organized into a time line that dictates the rendering and navigational characteristics of a story 180. This time line may include procedural tests, branches, jumps, conditional statements, and the like so that the rendering may not ultimately be perfectly linear or sequential.

For example, such a sequenced set of data may include a first set of computer program instructions to display a graphic. The first set of computer program instructions is followed, for example, data used by a story player to display navigational buttons on the story receiving devices display. Desirably, each media part is assigned an absolute priority that controls when and if a particular media part will be rendered.

The computer program instructions specify operations to render graphical user interface (GUI) components, media parts, and provide procedural control to user interaction with the GUI components. The control information, for example, provides offsets into the sequenced set of data that indicate where particular media parts are located. In one embodiment, control information also provides a set of semantics and flags for each logical element of a story to maintain the intent of the message on all receiving devices.

In yet another embodiment, control information, for example, includes an array of hot spots, one hot spot for every logical element. Such logical elements include, for example, button controls, text input controls, bitmaps, areas wherein motion video will be displayed, text boxes, decorative elements, and the like. Each hot spot is associated with a rectangular region of the receiving devices' screen display (if one is available). The rectangular region facilitates event identification. Such event identification is associated with user instantiated events. For example, if a user selects, for example, with a mouse device, a region identified by the rectangle associated with a particular hotspot, the operating system will generate a button click event which, as will be described in greater detail below is processed by a story player in the context of the logical element selected.

Each hot spot is further identified as being either active or inactive. An active hotspot is a hotspot that generates an event when a user selects a region within the rectangular area associated with the hotspot. In contrast, an inactive hotspot does not generate an event when a user selects a region within the rectangular area.

In a preferred embodiment, each hotspot area is implemented as a bitmap. Aspects of an exemplary procedure for a story player to use an array of hot spots to play a story is described in greater detail below in reference to FIG. 6.

In addition to areas the hotspot array may also contain semantic and alternative rendering element identifiers (ids) for logical elements other than areas. For example, a hotspot's semantic flags may indicate that there is overview test available that describes the overall purpose of a screen of information, and the hotspot may also contain the id of the overview text element of the story.

Aspects of control and control information include memory buffer creation, memory buffer loading, branching, condition or searching, layout, subroutines, linkage between different sequences of instructions, decompression and compression and file packaging, e-mail access for sending messages, requests for subfiles.

In one embodiment, each opcode, parameter and offset is a 32-bit word. This is beneficial for a number of reasons. For example, portability and adaptability are supported by the use of fixed size 32 -bit words A 32-bit fixed size word is advantageously used for representing a large dynamic range of value and is highly compressible because both instructions and parameters are designed to have mostly small integer values. The fixed size makes things very scalable and processor words are always aligned along the word boundary.

Because of this suitably chosen fixed size, the playback code, or the story 180 is also small and reusable. Parameters and opcodes can be processed by the same code and operation, for example, addition operations can be performed without the need for size conversion of the code. An additional advantage is that the opcodes and data are aligned in memory for fast access. Aspects of an exemplary procedure to use such a procedural data layout to play story 180 are described in greater detail below in reference to FIG. 5 and FIG. 6.

Such one-time processed information is stored by composition engine 170 as a set of master parts data into master parts database 178. Desirably, each set of master parts data is identified by a unique identifier that can later be used by sender/publisher 310 to access, modify, and delete the contents of a particular set of master parts data. in master parts database 178. The set of master parts data can be used by sender/publisher 310 (see FIG. 1 and FIG. 2) to generate and distribute any number of stories 180 to targeted e-mail enabled clients.

In one embodiment, composition engine 170 is eminently portable, meaning that it may also be embedded in other devices besides sending story server 302. For example, composition engine 170 may be embedded, for example, into a digital camera. A single global data structure allows the implementation of composition engine 170 code as a set of C++ objects, composition engine 170 code is reusable and can be instantiated more than one time. An additional advantage of this is that applications including composition engine 170 will be easy to build. Furthermore sizes of all program variables are explicitly defined and there is built-in support for little-endian and big-endian systems. A thin hardware extraction layer (HAL) and the ability for all text to be represented in ASCII or Unicode also supports portability. In combination, all of these aspects make a story quickly and easily portable to a broad range of devices, able to handle nearly all the computer programming instruction sets or languages.

Story teller 172 includes, for example, a set of programmed logic that will select at least a subset of a particular set of master parts data in master parts database 178 to build story 180. Because composition engine 170 represents the provided information in a procedural format, a story 180 is just one big procedural language/data/environment. In a preferred embodiment, a story 180 is part of the same procedural language including the content, decompression, rendering, layout, hotspot responses and navigation. In some aspects, a story 180 may be viewed as a self-contained ultra-low overhead multi-threaded run-time system. For example, a story 180 generates video frames by executing sequences of instructions. This allows for mixing of different video decompression/reconstruction algorithms within a single frame. For example, a motion compensation vector equivalent for a whole frame can be applied using a single instruction which moves rectangular parts of one picture into another.

In one embodiment, storyteller 172 builds a story 180 from the master parts database 178 in response to a message from StoryMail enabled client 336 (see FIGS. 1 and 4). (Such a message is described in greater detail below in reference to FIGS. 5 and 6). In this embodiment, the message will include a unique identifier, such as the unique identifier discussed above, to determine which set of master parts data to use to build a story. The particular master parts that a storyteller 172 will select to piece together story 180 together depends on the purpose of storyteller 172 and the particular hardware capabilities, network connection characteristics, and user preferences associated with a targeted story enabled client 336 (see FIG. 1 and FIG. 4). Aspects of an exemplary procedure to send server 302 such capabilities, characteristics, and preferences are described in greater detail below in reference to FIG. 5 and FIG. 6.

The purpose of storyteller 172 can include any one of the exemplary applications of a story 180 that were discussed in greater detail above or other purposes. In one embodiment, sending story server 302 includes any number of pre-configured storytellers 172, wherein each storyteller 172 will have a unique such purpose. For example, a first storyteller 172-1 may be used to build an e-coupon story 180, a second storyteller 172-2 may be used to build a parts catalog story 180, and the like.

In yet another embodiment, the invention contemplates that sending story server 302 will serve a Web page interface (not shown) whereby publisher/sender 310 creates and modifies storytellers 172. For example, in one embodiment, such a Web interface provides a set of button controls that when selected by a user allows the user to: (1) add logical story elements, for example, an MPEG file, to master parts database 178; (2) select portions of such logical story elements, for example, a user selects a particular picture and a particular video to include in a story 180; (3) specify the dimensions of portions of the story, for example, a user may specify that the dimensions of a particular sequence of logical story elements are to be of a particular width and height; (4) order the logical story elements on a time line, and take into consideration any user navigation; and, (5) define a set of templates, wherein a particular template specifies, for example, the particular operating parameters and rules used to scale the logical story elements to optimally play on a particular story enabled client 336 (see FIG. 1).

E-mail engine 173 is used to both send and receive e-mail respectively to/from sender/publisher 310, story enabled client 336 and conventional e-mail client 340. Conventional e-mail engines are known in the art of internet e-mail messaging. Aspects of such e-mail messages are discussed in greater detail below in reference to FIG. 5 and FIG. 6.

Referring to FIG. 5, there is a block diagram that illustrates aspects of an exemplary story enabled client 336 (client 336), according to one embodiment of the present invention. Client 336 receives and plays stories 180. Client 336 can also forward story 180 to other e-mail enabled clients, for example, another story enabled client 336 and/or conventional e-mail client 340 (see FIG. 1). To accomplish these tasks, client 336 includes processor 184 connected across local bus 186 to memory 188. Processor 184 is used to execute computer program applications 190 and fetch data 198 from memory 188. Local bus 186 can be any type of bus, for example, a peripheral component interconnect (PCI) bus, as long as local bus 186 has a set of signal lines that can be used by processor 184 to transfer information respectfully to and from memory 188.

Data 198 includes, for example, e-mail message 200, which is sent to story enabled client 336 by sending story server 302 (see FIG. 1). Aspects of an exemplary procedure for sending story enabled client 336 e-mail message 200 are described in greater detail below in reference to FIG. 5 and FIG. 6. In one embodiment, e-mail message 200 includes, for example, novel story e-mail, which indicates to story enabled client 336 that a richer content story 180 is behind e-mail message 200. Story enabled client 336 receives a mail message 200 before it receives story 180. As will be described in greater detail below in reference to FIG. 5 and FIG. 6, in a preferred embodiment of the invention, story 180 is only received by story enabled client 336 after story enabled client 336 collects its e-mail from an e-mail server, for example, conventional e-mail server 332 (see FIG. 1).

In one embodiment, story header 201 includes, for example, story teller ID 202, data set ID 204, and a URL 206. Story teller ID 202 identifies a particular story teller 172 (see FIG. 4) used by sending story server 302 (see FIG. 1) to build story 180. Aspects of exemplary procedure for sending story server 302 to build story 180 are described in greater detail above in reference to FIG. 2, FIG. 5 and FIG. 6.

Data set ID 204 is used to identify a data set that corresponds to at least a subset of the information in master parts database 178 (see FIG. 4) that will be used by sending story server 302 to generate story 180. URL 206 identifies the URL of the particular sending story server 302 that sent client 336 e-mail message 200. Although a conventional mandatory return path e-mail header (not shown) may also identify the particular story server 302, the URL information is beneficial because story messages may come from different servers belonging to different service providers or sender/publishers 310 (see FIG. 1).

Although, embodiments of the invention contemplate that story 180 may be forwarded by story enabled client 336 to another device, in a preferred embodiment, story enabled client 336 does not forward story 180 to another device, but rather e-mail message 200 is forwarded to another device. Such other devices include, for example, another story enabled client 336, a conventional e-mail client 340, and/or a story enabled device 344. After a targeted device receives the forwarded e-mail message 200, any corresponding collection request by the targeted device associated with e-mail message 200 is redirected to sending story server 302, such that sending story server 302 determines whether the target device is story enabled or not.

If the targeted device is story enabled, sending story server 302 determines, for example, the particular hardware characteristics, network connection characteristics, and any user preferences associated with the targeted device before sending story 180 to the targeted device. Aspects of an exemplary procedure to make such a determination are described in greater detail below in reference to FIG. 5 and FIG. 6. This level of indirection ensures that an optimized story 180 will be forwarded to story enabled clients 336 and story enabled devices 344. This level of indirection also ensures that if the targeted device is not story enabled, that the targeted device, although not receiving story 180, receives conventional content associated with the mail message 200 along with the novel story header 201 information. As described in greater detail above, in one embodiment, such conventional content is determined by sender/publisher 310 (see FIG. 1) and storyteller 172 (see FIG. 2) upon creation of a message or promotion that corresponds to story 180.

E-mail message 203, includes, for example, story 180. In a preferred embodiment, e-mail message 203 is received by story enabled client 336 after sending story server 302 has determined story enabled client's 336 particular hardware characteristics and any user preferences. In a preferred embodiment, story 180 is scaled to story enabled client's 336 particular hardware characteristics, network connection characteristics, and user preferences.

Applications 190 includes, for example, information provider 192, story player 194, and other applications 196. Information provider 192, for example, sends story enabled client's 336 hardware capabilities, network connection characteristics and any user preferences to sending story server 302 (see FIG. 4). Such capabilities and characteristics (discussed in greater detail above) are typically obtained by querying operating system software (not shown) that controls the execution of computer programs and provides such services as hardware management, computer resource allocation, input/output control, and file management in story enabled client 336.

Information provider 192 determines any user preferences in a number of ways. In one embodiment, information provider 192 displays a GUI onto a display device (not shown) connected to story enabled client 336. The GUI will have one or more user interface controls, for example, a dialog box, an edit control, and/or a combination box, to the end-user for end-user selection and input with respect to a predefined number of preference categories. Such categories include, for example, a preferred language, message size limits, message download time limits, message filters (for example, no e-coupons), data encryption requirements, and security requirements. (Either limits may be greater or less than a default set of time limits). In one embodiment, if there are a number of preferences, certain preferences will be given a higher priority than other preferences. In a preferred embodiment, such preferences are stored in data 198 as a text file (not shown) in a structured file format, for example, XML, that can be edited by a user with using a text editor.

Story player 194, for example, executes, or plays story 180. As described in greater detail above in reference to FIG. 4, story 180 includes one or more of op codes, parameters, offsets and media parts. To play story 180, player 194 sequentially parses story 180 to extract these op codes, control information (parameters and offsets), and media parts. As each op code is extracted, player 194 will match the op code to a particular computer program instruction, or procedure, which is a logical set of computer program instructions. There are a number of known procedures that can be used to map such opcodes to computer program instructions procedures. For example, a simple C programming language case statement can be used to perform such mapping.

Story player 194 will jump to a procedure that corresponds to the opcode and begin a set of corresponding computer program instructions. In a preferred embodiment, such computer program instructions are C instructions. If the computer program instruction requires corresponding parameters, the required parameters are extracted on an as needed basis from story 180. In one embodiment, parameters can signal the parsing of other parameters from the stack. There are a number of well known ways that a specific number and specific type of parameter can be mapped to a computer program instruction. For example, the number and types of parameters can be hard wired in the implementation of a computer program instruction. If a parameter is an offset to a media part of story 180, the offset is used when playing story 180 to extract the data for the particular media part when necessary. After a procedure returns a status code to story player 194, an instruction pointer points to the next opcode to be executed as described above.

Story player 194 advantageously implements cooperative multithreading and synchronization through resource constrained retry at the instruction level. To provide such advantages, each procedure in story 180 returns one of a number of possible status codes, for example, success, retry, and yield status codes. In one embodiment, story player 194 executes sequences of instructions for a thread as long as the instruction functions return a status code of “success”. Upon receiving a status code of success, a next thread is executed by story player 194 under similar constraints. Any instruction that takes a predetermined amount of time to complete will return a yields status code, indicating to story player 194 that other threads should be executed. Upon receiving a yield status code, story player 194 stops executing the thread and places it onto a queue for later execution. Such yield status codes are inserted at appropriate places in story 180 by story teller 172 when story teller 172 creates story 180.

Certain story 180 instructions are executed on a time line as described in greater detail above in reference to FIG. 4. Such instructions are so tagged with a “wait until time” instruction by storyteller 172 (see FIG. 4) before being placed into a master parts database 178. Story player 194 will wait until the indicated time to execute such instructions. If story player 194 encounters such an instruction and it is not time to execute the instruction, story player 194 will retry the instruction at another time.

Any instruction encountered by story player 194 that requires a memory buffer, wherein the memory buffer is not available, is placed on a queue such that story player 194 will retry the instruction at a later time wherein such memory resources may be available. In one embodiment, story player 194 identifies “wait for event” flags to synchronize story 180 instructions.

In one embodiment, story player 194 presents a purchase button to a user that is used to provide a response to the story 180. To implement such an embodiment, the HAL identifies a user selection in the rectangular area defined by a particular hotspot associated with the button. (Hot spots are described in greater detail above in reference to FIG. 4). Upon such a selection story player 194 executes a story procedure or story thread associated with the selection.

Other applications 196 include, for example, an optional e-mail client application, for example, Microsoft Outlook Express®, that provides e-mail receipt and delivery capabilities to story enabled client 336 using Internet e-mail protocols. In one embodiment, such Internet e-mail protocols include, for example, POP3 and IMAP protocols. In one embodiment such e-mail receipt and delivery capabilities are provided by story player 194.

Referring to FIG. 6, there is a block diagram that illustrates aspects of an exemplary procedure 210 to generate and distribute StoryMail messages 200 (see FIG. 4) to e-mail enabled clients, for example, StoryMail enabled client 336 (see FIGS. 1 and FIG. 5) or conventional e-mail client 340 (see FIG. 1). To better describe procedure 210, the following description references structure that are respectively illustrated in FIG. 1, FIG. 2, FIG. 3, and FIG. 4.

Step 212 provides, for example, multimedia content and/or message parameters to story server 302 (see FIG. 4). Such message parameters correspond to the multimedia content. For example, a message parameter is a discount rate. With respect to a targeted promotion story, which were described in greater detail above, such multimedia content includes, for example, product descriptions, promotional information, customer specific information and/or pictures to the story server 302 (see FIG. 1 and FIG. 4).

As described above, in one embodiment, sender/publisher 310 (see FIG. 1 and FIG. 2 sends such content in Document 154 (see FIG. 2). In yet another embodiment, sender/publisher 310 (see FIG. 1) accesses a URL that corresponds to a Web page (not shown) served by sending story server 302, whereby a user could input such content to sending story server 302. Such content is described in greater detail above in referent to FIG. 2. However, such content also includes, for example, the identity of a specific storyteller 172 to be used to generate a story 180 (see FIGS. 3 and 4). As described above, there can be a number of different storytellers 172, wherein each respective storyteller generates a story 180 with a specific predetermined intent.

For example, if sender/publisher 310 is an Internet book, music and video retailer that offers music CDs, video, DVD, computer games and other products, the specific storyteller 172 may be used to build a parts catalog story 180 to be distributed to retailers, or the specific storyteller 172 may be selected to generate a holiday card story 180 to be distributed to customers.

Step 218 performs one time processing of the content as described in greater detail above in reference to composition engine 170 as illustrated in FIG. 4. Step 220 returns a unique master parts identification to sender/publisher 310. As described above, such an identification is used to identify the particular set of master parts data that corresponds to the one time processed content. This identification can be used by sender/publisher 310 to access, modify and delete the one time processed information from sending story server 302, as well as to send new messages using the same master information as default content.

Step 220 sends e-mail message 200 (see FIG. 5) to each recipient that is identified in the provided content (step 212). As described in greater detail above in reference to FIG. 5, e-mail message 200 is an e-mail message that includes story header 201. In this step, a recipient can be either a story enabled client 336 (see FIG. 1), a conventional e-mail client 340, or a story enabled device 344.

Step 222 intercepts an e-mail collection request from the e-mail message 200 receiver. Step 224 evaluates whether the e-mail message 200 receiver is story enabled, for example, a story enabled client 336. If not, step 226 sends the contents of e-mail message 200 to the non-story enabled device, for example, conventional e-mail client 340 (see FIG. 1). Otherwise, procedure 210 continues as illustrated in FIG. 7.

Referring to FIG. 7, there is a block diagram that illustrates aspects of an exemplary procedure to generate and distribute StoryMail, according to one embodiment of the present invention.

Step 228 gets story enabled client 336 information. As described above, such information includes corresponding hardware capabilities, network connection characteristics, and any user preferences. In a preferred embodiment, such capabilities, characteristics and preferences are represented by story enabled client 336 in a structured file format, for example, as an XML document. In a preferred embodiment, quick communication protocols are used between story servers 302 and 328 and story enabled client 336 respectively for intra-server and server client communications, for example, HTTP communication protocols.

For purposes of illustration, story enabled client 336 could represent its particular capabilities characteristics and preferences in a structured file format as follows. “CPUSpeed=300” indicates that in the client 336 CPU speed is equal to 300 MHz. CPU or processor speed criteria may be used to influence the generation of an optimized story in that the CPU may not be fast enough to process large video clips in real time. A video clip with small dimensions (width and height) might be used instead. Or a signal picture may repress the video content instead of a video stream. “ScreenColor=yes” indicates that the client 336 display device can display color binary images. “Sound=yes” indicates that the client 336 includes a sound card, chip, or other sound or audio regeneration or playback means and that the data element that includes audio can be used to create a story 180. “LanguagePreference=English” indicates that the user of client 336 prefers to receive content in the English language. “CommunicationsSpeed=28800” indicates that the client 336 is connected to a 28.8 K-baud internet connection and is able to receive, for example, single pictures but not rich media such as motion video without incurring undue transmission delay. In one embodiment, such capabilities, characteristics and preferences are sent to the URL of sending story server 302, which was included in the story header 201 (see FIG. 5).

Step 230 generates the story 180 (see FIG. 4 and FIG. 5) using a particular storyteller 172 identified by story teller ID 202 (see FIG. 5) in e-mail message 200. To accomplish this, the specific storyteller 172 selects, or strings together only those portions of the set of master parts (identified by the date set ID 204, see step 219) in the master parts database 178 (see FIG. 4) that are compatible with each of the following: the capabilities, characteristics and preferences identified in step 228; and, the content which is compatible with the purpose of the specific storyteller. While stringing together such information, the specific storyteller 172 may create several original logical files, compress them, and compress each of the compressed logical files into a final single file. The logical order of the data in the each respective original single file is maintained in the headers of a sequence of sub-files that are automatically generated from each respective original logical file. Such a logical order is advantageously used by sending story server 302 (see FIG. 1) when transferring a story 180 to a story enabled client 336 (see also, step 232).

For example, the opcodes representing computer program instructions and parameters may be placed in a first logical file, text and parameters in a second logical file, all motion video may be placed in a third logical file, all audio data may be placed in a fourth logical file, and the like. Alternatively, the computer program, control information, audio data, motion video, and the like may be interspersed. In a preferred embodiment, the elements which are best compressed using the same compression algorithms are combined together so as to achieve a more optimal compression level.

Notice that system 300 (see FIG. 1) cooperates in collecting all relevant information and data first, such as for example, the capabilities, characteristics, and preferences described above, before generating a story 180 (step 230). This makes system 300, and in particular story 180 generation advantageously automated and dynamically adaptive. Having obtained all this information, system 300 then generates the optimum story 180 after a connection has been made with recipient. This is because only at the time of connection will story server 302 know for certain the particular characteristics of the recipient's client device, communication channel, and user preferences.

In some conventional systems, a user may register with a server characteristics of a registered device as well as registered user preferences. However, these conventional systems do not generally test or otherwise take into account the hardware capabilities of the device or network connection characteristics used by the device to communicate with the server at that moment of time.

The StoryMail system 300 (see FIG. 1) and procedure 210, on the other hand, take all such factors into account after connecting to a recipient's device to generate the optimal story 180 from a standpoint of story size, language, use or not use of audio or visual content, and the like. In a sense, the StoryMail procedure 210 is contrary to other prevailing trends which attempts to pre-form content so that is available as early as possible in that StoryMail 300 actually delays composition of an e-mail message until these capabilities, characteristics and preferences are known. In this manner, a story 180 sent to any device will be experienced in a manner that is optimal for that device and user.

Step 232 communicates a second StoryMail message 200 to story enabled client 336. The second e-mail message 203 (see FIG. 5) includes that generated story (step 230) and the corresponding story header 201 (see FIG. 5). In one embodiment, storyteller 172 encrypts generated story 180 (step 230) so that it cannot be read by any intervening process after it is sent to story enabled client 336 and before it reaches its destination In such an embodiment, if public key encryption is used, there is no need to have a central repository of public keys because the public keys of the center and receiver client can be exchanged after connection time when the story 180 is being generated (step 230).

As discussed above in reference to step 230, each logical sub-file of story 180 includes, for example, a startup sequence of instructions that can be used to start the transfer of the following sub-files in the sequence. Such segmentation of the files is beneficial for a number of reasons. For example, while transferring a story 180 to a story enabled client 336 (see FIG. 1), if the bandwidth is too small, a sub-file will not arrive in time. In one embodiment, story player 194 (see FIG. 5) pauses until each respective sub-file transfer is complete. In this manner, quality of story 180 presentation will be constant, even if receipt of story 180 content is intermittent. In yet another embodiment of the invention, real-time transmission of story 180 is not required so that the recipient may never be aware that transmission was delayed, suspended, or intermittent for a particular portion of story 180.

Step 234 executes, or plays the story. Aspects of an exemplary procedure to play a story 180 are described in greater detail above in reference to FIG. 4. In the preferred embodiments of the invention, a custom story 180 is generated for each receiving device, such that a story 180 can be generated to play on all types of story enabled devices and compatibility is maintained for all stories 180 even as story enabled devices may change or evolve. Even the rich media stories 180 will play on non-rich media enabled devices because, in preferred embodiments of the invention, there is always some text or other simplified content behind more complex elements such as sound or video clips to fall back on. This is because the master parts database 178 (see FIG. 4) includes information to create new stories that will play on all story players because there will always be the old instruction alternative to fall back on. Likewise in at least some embodiments of the invention, even rich media stories are able to playback on conventional e-mail clients 340 having rudimentary e-mail applications because of the fall back text provided in the master parts database 178.

As discussed in greater detail above in reference to FIG. 4, each logical element of a story 180 includes, for example, associated semantic information that respectively indicates a set of logical elements of story 180 that are to be displayed, or played on the recipients device. In one embodiment, such semantic information also indicates when story player 194 should substitute an alternative logical element for another particular logical element.

Step 236 determines whether there is a response to the played story 180. Such a response can be provided, for example, by a user selecting a button control that the story 180 causes to be displayed. If there is such a response, step 238 generates a response to the story 180. For example, if the story is an e-coupon that promotes the purchase of a particular book, story player 194 (see FIG. 5) will create a structured format purchase order form, for example, an XML purchase order form. Such a form includes, for example, the customer ID, the product SKU (stocking number) that was included in story 180 (parsed from document 154 (see FIG. 2, FIG. 3, and FIG. 4), and any preferences. Such preferences include, for example, an indication of whether the book is to be received in electronic format instead of a physical format, the language that the book is to be written in, payment information, and the like.

Step 240 communicates the response (step 238) to the fulfillment server that was identified in the story 180 (parsed from document 154 (see FIGS. 2, 3, and 4). Such communication can be implemented by using a number of different protocols, for example, the HTTP protocols or SMTP protocols.

The invention offers a number of strengths as compared to the closest competing technologies. A story 180 plays off line as well as online and is lightweight (thin) enough to run on inexpensive information appliances or other devices. When so desired, a story includes, for example, user navigational aids, user forms, and can automate a transaction fulfillment process. A story is instantly interactive, self-contained and reliable. Creation of a story's 180 content can be completely automated, such that devices made today will be able to handle future content without upgrades. The invention facilitates publishing messages that are meaningful to individuals with physical disabilities and provides for intelligent content specific scaling and compression. A story 180 is easily stored and exchanged as a single file, and the same content runs in Web pages in its own window and on low-power device screens.

Additional Exemplary Embodiments of System, Method, Computer Program, and Signals

Procedural System and Language for Generation. Customization, Encapsulation, Transmission, and Playback of Content and Single Language Instructions for All Applications and Devices

The inventive system and method provide a single file format (referred to as the story file format) and file execution procedure that permits communication of text, pictures, motion video, and other rich media content These story files and the story file format can encapsulate the rich-media content itself, user navigation, e-commerce, intelligent forms, automation, as well as other data and executables in a procedural form. In addition, embodiments of the story files are e-commerce and email aware, fully functional on-line or off-line, compressed to reduce storage and transmission overhead, efficient, and lightweight. All story files are desirably constructed to run in a large variety of operating environments and on a large variety of devices. The system allows for efficient automated generation and efficient automated customization through the use of logical files and indirection

For example, the inventive story file may be embedded in and run from an Internet web page, streamed from a server, run or executed from an email attachment, executed from ROM or RAM in any one of a variety of devices or device types, executed as an independent program (stand-alone program or as an application program within an operating system environment), as a Multipurpose Internet Mail Extensions (MIME) Type, as an ActiveX component, as a plug-in to another application program, executed within an email or other client, or in numerous other ways. The story file can be generated automatically by computer programs, for example a program running on an Internet connected server. Given various criteria presented as input, pieces of story procedural content can be very efficiently selected, concatenated into logical files, then packaged into a single story file customized according to the input, without the need for complex decision or linking operations. Such input may include limits on final story file size, content types, preferred language, and the like.

This functionality is at least in part due to the implementation as part of a single complex instruction based procedural language, sometimes referred to for convenience as Story Procedural Programming Language (SPPL). SPPL is designed for procedural content to be fully computer or otherwise autonomously generated without human involvement, though SPPL may be generated manually though less efficiently, and in one embodiment, provides a self-contained ultra-low overhead multi-threaded run-time system. SPPL provides a procedural and methodological framework that may advantageously be optimized for multimedia and e-commerce applications.

Semantic elements include flags and/or other indicators or indicia that identify the particular content element with which the semantic element is associated. For example, a semantic element may identify that the associated content element is for an overview of an element that would not be used as a direct substitute or replacement for an alternative (e.g. richer) content element. In this example, a story player would use the overview text and a text to speech algorithm to communicate what the screen shows for a user who cannot see the display screen at all In this case this overview element does not directly replace or back-up another element.

In one example, “this is an opportunity for you to contribute to the World Wildlife Fund” and “there are three options that you have; (1) make a contribution by credit card, (2) make a contribution by check, and (3) make no contribution”. A player that can automatically extract meaning from these two pieces and deliver them over a phone line would pull out these elements from the story according to their semantic flags and would be able to detect and relate how many options there are. Note that when displayed on a screen, there is no reason to explain it because it is clear to the message recipient viewing the screen what the intent of the message is.

More generally, semantic elements support explanation and navigation. Semantic elements need not be in a one-to-one relationship with other elements. Semantic elements further permit a type of filtering or extraction of story components. For example, it would be possible to search for all elements of any particular type (e.g. pictures, text, audio, motion video, overviews for content that would be rendered directly on suitable devices, and the like. In preferred embodiments, there is a set of semantic information for each rich-media element, along with a backing text element, with its own set of semantic information, to use as for generating a suitable alternate backup rendering that communicates the intent of the message for situations in which the rich media element renderings are not possible or not perceivable by the reader in the rich media format.

In certain preferred embodiments of SPPL formatted stories execute or play on all story enabled devices for all time. For example, all rich media stories will play on poor-media devices because there is always a text or symbolic (poor-media) element behind each rich-media logical story element to fall back on in the event the rich-media element cannot be played. For example, there is a text element “Photograph of Albert Einstein giving blackboard lecture on general relativity theory”, behind a black and white two-dimensional photograph of Albert Einstein, which itself is behind a richer color photograph of Einstein, which is behind a video-image clip of Einstein at the same blackboard. Semantic information and procedures included within the story ensure that the proper elements can be automatically selected at run time so as to preserve the intent of the story message regardless of the limitations of the story playback device.

Furthermore, new SPPL stories which contain new instructions will play on old story players (or on earlier versions of story player software) because in preferred embodiments there will be an older or compatible SPPL instruction set alternative to fall back on that will play either the richest-media alternative or a poor-media alternative using only the instructions supported by the old story player. The decision of whether to fall back is made using only instructions known to exist in all story players. In this manner new instructions are never executed on old players which do not support the new instructions, yet there is always a method for communicating the intent of the message, albeit in a less media rich manner.

The story capabilities are supported by several enabling technologies. These enabling technologies include the provision and use of a set of proprietary compression algorithms and techniques adapted for voice, video, music, images, and text or other symbolic data. Self-contained threaded procedural data technology is also used that is very processor and memory efficient, and highly functional, flexible and portable to a wide array of devices.

At a top-level, the story technologies are embodied in two portable code engines: a composition engine and a playback engine. The story composition engine may be used for human and computerized or autonomous authoring systems as well as for automatically generating custom stories using parameters from customer or other databases. The story playback engine may be used for story playback in for example, playback in Internet web browsers, playback in various devices, and playback in custom applications.

Embodiments of the inventive story file format and SPPL provide a run-time system with cooperative multi-threading at the instruction level, and thread and media playback synchronization based on resource constraints and instruction retry methods. The code-based story standard is advantageous for several reasons. It is reliable because a single set of source code is used for all encoders and decoders thereby eliminating incompatibilities that might arise because of untested combinations of encoders and decoders developed by different third parties. Also, there can be no misunderstandings on how to implement certain features such as may arise from ambiguities or misreading of text based specifications. It also provides for quick porting to Microsoft Windows OS, Linux OS, Unix OS, Macintosh OS, and Palm OS based computers, Cell Phones, PDAs and other current and to be produced information appliances and devices. The story file format is also interoperable across a wide range of networks and devices.

Having described features and operational characteristics of the Story File Format (SFF) and Story Procedural Programming Language (SPPL), attention is now directed to particular details of SFF and SPPL.

Embodiment of an Exemplary Story File Structure

Typically, a story file will include control information, text or other symbolic information, audio information, pictorial information, motion picture information, video information, and semantic information designed to allow players to preserve the intent of a story message when play back of elements of the story are not possible. The composition engine (described elsewhere in this specification) is responsible for putting together or packaging these information items into the single story file so that it may be utilized by the story player. The characteristics of the composer, communication channel, and story player influence how this packaging (and later unpackaging) is most beneficially performed. It is advantageous from the standpoint of the story player and the device on which the story player is installed or implemented that the received file is as small as possible, consistent with maintaining the message and its intent. Frequently, though not in all instances, the story player will be a thin device with small or modest memory. These story player characteristics plus the desirability of minimizing communication channel bandwidth, suggest that the story should be compressed prior to transmission to the story player. However, even if the thin story client is capable of receiving and storing the compressed story file, there remains a need to decompress the file for playback or rendering. The desirability of providing autonomously computer generated story files suggests using predetermined procedures for processing logical elements of the story file during its creation.

The inventive story file is therefore produced according to a story file assembly procedure that satisfies each of these and other needs and/or preferences. The story composition engine operates according to predetermined rules so that each story file is assembled into a standard framework that is understood by every story player. Assembly within the composition engine includes packaging and one or more levels of compression of a plurality of story file constituent logical elements into logical files. These logical files can also be compressed/decompressed using a top-level of compression during the packaging and unpackaging or unpacking process. Disassembly within the story player playback engine includes intelligent selective unpackaging and decompression of these constituent logical elements from logical files.

The composition engine is responsible for choosing the constituent logical elements required in each story file. These constituent elements will generally include commands, parameters for the commands, and data. Data may take the form of text or other similar symbolic or character data, audio data for generating or reproducing sound information, and video data for reproducing still or motion graphics, pictures, images, or other two dimensional (or three dimensional) information. As described elsewhere herein, preferred embodiments of the invention provide for multiple levels of media richness so that rich-media content may be utilized when possible but media having lower richness is available as a backup when necessary or preferred. Recall for example, that text is a backup for audio or video, that monochrome video is a backup of color video, that still imagery is a backup for motion video, and so forth. In addition to backup information additional elements may be included for which there is no specific rich-media counterpart. For example, there may be elements providing text that can serve as a primary description of what is being depicted on the screen. Such an element could be used for automatically rendering a rich-media story over a voice only phone so that the intent of the message can be fully communicated without any visual elements.

In many implementations, each logical element is matched to a set of semantic flags which indicate the circumstances and manner in which the logical elements might be used. For example a flag may be set for a text element that indicates that it is a first level overview of the message intent. A different flag for another element could indicate that element is selectable and has text available to describe the action taken when the element is selected. Multiple levels of audio sampling rates, video resolution rates, and even text language support may also be provided. Hence, without describing the intricate details of the composition engine selection or authoring process again here, it will be appreciated that a typical rich-media story will include multiple text, audio, and video logical elements, as well as control elements and semantic flags describing the role of elements for story playback and user interface and/or navigation.

In preferred embodiments of the invention, these logical elements are advantageously packaged and compressed differently. Control elements, text elements, audio elements, and video elements represent different types of logical elements arising at least in part from their associated data characteristics, available and/or preferred data compression schemes appropriate to each logical element type, the size of decompressed data in the story player, the relative or absolute time at which the particular type of logical element is needed during story playback in the story client (or intervening receiving entity), and other factors. Even audio logical element types may be further characterized into subtypes, that for example, treat speech differently from music. In similar manner, video type logical elements may be broken into additional subtypes, that for example, treat computer generated graphics having limited colors or tones and well defined color or tonal boundaries differently from continuous tone photographs. These subtle differences, may frequently permit the use of a more efficient compression/decompression scheme for each logical element. (The separate compression of different logical elements into like logical files as described hereinafter.)

In one embodiment, the composition engine builds each logical element separately or a group of logical elements having the same logical element type. A group may include only some logical elements of a particular type or all elements of that type. It then optionally but preferably compresses the logical element or group of logical elements using an appropriate compression scheme. Compression schemes for audio may, for example, include ADPCM, physco-acoustical models, Transforms, .MP3, as well as other schemes.

Compression schemes for video may, for example, include DCT, LZSS, Motion Vectors, Variable Length Codes, Run-length, Fractal, Vector Quantization, Wavelets, as well as other schemes. Where different groups of the same type are provided, different compression schemes may be utilized for different groups. Control type logical elements and text type logical elements may be compressed using, for example, be a LZSS, Run-Length, Table look up, or other suitable compression scheme, but may frequently not be compressed at this initial pre-packaging stage of composition. (But, see description of compression of packaged story file.) These compressed logical elements or groups of logical elements are then combined into a single file. The combination may be accomplished by concatenating the logical files (logical elements or group of logical elements) sequentially or in any other way. Recall that logical files are parts of a single story file. Subfiles, described further later in this document, relate to a streaming mechanism for such applications such as starting to play a story before the entire story has been received by the player, and which are in a sense complete stories in themselves that are chained together. The combined file is then optionally but preferably further compressed in a final compression stage. A generic compression scheme such as Lempel Ziv Welch (LZW) compression may, for example, be utilized as well as other schemes. Compression of the combined file is particularly advantageous when the control and text logical elements or groups of logical elements have not been separately compressed.

Using multi-stage (compress logical elements and then compress combined file) and element differentiated compression (use different compression schemes for different logical element types) may permit reducing memory and bandwidth requirements by a factor of from about 1 to about 1000, dependent upon data characteristics and the algorithms applied.

The compressed file is then communicated to the client, where it may be received in its entirety prior to the initiation of playback or where portions of the compressed file may be received after playback has begun.

Optionally the logical files, command portions, and the text portions, of the file are unpackaged and decompressed using the decompression to undo the final stage compression described above. Advantageously, the decompression occurs as the story is being played back so that only the portions of the commands (and optionally the text) that are actually needed are decompressed. In other embodiments, all of the commands (and/or text portions) are decompressed either when received or at the start of a story playback phase. In either case, the larger logical elements are not decompressed until their data is needed for playback. More specifically, the audio logical elements and the video logical elements are advantageously decompressed on the fly during playback so as not to unnecessarily consume client device memory. In the preferred embodiment, the decompressed audio and video logical elements are not saved, so that it is necessary to redo the decompression if the story is replayed. (Other embodiments save the decompressed elements but this is not preferred as client resources, particularly client device memory, are inefficiently utilized.

As a result of the procedural nature of the story file as implemented in a preferred embodiment, decompression of the logical elements (for example of a video image logical element) does not necessarily directly reveal a data structure having an array of picture elements (pixels). Instead, a procedure with commands and data are revealed that is easily implemented or executed by the story player to render the image This approach places a greater burden on the compiler in the composition engine but greatly simplifies the work in the story player. It also permits a thinner and more processor and power efficient story player. Other embodiments may directly decompress the larger logical elements, such as audio and video, and place them into a data structure for subsequent playback or rendering, but this approach is not preferred as it tends to increase memory requirements and playback engine or process sophistication.

This approach is particularly beneficial as the story instruction or command set is targeted to perform the tasks associated with story authoring and playback; for example, tasks such as implementing e-commerce applications, performing picture decompression, performing audio decompression, audio-to-video synchronization, forming XML strings, performing multimedia applications, and other functions associated with e-commerce and rich-media communication. Embodiments of the story procedures may conveniently be implemented in general purpose computer programming languages to take advantage of a large base of skilled programmers. For example, languages such as “C”, “C++ ”, JAVA, or the like may be utilized to author or generate programs into SPPL or SPF. However, when such conventional languages are used it will be understood that the functions and subroutines may be novel and specifically directed to story applications. For example, novel function and subroutine libraries are provided by the invention. One, such a library subroutine is a procedural function made up of a series of story instructions that decompresses, synchronizes and drops frames as necessary during playback of video streams

Exemplary Story Programming Conventions for a Preferred Embodiment of System and Method

Programming Issues and Conventions are now described. Each of the programming conventions and related methodologies pertains to a preferred embodiment of the invention and such conventions may often be ignored if only a subset of the full functionality is required or desired. Story implementation code has to be carefully constructed to ensure the security, portability, small code size, robustness, and speed of execution required for email based messaging that needs to work well on a large variety of devices. Some of the programming issues are discussed below. Where there are tradeoffs to be made, the issues are listed below in order from most important to least.

Programming for Portability

The SPE (Story Playback Engine) code should run in all devices and environments with a minimum of platform specific effort. The goal is to be able to enable a new device for Story playback with less than two work weeks of effort by a programmer familiar with the target device, but not necessarily familiar with the SPE code. It is expected that third party device and application programmers will be able to do ports based on the Story code-base and documentation, with only minimal support from StoryMail.

Preferred Embodiment Utilizes C-Language Subset

Preferred embodiments use a C language subset. C has proven to be efficient in code size and execution speed while remaining highly portable. C++ was not selected because it is not supported by tools for many DSPs and is not as efficient as C; however, we do want to take advantage of the modern optimizers built into existing C++ compilers and preserve some of the advantages of C++ such as the ability to easy create multiple instances. For this reason the C language subset we have chosen is compatible with C++ compilers and can easily be encapsulated in a C++ wrapper in a manner that allows for multiple instance creation. C++ as well as other current and to be developed languages may however be used to implement the invention.

Although aspects of the invention have been described in considerable detail, the listing below provides a sample of exemplary code so that some additional insight may be gained as to its structure and operation

Story and Story Playback Engine Versioning

Versions optionally but desirably are placed into Story Playback Applications using two values #defined in stConfig.h. The first value identifies the platform and the second identifies the platform independent revision number. Both values are 31 bits and are accessible during run-time as an indirect parameter to any Story instruction op-code. Hardware Abstraction Layer API (HAL)

This Applications Program Interface (API) is used to separate the portable code from the device dependent code necessary to graft the SPE to a particular device or application. The API is embodied in a set of C functions and associated informational memory structures and data structures for the media to be rendered. The portable code of the SPE handles as much as possible to make the Hardware Abstraction Layer (HAL) as simple as possible and to limit the need to use any more of the device operating system as possible. For example, pictures and audio are decompressed and rendered into simple raw output sample values in a very limited number of possible formats. Also, all synchronization of media and cooperative multitasking is done within the Portable Playback Engine code on a single device native operating system thread. Even this one thread returns to the device OS within 1/30 of a second so that the device can perform other functions even if it does not contain a multithreaded OS.

Hardware Abstraction Layer (HAL) Media and Data Formats

The Story Playback Engine (SPE) core will provide media and other data to the HAL in a limited number of formats, as discussed in this section. Though it is intent of the SPE core to provide the most useful and common formats, the large code size that would be entailed by directly supporting all data formats used across all platforms is to be avoided to the extent possible. Thus, it may be necessary for the HAL to perform data conversion if it uses a data format not supported by the SPE core. In some, such conversion code can be adapted from an existing HAL.

Audio Formats, Picture/Video Frame Formats, and Other Media Formats.

Media formats are advantageously limited to selected formats so that when exposed to the player device Hardware Abstraction Layer a lot of complexity (and code size) is not required. This preference yields simplicity and light weight and facilitates portability of the player on multiple platforms as the number of options are small. It should be appreciated, however, that this does not represent a compromise in system performance or in the features that the player (or composer) can offer. Rather than permitting numerous formats in the player, flexibility to handle multiple possibly diverse picture, video, audio, text, and/or other media is done by transcoding so as to be compatible with all current and future formats without requiring player changes or updates. The author of a message can use any format he or she wants, and transcoding or conversion from the author's format to one of the player supported formats is readily performed. This approach keeps the story player simple, lightweight, and portable. The intelligence and flexibility are provided in the transcoder.

For example, in one embodiment of the invention with respect to picture/video frame formats for planes, masks, alpha blend, scale, translate, rotate, and other image, graphic, picture, and video frame operations, the frame formats used by the player are BW, RGB, and YCbCr (analogous to YUV in analog formats). Audio sample and playback rate and channel formats supported by the player in this embodiment are 8000HZ 1 channel, 11025HZ 2channel, 22050HZ 2channel, and 44100HZ 2channel. With respect to text, either or both of ASCII or Unicode formats may be supported, and where one is supported, conversion to the other is accomplished using known techniques. It is noted that these particular supported formats are exemplary, and that the more important concept is to reduce the number of media formats that are supported within the player to those that are needed of provide significant advantages if they are not needed, and to provide support for other media formats through the composition engine and transcoders.

Time Format and Representation

In a preferred embodiment, all time is kept in milliseconds. A single HAL function, SU32 HalGetTime(void); is all that is needed to gain platform independence for time keeping. The HAL time returned never has to be explicitly set as the portable code will handle the base time and wrap around issues. There are, however, two modes of operation that HalGetTime( ) should support. One is based on actual time, and the other is related, but based on the actual physical audio sample's output rate. Having the two modes is necessary to ensure that there is no drift in the synchronization of audio and video. If a device does not support audio output then in both modes HalGetTime( ) should just return the time based on milliseconds from any fixed starting point. There is no time of day or calendar date available; however they may optionally be provided.

Hardware Abstraction Layer Functions for the Story Playback Engine Core

The functions that the Hardware Abstraction Layer (HAL) provides to the SPE core are listed in Table 2. Note that by programming convention all HAL function names use “Hal” as a prefix.

TABLE 2

| Exemplary HAL Functions | Remarks |
|---|---|
| SFILE *HalOpenFileByNameForBinaryWrite | Normally |
| ( | used for |
| SCHAR *pFileName | debug |
| ); | system |
| | only |
| SFILE *HalOpenFileByNameForBinaryRead | Normally |
| ( | used for |
| SCHAR *pFileName | debug |
| ); | system |
| | only |
| SU32 HalWriteFile | Normally |
| ( | used for |
| SFILE *pFile | debug |
| SU8 *pBuffer, | system |
| SU32 u32_NumberOfBytesToWrite | only |
| ), | |
| Void HalOpenFileForBinaryRead | Used by |
| ( | story |
| INPUT_FILE_INFO_TYPE *pFileInfo | player |
| ); | |
| Void HalExit | Used by |
| ( | story |
| S32 s32_ExitCode | player |
| ); | |
| SU32 HalReadFile | Used by |
| ( | story |
| SFILE *pFile, | player |
| SU8 *pBuffer | |
| SU32 u32_NumberOfBytesToRead | |
| ); | |
| SU32 HalReadInputFile | Used by |
| ( | story |
| SFILE *pFile | player |
| SU8 *pBuffer, | |
| SU32 u32_NumberOfBytesToRead | |
| ); | |
| Void HalPositionFile | Used by |
| ( | story |
| SFILE *pFile | player |
| SU32 position | |
| ); | |
| Void HalCloseFile | Used by |
| ( | story |
| SFILE *pFile | player |
| ); | |
| Void HalDebugOut | Used by |
| ( | story |
| SCHAR *pMessageString | player |
| ), | |
| Void HalUninit(void), | Used by |
| | story |
| | player |
| Void HalInitHardware | Used by |
| ( | story |
| SRECT | player |
| *pVisableDisplayRequestedRectangle | |
| ); | |
| SU32 HalAllocateMainMemoryBlock(void); | Used by |
| Void HalSetHalInfoSizeRectangle | story |
| ( | player |
| DISPLAY_DESCRIPTOR_ELEMENT_TYPE *pDescriptor | |
| ); | |
| Void HalDisplay | Used by |
| ( | story |
| DISPLAY_DESCRIPTOR_ELEMENT_TYPE *pDescriptor | player |
| ); | |
| Void HalProcessInput(void); | Used by |
| | story |
| | player |
| void HalClearEntireDisplay(void); | Used by |
| | story |
| | player |
| SU32 HalGetTime(void); | Used by |
| | story |
| | player |

The Story “ST(s)” Macro

All double quoted C syntax constant strings should be placed inside the STO macro. This is normally defined just to keep the double quoted string as is, but on some systems it may be necessary to redefine the STO macro so that the compiler can support both ASCII and UNICODE strings.

Data Variable Restrictions

C Bit Fields are preferably not used. The size and order of bits within integers will cause portability problems between little and big-endian machines.

No Structures In Interfaces Unless Linked In

When interacting between programs that are not compiled and linked together, you cannot assume that the structure offsets and sizes will match. You should use exact #define-based offsets based on byte size units instead of structures.

Dealing With Pointers

Pointers can have a size different from that of integers on some processors. So, it is important never to assume anything about the size of pointers. Also for security, robustness and portability reasons, no pointers should be stored on a Story Thread input buffer, thread stack, or in the main allocated memory block.

Small Size

Compression algorithms were selected to make for small de-compressors with low CPU requirements. Having a procedural representation allows for a small number of functions to be coordinated by procedural control to do a wide range of things, keeping the playback code small. All data is kept aligned on a four-byte boundary and accessed as 32 bit unsigned words. This eliminates the need to have code to convert and compare values of different sizes and allows us to use the same functions to operate on different types. All this results in smaller playback engine code size

The operations carried out by the story playback engine (SPE) are designed to be simple at the expense of complexity to the programmer or compiler that generates Stories. For example, there is no memory allocation related garbage collection because that would require a good deal of code to implement and present real-time execution uncertainties. Instead, the programmer, compiler or generator should explicitly specify with an INIT_OP operation (See description of INIT_OP operation elsewhere in this description) exactly how much memory will be required for execution until the next INIT_OP operation will be executed. At least one INIT_OP operation should be present in each Story, and executed near the beginning of the Story playback.

Multi-Threading Playback Engine Interface

The SPE creates its own cooperative multi-threading runtime system. The interface to the playback engine consists of two functions. The function void_InitStoryPlayback(void) is called once, then SINT StoryPlaybackCycle(void) is called repeatedly in a loop so long as the return value is positive. An example loop used for a single threaded Windows 32 bit implementation follows:

InitStoryPlayback( );

while ((iReturnCode=StoryPlaybackCycle( ))>0)

{

myYield( );

}

Notice that the myyield( ) call allows other Windows application functions an opportunity to run independently from the playback engine on the same host operating system (OS) thread that the playback engine is running on. The interface is designed this way so that the playback engine could run on devices that do not have a host-based multithreading system.

Run-time Requirements

The Story compiler tools or Story author should ensure that no set of active threads can take more than 1/30 second before returning to the main cycle loop when running on a 300mhz Pentium (or equivalent) processor. This is to ensure that smooth video playback is possible on high end devices, and that non-Story features of a device controlled by the CPU will still be able to have a responsive user interface.

Speed

Optimize individual functions invoked using single flag change automated by the release flag Speed of automated customized Story content generation is aided by having recursive indirection in the PBE for all input.

Compression Algorithms and Procedures

Various compression/decompression schemes and algorithms are known in the art and may be utilized in conjunction with the invention. In one embodiment, Story Files encapsulate all multimedia content using just three fixed compressions schemes; however, support for all video and audio formats can be supported by transcoding files from these formats to a procedural Story representation at the time that Stories are created.

In one embodiment of the invention, LZSS compression is typically used for Text, Native Executable code, Story Format Code, and some Discrete tone pictures. ADPCM is used for two-channel Music and one-channel voice. Discrete Cosine Transforms (DCT) are used for continuous tone pictures and corrections for motion compensation equivalent functionality provided by use of Story instructions which result in the copying of rectangular areas from exiting pictures to ones being built by the Story procedures. Graphics operations are advantageously handled procedurally. For motion compensation equivalents, compression of video streams can be encoded as a sequence of compressed isolated frames, but taking advantage of the redundancy between adjacent frames normally improves the compression effectiveness by a factor of about three. Story instructions can be used to move any rectangular area of any existing uncompressed picture to anyplace in a picture buffer into which a new picture is being decompressed. This rectangular area can serve as the starting point for corrections applied using Inverse Discrete Cosine Transform (IDCT) results. To perform these operations there are instructions to move rectangles, average source rectangles with the target pixels, and add IDCT results to target 8×8 pixel areas in the target picture buffer.

A picture operation (PICTURE_OP) instruction with flags is provided to indicate to move a rectangle from a source picture buffer to a target picture while applying unary, binary, filtering, scaling, rotating, and/or fading operations to the source and target pixels.

Special Effects

Special Effects may also be accommodated, including internal animation, compositing, translations, rotations, fades, scaling, and the like. PICTURE_OP instruction will be able to perform compositing, rotations, fades and scaling similar to Macromedia Flash technology, but using pixel graphics operation in addition to the mainly vector graphics operations of Flash. Translation can be performed as part of the DESCRIPTOR_OP and LAYOUT_OP instructions.

Coding Rules/Conventions

Master Story Configuration File (stConfig.h) With Single Release Define

The Portable Playback Engine will become part of many applications across many platforms. Conveniently, steps are taken to document and maintain version release control for the story playback engine Embodiments of the inventive system used a two-fold approach. First, as many aspects of building a release will be automated as much as possible. This ensures that there is a way to determine exactly what files and actions are used to build each release. Also, it reduces the likelihood of making simple human mistakes Second, each build will be dependent on making one #defined release-specific symbol have the value one and all other #defined release symbols have the value 0. All other build level and type related #defines will be automated based on the release symbols. See the stConfig.h file to see how this is presently done. No make system or build environment #define equivalents should generally be used, as this makes it difficult to set up new compiler and platform builds without a lot of auxiliary information. All source files should desirably be included in each build. Files that should not be contributing code to the release should use #defines ultimately based on the #define release symbols to decide whether the code for that file needs to be generated or not. This may result in many files compiling into effectively null object files, but modern the compilers and linkers will not waste much time on these. It should be noted that the Playback Engine code is pretty small and compiles and links pretty fast even with all these build rules.

One Global Structure Facilitates Speed And Small Code Size

Global variables are a bit more efficient in terms of code size and execution speed, but having a lot of global variables will create problems when we want to make a C++ object out of the playback engine code. Although C++ is not as efficient as C code, C++ compatibility is desirable because it will make it easier to integrate into C++ applications. Also, C++ makes it easy to build applications that require multiple instances for the player, such as authoring systems. Besides the efficiency issues, we should preferably not use C++ for the core portable engine code because we want the playback engine code to run on Digital Signal Processors for which there may not be C++ compilers available.

To maintain compatibility for both C and C++ and to take advantage of the efficiency of global variables, the SPE code contains exactly one Global Variable. That variable, “p” is of type STORY_PLAYBACK_TYPE. (The STORY_PLAYBACK_TYPE is defined in stTypes.h.) It is a multi-level structure containing all the individual variables used throughout the SPE code. One may note that many functions, in particular the op-code specific functions, do not take any parameters or return any values. Instead everything is passed in the global, “p”. This eliminates the code and execution time that it takes to pass and return parameters.

When it is desired to make a C++ Story Playback object out of the SPE Code it is only necessary to make “p” a member variable of the Story Playback object class, and make the Core engine functions member functions.

A side benefit of having one global variable is that it makes looking at variables in a visual debugger very easy since you only need to have one variable in a watch window and all the terminal variables are organized logically by structure.

Special File Types

The portable files should preferably not use any C or C++ variable types directly. Instead it is preferred to always use one of the Story Types as typedefined below in a code fragment that is compiled in when USE_{—}32BIT_VISUAL_C_PLUS_PLUS_TYPES is not zero.

Fixed Size and Alignment of Data

We have chosen to use 32-bit variables wherever possible. Most of these are unsigned 32 bit variables of type SU32, but where it is necessary to have signed numbers then we use the S32 type. Using these sizes makes for less conversion code on most platforms and reduces the types of errors that show up when porting to different platforms. 32 bits was also chosen because it can represent a wide range of values, and on most processors, variables on 4 byte boundaries result in efficient data accesses

TABLE 3
Exemplary Embodiment of File for Story Code Root Data Types

/* This file defines all the root data types for portable Story code */
#if USE_32BIT_VISUAL_C_PLUS_PLUS_TYPES
typedef unsigned char SU8,
typedef unsigned char *PSU8;
typedef unsigned int SU32;
typedef unsigned int *PSU32;
typedef signed char S8;
typedef signed char *PS8;
typedef int S32;
typedef int *PS32;
typedef SU32 SBOOL;
typedef void SVOID;
typedef void *PSVOID;
#endif /* USE_32BIT_VISUAL_C_PLUS_PLUS_TYPES */

Run-time System, System Start-Up, and Instruction Processing

In another aspect, the invention provides a system, device, method, computer program, and computer program product for cooperative application-level multi-thread execution including instruction retry feature upon identifying constrained system resource. This aspect is now described in greater detail.

Initialization of Variables and Main Memory

The one global variable “p” is initialized to all zeroes when void InitStoryPlayback(void) is called before the first play cycle. Also, the one memory block allocated by the HalAllocateMainMemoryBlock( ) call in the InitOp( ) function is zeroed just after it is allocated. Knowing that all variables and main memory start with a zero value eliminates the need to have code to initialize individual values, and makes the code more robust because it always starts in a known state. Many variable values, such as thread states are defined so that a zero value represents the initial state desired. Likewise the pointer table to buffers, and all buffer memory can be assumed to initially have zero values. Note that the CreateBufferOp( ) function does not zero the buffer memory. If the same buffer is created a second time, then the header and data of the buffer will still contain its old values until these are explicitly specified. Another exception to the zeroing rule is the stack and input buffer for thread 0. One should not assume anything about the starting state of the stack and input buffer memory contents for thread 0. This is done on purpose so that thread 0 can run the first INIT_OP instruction that does the allocation of the one main memory block. Also, because they are not zeroed, the stack and input buffer of thread zero can be used to retain state when the main memory block is reinitialized over and over again by multiple INIT_OP instructions.

Story File Packing and Unpacking

Logical Story files contain a part of a final packaged Story File. Logical files are accessed by the portable code, not by name, but rather by a number pair, the content ID (contentId) and the current file number (currentFileNumber). By convention, the contented identifies like data types. For example, contentld=0 is normally used for the main startup and control procedures, while contentld=2 is used to store pictures and video. Separating like data into separate logical files allows for better compression and quicker access to consecutive data due to the file caching techniques employed by many device file systems.

Story Procedural Sequences and Story Instruction Processing

Story Content is encoded as sequences of 32-bit unsigned values. Each value represents either an op-code or an op-code parameter. The next value to be accessed is pointed to by an instruction pointer (IP). In one embodiment, content or story playback begins with the Instruction Pointer (IP) pointing to a value that represents an op-code. Playback then proceeds according to steps (a)-(f), as follows:

(a) The value of the op-code pointed to by the IP is fetched.

(b) The IP is moved to point just past the op-code.

(c) The value of the op-code is used as an index into an array of function pointers to call a C function that implements the op-code function.

(d) The function then fetches the op-code specific parameters which follow the op-code. The IP pointer is advanced as each parameter is fetched.

(e) The number and type of parameters is specific to the op-code. The number and types of parameters following the first can change based on the values of previous parameters.

(f) When the C function for an op-code is finished performing the instruction it returns a status code. Most instructions will return a code with the value, SUCCESS_RETURN_CODE (which has the value 0).

Story Playback Engine Threading And Synchronization

Each Story Playback Engine (SPE) thread executes one sequence of instructions/parameter values Each thread has a context, which includes its own IP, a stack mostly used for calling Story subroutines, and an input buffer to hold the sequence of values as it is executing. The input buffer can be tied to a specific file that holds the thread's sequences of instructions that are not resident in memory.

When a Story Begins playback a file with contentID of 0 is automatically opened and the first thirty-two 32-bit words are read into Story thread number 0's input buffer. It is then up to the procedural sequence in the first thirty-two words to boot-strap the rest of the Story playback, including allocating all buffer memory and the creation of other threads. All threading and synchronization of the actions of threads, for example synchronizing a thread that is playing audio and another that is playing video, is performed using a very lightweight technique we call, “Instruction Retry Upon Resource Constraints.” Normally, the C language functions that implement individual opcode's functionality return with a status equal to SUCCESS_RETURN_CODE, but other return code values can be returned. YIELD_TO_NEXT_THREAD_RETURN_CODE will be returned when it is time for the thread to give up control of the CPU and move on to the next thread. RETRY_INSTRUCTION_RETURN_CODE will be returned when an instruction cannot perform the operation called for by the op-code and its parameters because it encounters a resource constraint. One example of a resource constraint situation is when a TIME_OP op-code that is set to wait for a particular time to occur, but it is not that time yet. In this case, the op-code returns the RETRY_INSTRUCTION_RETURN_CODE. When the outer instruction dispatch loop sees that an instruction returned such a code, it resets the IP for the thread to point back to the op-code it just tried to execute. Then it starts up the next thread. After all other threads have had an opportunity to run, the TIME_OP thread will run again and try to execute that same instruction again. In this manner the thread will effectively wait for a resource, the time at which to continue the sequence, to occur without blocking the other threads. Similarly, a thread can wait to decode a picture into a particular buffer until another thread empties the buffer and releases it for use by other threads.

Each thread always has exactly one of the three states defined below:

/* Thread context states */

#define UNINITIALIZED_CONTEXT_STATE 0

#define RUNNING_CONTEXT_STATE 1

#define SUSPENDED_CONTEXT_STATE 2

Memory Allocation

Memory allocation is done as part of the functionality of an INIT_OP instruction. Except for the Input and Stack buffers of thread 0, all memory that is to be used until another INIT_OP instruction reallocates (and thereby destroys all past memory allocations) is desirably allocated as one big main memory block allocation performed during the execution of the INIT_OP. From within this main memory block, buffers are created to hold pictures, audio samples, subroutines, text and even the stack and input information for all but the very first thread. Allocating memory in this manner allows for security checks to be performed with a small amount of code, and avoids the need for any complex and lengthy garbage collection algorithms.

Thread 0's stack and input buffers are allocated by the C compiler as a static array of characters inside of p. This allows the first thread to run even before any memory allocations are performed. Thread 0's static buffers can serve as a place to save parameters that you want to survive a new INIT_OP memory allocation.

Buffers

The INIT_OP that performs the main memory block allocation also sets aside an array of pointers to a set number of buffers to hold Story playback data. The array of buffer pointers resides at the top of the main memory block allocation. They are initialized to zero, as is all memory in the main block. CREATE_BUFFER_OP instructions are used to create buffers from within the main memory block Each buffer is created with a maximum size in bytes, including space for a buffer type-specific header that precedes that actual buffer data area. The header is pointed to by an entry placed into the array of pointers. The index of the pointer in the array is the buffer number. The type of header is determined by a 32-bit properties field at the same beginning offset of all buffer headers. The rest of the fields in the header are specific to the particular property value. Buffers types are indicated in the property field as a buffer kind value specified by a #defined value that ends in the suffix, “_BUFFER_KIND”.

All buffer headers and data elements should be aligned on four-byte (or other predetermined size) boundaries for efficiency of access and portability reasons. So, for example, a TEXT_ASCII_ARRAY_BUFFER_KIND buffer that contains three one-byte elements must also have one padding byte on the end so that the total size is a multiple of 4 bytes. Similarly, picture buffers should have the distance between rows of pixels always be a multiple of 4 bytes, even if the picture is not a multiple of 4 pixels wide.

There are two generic types of buffers: singletons and arrays. Arrays have a common array buffer structure as part of each buffer header immediately after the common buffer structure. An array can be used to hold any type of data, but each element in the array list should be exactly the same size as every other element in the array. Array element size and the number of current elements in each array are specified using an ARRAY_OP instruction and stored in the common array structure part of the buffer header. By convention, all buffer kinds that are arrays end in the suffix, “_ARRAY_BUFFER_KIND”.

In one embodiment of the invention, the Singleton Buffers include:

PICTURE_RGB_BUFFER_KIND, PICTURE_YUV_BUFFER_KIND, AUDIO_{—}8000_PICTURE_BUFFER_KIND, AUDIO_{—}44100_PICTURE_BUFFER_KIND, and INPUT_THREAD_BUFFERS_BUFFER_KIND.

Each of these Singleton buffers are now described. In one embodiment, the PICTURE_RGB_BUFFER_KIND has R, G, B and alpha, but other formats and structures as are known in the art may also be used. In one embodiment, the PICTURE_YUV_BUFFER_KIND has three planes in 4:2:0 Y Cb Cr format (like MPEG 1 and JPEG). Each active input thread, other than thread 0, needs to have a single buffer associated with it to hold both the stack and input buffer. How much of the buffer data is assigned to each is determined by parameters to the THREAD_OP instruction, but in no case should either buffer be less than 4 bytes in size.

Array Buffers

In one embodiment, seven array buffers are provided, they are:

DISPLAY_DESCRIPTOR_ARRAY_BUFFER_KIND, HOTSPOT_ARRAY_BUFFER_KIND, TEXT_ASCII_ARRAY_BUFFER_KIND, TEXT_UNICODE_ARRAY_BUFFER_KIND, EIGHT_BIT_VARIABLE_ARRAY_BUFFER_KIND, THIRTY_TWO_BIT_VARIABLE_ARRAY_BUFFER_KIND, and SUBROUTINE_ARRAY_BUFFER_KIND.

Indirection, Indirect Linking, Recursive Indirection, and Nested Indirection

All op-code and parameter values that are fetched from a thread's input buffer can specify indirection. Rather than containing a value for use, when indirected, the value fetched from the input buffer specifies how to get a value to use. The top two bits of each 32-bit value in the input buffers are “01” when used for indirection. Any op-code or parameter values that have the top two bits “01” that are not intended to indicate indirection, should be encoded as an IMMEDIATE_INDIRECTION value (top two bits are “01”, other bits have the combined value of 2) followed by the actual value. Many of the indirection values must be followed in the input stream by other parameters that help to specify the actual target value. Using the two top bits allows one to have a 30 bit range of two's-complement numbers that do not generate bit patterns that could be misinterpreted as an indirection. Note that it is important to use at least two bits to indicate indirections. For example, a scheme using only the top bit would not be able to represent even small negative numbers without the need for an IMMEDIATE_INDIRECTION. Indirect scalar values are used to reference individual 32-bit values and in one embodiment include the following

#define INDIRECT_BUFFER_NUMBER 0x040000002

#define INDIRECT_TARGET_BUFFER_NUMBER 0x040000004

#define INDIRECT_TIME 0x040000005

#define INDIRECT_IMMEDIATE_VALUE INDIRECT_BUFFER_NUMBER

#define INDIRECT_RECTANGLE_ELEMENT_VALUE 0x040000001

Indirect array values are used to reference values inside an array buffer and data area and include the following:

#define INDIRECT_ARRAY_VALUE 0x040000000

#define INDIRECT_ARRAY_VALUE_AT_OFFSET 0x040000003

Indirect rectangle values are used to reference individual sets of four 32-bit values representing the x,y location and width and height of a rectangle and include the following:

#define IMMEDIATE_RECTANGLE_SELECTOR 0x40000003

#define LAYOUT_BOUNDING_RECTANGLE_SELECTOR 0x40000004

#define HAL_VISABLE_BOUNDING_RECTANGLE_SELECTOR 0x40000005

#define LAYOUT RECTANGLE SELECTOR 0x40000006

#define PICTURE_BUFFER_MAIN_RECTANGLE SELECTOR 0x40000000

#define PICTURE_BUFFER_DISPLAY_RECTANGLE_SELECTOR 0x40000001

#define PICTURE_BUFFER_ACTIVE_RECTANGLE_SELECTOR 0x40000002

Indirect post-operations are used to perform calculations of a wide variety of possible arithmetic and/or logical expressions. Any op code can have any mathematical expression of almost any complexity using this feature. Indirect post-operations include the following:

#define INDIRECT_POST_OPERATION_SELECTOR_FLAG 0x40000000

#define CHANGE_RELATIVE_IMMEDIATE_RECTANGLE_FLAG 0x00010000

Indirect Linking is one of the most powerful uses of indirection and automatically links Story Segments (procedural sequences of op-codes and parameters that perform specific tasks) into working Stories in which all the Segments interact. When used in a story message based email messaging system (StoryMail), this allows the StoryMail server to generate a multitude of custom Story format messages, each optimized on the fly to conform to device capabilities and user preferences, just by concatenating the right mix of Story Segments into logical Story files and then top-level compressing and packaging those logical files into a Story file. Because the Segments link themselves using redirection at the time that the Story is played, there is no need for the Server to perform complex an inefficient relocation and linking operations. Thus indirection allows a single message generating server to generate many times as many messages per given unit of time, advantageously reducing the number and cost of servers needed to implement a customizing message email system for a given amount of traffic.

Recursive Indirection is also supported. An indirect value can refer to another indirect value, this is referred to as recursive indirection. To guard against native processor stack overflow, in one embodiment, the recursion is limited to 16 levels, but this is not a fundamental limitation to the inventive method. Recursive indirection using post operation features can be used to specify a wide range of mathematical expressions involving a multitude of operations and values for any parameter. It would be an unusual use, but even the opcode value can be derived from the use of recursive indirection, allowing dynamic code generation.

Display Layout

Like many other aspects of stories, the screen layout of displayable elements is performed procedurally. The following steps are commonly used in different aspects of the inventive method and procedures:

1. Each element to be rendered is assigned to a display descriptor (DisplayDescriptor) element of a display descriptor (DisplayDescriptor) array buffer. This is done using the display descriptor operation (DISPLAY_DESCRIPTOR_OP). Each display descriptor contains a buffer number that contains the data to be displayed (e.g. a picture buffer number).

2. The set rectangle operation (SET_RECTANGLE_OP) is used to set the layout rectangle (layoutRectangle).

3. The layout operation (LAYOUT_OP) is used to place a list of display descriptors (DisplayDescriptors) inside the layout rectangle (layoutRectangle). The horizontal center then vertical center layout method (HORIZONTAL_CENTER_THEN_VERTICAL_CENTER_LAYOUT_METHOD), may for example, among other possible methods be utilized.

4. The layout rectangle (layoutRectangle) is reset to layout something else according to the results of a previous layout operation (LAYOUT OP).

5. If there are more elements to be laid out then the set rectangle operation (SET RECTANGLE OP) is applied for each element. Branching flags are set if a LAYOUT_OP operation found that an item does not fit at all, did not fit horizontally and was wrapped to fit below, and if the layout went outside the layoutRectangle in the vertical direction Jump instructions can therefore be used to perform complex procedural layout operations.

Logical Element Hot Snot Array

Hotspot array buffers contain elements called hotspots that contain information about a logical element of a message. This information includes a set of flags indicating the type of element represented, an optional buffer number that holds text describing the element, and an optional buffer number that contains a subroutine to be executed if the element is selected by the user. Example hotspot flags are the:

SELECTION_SUBROUTINE_AVAILABLE_HOTSPOT_ELEMENT_FLAG, and VISABLE_HOTSPOT_ELEMENT_FLAG.

If these two flags are set in a hotspot, then that hotspot occupies a rectangle on the screen, and the user can select that hotspot. If the user selects the hotspot the subroutine in the buffer number contained in the hotspot will be executed.

Run-time Security, Conventions, and Threaded Model

Run-time security is advantageously provided in order to prevent viruses or malicious software code from being encoded as a story or as a side effect from being played as a story. Security is also intended to protect against crashing or hanging the target device as a result of a incorrectly generated, corrupted story or story impersonator. Techniques for providing such security such as the memory allocation procedures, using a small number of memory buffers, “sandboxing” and other techniques are described elsewhere in this application.

In a preferred embodiment of the invention, there can be up to 8 active threads in a Story.

Each thread is addressed as an index from 0 to 7. Thread 0 is special because it has its own statically allocated stack and input buffer located outside of the main memory block. Also thread 0 is always started automatically when Story Playback begins. All the other threads, 1 through 7, are logically equivalent in operation, but should follow the following usage conventions in order to allow for good reuse of Story Segments and subroutines. Following this convention also results in more reliable programs because the design ensures that playback of multimedia Stories is largely deterministic. Conventions for threads are listed immediately below:

/* Convention for threads *1

#defineMAIN_CONTROL_THREAD_INDEX 0

#define HAL_INPUT_THREAD_INDEX 1

#define PICTURE_DECODE_THREAD_INDEX 2

#define PICTURE DISPLAY THREAD INDEX 3

#define AUDIO_DECODE_THREAD_INDEX 4

#define AUDIO_PLAY_THREAD_INDEX 5

#define SPECIAL_EFFECTS_THREAD_INDEX 6

#define AUX1 THREAD INDEX 7

Content ID (contentId) values are described above and in one embodiment, include, but are not limited to the values listed below.

#define CONTROL_FILE_ID 0

#define AUDIO_FILE_ID 1

#define PICTURE_FILE_ID 2

#define TEXT_FILE_ID 3

Semantic Flags or other indicators and text are provided as backup behind every logical element to support content and media-richness scalability. Although the presence of text and semantic flags is not enforced by the run-time code, all elements key to the intent of a Story message should have these since they will allow the message to play in any device or be automatically read or operated using only an audio phone call. In general, before playing back rich media, the Story Message should procedurally check that the device has the capabilities and resources necessary to play back the rich media elements used. If the device cannot support the rich media playback, then a less-rich media version of the message should be played. If no rich-media versions can be played, then a text version should be played as a lowest common denominator representation of the Story Message.

Exemplary Story Instruction Types and Instruction Set

An exemplary instruction set is now described. It will be understood that this instruction set and the operation codes (op-codes) and op-code values associated with it are exemplary and not limiting of the invention. It is described to assist in understanding the structure and function of the stories, the manner in which they are generated, and the manner in which they may be played or rendered on a wide range of devices. It is also to understood that some operation codes may be eliminated and others added.

Op-codes are small positive numbers that correspond to programmatic Story operations that are carried out by a specific C function that normally has a name based on the op-code name. Story instructions are opcodes followed by whatever parameters will be expected by the op-code's C language implementation function during its execution. In general the parameters needed to follow each op-code are op-code specific, and in fact the parameters expected can depend on previous parameters in any way that can be implemented programmatically in the C functions that implement the op-code functionality and parameter indirection. So parameter use can be complex, but there are some rules and conventions.

Firstly, most op-codes can perform a sequence of sub-operations. Each sub-operation may or may not be optional; however, the order of sub-operations is always processed in a given order. In general op-codes that have optional sub-operations are indicated by the first parameter that follows the op-code number. This parameter is a “Flags Parameter”. The Flags Parameter contains a set of predefined bits, one for each sub-operation. In preferred embodiments of the invention, a convention is established such that the flags are always numbered in the order that the op-code's C function will execute sub-operations, and retrieve sub-operation parameters from the input buffer. Also, the sub-operations are always executed from lowest order bit to highest. Different conventions may alternatively be adopted.

Memory access with indirection as provided for in some embodiments of the invention is a novel approach, particularly when used with a JUMP OP operation to an absolute offset.

Conventionally, relative addressing is provided for in addition to absolute addressing. In embodiments of the invention, one can specify an initial position of the program counter (PC) as an indirection, then specify that the indirection involves a post-operation. Thus all absolute addresses can be used for relative addressing, and multiple forms of addressing are not required, yet the functionality is provided. This same technique can be applied to other ordinarily absolute op-code parameters such as to provide a relative time to wait in a TIME_OP parameter.

TABLE 4
Selected Exemplary Op-Codes and their Description

| OpCode Type/Name | Description |
|---|---|
| Initialization | |
| Op-codes | |
| INIT_OP | Initialize hardware and/or initialize |
| | main memory allocation |
| LOAD_OP | Load input data from the logical |
| | file into the thread's input |
| | buffer and/or a memory buffer. |
| Branching Op-codes | |
| JUMP_OP | Transfer control to a different section |
| | of the procedure. |
| END_OP | End the subroutine and return control |
| | to the caller. End the thread if there |
| | is no caller. |
| THREAD_OP | Create or modify a new or existing |
| | thread's status or procedure. |
| YIELD_OP | End current thread's current execution |
| | to allow other threads to run |
| | until this thread's turn to execute again. |
| CALL_SUBROUTINE_OP | Call subroutine. |
| Memory Op-codes | |
| CREATE_BUFFER_OP | Create or modify a buffer inside the |
| | main memory allocation and/or |
| | sets its characteristics. |
| DECOMPRESS_OP | Starts execution of a subroutine in a |
| | specified logical file after setting |
| | a target buffer. |
| PICTURE_BUFFER_OP | Sets or modifies characteristics of a |
| | picture buffer. |
| SET_RECTANGLE_OP | Change or sets a rectangle's values. |
| HOTSPOT_OP | Change information inside a hotspot |
| | buffer. |
| ARRAY_OP | Change information inside an array |
| | buffer. |
| Calculation Op-codes | |
| COMPUTATION_OP | Perform arithmetic and/or logical |
| | expression computation. |
| Display Op-codes | |
| DISPLAY_DESCRIPTOR_OP | Modifies values in display descriptor |
| | element. |
| LAYOUT_OP | Performs a layout operation on a set of |
| | display descriptors. |
| DISPLAY_OP | Causes the data in a buffer or set of |
| | buffers to be rendered. |
| Time Op-codes | |
| TIME_OP | Sets time value, the time mode, and |
| | other time operation characteristics. |

Exemplary Story Instruction Types and Instruction Set Parameters

The parameters for COMPUTATION_OP define an Operation and have a SourceValue1. If (Operation&1==0) then there is a second parameter, SourceValue2. The parameters also identify a destination for the final computational result. For Computational Operation value defines, the low bit is used to determine how many parameters an operation needs. If the low bit is 1 then only 1 parameter is needed, else two parameters are needed. The following provides examples of Unary and Binary operations.

/* Unary computational operations (must be odd)*/

#define COPY_COMPUTATIONAL_OPERATION 1

#define BITWISE_NOT_COMPUTATIONAL_OPERATION 3

#define TWOS_COMPLEMENT_NEGATE_COMPUTATIONAL_OPERATION 5

/*Binary computational operations (must be even)*/

#define BITWISE_SHIFT_COMPUTATIONAL_OPERATION 0

#define BITWISE_AND_COMPUTATIONAL_OPERATION 2

#define BITWISE_OR_COMPUTATIONAL_OPERATION 4

#define BITWISE_XOR_COMPUTATIONAL_OPERATION 6

#define ADD_COMPUTATIONAL_OPERATION 8

#define SUBTRACT_COMPUTATIONAL_OPERATION 10

#define MULTIPLY_LOW_COMPUTATIONAL_OPERATION 12

#define MULTIPLY_HIGH_COMPUTATIONAL_OPERATION 14

#define DIVIDE_COMPUTATIONAL_OPERATION 16

User Input Op-codes are also provided and include the HAL_PROCESSING_OP instruction opcode. It does not require any op code parameters. When the HAL_PROCSSING_OP C function runs, it calls the HAL function, void HalProcessInput(void) during which user input will be processed. The HalProcessInput( ) function can respond to user input by calling void UtilCallSubroutine(SU32 u32_SubroutineBufferNumber), so that the indicated Story subroutine will run immediately upon return from the HAL_PROCESSING_OP instruction's C function. For example, the HAL PROCESSING OP instruction is normally used in a looping sequence on the input thread (thread 1 by convention), such as the procedure:

HAL_PROCESSING_OP

YIELD_OP

JUMP OP(LOGICAL_OFFSET(0))

The HAL function can use this call to look for any user input, such as for example, the user selection of a button corresponding to a hot spot

Having now described a variety of features and characteristics of embodiments of Story Files, it will be apparent to those having ordinary skill in the art in light of this description that the invention provides numerous innovations and advantages over conventional systems and methods. By way of highlighting selected ones of these innovations, the characteristics of several are described immediately below.

Single Language Instructions for Wide Range of Applications and Devices

The invention further provides a system, device, method, computer program, and computer program product for a hardware architecture neutral computer program language and structure and method for execution.

Embodiments of the story file format, story organization, programming language conventions, run-time playback engine, and the like have been described in considerable detail above. These and other features of the inventive system, separately and in synergistic combination provide powerful yet fast and efficient message communication features. In addition, these features are adapted for single language implementation over a broad range of application programs, application platforms, operating systems, and devices.

In a preferred embodiment of the invention, a single computer programming or code language is used for all instructions and procedures in all story applications and devices. By way of example but not limitation, this common language set of instructions is used for (i) navigation, (ii) decision making, (iii) scaling, (iv) decompressing, (v) setting, using, and calculating parameters, (vi) generating other data and/or procedural streams; (vii) parsing, formatting, and selecting text and other media elements such as images, graphics, and audio; (viii) responding to item selection by a story player user, (ix) requesting further files during streaming, (x) formatting XML (or XML extensions); (xi) formatting text; (xii) performing; validation of user input; (xiii) performing calculations, simulations, animations, special effects, signal processing, run-time scaling (e.g. scaling of pictures) and synchronization tasks, and the like. Advantageously, this single language set of instructions is compatible with and inter-operates with the cooperative threading model described elsewhere in this specification.

Note, that the playback engine or processor can be implemented as hardware or software/firmware/micro-code or a combination of hardware and software/firmware/micro-code and that the invention provides a method independent of the particular computer code structure involved. The entire processor can for example, be implemented in hardware with a hardware instruction set. The preferred embodiment of the playback engine is implemented in software so that it may be implemented on any hardware platform and be adaptable to various hardware platforms that we designed and/or made before the story file format, system, and method were available. At least some embodiments of the invention may be implemented using a complex instruction set suitable for a specialized processor.

The system is platform portable and may readily be integrated with or adapted to many computer, telephone, personal communicator, personal data assistant (PDA), point-of-sale display, venting machine, various interfaces, and almost an unlimited variety of electronic devices or machines having electronic components capable of executing the story playback engine code. It is therefore highly architecture neutral. The user interface is not constrained and may be readily adapted to a variety of system, software, operating system, and device input/output interface characteristics. For example, the input and/or output may separately or together be visually based, audio based, tactilely based, or rely on any other human or machine sense. While the story interaction is described in the context of filling out a form, it will be appreciated that this form can be of any variety and need not be text, graphical, or visual. It may instead, for example, include articulated prompts and accept spoken user responses. It is therefore user access and perceptual neutral as users may access its capabilities over a telephone or any other communication device or system, and motor and/or sensor challenged individuals may readily access and perceive the results of such access.

Therefore, it will be understood that the invention provides a hardware architecture neutral executable program structure for execution in a processor. (This is an embodiment of a base program structure.) The program structure comprising: a plurality of instruction threads selected from a library of possible instruction threads; a plurality of data parameters integrated among at least some of the instruction threads and influencing execution of the instruction threads; and at least some of the selected instruction threads being adapted for cooperative execution with other of the instruction threads by yielding ownership of the processor upon the occurrence of a predetermined condition.

In one embodiment, the instructions comprise operation codes representing commands executable in a processor. In another embodiment, the predetermined condition comprises the yielding instruction yielding after a predetermined time period of ownership. In another embodiment, the predetermined condition comprises the yielding instruction yielding upon determining that a required resource is constrained. Here, the program structure may be further defined such that the constrained resource is selected from the group consisting of a memory buffer, an input device, an output device, an input/output device, a digital audio processor, a display device, a communication link, a communication bus, a buffer, a data compression processor, a data decompression processor, a vertical refresh signal (so user does not see display screen refresh), a time limit being exceeded or not yet being exceeded, and combinations thereof.

The program structure may also be defined such that the constrained resource is a constraining condition associated with the resource. The characteristics may for example be selected from the group characteristics consisting of: a buffer existing, a buffer not existing, a buffer being initialized, a buffer being uninitialized, a buffer holding a set of data, a buffer not holding a set of data, a buffer holding a subset of a set of data, a buffer not holding a subset of a set of data, and combinations thereof. Other characteristics may be selected from the group consisting of or including an input device, output device, or input/output device signaling that it is available, not available, has text, selection, location, textural or other input data available or not available, and combinations thereof. Alternatively or in addition, the characteristics may be selected from the group of characteristics consisting of: a digital audio processor, display device, a communication link, a communication bus, a buffer, a data compression processor, a data decompression processor, a vertical refresh signal being in a ready state, a vertical refresh signal not being in a ready state, condition where capacity or features are assured or not assured, and combinations thereof. Thus from the breadth and scope of these exemplary characteristics that may be used as the resource constraint, those workers having ordinary skill in the art will appreciate that many other alternative characteristics, devices, conditions and the like may be used with the inventive program structure, method, and computer program.

In at least one embodiment, the response to data or commands, or other input from a user includes responding by causing a program subroutine to be executed on the thread in which the input, data, or commands are detected.

The hardware architecture neutral executable program structure may also be defined such that instruction thread is selected from the group of instruction threads that: perform a navigation; make a decision, scale a data item; decompress a data item; set a parameter; use a parameter; circulate a parameter; generate data; generate a parameter or instruction stream; parse a data item; format a data item; select a data item; test a data item; respond to an input; send messages; receive messages; receive responses to messages; request file from a server or other source; store data; perform calculations; perform an animation; perform signal or image processing; respond to a data or command from a user; send a message; request a file; request additional data in a data stream; request data and/or commands in a stream of data and/or commands; navigate; make a decision; scale; decompress; set, use, and calculate parameters; cause audio to be rendered, cause video to be rendered generate other data and/or procedural streams; parse, format, and select text and other media elements such as images, graphics, and audio; respond to item selection by a story player user; request further files during streaming, format XML (or XML extensions); format text; validate user input; perform calculations, simulations, animations, special effects, signal processing, run-time scaling and synchronization tasks; and combinations thereof.

It may be further defined such that the data items are selected from the set of data items consisting of a digital image media data item, a digital audio media item, transition and special effects control data, and combinations thereof.

Alternatively, the program structure may be defined such that the response to a data or command from a user comprises responding to a command or data generated by a user button press from a device incorporating the processor. In another embodiment, the program structure may be defined such that the requesting additional data and/or commands in a stream of data and/or commands comprises requesting additional ones of the instruction threads integrated with the data parameters.

The base program structure may also provide that the cooperative execution is under programmatic control. The basic program structure may also or alternatively be defined such that the predetermined condition is either (i) yielding after a predetermined time period of ownership, or (ii) yielding upon determining that a required resource is constrained, or (iii) a combination of yielding after a predetermined time period of ownership, and yielding upon determining that a required resource is constrained. And this may be even further defined so that the resource being constrained comprises the resource being unavailable at the time access to the resource is required; or so that the predetermined time period of ownership is established programmatically.

The program structure may be defined such that a predetermined time period of ownership is provided as a parameter within the message.

In other embodiments, operation codes may for example, comprise integers and an association between the integer and an operation is identified by a table look up procedure, the integers providing a compact representation of the operations. In yet other embodiments, the program structure may include an instruction thread retry attribute associated with at least some of the possible instruction threads, the retry attribute causing the processor to repeatedly retry to execute an instruction thread that has yielded ownership of the processor either (i) after a predetermined time period of ownership, (ii) after running all of the active threads until each has yielded the processor, or (iii) upon determining that a required resource is constrained.

In yet still another embodiment, the base program structure may be further defined such that the instructions comprise operation codes representing commands executable in a processor; the predetermined condition comprises the yielding instruction yielding after a predetermined time period of ownership, or the yielding instruction yielding upon determining that a required resource is constrained; the constrained resource is selected from the group consisting of a memory, an input device, an output device, an input/output device, a digital audio processor, a display device, a communication link, a communication bus, a buffer, a data compression processor, a data decompression processor, a vertical refresh signal (so user does not see display screen refresh), a time limit being exceeded or not yet being exceeded, and combinations thereof; and the instruction thread is selected from the group of instruction threads that: perform a navigation; make a decision; scale a data item; decompress a data item; set a parameter; use a parameter; circulate a parameter; cause audio to be rendered; cause video to be rendered; generate data; generate a parameter or instruction stream; parse a data item; format a data item; select a data item; test a data item; respond to an input; send messages; receive messages; receive responses to messages; request file from a server or other source; store data; perform calculations; perform an animation; perform signal or image processing; respond to a data or command from a user; send a message; request a file; request additional data in a data stream; request data and/or commands in a stream of data and/or commands; navigate; make a decision; scale; decompress; set, use, and calculate parameters; generate other data and/or procedural streams; parse, format, and select text and other media elements such as images, graphics, and audio; respond to item selection by a story player user; request further files during streaming, format XML (or XML extensions); format text; validate user input; perform calculations, simulations, animations, special effects, signal processing, run-time scaling and synchronization tasks; and combinations thereof.

In addition to the architecture neutral structure, the invention also provides a method for cooperatively executing a plurality of code threads in a processor, the method comprising steps of: (a) communicating a plurality of code threads, including a first code thread and a second code thread, to a processor for execution; (b) setting a program counter for execution of the first code thread; (c) allocating ownership of the processor exclusively to execution of the first code thread and executing the first code thread until the first code thread completes execution, except stopping execution of the first code thread and yielding ownership of the processor by the first code thread during the execution to the second code thread upon the occurrence of a predetermined first code thread yield condition; (d) if execution of the first code thread has been stopped, then storing an indication that execution of the first code thread has been stopped, including a program counter value for the stopped first code thread, in a storage location; (e) setting the program counter for execution of the second code thread; (f) allocating ownership of the processor exclusively to execution of the second code thread and executing the second code thread until the second code thread completes execution, except stopping execution of the second code thread and yielding ownership of the processor by the second code thread to any other one of the plurality of code threads upon the occurrence of a predetermined second code thread yield condition; (g) reallocating ownership of the processor and re-executing the first code thread according to predetermined processor ownership reallocation rules; (h) retrying execution of the yielded first code thread including setting the program counter with the stored program counter for the stopped first code thread and re-executing the first code thread; and (i) repeating steps (b) through (g) for each of the plurality of code threads until each of the plurality of code threads has been executed.

This method may be further defined such that the predetermined first code thread yield condition comprises yielding after a predetermined time period of processor ownership. Alternatively, the method may be defined such that the predetermined first code thread yield condition comprises yielding upon determining that a resource required for execution is constrained. Or, it may be defined such that the predetermined first code thread yield condition and the second code thread yield conditions are each selected from the group consisting of: (i) yielding after a predetermined time period of ownership, or (ii) yielding upon determining that a required resource is constrained, and a combination thereof.

Embodiments of the inventive method may further define the above method such that the cooperative execution of the plurality of instruction threads is achieved by establishing the predetermined time period of ownership of at least selected ones of the plurality of threads as a instruction thread execution parameter communicated with the instruction thread.

The invention also provides a method for cooperatively executing a plurality of code threads in a processor, the method comprising steps of: sequentially executing a plurality of code threads until a predetermined code thread yield condition is detected for a particular code thread; stopping execution of the particular code thread for which the thread yield condition was detected; storing an indication that execution of the particular code thread was stopped before completion in a memory storage location; resuming sequential execution of the plurality of code threads at the next sequential code thread following the particular code thread; retrying execution of the particular code thread during the resumed sequential execution according to predetermined rules for preempting a next sequential code thread and retrying execution of the particular code thread in preference to a next sequential code thread.

This method for cooperative execution may optionally provide that the step of retrying includes storing an indicator for the preempted next code thread and retrieving the stored indicator for the particular code thread. It may further provide that the stored indicator for the preempted next code thread comprises a program counter value for the preempted next code thread, and the stored indicator for the particular code thread comprises a program counter value for the particular code thread that was yielded. These methods may additionally include the step of resuming the sequential execution of code threads after the particular code thread has been executed by retrieving the stored program counter value for the preempted next code thread.

The code thread yield condition may, for example, yield after a predetermined time period of processor ownership. The code thread yield condition may yield upon determining that a resource required for execution is constrained. The predetermined first code thread yield condition and the second code thread yield conditions are each selected from the group consisting of: (i) yielding after a predetermined time period of ownership, or (ii) yielding upon determining that a required resource is constrained, and a combination thereof.

Cooperative execution of the plurality of instruction threads may in some embodiments, be achieved by establishing the predetermined time period of ownership of at least selected ones of the plurality of threads as a instruction thread execution parameter communicated with the instruction thread.

Cooperative execution of the program instruction threads may achieved by detecting a resource constraint and returning a code to the instruction dispatcher to set the program counter to point back to the same returned instruction before yielding to the next thread.

The invention also provides for an instruction set for execution on a general purpose processor wherein the instructions are selected from those described herein. The invention further provides for a hardware processor implementing the capabilities described herein to provide a very simple and low-power low-cost multi-media player (independent of story content itself) applicable to many things. The invention further provides a multimedia player using the same or similar instruction set. Computer program and data structures as described are also included within the invention.

Automatic Fast Generation of Customized Stories from a Flat File Input

The invention further provides a system, device, method, computer program, and computer program product for autonomous generation of customized file having procedural and data elements from non-procedural flat-file descriptors.

Story procedures, messages and applications are designed to be automatically and rapidly generated from inputs in flat file format. For the purposes of discussion, there are three types of flat file input. The first one provides or points to the one time content values and elements. The second flat file contains or points to the per-instance content values and elements. And the third flat file input is used to customize the final form of the message. It should be noted that any one of the input files may be sufficient for generating a Story, and that the contents of the different flat files may or may not include the same elements. In cases where the same elements are included, usually the last input to be applied takes precedence (but this is not a requirement). Also, the three types of information provided by the flat files may be combined into one, two or any number of flat files.

The typical steps for automatic Story or Story Mail based message generation according to one embodiment of the invention are now described. This description is then followed by a description of a system that implements the story based message generation scheme.

(Step 1) The sender of the message selects a pre-prepared template that identifies the intent of the message. For example there may be ten different templates for creating various kinds of electronic product promotions. Other examples are templates for creating meeting scheduling messages. Templates can be very specific, for example, a StoryMail company final patent approval notification message with animated pictures of the patent authors. And templates can be very general, for example a template for generating a message containing a picture with a caption. The sender could be either a person or a computer program that automatically specifies messages to be sent out. The story can be any type of application in story format and is not necessarily a message.

(Step 2) The sender fills out a form using any of a number of possible user interfaces that conform to the template selected in Step 1. Form entries can be actual value and word entries, actual rich media data, or pointers to the actual values, word entries or actual rich media data.

(Step 3) The filled out form information gets converted to a computer structured flat file suitable for parsing by other computer programs. In a preferred embodiment the structured flat file format conforms to XML standards or to one of the XML extensions.

(Step 4) The flat file is fed as input into a template specific SEGMENTOR program. The SEGMENTOR program parses the flat file and reformats the information in the flat file or pointed to by the flat file into story procedural segments. Along with the segments themselves, the SEGMENTOR also outputs a flag selection value, a selected flag value, and properties of the segment. Such properties may include, but are not limited to, the width and height of a picture, the length of time of an audio stream, the color depth of a picture, and the like. In order to convert known media types, such as MP3, to a story procedural representation of the same audio data, it may be necessary for the SEGMENTOR to pass the media types though programs designed to perform transcoding and properties extraction. These programs will be referred to as TRANSCODERS.

(Step 5) All the segments and their properties are stored in a message database.

(Step 6) For each instance of the message, a second flat file is used to provide customizing information such as the receiver's first name, a list of receivers' first names, a customer id, and/or other relevant information This file can be used by the SEGMENTOR to create additional segments along with their properties to be stored in the database.

(Step 7) For each client device or application for which the form of the message needs to be optimized or customized to best conform to the capabilities and limitations of the device, communication connection or application, a third flat file is input to a program referred herein this document as a BINDER. Like the SEGMENTOR, the BINDER is also programmed or configured to conform to the specific intent of the selected template. It is the job of the BINDER to select from and arrange the segments in the database into logical files according to the properties of the third flat file input.

(Step 8) The BINDER first uses the information in the database and the third flat file input information to set the values of a set of binary flags called the MASTER_FLAGS. The MASTER_FLAGS will be used to select the segments that will be included into the logical files being created by the BINDER. For purposes of example, and to facilitate understanding these procedural steps more clearly, assume the following conditions: (i) The SEGMENTOR has created a particular segment, A, that contains a story procedure to decompress a picture of a book (along with the compressed picture data that is part of the parameters to instructions that make up the procedure). (ii) Properties generated by the SEGMENTOR, though use of a TRANSCODER, include the width and height of the picture, which are 400×400 pixels respectively. (iii) The SEGMENTOR also generated a segment, C, containing a story procedure to place text that can be used as in place of the picture when rendering the message. (iv) It is desirable to keep the story file size small, so it is best if only one of these segments is included in each generated story representation of the message. (v) Device E, which is to receive the message has a screen width of 100 pixels as indicated by the third flat file used to generate the optimized story message for that Device E. (vi) Device F, which is also to receive the message has a screen width of 600 pixels as indicated by the third flat file used to generate the optimized story message for Device F. In this example, the BINDER program sets a binary flag inside the MASTER_FLAGS to 1 if the information from the third flat file indicates that the client device's max screen width is greater than or equal to the width of the picture, as indicated by the properties stored in the database for the segment. The same binary flag is set to zero if the max screen width is not greater than or equal to the width of the picture.

(Step 9) Once the MASTER_FLAGS have all been set, the BINDER program processes each segment in the database and associated properties in a predetermined order as follows: (Step 9a) The flag selection value stored in the database as a property of the segment is logically ANDed with the value stored in the MASTER_FLAGS. (Step 9b) The result from Step 9a is compared to the selected flag values value from the properties associated with the segment. (Step 9c) If the values compared in Step 9b are equal, then the segment will be concatenated onto the end of the file identified by the logical file number which is associated with the segment as a property in the database.

(Step 10) Once all the segments have individually been rejected or selected and placed into a logical file, the logical files are compressed with a top-level compression scheme and packaged together into a single story file.

(Step 11) Linkage between different procedural segments inside logical files and between files is handled using carefully formed segments that preferably but optionally use the indirection mechanism of the story language implemented by the story playback engine software.

This methodology has numerous benefits. It has a low overhead for situations where a multitude of individually customized message stories must be generated on the fly, such as for an email promotion. This is true because segments with a flags selection mechanism makes for fast servers that can generate a multitude of different story messages customized and optimized according to any playback situation's characteristics. Furthermore, logical files generated from MASTER_FLAGS with the same values will always be identical. Therefore, logical files and even entire customized stories can be cached for use and reused without the need to regenerate them whenever the MASTER_FLAGS binary flag values that effect the composition of a logical file are identical. Hence the MASTER FLAGS, or subsets of the MASTER_FLAGS binary flags values can be advantageously used as caching keys. This is important because of the need to handle potentially millions of messages very fast on a single server (or small number of servers).

The whole story procedural language and the way it is designed and implemented is important to permitting computers to generate them easily and quickly on a server. In implementing an electronic mail system, for example, the mail system will handle millions of messages a day and it is desirable to provide only a minimum number of servers to satisfy the demand. It is important that it be fast so that even though there may be hundreds of millions of commutations and permutations for a single message to end up as a story based on inputs, it is desirable that it run very quickly and that results be cacheable. The procedural language and in particular the indirection allows concatenation the story parts, which are very simple operations, and decide using flags as described in this document. The flagging mechanism is provided and permits performing very light weight calculations and assembling together the stories in all kinds of combinations and permutations without having to relocate all the jumps between them and offsets and all those things that would be very computationally intensive and have inefficient memory access because it would jump all around. In one aspect it is a very linear process involving the concatenation of elements. There is no need to go back, to pluck, relocate or insert data in the middle of a story, which is very inefficient because of the caching of logical files or other data on the servers. The sever is basically making a lot of simple linear decisions so that it ends up with a story that at story run-time links all of the parts together automatically.

Having described aspects of a procedure according to one embodiment of the invention, attention is now directed to aspects of a system that implements the inventive procedure for automatically generating customized procedure-based story files from flat file descriptor input.

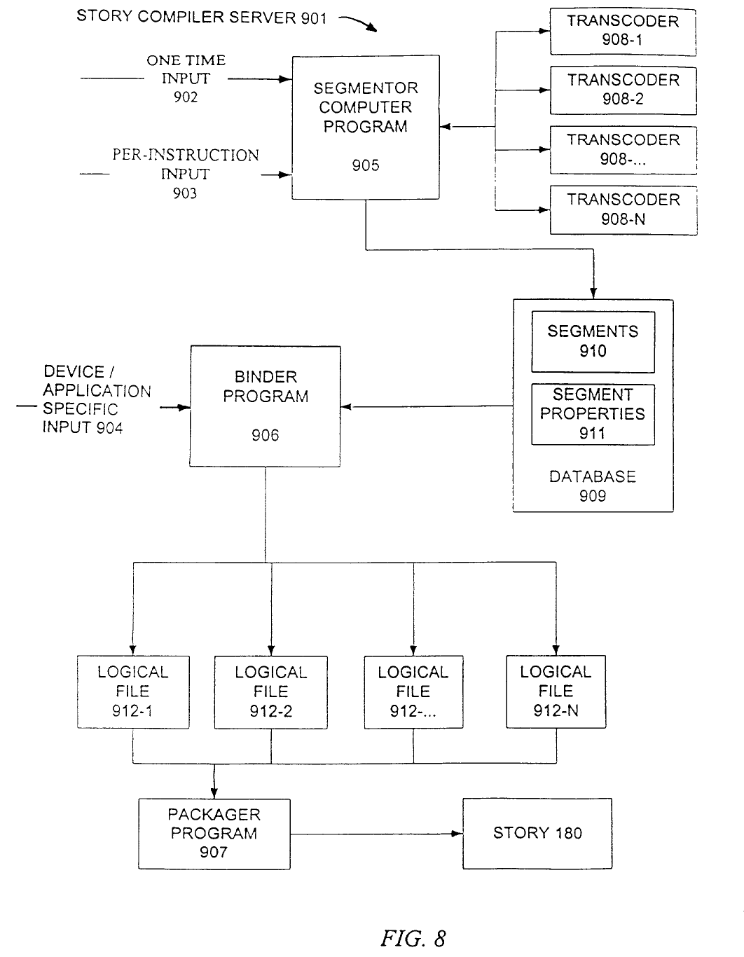

With respect to FIG. 8, wherein there is illustrated an embodiment of a Story Compiler implemented on a computer, such as a server. Server (Story Compiler) 901 receives three kinds of input: (i) One-Time Information Input 902, (2) Per-Instance Information Input 903; and (3) Device/Application Specific Information Input 904. Each of these three inputs are flat non-procedural files. The Story Compiler Server 901 includes (or executes) a Segmentor Procedure (or Program) 905, a Binder Procedure (or Program) 906, and a Packaging Procedure (or Program) 907. The Story Compiler 901 is advantageously implemented as one or more computer programs executing on a general or special purpose computer system such as a conventional server; however, the functional blocks (Segmentor, Binder, and/or Packaging) may alternatively be implemented in specialized hardware with other different software and/or firmware.

One or more Transcoder(s) 908 are desirably provided within the Story Compiler Server 901, though it may alternatively be provided external to the server. The Segmentor Procedure 905 receives the One-Time Information Input(s) 902 and the Per-Instance Information Input(s) 903. The Per-Instance information includes, for example, the address(es) that the message (story) is to be sent to. Note that the story may be sent to a multitude of addresses (people) so that the per-instance information may include a plurality of addresses. The Binder Procedure 906 receives the Device/Application Specific Input(s) 904 for customizing the final form of the message. Device/Application Specific Input(s) 904 include for example, screen size, processor speed, communication channel characteristics, memory, and other device or application specific parameters as are described elsewhere in this specification. The Segmentor 905 communicates with the Binder 906 via a Database 909 storing Segments 910 and Properties of Segments 911 The Binder 906 generates at least one and usually a plurality of logical files (0, 1, 2, . . . n−1) 913. The Story Compiler Server also includes a Packaging Procedure or Program 907 that generates story files by packaging particular combinations (and/or permutations) of the logical files.

Desirably, the logical files are cached either within the Story Compiler Server or external to it in associated storage so that existing logical files may be reused as components of other stories to be generated at a later time or date. Note that the three flat files are described separately for purposes of clarity and convenient exposition, and are three separate files in one embodiment. Other embodiments combine the information into different numbers of files, for example, into a single file or into more than two or three separate files. The number of files is selected according to the particular implementation, and it is only important to appreciate that there are generally three types of information received and utilized by the Story Compiler Server and that this information is not always stored on an actual hard disk or in an in-memory file related format.

The Binder is responsible for taking the information about specific devices, the transmission characteristics, other information such as information relevant to the mail system. It also takes the segment information, and creates the master flag values by comparing all of the properties of the actual device to receive the message with the actual opcodes and parameters (media data are also stored as parameters) that are in the segments, and it determines or selects linearly whether the segments get included in a specific logical file which may itself be included in a final story file. There is also information about which logical files to end up putting segments into. By linearly, we mean that the segments are looked at once in a predetermined order and either discarded or included in one of the logical files. Inclusion in the logical files is by simple concatenation, or addition of the new segment at the end or terminus of an existing collection of segments. Where the existing collection of segments is a file, the new segment is concatenated to the end of the file. Each logical file therefore includes one or more segments. The Packager 907 combines the logical files into a single story file.

One-time information may, for example, include a URL pointer to an MP3 file, the actual MP3 data, discount rates, specific message types, and the like. The one-time information may include either raw or processed content. The one-time information is the information that is provided just once to generate all of the stories no matter what number of actual messages are generated or sent. The server can generate the segments all at once. The per-instance information is the information that identifies, for example, some or all of the recipients. It will be using some or all of the media parts from the one-time information. There can be overlap in the information provided in the per-instance information and in the one-time information, and the system optionally provides means for determining which of the potentially conflicting pieces of information to use when there is overlap.

Consider, for example, a StoryMail promotion message. These three types of information would generally be separate. A database would be created having a database of segments for the entire promotion There would also have to be a list or multiple lists of people to send the promotion to. There would be customization information such as names, nick names, etc for each instance of the message. Then when a device, email environment, application, and the like that wants to receive the promotion is identified, another device specific information file is sent to the Binder that goes through all the segments in the database one-by-one to decide to include or not to include the segment. The binder binds these segments to be included and linkage information sequences into a set of logical files. The Packager takes the set of logical files (optionally does a top level compression) and packages them together as a single story file.

Thus, in one embodiment, the invention provides a method for automatically and autonomously generating a customized combined data and procedural file from non-procedural flat file descriptions. The method includes retrieving a plurality of flat file format content precursors from at least one storage location, segmenting the retrieved plurality of flat file format content precursors into segments comprising procedural representation sequences, generating linkage information sequences for the segments, binding the segments and linkage information sequences into a set of logical files, and packaging the set of logical files into a single story file.

The transcoder that the segmentor can call are just separate programs for different media types (such as an MP3 transcoder). The MP3 transcoder knows how to transcode MP3, the usual process being to decode MP3 into the actual physical decompressed representation and then to re-encode it into the Story compressed procedural representation in segments. This process may also include generating some characteristics, such as the width and height of the picture, the length of audio portion. The segmentor and binders may typically be optimized or adapted for particular types of messages or stories. For example, different segmentor and binders may be used for generating catalogs than for generating greeting cards, though somewhat less desirably, the same segmentor and binders may be used. The transcoders are not typically built into the segmentor because they can be used as is without modification for many different templates; however, in alternative embodiments they may be integrated with the segmentor.

In some embodiments, parts of the segmentor and binder may merely be data table driven where the data tables are different for different applications. A template is selected, and associated with the template is a form that is filled out by the user. The user need not know or care what happens after the form is filled out. Intelligence in the system selects an appropriate processing or presentation scheme. The form may result for example in an XML based schema that is used in conjunction with the segmentor program and binder program. From the user's perspective, it is the type of message or story that the user wants to create that is important, not the details of how this is accomplished to maintain the message intent.

The master mask includes bits for all the segments that are to be considered in generating the story. This is very efficient, because one can have a completely different input file and end up with exactly the same story. It is desirable not to have to generate the same (or even nearly the same story again if it can be or has been cached. Masking provides a good key for a story caching and retrieval methodology that permits selecting or otherwise identifying an existing cached story that will be compatible for someone else's needs. The story does not have to be the identical, because even when the complete story is not identical, the story can still use many of the logical files that are the constituent parts that make up the story. When these existing logical files can be reused (e.g. from a cache) then do not have to be regenerated. Frequently, it is only necessary to generate a certain logical file or a small number of logical files that are different, such as for example those that include the name of the message addressee or recipient. Use of the binary mask makes it possible to perform the selection and “generation” very quickly. The whole mechanism is very light weight or thin and highly efficient. One can use mask values to efficiently know how to cache data and how to access previously cached logical files as well as complete stories. The combination of the masking scheme with caching is very powerful and fast.

Story Player Having Out-of-Order Processing with Automatic Error Recovery

Embodiments of the story player (in conjunction with the story composition engine or story compiler) provides out-of-order processing of the procedural codes within the story. It also provides automatic error recovery. Out-of-order processing results at least in part because of the procedural nature of the stories. Execution of any particular story procedure or op code may generally be dependent on the results of earlier story procedure or op-code execution, user navigational or other inputs during story playback (rendering), user preferences, device limitations and characteristics, and the like features described elsewhere in this specification. Some embodiments also provide for speculative execution, as the system, method, and procedures will attempt to anticipate particular portions of large story files will be needed and preferentially retrieve these from the sender. This speculative execution is particularly advantageous when receiving and playing back large story files that are received in the streaming mode using story subfiles as described elsewhere in this specification.

Errors, such as errors in execution, are less likely to occur than in conventional systems, methods, operating systems, and computer programs as the result of the preferred procedures for allocating memory and buffers, programming conventions that facilitate security and stability, as well as other features described elsewhere in this application. In the even that an unexpected condition arises that might otherwise give rise to an error, error recovery is automatic at least in part due to the procedures for resource constrained retry (described elsewhere in the specification) and the ability of the procedural language itself to provide alternative courses of action, should an unexpected condition arise. This lessens the chances that the device or program will hang. The inventive system and method also make very few, if any, demands on the device operating system so that compatibility is less problematic than in some operating system-application program environments.

Automatic Computer Generation of Story File From Flat File Description

In a preferred embodiment, the invention provides automatic computer generation of a story file procedural format file from a flat file description. For example, XMP and extensions of XML such as EXML, VXMP, and the like are flat files. Content such as multimedia content may be provided as MP3, MPEG Video, Text, and the like, and described by an XML code description. In an inventive conversion or generation procedure, these content parts are transcoded into (i) procedural representation story sequences, and (ii) linkage information sequences. In the preferred embodiment, the story sequences are sequences of 32-bit fix length words as described elsewhere in the specification. The linkage information my for example specify the offsets of pictures in a logical file containing a stream of video pictures. This transcoding will generally be performed by the composition engine or by an agent or entity (transcoding engine) associated with the composition engine at composition time. However, it may be performed at a different time and/or external to the composition engine.

Inputs to this binding procedure may for example include a display screen size, user preferences, and the like parameters as described elsewhere in this description. The binding procedure then selects which sequences of segments to concatenate in each logical file of the single story file. (See description of story file structure elsewhere in this description.) The selected logical files are then packaged into one story file. Optionally, but desirably, the logical files are encrypted to prevent third parties from making use of the information and digitally signed so as to assure source and authenticity The linkage information may be directly accessed but is typically accessed through one or more levels of indirection, and the indirection may be recursive. By indirection we mean the parameters do not contain the value to be used but rather a reference to the value. This is beneficial because segments can just be concatenated and they link correctly to each other using fewer server (computer) resources and increasing message capacity. There is no need to provide complex linkage or relocation operations on the servers as in conventional systems and methods.

The invention therefore also provides a method for automatically and autonomously generating a customized combined data and procedural file from non-procedural flat file descriptions, the method comprising the steps of: retrieving a plurality of flat file format content precursors from at least one storage location; segmenting the plurality of flat file format content precursors into: (i) procedural representation sequences called SEGMENTS; (ii) linkage information sequences generated by a SEGMENTOR program and/or TRANSCODER program; (iii) a BINDER program; and (iv) a Packager program.

This method may be further defined such that the step of binding includes receiving inputs identifying story player device characteristics. The method may alternatively be defined such that the step of binding includes receiving inputs identifying story player device user preferences. It may be defined such that the step of transcoding includes receiving inputs identifying communication channel bandwidth characteristics.

The method may provide that the step of transcoding includes receiving inputs identifying story player device characteristics, story player device user preferences, and communication channel bandwidth characteristics.

The method may provide that the step of binding further comprises selecting particular sequences of SEGMENTS to concatenate into each logical file. This embodiment of the method may also provide that the step of packaging further comprises assembling a plurality of the logical files into a single story file. A single story file may comprise one, more, or all of the elements as described elsewhere in this description.

The method may provide that the selected and concatenated sequences are packaged into a single story file. The logical files may be encrypted for security and/or digitally signed. The method may provide that the linkage information includes direct linkage information (links) and/or indirect linkage information (links). The linkage information in either instance may include recursive indirect linkage information. Logical files may be compressed, and the packager may performs a top-level of compression as part of the packaging process. Numerous other embodiments having one or more of these alternatives may be provided.

SFF File Convention

In one embodiment, a single story file for transmission and playback is comprised of a top-level compressed and packaged set of possibly compressed logical files. During playback of the story, the player top-level decompresses and un-packages these logical files into the individual logical files. The order in which the decompression and unpackaging occurs is not important, in one embodiment decompression precedes unpackaging, and in another embodiment, unpackaging precedes decompression. Note that a logical file includes: (i) a header, (ii) a start-up procedure (optional), and (iii) data (optional).

A logical file is specified by two number identifiers, a content identifier (Content ID) and a current file number. One embodiment implements a file open and play procedure as follows. The received story file is opened (either as it is received or after a period of storage), and all logical files are unpacked and decompressed from the single transmitted story file. As each logical file is opened for playback, a program procedure or subroutine read from the logical file is executed. This program or subroutine can be used for storing logical information accessed by other story programs and procedures and subfiles.

When packaging into a single story file there is a top-level compression applied to the components, some of which may be compressed (e.g. DCT compression of image files) and other of which may be uncompressed (e.g. text). This is referred to as “top-level” compression. The single top-level compressed story file (Table 5) is unpackaged and top-level decompressed before playing back the story (Table 6). Logical Files 0, 1, 2, and 3 in Table 6 may still include compressed portions. In Table 7, subfiles are illustrated. There are at least two reasons why one might not send the entire story file and instead send multiple subfiles. First, it is desirable to be able to start playback before the entire story file has been transmitted (or received) and it is desired to temporally overlap the transmission time with the playback time. Suppose for example that content is being received from one web page and the story is one hour long and will play continuously. It is undesirable to have to wait for the entire story to be transmitted and received from the other web site before beginning playback. There is only a need to delay or wait long enough (typically for a few seconds to provide some input buffering) of the story to be received to begin playback of the story. The headers are provided in so that a program can easily break up a single story file into sub-story files, which are conveniently referred to as subfiles. The subfiles are the same format as a single story file, except that they only contain an expression of a portion of the original full story. As soon as a subfile has been received, a partial full richness story is available to begin playing which includes all of the multiple and backup richness content as the full story as well as navigation features and the like of the full story.

The headers in the logical files and their associated reference numbering system whereas the file is identified using a Content ID (CID) and Content file number (CFN) allows a story file to be broken up automatically. But one potential problem with this goal is that all parts of a story potentially reference all or many other parts of the story, for example, for navigation, picture offsets, and the like. If the story file is broken up, without other steps being taken, and one were to use the physical offsets in the story file, the references would be wrong unless they were relocated. In general, one does not want to have to handle such relocation. Preferably one provides for a single global relocation which is provided by the header. The headers let one preserve all of the offsets, such as offsets in jumps of subroutines, without changing any of the parameter values or offsets specified as parameter values, and being able to break up the original single story file into files (subfiles) that do not have the same physical offsets as the original story file.

Details of these offsets, headers, and file elements using logical file offsets are described hereinafter relative to story streaming procedures. (The use of subfiles, headers, and/or logical file offsets is beneficial for both streaming and non-steaming environments.) For non-streaming environments and/or applications, the use of logical file offsets rather than physical file offsets is optional though desirable.

Note that it is up to the system that is de-composing the story file into subfiles to make sure all of the content is present in the subfiles so that playback for the desired period of time, or functionality can take place without the need to receive other subfiles. This somewhat presupposes that the user does not implicitly or explicitly invoke navigation so that other segments not immediately available in the player would be required. If such navigation is utilized, the required segments are merely requested and transmitted in accordance with the current playback needs. In a preferred embodiment the startup procedure inside logical files is used to request commencement of transmission and top-level decompression of all subfiles to which direct navigation from the current sub-file is possible. In most cases by the time the user or story procedure attempts to navigate to a procedure in another subfile the other subfile will already have been delivered and top-level decompressed. In cases where the new needed subfile is not yet available, the resource constraint and instruction retry technology of the Story Playback Engine will cause the player to effectively stop media playback operations and poll for the new subfile information. As soon as the new subfile information becomes available, the story media playback operations will resume.

The header also includes the physical position in the file where the offset referenced data starts. The data is located after the header and the starting subroutine (start-up routine). These start-up routines are just another story subroutine. What happens whenever you open a logical file the first time when playing back a logical file, is that if there is a start-up procedure it is run immediately. For example, you may have a subroutine that causes calls to functions in the Hardware Abstraction Layer that makes a request of the transmitting device for whatever subfiles it is going to need in the near-term future based on information it currently has. The subfiles are all chained together in this manner. Recall that in preferred embodiments, stories are not just continuous streams having a beginning, a middle, and an end. Rather they have navigation features that permit jumps, and alteration in what might be played back. Depending upon the navigation steps taken (or not taken) some subfiles will never be needed and need not be transmitted. The system, including the story compiler, has enough intelligence to compile the story and subfiles in a manner that supports these operational features. The ability of the system and method to survive the temporary unavailability of one or more subfiles is taken care of by the story procedural features, including resource constrained instruction retry, described elsewhere in this application and related applications incorporated by reference. There is no need for an additional or extra mechanism to handle this situation. Eventually, there will be a reference to an offset and a realization that the logical file is not available at the player yet. At this point the instruction that needs the resource from a new subfile not yet present issues a retry return code. Furthermore, anything requiring this step to complete will also stop because there will be a resource that is not available because the original retry instruction containing thread is effectively stalled before it can make any other resources available to other threads. For example a thread will just keep trying to open the file until it is available Eventually the HAL will have fetched the other subfile, because it had to have requested it in one of the startup subroutines, when it becomes available it will be opened and playback will commence or continue. Other threads that were suspended for lack of the resource will likewise resume as resource constraints have been removed.

Regarding Table 7. There are now a number of subfiles that each contain a piece of the story file. And now instead of all the logical files having the file number of 0, only the first one has zero and subsequent logical files inside the subsequent subfiles have higher numbers.

Pieces of logical files as they appear in Table 5 are effectively distributed among the subfiles (e.g. subfile 0, subfile 1, . . . , subfile-1). They need not break at the same place as in the original story file. The program or user or tool that generated the subfiles has to generate the subfiles that link them all together in terms of asking for transmission of them, but the logical story “information” (data, procedures, opcodes, etc.) that goes into the actual subfile only has a requirement that a logical file with a Content File Number (CFN) from a subfile that has a higher CFN than another subfile also has logical files that have offsets larger than those from logical files included in subfiles with lower CFN.

When an offset parameter to a JUMP_OP is not within the current logical file (the PBE can tell because it looks for the bounds of the logical file offsets in the header) then it has to go open and decompress the subfile with a higher CFN if it has not already been done (the HAL decides how to do this). If it jumps backward, before the first logical offset in the currently open logical file that it is executing, then it needs to open a logical file with the same content id but from a subfile with a lower CFN. If there is a jump from the beginning of the story to the end of the story the middle ones won't even exist. Note, that in a preferred embodiment, the subfiles are not sent unless the player asks for them. Therefore, no bandwidth is lost transmitting and receiving unneeded subfiles or content generally. It should also be appreciated that the method for finding the subfile with a particular logical file offset's data does not need to be a linear incremental search as described above for explanatory purposes.

Typically, the subfile will have sufficient information to enable uninterrupted playback for the user. Uninterrupted playback need not however be guaranteed, as some occasional waiting on the part of the user is acceptable. Providing and buffering enough story content for between about 1 second and about 20 seconds is normally satisfactory, typically providing such story content for between about 2 seconds and about 5 seconds may be sufficient. Note that account may be taken of current and/or historical communication link characteristics in determining the size and/or duration of subfiles to communicate. It is advantageous to reduce the size of the subfiles as much as possible while providing reasonably uninterrupted playback as user navigation within the story may alter the identity of the subfiles that will be needed. User navigation or user choices within the story playback. Too much time and bandwidth might otherwise be consumed in downloading story content that will never be rendered. Therefore, it is desirable to request transmission only of information for which direct links are indicated, or where there is a reasonable chance that the story content will be rendered. Optionally, some decisions may be made based on user characteristics, communication channel characteristics, and traffic in and between communicating devices.

Desirably, subfiles for which there are direct links from currently executing subfiles will be requested from the server. Direct links to story content from the then currently executing subfile are advantageously requested before they are needed so that branches to any such identified directly linked content may be made without undue delay or objectionable interruption. The subroutine will try to figure out which all the needed subfiles are. The subroutine may even try to anticipate where a branch will take place, somewhat like the speculative execution of microprocessors, because it does not know which way the user will navigate. Most stories will typically not have complex navigation, but they can. Intelligence is applied to breaking them up intelligently, and enough intelligence can be applied such that the computer can automatically break up into subfiles in at least an acceptable manner and in some instances in an optimal or near optimal manner.

For very complex navigation, fast playback, and a slow transmission speed, needed subfiles may sometimes not be immediately available; however, fielded systems are designed to reduce any delays to acceptable levels. It will request files, wait for receipt of such files (they may be considered to be a constrained resource), and they will eventually be received, and played if and when needed. In some instances, a first logical file will request a first set of subfiles and a later logical file will request a different set of subfiles, since the later logical file is presumably executing, the retrieval of the second set of subfiles may be performed preferentially and the first set of subfiles cancelled as no longer needed, or the newer request may be given a higher priority. Of course various rules and procedures may be envisioned to implement particular subfile requests.

Streaming is one application for which subfiles are advantageously provided, particularly when the stories are large and it is desired to start playing a story before the entire story has been received by the story playback device. Starting playback before one has the entire story is a second application and justification for subfiles. The size of a subfile may generally depend on many factors. In one embodiment, the size of the subfile is dependent on the content, transmission channel characteristics, device characteristics. Generally a story is generated that is correct for the intended device and transmission channel characteristics. Then the story is broken up into subfiles based on predetermined criteria, such as for example, that each subfile should contain a predetermined period of playback. In one embodiment, the predetermined period of playback is about 5 seconds. This playback duration pertains at least in part to buffering so that the person never needs to wait for more information to arrive. The goal is to maintain continuous or substantially continuous playback to the extent possible, and to reduce the number of instances where there is a stall or pause in the playback. In general playback in subfile pieces of between about 2 seconds and about 20 seconds may be used, with longer subfile durations being used when the application is less tolerant of interruption and/or when the communication link is slower or less desirable such that having more content available in the playback device (assuming adequate available memory) is desirable. It may also be efficient when communication channels are fast and user navigation may be complex, to reduce the size of the subfiles and request additional subfiles as needed, especially as this may permit requesting some subfiles speculatively according to a plurality of navigational choices and the resulting jumps and/or branches. Subfiles may be quite long (for example, tens of seconds, minutes, or fractions of an hour. There are no actual technical limits on size, however, the one disadvantage of large subfile size being that navigational branching may render significant portions of subfiles unnecessary. Thus there are a number of tradeoffs to be considered in selecting the selecting subfile playback duration and hence subfile size.

Streaming and Receipt of Streamed Story Files or Other Content

The invention further provides a system, device, method, computer program, and computer program product for streaming multimedia-rich interactive experiences over a communications channel. Logical Story files contain a part of a final packaged Story File. Logical files are accessed by the portable playback engine code, not by name, but rather by a number pair, the contented (CID) and the currentFileNumber (CFN). By convention, the contentld identifies like data types. For example, a contentld of 0 is normally used for the main startup and control procedures, while a contentld of 2 is used to store pictures and video decompression procedures and associated data. Separating like data into separate logical files allows for better compression and quicker access to consecutive data due to the file caching techniques employed by many device file systems.

The currentFileNumber is normally 0, since in a story file there is only one logical file for each contentld; however, currentFileNumber can be used in cases where the single story file is automatically broken up into or directly composed as a set of sub-files. Story sub-files have the same structure as a complete story file, but only contain a subset of a complete story message.

Story sub-files can be used to allow Story playback to begin before the entire Story File could have been transmitted over a communications link. Only the first sub-file is needed to start playback, other sub-files are requested automatically in advance so that under normal conditions necessary sub-files will always arrive by the time their content is needed during Story playback. Hence the transmission time for subsequent sub-files can overlap with the playback time of the preceding sub-files.

One of the preferred uses of the sub-files is to allow for continuous streaming of Stories over a network. In order to make streaming work effectively, every logical file begins with a header that contains information on what portions of the complete story procedures and data are contained in the sub-file.

In preferred embodiments, each logical file header contains at least the following elements: (1) a first logical file offset (FirstLogicalFileOffset), (2) a last logical file offset (LastLogicalFileOffset), (3) a physical position of first logical file offset (PhysicalPositionOfFirstLogicalFileOffset), and (4) a file starting subroutine size (FileStartingSubroutineSize). Offsets are used to identify the entry points for branches of control between procedural code sequences. If the offsets were the physical byte offsets within the logical files then branching to the 0 offset from within a story would start execution with the very first 32-bit word of the logical file. And a subroutine call instruction with an offset of 40 would start execution of a subroutine using input data from offset 40 in the physical file. But this is not the case in the inventive method or implementation. The physical files begin with a header followed by a file starting subroutine, so there is a header instead of executable instructions stored at offset 0.

When a story file is to be automatically broken up and streamed as a sequence of sub-files, the header information at the start of each logical file are used to maintain the offsets values within the original story. In this manner the offsets for branching and subroutine calls within the story do not need to be relocated, so long as the process of breaking up the story files into sub-files generates the values of the headers of the sub-file logical files to maintain the absolute offset values from the logical file with the same contentld from the original story file. If a jump to an offset occurs to an offset that is not in the range FirstLogicalFileOffset to LastLogicalFileOffset of the current logical file, then the story playback engine code can find the correct file by incrementing or decrementing the currentFileNumber and opening the new logical file. This process is repeated until a sub-file logical file with the same contentld is found that contains the target offset. Larger currentFileNumber values indicate that the logical offsets within the logical file are all greater than logical files with the same contentld with lower currentFileNumber values.

Before any procedure in a logical file that is opened begins execution, the FileStartingSubroutine that follows the header, if present, will be executed. When story files are broken up into sub-files for streaming the generated sub-file logical file FileStartingSubroutine can be used to request that specific other sub-files be transmitted so that they will become available by the time execution is passed to them during story playback.

Logical File headers and FileStartingSubroutines can be used to allow automatic generation of sub-files used for starting execution of the story before the entire story message is received, or to allow for continuous streaming of large or continuously generated stories. The job of breaking up a singe story file into sub-files is much less complex because of the logical file header information which provides an effective file scope relocation value which preserves the original offsets which are normally scattered throughout the story procedures and logical files. The FileStartingSubroutine provides a convenient and efficient mechanism for automatically adding any story procedural instructions necessary to control the transmission and coordination of the sub-files to accomplish the mission of the original story file without the need for the entire story file to be present on the client that is playing the story. So one use of the sub-file system is to allow for the continuous playback of large story files that would otherwise not fit into a specific playback devices. Another use is to allow the streaming of real-time stories that are being generated on the fly An example of which would be the real-time transmission of a baseball game that is to be viewed effectively simultaneously with those directly viewing the event at the actual stadium.

These structures and procedures provide means for preserving message intent and quality in a streaming story implementation.

TABLE 5
SINGLE COMPRESSED STORY FILE

Top-Level Compressed Logical File 0
Top-Level Compressed Logical File 1
Top-Level Compressed Logical File 2
Top-Level Compressed Logical File 3

TABLE 6
UNPACKED AND TOP-LEVEL

Unpacked and Top-Level Decompressed Logical File 0
Unpacked and Top-Level Decompressed Logical File 1
Unpacked and Top-Level Decompressed Logical File 2
Unpacked and Top-Level Decompressed Logical File 3

TABLE 7
SUBFILES

| Subfile 0 | Subfile 1 | . . . Subfile N |
|---|---|---|
| Compressed | Compressed | Compressed |
| Logical File 0 | Logical File 0 | Logical File 0 |
| Compressed | Compressed | Compressed |
| Logical File 1 | Logical File 1 | Logical File 1 |
| Compressed | Compressed | . . . Compressed |
| Logical File 2 | Logical File 2 | Logical File 2 |
| Compressed | Compressed | Compressed |
| Logical File 3 | Logical File 3 | Logical File 3 |

It will therefore be appreciated in light of the description provided above, that the invention provides a method for streaming electronic content from a sender to a receiver over a communication link, the method comprising the steps of: forming a single virtual story file of substantially the complete electronic content of the story, or at least for a predetermined playback period or playback functionality; communicating the single virtual file over the communication link in a data stream at a data rate commensurate with available bandwidth and characteristics of the communication link, the file being received by the receiver as sequential portions of the single virtual file in the form of individual subfiles; and, the opening of a later received subfile being controlled by a previously received subfile such that each the currently executable portion of each of the subfiles is executed only upon the direction of an earlier executing subfile.

The virtual story file comprises a set of logical files, each logical file including a header indicating that the first logical file procedural/data content offset is zero (0) and that the last procedural/data element offset is the size of the logical file procedural/data content less one atomic unit. The single virtual story file includes a plurality or set of sequentially arrayed subfiles, each subfile including (i) a header portion identifying a first subfile procedural/data content offset from a reference location in the single virtual file The virtual story file also includes (ii) a currently executable portion with each the subfiles that executes when the subfile is opened after receipt; and (iii) a control portion that controls loading and execution of other subfiles.

Therefore, in one embodiment of the inventive method for streaming electronic content from a sender to a receiver over a communication link, the method includes the steps of: forming a single virtual story file comprising substantially the complete electronic content of comprising: a set of logical files, each logical file including a header indicating that the first logical file procedural/data content offset is 0 and that the last procedural/data element offset is the size of the logical file procedural/data content less one atomic element; automatically and intelligently reforming the single virtual story file into a plurality of sequentially arrayed subfiles, each subfile including: (i) a header identifying a first subfile offset from a reference location in the single virtual file and containing a substantially complete story for a predetermined playback period or playback functionality; (ii) a currently executable portion with each the subfile that executes when the subfile is opened after receipt; and (iii) a control portion that controls loading and execution of other subfiles; communicating the single virtual file over the communication link in a data stream at a data rate commensurate with available bandwidth and characteristics of the communication link, the physical file being received by the receiver as sequential portions of the single virtual file in the form of individual subfiles; and the opening of a later received subfile being controlled by a previously received subfile such that each the currently executable portion of each of the subfiles is executed only upon the direction of an earlier executing subfile.

This method may be further defined such that a leading and previously received subfile holds and controls execution of a trailing and subsequently received subfile. The above method may as well be further defined such that each subfile includes a control portion that instructs the playback engine to search for and open and execute procedures and/or data from a preceding or trailing subfile or set of preceding and/or trailing subfiles.

The method for streaming may in some embodiments, provide that one or a number of subfiles is requested to be transmitted by a starting subroutine as each logical file is opened for use by the story being played. In other or the same embodiment, the method may provide that each subfile received is executed until all subfiles for the single virtual file have been received and executed. It may as well provide that there can be branching forward and backward to any number of points between sub-files because of navigation.

If a trailing subfile directed to be sent and received during the execution of the control or main procedural parts of a previous subfile is not yet completely received at the time control is transferred to the trailing subfile, the procedure transferring control will recognize this as a resource constraint and automatically retry the story instruction or instructions that require the presence of the complete trailing subfile. Embodiments of the method of streaming electronic content may also provide that if a trailing subfile identified by the control portion of a leading subfile logical file has not been received, the control portion retrying opening the trailing subfile until it is received so that the quality of the stream is not degraded. These optional steps may be combined in many ways. For example, the method may include one or more of providing for: a leading and previously received subfile holds and controls execution of a trailing and subsequently received subfile; each subfile includes a control potion that instructs the playback engine to search for and open and execute procedures and data from a preceding or trailing subfile or set of preceding or trailing subfiles; one or a number of subfiles is requested to be transmitted by a starting subroutine as each logical file is opened for use by the story being played; each subfile received is executed until all subfiles for the single virtual file have been received and executed; there can be branching forward and backward to any number of points between sub-files because of navigation; if a trailing subfile identified by the control portion of a leading subfile logical file has not been received, the control portion retrying opening the trailing subfile until it is received so that the quality of the stream is not degraded; if a trailing subfile directed to be sent and received during the execution of the control or main procedural parts of a previous subfile is not yet completely received at the time control is transferred to the trailing subfile, the procedure transferring control will recognize this as a resource constraint and automatically retry the story instruction or instructions that require the presence of the complete trailing subfile; the electronic content comprises an electronic content selected from the group consisting of real-time transmission of video and audio of events and non-real time audio and video of events, real-time and non-real-time transmission of navigation, and combinations of these.

When a high-bandwidth connection connects the sender and the receiver but memory in the receiving device is not of sufficient size to simultaneously store the entire story, the story being received as a plurality of subfiles as they are requested, sufficient memory being reserved for execution of subfiles already received, the story never residing in the memory of the device in its entirety at the same time. Any of these embodiments may provide for either a real-time streaming method or a non-real-time streaming method

Different types of electronic content may be communicated. For example, in some embodiments, by way of example but not limitation, the electronic content comprises an electronic coupon for a product, an electronic advertisement for an item or service, an electronic commerce content, an electronic greeting card, an electronic catalog, and combinations or variations of these. In fact, the inventive method may be used with virtually any type of information or data that can be communicated in electronic form.

In one particular embodiment, the electronic content comprises an electronic content selected from the group consisting of real-time transmission of video and audio of events and non-real time audio and video of events, real-time and non-real-time transmission of navigation, and combinations thereof.

The method is applicable to small and large content items, and in one embodiment, the electronic story content is larger than device can store at one time. For example, in one embodiment of the inventive streaming method, a high-bandwidth connection connects the sender and the receiver but memory in the receiving device is not of sufficient size to simultaneously store the entire story, the story being received as a plurality of subfiles as they are requested, sufficient memory being reserved for execution of subfiles already received, the story never residing in the memory of the device in its entirety at the same time.

The invention provides a system and method that allows for forward, backward, and random access of various ones of the story subfiles as navigation occurs.

The method of streaming also may provide that the story subfiles are executed non-sequentially, and permitting non-sequential execution of subfiles in response to navigational decision inputs to the device

Use of Fixed Size Instruction Opcodes and Parameters With Appropriate Compression

In story procedures fixed size instructions and parameters with nominally small values are used in conjunction with appropriate compression to enable small portable and fast execution, and to enable physically small Play Back Engine, PBE, code, physically small procedural representations of messages and a large dynamic range of values. Although the size of opcodes and parameters is fixed a relatively large size to the values most used, the compression of the story procedures mitigates for the size of all the otherwise unoptimal or sub-optimal use of bits. In addition properly choosing the size of the fixed size opcodes and parameters can aid in quick execution of the PBE because of memory access alignment restrictions of most commonly used processors. In conjunction with appropriate compression and small values of opcodes and parameters so that there is little penalty for using large fixed sizes (e.g. 32 bits) to provide a dynamic range of values suitable to represent a very large range of opcodes, media sizes and parameters.

An additional benefit for using fixed size op-codes and parameters is that it permits use of the same indirection mechanism, method and procedures. The same native processor computer software code can also be used to implement the PBE code that accesses the opcodes and parameters for the op-codes so that the amount of native code is kept small, the same code being used for both.

In one embodiment of the invention, stories are structured as sequences of a fixed number of bit representations, desirably sequences of a fixed size word. For example, the stories may be structured as a plurality or sequence of 8-bit, 10-bit, 12-bit, 16-bit, 24-bit, 32-bit, 36-bit, 48-bit, 64-bit, 96-bit, 128-bit or any other sized bit words. In one preferred embodiment, stories are provided as a sequence of 32-bit words.

In one embodiment, all op-codes, parameters and offsets are a fixed size. Use of a fixed size, especially of a suitably chosen size is beneficial for a number of reasons. For example, portability and adaptability are aided by the use of fixed size words. A 32-bit fixed size word is advantageously used for representing a large dynamic range of value, and is highly compressible because both instructions and parameters are designed to have mostly small integer values. The fixed size makes things very scalable and processor words are always aligned along a fixed size (e.g. 32-bit) word boundary. Alignment of values on 32-bit boundaries is sometimes required and often provides for quicker access on many existing and most likely on yet be developed processors.

Because of this suitably chosen fixed size, the playback code, or the story is also small and reusable. Parameters and opcodes can be processed by the same access code and operations. By access codes it is meant the native processor code used to implement access to the input buffer words while applying possible indirection. Small size, also results because operations can be performed without the need for size conversion in the player implementation native processing code. An additional advantage is that the op-codes and data are aligned in an appropriately sized and organized data structure and/or memory for fast access. The native processing code is the code running on the real machine implementing the playback engine. The code that the playback engine is implemented in is referred to as the native processor code (or playback engine code), and may for example be in the “C” language, and produces native processor code when compiled. The story procedural code is different from the native processing code. For example, the same common native processor subroutines or procedures may be used to collect opcodes and parameters from one or more input buffers while applying indirection in the same manner for both opcodes and parameters.

When compression is used, such as for example LZW compression, there is little penalty for using a fixed word size that has more bits available in the word than are normally necessary to represent the op-code, parameter, or other value stored in or represented by the word. In fact, fixed sized words aid in the compression process where the unit of redundancy, for example, the word size matters. Normally there is a redundancy unit for compression schemes which is larger than a single bit. For text this is typically a byte or character rather than a bit. For stories with a fixed size word of 32bits, 32 bit words are expected to be the redundant unit size to be used to best compress the story procedures.

Even when a compression scheme such as LZW Compression is applied to an information set (data, instructions, procedures, opcodes, parameters, control, or the like) there is normally a bit sized unit of storage that might repeat so that there is generally no reason for the encoding to be bit encoding. Often for text, the unit of repeat will be a byte or a character because these are the things that will form chains to repeat rather than the bits within the bytes or characters.

For stories, there are advantages to specifying a fixed size. The fact that they are fixed size means that you can use that fixed size as the compression repeat unit. It tends to compress even better in this case because the semantics that are being communicated are communicated in a fixed size so that there is a natural redundancy size that will tend to increase the compression effectiveness beyond the fact that zeros or other repeated bits or other entities (normally removed during many compression schemes) go away.

For compression, it is desirable that the size of the elements of the repeating unit are not smaller than the logical values that repeat. For example, if one is compressing text one should use bytes (8-bits) rather than nibbles (4-bits) because nibbles would not tend to repeat within the characters of the text. Here, the semantic thing that is repeating is the character combinations and words, not bit combinations that make up the characters that you are expecting to repeat.

The fact that the invention puts its logic into a structure that repeats into a series of fixed size words, instead of having variable length pieces of the same information all over, which would tend not to repeat very often and to defeat the kinds of repeats that provide good and efficient compression. Therefore, even though the uncompressed instantiation of the procedural data might be smaller, the compressed version might actually be larger than if they were put into fixed size words, because more things would repeat and any information that repeats is nearly free or at least effectively free.

The Playback Engine (PBE) run-time module or system also benefits from the sequences of fixed-size words. For example, a story may be structured as a sequence of concatenated interspersed instructions and parameters of the general form “Instruction1, param1, param2, . . . , Instruction2, param1, param2, param3, . . . , Instruction n, param1, . . . , param k”. Each of these instructions (e.g. Instruction 2) and parameters for the preceding instruction (e.g. param1, param2, param3) are 32-bit (or other fixed length words). The story playback engine or player fetches each word and either utilizes the value in the word as a parameter for a function or other operation, or uses the value in the word to identify and execute a function based on the value found in the word. Various program instruction types may be used.

Once the function associated with the value in the word has been identified, the function then fetches the parameters that follow the instruction. It then performs the instruction (while fetching additional parameters, if any); advances the program counter past the parameters to the next instruction; and returns a status code that, for example, indicates the completion, error, or other status of the instruction. Extraction of the parameters for a particular instruction, and movement of the program counter to a next instruction are facilitated by the fixed-size characteristic of the stories.

Although stories are desirably structured as sequences or a plurality of fixed-size words, this is an optional feature, and stories having other organizations may be utilized. For example, the stories may be organized as sequences of variable length portions, or stories may be organized using a nominal fixed size and even and/or odd multiples of that size, such as for example a nominal 16-bit size with 32-bit (2×), 48-bit (3×), and 64-bit (4×) multiples of this nominal size. This provides for at least some memory alignment and efficiency.

The use of a fixed size, such as 32-bit, that is large enough to handle codes for the instructions implemented and the parameters used by the instructions is chosen because such size may generally provide for good alignment with most processors (CPUs) to work efficiently; less native player code size because conversion and masking instructions that may sometimes be required for type conversion in expressions, are not needed; and less native player code size is needed because the same native player processor code can fetch instruction opcodes and parameters (because they are the same size) and do operations on them. The relatively large fixed size also allows values with larger dynamic range to be represented within one word. For example, a 32-bit word can represent a value of 2³² (about 4.29×10⁹) so that data values, image coordinates and the like can be represented. In the case of imagery data, such as X-ray image data (as well as other data), image coordinate values may be as large as 4 Gigapixels wide and high (4 Gpixels×4 Gpixels) when 32-bit words are used. Use of smaller word size would limit this range of values and/or require a different scheme for representation.

In spite of the use of relatively large fixed word size, there is little waste because story streams of op-codes and parameters are compressed when in a single file package as described elsewhere in the specification. Also, the instruction set is designed in a way that most opcodes and parameters are small positive numbers making them very efficiently compressed by algorithms that look for redundancy, such as redundancy in the form of leading zero bits. LZW like compression schemes can for example efficiently compress such words.

Procedural Representation of Motion Data

Procedural representations of motion video data are provided by the inventive system and method and are better than conventional non-procedural or flat file descriptions. Some reasons why they are better are set forth immediately below.

It is known that MPEG uses Discreet Cosine Transform (DCT) and other motion video compression schemes for spatial compression within single video frames and motion vectors for temporal compression. MPEG, however, is a flat data description and specifies motion vectors for each 16×16 macro-block of pixels.

In one embodiment, stories also use DCTs for spatial compression within single video frames and motion vectors for temporal compression, but stories do not rely on a flat file description. Instead, preferred embodiments of stories generate video frames by executing one or more sequences of instructions. This methodology allows for the mixing of different video decompression or reconstruction procedures or techniques within a video stream and even within a single video frame. That is, within a video stream or even within a single video frame, different techniques may be applied to different picture portions within that stream. This can be done because it is procedural. For example, within a common video stream, cartoon frames typically having a limited range of colors and textures as well as more sharply defined edges or transitions between cartoon elements may be compressed using different techniques than continuous tone image frames having potentially more colors, greater texture within a graphic element, and different edge and transition characteristics. The different characteristics of cartoon and/or computer generated graphics and conventional imagery are known and not described here.

Conventional compression schemes known to the inventors do not compress different frames within a video stream differently. For example, MPEG cannot handle different frames differently. The inventive method, being procedurally based, can readily provide for different compression techniques within single video (or other data) frames (or sets) or between frames in a multi-frame video (or other data) stream. Even sections of a single frame may be processed differently. For example, motion compensation for a whole frame can be applied using a single story instruction. In conventional techniques, such as standard MPEG (versions 1 and 2), this is not possible because a single motion vector can only apply to a 16×16 pixel block. Even extending to larger or different block sizes would not cure this deficiency. Also non-procedural algorithms such as MPEG normally must have fixed frame rates. The inventive system and method have no such limitations. Furthermore, because, the invention is procedurally based, in the case where there are no changes between frames, such as the title frames for a movie, it is not even necessary to actually generate a plurality of identical frames at the video frame rate as in conventional techniques, rather, the first frame is generated and then waits until the next changed frame is required. No extra data need be generated.

This provides significant advantages for procedural motion vector compression and/or decompression, including: (i) more compact compression because unused parameters such as real or implied motion vectors do not have to be communicated, (ii) more effective compression because a plurality of advantageous compression/decompression techniques can be intermixed, for example, LZSS for cartoon or graphic sequences and DCT for continuous tone image frames or sequences, (iii) easy extensibility, and, (iv) smaller player code.

Among the numerous features and advantages of the invention there include a novel procedural implementation, and the use of procedural representation for motion data. Motion vector is just an example of a situation where one does not need to send information for every block and figure how to apply it. Any need for code to implement it is eliminated so that the player code can be much smaller if implemented in software. The invention also provides more flexibility for frame rate and how to compress frames and streams of frames. It is possible to intermix different techniques within a frame or a stream of frames, and frame rates can be altered and intermixed. Motion vectors can be specified for entire frame rather than just 16×16 block as in conventional schemes. These features have an additional advantage that one does not need to send parameters that are not needed. Motion vectors can be specified for an entire scene not just for a 16×16 block of pixels, so among other advantages, it is more efficient

Intent Preserving Content Scaling For Device Limitations Or User Preferences

The invention further provides a system, device, method, computer program, and computer program product for intelligently scaling message procedural/data sets to adapt the procedural/data sets to receiver attributes and maintain message intent. The invention also provides a system, device, method, computer program, and computer program product for an intent preserving message adaptation and conversion system and method for communicating with sensory and/or physically challenged persons.

The inventive system and method provide multi-level scaling of content. Content may refer to the “data” component alone, but more usually refers to the “procedural” and “data” elements of the story. Scaling can be performed in any one or more of three ways: (1) When generating the message, (2) When executing the procedural elements of the message, and (3) While the message elements are being rendered by the hardware specific functions (e.g the HAL functions) that connect the portable playback engine to the actual device specific hardware.

For example, in one preferred embodiment, sending story server (see FIG. 1) scales the story content when generating the message to conform to the story enabled clients' 336 hardware capabilities, network connection characteristics, and specified user preferences at the time that such information are determined (see FIG. 7, step 228). In yet another preferred embodiment, story player 194 (see FIG. 5) scales the content of the story when the procedural elements of the story are executed, or played. For example, a digital image may be scaled from 300 dpi to 200 dpi while the digital image is being displayed. In yet another embodiment, story player's 194 HAL may scale the story to fit into a particular display screen size and/or add scroll bars to the display so that an entire story can be viewed.

One embodiment of the invention scales a procedural/data set by: (1) performing a first attribute scaling of a message when preparing and before transmission of the message to a client device based on receiver client attributes and a priori sender knowledge of receiving client device and user preferences; (2) performing a second procedural scaling of the message including executing capability determining procedures embedded within the message after message preparation, message transmission, and message receipt, that determine receiver client capability attributes and select a particular message expression from a plurality of message expressions and element selection available in the received message; and (3) performing a third hardware abstraction layer scaling of the particular selected message expression to adapt the selected message expression for presentation on the client device. It can be appreciated that aspects of hardware abstraction layer scaling include the adaptation of the message expression to match the client device hardware characteristics.

The receiver client attributes can be selected from a group consisting of: a message language preference, a message security preference, a message size constraint, connection speed, audio rendering capabilities, video rendering capabilities, device memory size, device memory availability, device CPU limitations, user nationality, playback engine version or capabilities; and combinations thereof. The receiver client attributes can also be selected from a group consisting of: a speed attribute of a processor within the client device, an available memory attribute of a memory device connected to the processor, an audio capability attribute, a video capability attribute, and combinations thereof. The receiver client attributes may also include a communication link connection speed determined substantially during preparation of the message either (i) prior to transmission of the message, or (ii) after initiation of transmission but prior to completion of transmission of the message.

It can be appreciated that the video capability attribute includes attributes for screen size, monochrome or color display capability, number of monochrome gray scale levels, number of presentable colors, color palate, and combinations thereof.

The procedural scaling of the message (procedural and/or data components) includes a number of determinations such as when an audio message expression is included within the plurality of message expressions, determining whether the client has specific audio presentation capabilities, and when the client does not have a suitable audio presentation capability, selecting a text message expression in place of the audio message expression. In yet another aspect, the procedural determinations include, when first message expression is included within the plurality of message expressions, determining whether the client has a first message type presentation capability, and when the client does not have the first message type presentation capability, selecting an alternate message type expression in place of the first message type expression while still maintaining the intent of the message.

This method may be further defined such that the alternate message type is selected from a plurality of alternate message types for the first message type according to predetermined rules and on the client message type presentation capabilities. Embodiments may also provide that the predetermined selection rules include selecting a text type alternative message when a client does not have any of an audio message type presentation capability, a video message type presentation capability, an audio-video message type presentation capability, a graphic message type presentation capability, or a photographic message type presentation capability.

It can be appreciated that in embodiments the predetermined selection rules may include a hierarchical selection preference that selects the message presentation type that provides a maximum available amount of information possible for the client device. Furthermore, the message presentation type may be selected using semantic information about the elements.

In one particular embodiment, the hierarchical selection preference selects a message presentation type in the order of decreasing preference from highest preference to lowest preference as follows: (i) multi-media including audio and motion video content; (ii) multi-media having audio and still graphic imagery content; (iii) motion video without audio; (iv) still graphic without audio; (v) audio; and, (vi) text. The hierarchical selection preference can select the message presentation type to be a text or symbolic message presentation type when the client device does not support other message presentation types.

The hierarchical rules can be altered by a user preferences, such as a preference that identifies a user of the client device as sight impaired, and/or providing an audio message format type in preference to video, graphic, or text message presentation types.

With respect to performing a third hardware abstraction layer (HAL) scaling of the particular selected message expression as discussed above, such HAL scaling includes adapting a two-dimensional graphical display device having display device characteristics to display a graphical data set that does not exactly match the display device characteristics. For example, if the graphical data set is a three color graphical data set and the graphical display device is a monochrome display device, the scaling includes transforming the three color graphical data set to match the number of gray scale levels of the monochrome graphical display device.

In yet another example, if the graphical data set has dimensions larger than can be simultaneously displayed by the graphical display device, the HAL scaling adaptation includes reducing the graphical data set so that all elements of the graphical data set can be simultaneously displayed. In such an embodiment, a horizontal and/or vertical scroll bar may be displayed so that a user of the client device may sequentially scroll through different regions of the graphical data set.

In yet another aspect, if the graphical data set has dimensions smaller than will fill an available display dimension, the HAL scaling adaptation includes magnifying the graphical data set so that available elements of the graphical data set fill at least one dimension of a two-dimensional display.

In a particular embodiment, audio is adapted to a number of different playback environments. For example, audio can be sped-up during up playback while reducing frequency to maintain normal sound and audio playback can be scaled from mono to stereo and vice versa. Audio can be scaled to move sound around to create 3D effects, generate particular acoustic effects, to simulate different environments, eliminate silence, filter background noise, filter particular frequencies, enhance particular frequencies, adapt to particular persons hearing range, blend sounds, normalize output level (for hearing impaired person using HAL layer), filter to enhance high-frequency components for older persons, special versions of voice, and karaoke filtering to suppress voice but retain music.

With respect to third hardware abstraction layer scaling of the particular selected message expression, an audio playback device having audio playback device characteristics can be adapted to playback an audio data set that does not exactly match the audio playback device characteristics. For example, where the audio data set has a larger frequency range than can be reproduced by the audio playback device, the frequency content of the audio data set is reduced so that the audio data set can be reproduced by the audio playback device. In yet another example, audio playback device characteristics can be adapted by performing a sample rate conversion so that a device that does not supports all sample rates uses software and/or hardware to convert sample rate to a supported rate.

In yet another embodiment, the invention scales a data set by performing a number of steps including performing a first attribute scaling of a message when preparing and before transmission of the message to a client device based on receiver client attributes. Next, performing a second procedural scaling of the message including executing capability determining procedures embedded within the message after message preparation, message transmission, and message receipt, that determine receiver client capability attributes and select a particular message expression from a plurality of message expressions available in the received message. Then, performing a third hardware abstraction layer scaling of the particular selected message expression to adapt the selected message expression for presentation on the client device.

The receiver client attributes are selected from the group consisting of: a message language preference; playback engine software version number; software playback engine capabilities; a message security preference; a message size constraint; a speed attribute of a processor within the client device; an available memory attribute of a memory device connected to the processor; an audio capability attribute; a video capability attribute including video attributes for screen size, monochrome or color display capability, a number of monochrome gray scale levels or a number of presentable colors and color palate; a communication link connection speed determined substantially during preparation of the message either (i) just before preparation while the communication link is still open; (ii) prior to transmission of the message, or (iii) after initiation of transmission but prior to completion of transmission of the message; and combinations thereof.

The procedural determinations include, when first message expression is included within the plurality of message expressions, determining whether the client has a first message type presentation capability. When the client does not have the first message type presentation capability, an alternate message type expression is selected in place of the first message type expression while still maintaining the intent of the message. The alternate message type is selected from a plurality of alternate message types for the first message type according to predetermined rules and on the client message type presentation capabilities.

The predetermined selection rules include a hierarchical selection preference that selects the message presentation type that provides a maximum available amount of information possible for the client device The hierarchical selection preference selects a message presentation type in the order of decreasing preference from highest preference to lowest preference as follows: (i) multi-media including audio and motion video content; (ii) multi-media having audio and still graphic imagery content; (iii) motion video without audio; (iv) still graphic without audio; (v) audio; and, (vi) text.

In one embodiment, the hierarchical selection rules can be overridden by a user preference. Such user preferences include, for example, a user preference identifying a user of the client device as sight impaired, and providing an audio message format type in preference to video, graphic, or text message presentation types. The audio for the hearing impaired person audio can be converted into text and rendered so that the text flashes on the screen all at once, so that the text appears sequentially on the screen or scrolls on the screen, or so that the text is animated in some way (e.g. moves around the screen in some way, e.g. to avoid covering other text or information on the screen).

Another aspect of the invention covers performing client attribute scaling of a message when preparing the message before communicating the message to a client device based on receiver client attributes. This aspect also covers performing a procedural scaling of the message within the client device including executing capability determining procedures embedded within the message after message preparation, message communication, and message receipt by the client, that determine receiver client capability attributes and selecting a particular message expression from a plurality of message expressions available in the received message.

In another embodiment, the invention is a method for optimizing content sent to a client device for a user that minimizes transmission bandwidth while maintaining the intent of the content. The method includes: (i) scaling the content (story) by the producer (composer engine) producing the content so that the data and procedural aspects of the content are scaled to match anticipated attributes of the target client device and user preferences at the time of composing the content; (ii) scaling the content by the story during execution of procedural content (instructions) to match the capability of the client device after the content is received by the client device; and (iii) scaling the content by the hardware abstraction layer to match client device specific characteristics to enable playback of the content on the client device.

In this embodiment, the hardware extraction layer scaling includes the steps of: (i) comparing the hardware resources required to perform an action requested by the story procedure executing in the client with the hardware resources available in the client device; and (ii) performing a substitute action for the requested action if the available hardware does not permit performing the requested action.

The substitute action is selected from the group of actions consisting of: (a) substituting an alternative content of a different content type for the requested content; (b) modifying the manner in which the requested content is presented to the user; and (c) modifying the requested content so that it can be presented to the user in its modified form. The invention provides the following substitute actions if the content is a digital image and the digital image is too large to be displayed as a single image on the client device: (i) substituting a text description of the image for the image; (ii) displaying a portion of the image and providing the functionality of scroll bars so that the user may interactively scroll to different portions of the image viewing only a portion of the image at a time, (iii) decimating pixels of the image to reduce the size of the image to fit within the display area of the device display; (iv) processing the image to reduce the size of the image to fit within the display area of the display device; (v) substituting a smaller image; and, (vi) combinations of (i) through (v).

If the content is an audio content and the client device does not provide audio content playback capabilities, the substitute action comprises substituting a text description of the audio content. If the content is an image or video content and the client device does not provide imagery or video content playback capabilities, the substitute action comprises substituting a text description of the imagery or video content Furthermore, if the content is a text content and attributes of the client or the user indicate that the user is a blind individual and the client device provides audio output and text-to-speech conversion, the substitute action comprises performing a text-to-speech conversion of the text description to generate an audio content.

Content Adaptation and Scaling—Message Content Element Semantics

The invention further provides a system, device, method, computer program, and computer program product for searching and selecting data and control elements in message procedural/data sets for automatic and complete portrayal of message to maintain message intent; as well as for adapting content for sensory and physically challenged persons using embedded semantic elements in a procedurally based message file.

In addition to providing story information or content (multiple-richness levels and alternative and backup content types as already described) that may be sensed by individuals who are sensory and/or motor challenged or have particular sensory or motor disabilities, the inventive system and method provide structures and procedures for identifying substantially all information that can be portrayed automatically and that will portray substantially all of the information that needs to be communicated. This is provided in the inventive system and method by using the semantic flags within the story, by providing procedures that can search for or otherwise identify the semantic flags or sets of semantic flags and associate them with particular navigation type, content type, other data or procedural characteristic, and the like, and the manner of searching through these semantic flags and using the information items or the characteristics of the information items thereby identified.

In one embodiment, the invention provides a method for communicating an idea to a user that includes a sensory or physically challenged user. The method includes a number of the following steps: (i) identifying an idea to be communicated to a user; (ii) collecting and storing a plurality of alternative expressions for the idea, each the alternative expression being associated with a different one of a plurality of possible outputs generated by a client device, each the output intended to stimulate a different sense of a user; (iii) composing an electronic content encompassing the idea from selected ones of the plurality of alternative expressions; (iv) communicating the electronic content to the client device for presentation to the user; (v) selecting a particular output to generate from among the plurality of possible outputs; and (vi) executing instructions in the client device to generate the selected output so as to stimulate a particular one of the user senses.

According to one aspect of the invention, a semantic flag mechanism provides multi-information for identifying and enumerating content items according to their meanings and relationships to other items to be communicated as part of the message intent-sensor capability.

In yet another aspect of the method to adapt and scale story elements, the method further includes steps for soliciting user input in one or more of a plurality of manners selected from the set consisting of: enumerating the available user input sources and selected from one of the enumerated input sources, entering choices in words where the manner of input is a combinations of words, characters, letters, numbers, sentences, paragraphs, sets of paragraphs, articulated text, so as to provide an input for filling out forms It can be appreciated that the user senses can be selected from the group of senses consisting of sight, hearing, touch, smell, taste and combinations thereof. Moreover, the client device possible outputs can include: a display device for presenting symbols, text, graphics, and pictures and/or motion video sensible by a user's eyes; an audio output device for presenting a sound sensible by a users ears; a tactile output device sensible by a users touch at or through a skin surface; an electronic signal for coupling to a user skin surface mounted or internally implanted sensory transducing device adapted to produce a sensory experience for the user.

In one aspect, the step of selecting a particular output to generate from among the plurality of possible outputs includes: (i) the selection by the user when the content is received; (ii) the selection being selected in response to an indicator received with the content; (iii) the selection being selected in response to user preferences identified prior to receipt of the content; (iv) the selection being selected in response to client device characteristics.

Such client device characteristics are selected from the group consisting of: client device hardware characteristics, client device software device characteristics, client device firmware characteristics, client device programmatic characteristics, client device data characteristics, and combinations thereof.

Where user inputs are solicited, such inputs can be selected from the group of inputs that include eye movements, direct sensing of brain signals with electrodes, direct sensing of neuromuscular signals, sensing of skin characteristics, and combinations thereof. It can be appreciated that in one embodiment, the tactile output device can generate a Braille tactilely sensible indicia.

In one particular embodiment, the plurality of alternative expressions for the idea includes symbolic expression. The plurality of alternative expressions for the idea can also include a text expression for each content item including a description of all audio and graphical content. Additionally, the sensory challenged user can be a sight impaired user, a hearing impaired user, a sight and a hearing impaired user. Furthermore, semantic information contained in the message can be associated with the message and used in conjunction with the solicited user input.

In yet another aspect, user input solicitation and enumeration can be performed by moving a single button to cause the selection to be sequentially highlighted or sequentially articulated or tactilely identified. However, it can be appreciated that the user input solicitation and enumeration can also be performed by an act selected from the set of acts consisting of: select from articulated text, selection from items enumerated by voice, button pressing, double mouse button clicks, selection based on button press during an automated continuous sequential enumeration of the available selectable items, selection based on button presses that cause the individual enumeration of selectable items in an order based on which buttons are pressed and with an additional button press to perform the actual selection and combinations thereof.

In yet another aspect of the invention regarding content adaptation and scaling using story element semantics, the invention provides a multi-sensory electronic content package for communicating with sensory impaired users, wherein the package comprising procedural portions and data portions. In one embodiment, there are semantic flags and text behind at least a subset of the logical elements of the message to be communicated. The semantic flags allow for automated procedural enumeration of the elements needed to communicate the intent of the message and user interaction methods for presentations in a manner conforming to the selection of a given set of flags of interest and the values that the flags of interest must have if each element is to included in the enumeration.

The semantic flags' meanings indicate one or more of the following with respect to identified content first level complete story message overview, second level complete story overview, first level single screen overview, second level single screen overview, contains text, contains audio, contains video, contains text backing, contains audio backing, contains video backing, is selectable, is visible, selection action description, is played back as audio for this screen, can be omitted without losing intent of message, suitable for hearing impaired, suitable for visually impaired, suitable for people with disabilities of movement, describes what happens when selection is made, describes complete list of currently selectable items, is complete text containing the entire intent of message, is objectionable for rendering for children under 12 years of age, is objectionable for rendering for children under 18 years of age, is objectionable for rendering for children under 120 years of age, contains religion related content, contains Christian related content, contains Jewish related content, contains Muslim related content, contains Atheist related content, contains material objectionable to men, contains material objectionable to women, and the like. These are merely exemplary and any other indicator for particular content type may be applied and coded.

In one particular embodiment, additional semantic flags can be added to the semantic flags to further refine the meaning of the semantic flags as being of a certain priority, level, or order with respect to the other the semantic flags which may be set for an element or set of elements.

In yet another embodiment, a given set of flags of interest are isolated and identified by the process of performing a binary logical “and” operation of the set of binary flags, with a mask value identifying the given set of interest. In one aspect, the result of the “and” operation is compared to a set of required binary values to determine if the element or elements associated with the semantic flags meet the criteria for inclusion in the enumeration of selected elements.

In one embodiment, the semantic flags meet the criteria if the result is found to be equal to the required binary values. In yet another embodiment, the semantic flags meet the criteria if the result is found to be not equal to the required binary values. In yet another aspect, the semantic flags meet the criteria if the result is found to contain a number of set flag bits above a given threshold, above or equal to a given threshold, below a given threshold, below or equal to a given threshold or equal to a given number.

The semantic flags can be further refined as to their respective meaning(s). For example, a semantic flag can be used to indicate that identified content can be used on a particular device, operating environment, playback engine version or versions, and/or application.

Story File Versioning for Story Playback Forward and Backward Version Compatibility

The invention further provides a system, device, method, computer program, and computer program product for forward and backward content based version control for automated autonomous playback on client devices having diverse hardware and software.

In a preferred embodiment of the system and method, it is expected that all stories ever created will run in all environments that are ever made appropriate for stories. This feature is referred to as content versioning or in the context of a story, as story versioning. At least in part because the story system and method have procedural foundations, instructions or commands are provided to adapt an old story to a new feature (i e to a newer version of a story player) or to adapt a new story to an old set of story features (i.e. to an earlier version of a story player). For example, using the versioning methodology, a story player and/or the device executing the story player adapts if the (presumably) newer procedures or instructions received in a story file could not be understood. The recognition that an instruction is not understood may be based on internal programmatic comparison between known instructions (such as by comparing opcodes or other instruction indicators) or based on the comparison of an explicit version number identified in the received story file as compared to the version of the story player.

At least in part as a result of hierarchical content or message richness where the lowest richness message or content is a text message or content, and a convention in which support for text-based message or content is and will be supported for all versions of stories, at least a text based message or content will be interpretable and playable in all versions of stories and on all story players. In at least one embodiment, the story player by convention ignores any commands, instructions, or opcodes it does not understand and plays the text message. Compatible procedures are always communicated in the story files and playable within the story players. In one embodiment, the story player recognizes the receipt of a story file that is compatible with and contains features of a newer version of the story player and provides the user with an opportunity to download or otherwise acquire the updated story player software or firmware, either prior to playing the received story file or at a later time. However, maintaining compatibility with older story players is advantageous as in some devices it is anticipated that the device may not readily be ungradable or that memory requirements for a new version may not be sufficient with some third-party devices.

Even if you have a story that is made rich and in the future you are using new instructions that weren't around at the time the prior story was generated, you will still be able to play the old story. The story is procedural, and if it procedurally determines that the device doesn't have some capability needed to execute parts of the story, then it will execute other parts that the device does recognize and implement.

Players can therefore be very thin or very light. In some embodiments of the players that provide only a basic set of features and limited richness, the core software or firmware is only from about 2 kilobytes to about 8 kilobytes depending upon what is provided in the core of the engine, including the entire run-time module. The run-time module advantageously has very little overhead as compared to conventional systems and methods, such as for example, as compared to RealVideo (typically about 7 Megabyte) or Java playback engine (typically at least about 100 kilobytes or more) even though such typical systems and methods do less than embodiments of the inventive player. It is understood that some embodiments of the story player will be larger when additional optional features are implemented.

In one embodiment, when a new version story file is received, a determination is made by the story procedure itself as to the player version number or other version indicia. There are actual story procedures that decide which version of the story player (software or hardware) is present. If the version of the player that it is playing on is not right, the story procedure itself branches to different procedures within itself that are correct for the version of the story player that will are playing the received story.

In the preferred embodiment, it is the story procedure that decides, not the story player, as the player will not have the intelligence or the information to make this decision. This is particularly true where there is an old player and a new story having features that were not available when the player was implemented Typically, a story will contain several complete message intent representations at different richness levels. At the head of each representation there are procedures that determine whether the playback device has the capabilities to render the representation at the intended richness level. This determination is performed only using instructions know to be part of every playback engine ever made. If the PBE and device support the opcodes, functionality and capabilities checked for by the heading procedure for a rich media representation, they will execute the procedures rich media representation procedures If the play back engine or device does not have the functionality and capabilities needed to run a particular rich media representation in the story, then the procedure will branch to the header procedure for the next lower-richness media representation. This determination and branching may be direct or iterative. Procedural tests may be combined with the branching so that alternative procedures may be executed depending upon the result of the conditional test or tests. A direct determination uses information to match a richness level of the story content to the richness level appropriate to the player in one step. An iterative approach progressively compares the different richness levels in the story to the richness level that can be rendered, starting at the highest richness level, and progressing to lower richness levels. Ultimately the iterative procedure matches player to an available richness level, the lowest richness level typically being text or some other symbolic form that can be rendered in some manner on all story playback engines or devices in some manner, for example by displaying the text or using a text to speech algorithm to articulate the text.

In one embodiment, the playback engine version number (or other indicia) is used to determine its playback capabilities. With a properly constructed story, the playback engine should never encounter instructions that it does not know about or does not understand even if newer instructions and capabilities are contained in parts of the story. For example, if the story player is a new version, the new instructions included in the new version story are executed or otherwise used so that the (presumably) enhanced newer features associated with the newer version stories are accessible. On the other hand, if the story player receiving the new version story is an old player, then the story procedure will detect this and not branch to or execute any procedures containing new instructions not supported by the old player. The manner in which the new version story is played on the old version player is not intended to be random or problematic. Even though a future story feature or the associated instructions to implement that feature may not be known at the time the old story player was created or last updated, by convention all story content checks its requirements before executing any instructions that might not be supported by the player. Also by convention each high richness media element is backed up by a lower richness media element, as described elsewhere in the specification. Recall, for example that a motion video element is backed up by a still image element, which is backed up by a text element describing the still image element.

The terms old and new as used here are intended to represent relative versions, as it is likely that numerous versions of the methods and computer software will exist and that improvements and enhancements will be provided. Hence an old version is any earlier version, and a new version is any later version.

Consider the scenario in which an old story player had been created in which motion video playback was unsupported. Upon receiving a new version story file having motion video, the story procedure checks for the player's capabilities using only instructions known to be supported in the player. Then, the story procedure executes alternative procedures containing only instructions now known to be supported by the player Unrecognized instructions or indicia and data which might otherwise cause the story player to hang, crash, or otherwise fail are not encountered or executed. Rather, according to a set of programmatic rules, the player simply avoids executing such unknown instructions. According to the organization of the story file, the still image would be encountered and executed if the player supports playback of still images, or lacking that capability, the instruction for displaying the textual description of the motion video and/or still image would be executed to playback the text. Text is desirably supported in all versions of stories and story players. Audio playback of a text message may also or alternatively be used when supported.

It may be seen from the above example, that generally the only loss that occurs when an older version of a story player receives a story file created using newer story features or enhancements to features is that the story rendered is less rich than it might otherwise have been. Similarly, if an old version story file is received by a new player, the old story file will be played back correctly either because all of the old file's instructions and data are still interpretable by the new story player or because the new story player has been made aware of the old instructions and formats and performs some conversion to the new format.

It will be appreciated that these features allow all stories to be played in all story players for all time, reduces obsolescence of old players, and increases the likelihood that the intent of a story message will be maintained substantially independent of the story player on which it is ultimately received and played.

The invention therefore provides system, method, and computer program for procedurally assuring that message intent is preserved and substantially optimized on players both older and newer than the story content. In some embodiments, the semantic information associated with story access elements built into the story message is used to procedurally substantially optimize the message for the playback capabilities while preserving the message intent in its rendering.

Stability and Security Through Single Memory Allocation and Instruction Checking

The invention further provides a system, device, method, computer program, and computer program product for reducing unauthorized access by procedural messages executing in a computer system to computer system or memory or programs or data stored therein. Single Memory Allocation allows for small code size where maintain security avoiding attacks by hackers who would try to gain control or information from a story device by sending stories which access or execute their non-story procedures or programs through various means. Some of these means and the structures and methods taken to counteract them in the inventive system and method are described below.

Security and Computer Hacker-Proofing

Story implementation code has to be carefully constructed to ensure the security required for email based messaging that needs to work well on a large variety of devices. Great care must be taken in writing Story Playback Engine (SPE) code to make sure it does not introduce any security holes. Security is a very high-priority programming concern because the code will be installed on millions of devices. If a hacker finds a way to take control of people's computers through a security hole in the software it could be a disaster for the users.

The playback engine (PBE) code and architecture carefully guard against hackers being able to send email or Stories to user's devices that can do harm to or take control of the target device through security holes in the PBE software or hardware. Most security holes involve taking advantage of bugs in code to get control of the device. The Story Playback code is architected to be resistant to such attacks, but it still requires careful coding to make sure that no holes are created. For example, Story procedures operate in a “sandbox” manner in that no functions are allowed to access memory or files that do not belong to the Story that is playing. If Story procedures were allowed to open files by file name this would be an obvious way to gain access to information outside of the Story Message related files.

No Input Buffer or Stack Overflows

One way to gain control of a computer is by providing so much input information to a program that its data structures designed to receive that information can't handle it. The data that overflows the program's data structure can overwrite other parts of the program that may eventually get executed, only now what is executed is the hacker's code that wrote over the original program instructions. If the receiving data structure is on the stack then the overflow data may overwrite a return address so that a hacker's code will be executed upon return from a function. For these reasons story playback engine code always checks the size of data structures to be written to or read from to sure all the information that is to be stored there will fit, before writing the data and that no information outside the story and playback engine itself can be accessed.

Just as attention should be provided against input buffer overflows, the SPE code or hardware also guards against overflow of the native processor stack (as opposed to the SPE's Story thread's stack). Without precautions in the SPE code, this could occur as a result of recursive Story parameter indirection (see discussion of indirection elsewhere in this specification) or the use of deeply-nested Story subroutines.

No Bad Indexes and No Bad Parameters Sent to the Operating System

Functions make sure all array indexes are in range before using them. Hardware Abstraction Layer (HAL) functions are used to marry the portable playback engine to a particular device or OS. Care is taken to never allow invalid or out of range values to be passed to the OS functions that might cause these functions to overflow any of their input buffers or otherwise cause any malfunction (e.g. crash). Aside from robustness, any possibility for buffer overflow or errant execution in the OS is a security hole that may be exploited by hackers.

File Access

The SPE will not access files directly by name, but rather by a two-number ID. These numbers are passed to a HAL function that can only open files located in a single temporary Story directory and whose names can be derived in a very specific manner from the two-number ID given. The temporary directory will contain only files local to the Story currently playing.

One Memory Allocation and No Pointers in Allocated Memory

To make it easy to defend against memory accesses outside of that memory allocated by the SPE itself, a single OS memory allocation call is made when a Story initialization opcode, INIT_OP, is executed All memory allocations are made during Story execution from within this one main allocated block of memory No (or few) pointers are allowed within the main allocated block of memory, only references to other sub-allocated memory buffers by number. Any pointers used within instruction implementation functions must be explicitly checked by calling a single function:

void AllocatedMemoryBlockSecurityCheck

(

PSU8 pu8,

SU32 u32_SizeInBytes

);

If one knows the maximum size of the access at the time a buffer number is turned into pointers, then pointers to buffer memory can be checked as part of the call to:

(

void GetPointersFromBufferNumber

SU32 u32_BufferNumber,

SU32 u32_MaxDataSizeInBytesForSecurityCheck,

COMMON_BUFFER_HEADER_TYPE **ppcbh,

SU8 **ppu8_BufferData

);

These functions make sure the access will be within the main allocated block. This helps to keep the code size small, because a single function can be used to check all memory accesses without the need to have one function for each sub-allocation. It should be noted that Story procedures will be able to write over any sub-allocation block, and even write and execute complete Story procedures. The important thing is that the worst outcome of a poorly coded or maliciously coded Story is an infinite loop within the Story execution. A Story should not be able to crash or access memory outside of its own allocated memory under any circumstances.

In this regard, the invention provides a method of maintaining anti-hacking security in a computer system, especially a system that executes procedural messages or other content using native code to carry out or otherwise perform the procedures contained in the messages. In one embodiment, the method comprises the native code carrying out the procedures of the message allocating, in a single operation (such as for example a single atomic operation) one contiguous memory block range having a single memory boundary position as a buffer. The buffer is used for data or other storage. The allocated storage buffer is protected from overflow by: reducing the number of operations a computer program (such as the native code) uses to carry out the procedures of the message that obtain memory pointers to the allocated buffer, and checking attempts to access memory locations outside of the allocated single memory block range only against the single memory boundary position of the single buffer memory block range. By so doing, the likelihood that a computer system or information appliance hacker attempting unauthorized access can create a buffer overflow and thereby obtain access to other memory ranges to gain entry or control over functions or data of the computer system is reduced if not effectively eliminated.

In one embodiment, the inventive system and method are further defined such that the message procedures optionally include instructions which sub-allocate all memory regions from the single memory block. The message procedures may also optionally include instructions which can cause the single memory block to be destroyed and reallocated when different parts of the message are executed, thereby providing procedural flexibility while avoiding the complexities normally associated with memory garbage collection algorithms. This latter feature may be further augmented such that the message procedures include at least one instruction which can preserve some or all parts of the data or other information stored in the the single memory block in a second allocated memory block, which is itself also checked to make sure accesses outside of the second allocated memory block are never made while the single memory block is being reallocated. Finally, the second allocated memory block may be defined such that it is always available during execution of the the procedural messages and accesses are checked to be contained within one of the two allocated memory blocks.

This method may be further defined such that the computer system includes a story player device. It may also be defined such that the computer code to perform memory checking is uniform and compact, and/or to provide for a common core of instructions operate on memory. In the method first described above, the method may provide that a hacker attempting to produce a memory buffer stack overflow in order to introduce executable code into the system is substantially prevented by the single memory range allocation and checking. In some embodiments, the computer system is provided more stable operation as a result of the predictable memory operating environment.

Self-Directed Buffer Loading Procedure

The invention further provides a system, device, method, computer program, and computer program product for self-directed loading of an input buffer with procedural messages from a stream of sub-files containing sets of logical files.

In many conventional systems, large input data or file streams are loaded into input buffers as they are received, then checks for ends of buffers are performed as the input stream is consumed. The problem with this approach is three-fold. First, there is a need to constantly check to determine if all of the input data has been received, that is, if it is out of data. This imposes an execution time penalty. Second, different size input memory buffers and other variable factors can cause data to be loaded in different places in memory and in different amounts each time the story is played whether or not on the same player or device. This second factor makes it more difficult than necessary to test for and identify program bugs. Third, program code size is increased beyond what is necessary based on need to check to determine if the time to reload or reset the buffer to handle buffer switching or buffer wrap when data gets to the end of current memory buffer.

In embodiments of the present invention, these problems are reduced or eliminated. Story instruction streams explicitly load data deterministically into the input buffer. This is accomplished using the LOAD OP story instruction whenever data is to be loaded. This LOAD OP story instruction specifies exactly where to load new input code into an input memory buffer from a logical file. Also this instruction can cause data in an input buffer to be moved before new data is placed into the input buffer.

This inventive approach results in (1) less program code, (2) faster program execution, and (3) deterministic behavior that lessens the probability that program bugs (particularly untested or undiscovered program bugs) will occur during operation.

The invention provides a method for loading a procedural input explicitly and deterministically using instructions in the playback stream itself. With this method it is up to the programmer or compiler which creates the story code to ensure that each LOAD_OP instruction loads enough of the story code so that another LOAD_OP will be executed before any code not in the buffer is executed. It is also usually necessary to bootstrap the very first loading of procedural code into the input buffer when starting a new story playback

In one embodiment of the invention, the story player, after being initialized, performs the following procedure: First, the story playback engine initialization function is called before each new story playback begins, this initializes the story thread number zero. The zero thread state is set to “running” and its input buffer is set to be associated with logical file with content ID equal to zero (0) and current file number zero (0). The idea being that at startup it goes to logical file 0, content ID 0, and loads the first set of words (in one embodiment it loads the first set of thirty-two words) so it can get started. Next, the story playback cycle function is called repeatedly to perform one execution of all active (or running) threads until all of the threads have yielded. The first time the playback cycle function is called, logical file 0,0 (content ID=0, current file number=0) is opened and the first thirty-two (or other predetermined number) of 32-bit (or other size) words are read in.

Thirty-two words was picked in one embodiment for the amount of information (data and/or procedural information) so that there will be enough instructions to allocate memory and load more instructions, and not so many instructions that you waste space and execution time if you don't need it all. Other numbers of words to read may be used and can be any convenient number satisfying this goal. For example, 16, 32, 50, 64, 100, 128, or other number of words may be read. Note that there are stories that do not have more than this so it is not necessary to read this much or to read more than this in later steps. Within these thirty-two 32-bit words there must be a LOAD-OP (or equivalent) if the story procedure is not contained in the thirty-two 32-bit words.

The invention therefore will be seen to provide a method and various procedures or sub-procedures within the method that may be implemented as a computer program and stored as a computer program product. The invention also provides a information appliance, computer, computer system, and the like that implements the functionality provided by the method and program.

In one particular embodiment for a computer or information appliance, the method provides for self-directed loading of a buffer from an input stream containing at least one procedural thread having at least one executable instruction. The input stream and executable instruction may frequently include optional parameters associated with the executable instruction, however such optional parameters are not required. This embodiment of the inventive method includes several steps. First, a first story thread is initialized to a “running” state. Then, a particular input memory buffer from among a plurality of available memory buffers within the device is assigned to the first thread; and the the first thread input memory buffer to be associated with the logical file in the input stream having content ID zero (CID=0) and current file number zero (CFN=0) is set, so that at story playback startup the device loads from the first content portion (CID=0) of CFN=0=content file number. Next, execution begins with the first logical file in the first sub-file with CFN=0 and CID=0; and subsequent logical files within other subfiles that have arrived at the information appliance device or are yet to be streamed into the information appliance device are accessed, so that playback can begin according to predetermined criteria or preferences or instruction before all the sub-files and their constituent logical files have been received. The first thread starts the processing of the procedures and other threads that render the other portions of the message. All or substantially all loading of succeeding procedural and data elements of the messages is performed by explicit procedural load instructions. Thus the procedures are themselves self loading. One execution of all threads having the state of running are performed including first performing one execution of the first thread having CFN=0 and CID=0; and then repeating the step of performing executions of threads until all of the threads have transitioned from a running state to a non-running state, each non-running thread transitioning from a running state to another state. When the step of performing is performed the first time after initialization, opening logical file having CID=0 and CFN=0, and reading into a buffer a first predetermined number of words, where in a preferred embodiment each word has a predetermined word size, which size is desirably fixed for all words. The predetermined number of words either containing an entire story procedure or containing a load operation for loading any portion of the story procedure not contained in the predetermined number of words.

Although the procedure described immediately above provides for ready implementation, the idea is much broader in that the message includes procedural portions that direct the manner in which the currently received portion of the message will be loaded as well as controlling the manner in which subsequently received portions will be loaded into one or more input buffers. This self-direction can be direct when it controls its own loading, or indirect when it controls the loading of alternative procedures which will in turn direct their own loading at a later time.

Several variations or options for the above described method may be implemented. These are now listed or described briefly. The base method may provide that explicit message procedure load instructions are the only method of procedural and data input words of the message, once the initial words of CID=0 and CFN=0 have been loaded at startup. The first message thread may be defines as thread number 0. The running state may further comprise a state selected from the set consisting of a running state, a suspended thread state, and an uninitialized thread state. Other states may also or alternatively be implemented.

When and if explicit message procedure load instructions are the only method of procedural and data input words of the message as described above, a second descendant thread may optionally be created, associated with input buffers and have their states set as a direct result of procedures executed on a particular thread, such as on thread 0 starting with the initial loading of words from the logical file with CID=0 and CFN=0. All other threads are then created, associated with input buffers and have their states set as a direct result of procedures running on the descendant threads or descendants of these threads. Furthermore, any thread in a running state can set or reset any or all attributes of any other thread or its own attributes. These optional steps enable very powerful additional features.

In one embodiment, the explicit procedural load operations are implemented with a LOAD_OP instruction that is provided as a member of the instruction set. Information contained in the input stream is deterministically and explicitly loaded into the input buffer in response to execution of the load operations contained within the input stream.

The base method including some of the optional steps and procedures described therein may operate with the threads comprising a general class of threads as are known in the art or with threads comprising StoryMail story threads as described herein. The step of performing execution may optionally be implemented with a story playback cycle function, and the step of repeatedly performing execution is implemented by repeatedly calling the story playback cycle function. As mentioned elsewhere in this description, fixed word size and fixed numbers of words may advantageously be used with the invention generally, and in the case of this self-directed loading base method, the first predetermined number of words may advantageously be a fixed number of words. The fixed number of words may be chosen to satisfy programmatic, efficiency, and other needs and may be influenced by the nature of the content and intent of the message itself so that it would vary from implementation to implementation. Device characteristics may also influence optimal number of word selection. Usually, the number of words will vary from 8 words to 1024 words, more typically between about 16 words and 512 words, and even more frequently between 16 words and 128 words. In one particular embodiment, the fixed number of words is 32 words and provides good performance for the StoryMail content being communicated.

With respect to word size, embodiments of the invention having 16-bit, 32-bit, 64-bit, 96-bit, or 128-bit word size may be provided. These sizes are exemplary and though powers of 2 for word sizes are conveniently used as a result of computer (processor, memory, and the like) architectures, non-power of two word sizes may also be used. Furthermore, 8-bit words as well as larger bit words may be utilized but when word size is too small or too large some compromises in performance may occur.

In some embodiments of the invention, the input buffer loading is accomplished in predetermined fixed-length blocks. The load operation may optionally specify a particular location in an input memory buffer to load the newly received logical file or portions thereof. The method may also optionally include the further step of executing an instruction causing data in an input buffer to be moved to another location before new data is placed into the input memory buffer. The instruction causing data in the input buffer to be moved when present may comprises a buffer data move instruction. The load operation instruction may optionally further cause data in an input buffer to be moved to another location before new data is placed into the input memory buffer. The input buffer loading procedural components within the logical files explicitly and deterministically use instructions in the playback stream itself for directing input buffer loading. These procedural components may be and preferably are self-loading.

The method may further comprise constructing the input stream according to some set of rules, guidelines, or procedures to ensure that each load operation instruction contained within the stream loads enough of the stream to that another load operation instruction will be encountered and executed before any code not in the input memory buffer is needed.

When a bootstrapping portion is present, the method may optionally include bootstrap loading a first portion of procedural code into the input memory buffer when starting a new story playback. The bootstrap loading may for example comprises loading a procedure to initiate loading of the stream into the input buffer.

To the extent that the information stream has characteristics that support the self-directed loading features described here, the invention further includes a method for building an information stream for self-directed loading and playback in a computer, information appliance, or other information stream receiving device or system. The method includes the steps of: constructing a single physical or virtual file as a concatenation of a plurality of sub-files, which contain sets of logical files; and constructing each sub-file to include at least one procedural thread having at least one executable instruction and optionally including parameters associated with the instruction. The single concatenated file is build consistent with the above described method to provide desired self-directed loading and execution.

The inventive methods may readily be implemented as one or more computer programs or computer program code modules that may be stored in a storage device such as ROM and/or RAM and executed by a processor or microprocessor in a computer or other information appliance. As such the invention provides the device or system preparing the information stream for transmission to a receiving device as well as the device or system receiving and playing back the stream.

Procedurally-Based Device-Neutral Display Layout and Rendering

The invention further provides a system, device, method, computer program, and computer program product for device-neutral procedurally-based content display layout and content playback. As earlier described, like many other aspects of stories, the screen layout of displayable elements is performed procedurally. This provides some novel and advantageous capabilities for a procedural layout scheme using rectangular regions and one degree of freedom. In a preferred embodiment, the inventive system and method provide for procedurally-based layout and display of information, including both graphical and symbolic (e.g. text) information, on a display device. Procedurally-based layout and display is advantageous as it permits the story to be authored without prior knowledge of the particular hardware characteristics of the device on which it will be displayed and simplifies such display. This is desirable even in the situation where the story composer determines the characteristics of the hardware on which the story will be displayed prior to completing authoring (composing) the story file and communicating it to the player because it allows for a wide degree of customization at run time.

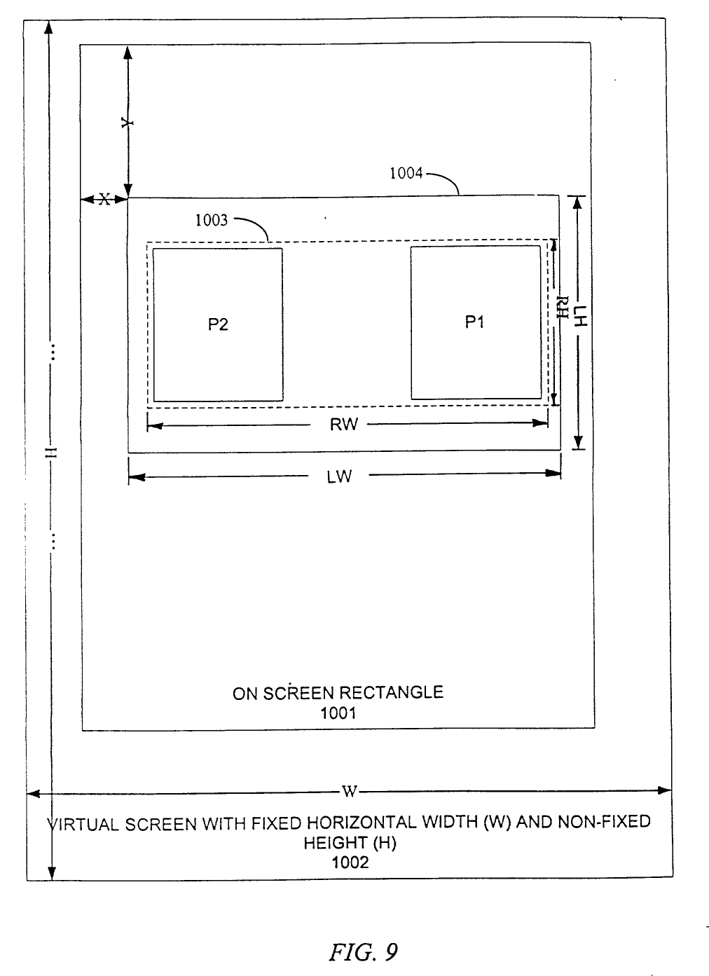

The procedural nature is advantageously described by an example relative to FIG. 9 which illustrates some of the relationships between the various layout and device display parameters. For purposes of this description, and to provide generality, it is assumed that exactly one of the horizontal or vertical directions of the display device or available display area has a fixed size. The other of the two directions is assumed to be infinite or at least larger than will ever be needed to display an object. These assumptions are made because a single layout model with a high degree of flexibility can easily be implemented with scroll bars and/or paging mechanism to implement a system to display large amounts of screen information even when the actual screen area is more limited than the amount of information that you want to appear on the screen. In a preferred embodiment the horizontal dimension is a fixed size as measured in pixels and the vertical dimension is logically unlimited.

Before describing embodiments of the inventive layout method in detail, certain concepts and definitions are set forth that assist in understanding the method and its procedures. Particular exemplary instructions or operations from a code set that have been implemented on one prototype embodiment are set forth parenthetically after its generic description. The description of the operation generally follows the order of execution, though a more through description of embodiments of the method are provided below.

First, each element to be rendered is assigned to a display descriptor (DisplayDescriptor) element of a display descriptor array buffer. In one embodiment, this is done using the display descriptor operation (DISPLAY_DESCRIPTOR_OP), where each display descriptor includes one or more of a display content buffer number, a screen rectangle, and a hotspot descriptor array. A set rectangle operation (SET_RECTANGLE_OP) is then used to set the layout rectangle (layoutRectangle). Next, a layout operation (LAYOUT OP) is used to place a list of display descriptors (DisplayDescriptors) inside the layout rectangle (layoutRectangle). A “horizontal-center-then-vertical-center” layout procedure or method (HORIZONTAL_CENTER_THEN_VERTICAL_CENTER_LAYOUT_METHOD), may for example be used, among other possible methods. The layout rectangle (layoutRectangle) is then reset if needed to layout something else according to the results of a previous layout operation (LAYOUT_OP); and, if there are more elements to be laid out then the set rectangle operation (SET RECTANGLE OP) is applied for each element.

Separate branching flags are set if a layout operation (LAYOUT OP) found that an item does not fit in some way. For example, the item may not fit at all, may not fit horizontally and was therefore wrapped to fit in additional space below a portion already displayed, or does not fit because the layout went outside the layout rectangle in the vertical direction. Conditional jump operation (JUMP OP) instructions can therefore be used to perform complex procedural layout functions.

With further reference to FIG. 9, consider a visible or on-screen rectangle 1001 (the pixels that can be seen on the actual physical screen of a device having width (W) and height (H), that is a visible or on-screen rectangle of dimensions Width×Height (W×H). Also consider a logical or layout rectangle 1004 used for placing spaced multiple items within the visible screen. The layout or logical rectangle 1004 is the amount of screen that is allocated to a particular display task or set of items. Note that because of the presence of scroll bars and/or the assumption that the screen in infinite (or very large) in one dimension, the layout rectangle may be smaller or larger than the visible rectangle. Almost always the layout rectangle will lay within the boundaries of the virtual screen rectangle 1002 with width W and height logically unbounded. The layout rectangle is specified using instructions that specify LW, LH, and (x,y) coordinate, where LW is a layout rectangle width, LH is a layout rectangle height, LW×LH is the product of the two, and (x,y) is the location or coordinate of the upper left corner of the rectangle with respect to the visual screen rectangle 1002. A layout resultant bounding rectangle (1003) of size RW×RH, RW defines the outside area limits of a set of laid out elements. All item rectangle boundaries placed by the LAYOUT_OP instructions can be optionally added to the resultant bounding rectangle as they are placed. The Story may empty the resultant bounding rectangle 1003, or allow the LAYOUT_OP instructions to add to the resultant bounding rectangle 1003 of previous operations. Separate branching flags that can be tested by JUMP_OP conditional instructions are set by the LAYOUT_OP to indicate when the layout of one or multiple objects required a wrap to multiple vertical layers or horizontal layers, or goes outside of the layout rectangle 1004.

It is noted that using the inventive methodology for a display screen using rectangular regions and one degree of freedom, an instruction that results in evenly horizontally spaced and centered objects requires only two parameters, parameter P1 and parameter P2. Parameters P1 and P2 are specified in two display descriptor elements of the display descriptor array buffer. If all of the items do not fit across the screen, it starts the next line a given number of pixels down, analogous to like word wrap for a word processing application. Also, if all the objects do not fit across the screen, a branching flag “does not fit across” is set and used procedurally to enable the object to be displayed in an appropriate manner given the object size and the available screen size. If P1 and or P2 do not fit in layout rectangle then set branching flag for “layout does not fit”. One can test and branch to control layout based on these branching flags or other coordinate based calculation resultant.

Particular embodiments of the inventive method for a device-neutral procedurally-based content display layout and content playback method are now described. The method provides for procedural layout of a display screen using rectangular regions and one degree of freedom, the method comprising the following steps: First, assigning a display descriptor element of a display descriptor array buffer to each item to be rendered on the display, where each the display descriptor element includes a display content buffer number, a screen rectangle, and a hotspot descriptor array number. The display content buffer number identifies the item to be displayed; the screen rectangle identifies the area of the screen on which to display the item; and the hotspot descriptor array contains hotspot elements which each contain semantic flags, information, and buffer numbers which can be used to control, find or select other alternative media representations or informative media associated with the item. Next, assigning a layout rectangle to layout zero or more items spatially with respect to each other and the layout rectangle; and, intelligently setting a bounding rectangle as items are laid out. Finally, carrying out farther layout operations based on the bounding rectangle results of previous layout operations and/or based on status and branching flags set or reset while laying out the items; and, as long as there are more items to be laid out, then repeatedly applying the set of rectangle based operations for each item or set of items to be laid out.

The basic content display layout and content playback method may optionally incorporate various other features. Some of these features are now listed or briefly described: The display descriptor assignment may be performed using a display descriptor operation. The display descriptor operation can include zero or more optional steps selected from the steps consisting of: setting descriptor flags, setting the display item's buffer number, setting the screen rectangle, setting the hotspot array buffer number, and any combination or selection of a subset of these steps. The layout rectangle may be defined using a set rectangle operation. The layout operation comprises a LAYOUT_OP operation. Separate branching flags may be set as a result of a layout operation determining that an item or set of items to be displayed does not fit inside the layout rectangle in any of a number of ways, and these flags may be set or reset when the item or items do or do not fit horizontally inside the layout rectangle, and/or the flags are set or reset when the item or items to be laid out do or do not fit vertically when wrapped into the display rectangle.

In addition, a layout operation may be used to place the list of display descriptors inside the layout rectangle, and optionally, laying out the item or set of items using a first horizontal center then a vertical center procedure. Alternatively or additionally, laying out the item or set of items using a first vertical center then a horizontal center procedure. The display descriptor element may for example contain a picture buffer number. Furthermore, the picture buffer number may optionally define a picture in RGB, RGBA, YUV, YcbCr, or Y format. The display descriptor element may alternatively or in addition include a text buffer number. The picture buffer number defines the text in ASCII, UNICODE, or multi-byte character format.

Conditional jump operation instructions may be used to perform complex procedural layout functions, the jump operation instructions directing procedures to perform intelligent operations according to the layout operations' results or flag settings, and optionally, the conditional jump operation comprises a JUMP_OP instruction operation.

The layout method may be procedurally based to layout and display information on a display device. Optionally, the information is selected from the set of information items consisting of graphical information, textual information, character information, symbolic information. The information includes written language in any alphabet, character set, or other language representation. The procedurally based layout and display may comprise layout mode type operations, including operations selected from the set of operations consisting of: horizontal only, horizontal evenly spaced, vertically only, vertically then horizontal, centered, items spaced a fixed distance apart horizontally, items spaced a fixed distance apart vertically, and combinations thereof. The procedurally-based layout and display operations permit content to be successfully authored to display in an acceptable manner without prior knowledge of the particular hardware characteristics of the device on which the content will be displayed. In the preferred embodiment, the content comprises a StoryMail story, however the method is not limited to this particular content type. The procedurally-based layout and display operations permit content to be more easily authored for display on a variety of display devices, and the procedurally-based layout and display operations permit content to be authored in a display hardware neutral manner without regard for particular display device hardware and/or display device driver characteristics. The procedurally-based layout and display also permitting content playback to be customized during its run-time on the player. Customization may for example be performed by the Hardware Abstraction Layer (HAL), and/or in response to user commanded preferences. The procedurally-based layout and display permits content to be authored in a display hardware neutral manner even when hardware characteristics are known in advance of authoring the content without regard for particular display device hardware and/or display device driver characteristics.

The invention also provides an embodiment of the inventive method for laying out two-dimensional items on a display screen having fixed physical dimensions and width and height dimension that are logically unbounded, and where at least one of the items to be displayed may require more display screen area that in physically available. This embodiment of the method includes the steps of: (i) providing means for logically extending the height dimension for display of objects in a first screen direction, the first screen extended dimension representing a virtual screen dimension; (ii) generating on-screen or visible rectangle of physical picture elements (pixels) having width (W) and height (H); (iii) generating a logical or layout rectangle allocated to a particular display task for placing spaced multiple items within the visible screen, the layout rectangle having the possibility of being either smaller than, larger than, or equal in dimension to the visible rectangle owing to the presence of the logical display extension means; (iv) specifying the layout rectangle with instructions that specify (i) a layout rectangle width (LW), a layout rectangle height (LH), and the location or coordinate of a corner (such as the upper left corner) of the layout rectangle with respect to the visual screen rectangle; (v) generating layout resultant bounding rectangle having size RW×RH where RW defines the outside width limits of a set of laid out items; and (vi) laying out the items using the bounding rectangles in combination with procedural instructions to layout, position, set layout rectangles, and define which items are to contribute to the bounding rectangles used to re-layout an item or set of items, or lay out an additional item or set of items.

The inventive method for laying out two-dimensional items on a display screen having fixed physical dimensions and width and height dimension that are logically unbounded, may also be modified with various alternative and/or additional procedures for particular situations. Some of these alternatives and additions are now listed or briefly described. The means for logically extending may, for example, comprise a scroll mechanism and one or more scroll bars. The means for logically extending the display may alternatively comprise a display paging mechanism.

The method may also provide that any laid out items contributing to a resultant bounding rectangle may be subtracted from the resultant bounding rectangle prior to the final layout of additional items. New items may be added to items laid out to be displayed in the resultant bounding rectangle in prior operations, and/or new items may be combined with existing items in the resultant bounding rectangle according to predetermined logical or mathematical procedures. Additional items are laid out in the resultant bounding box window using the layout operation instruction.

The method may optionally further comprising setting branching flags to indicate when the layout of an item or set of items (i) required a wrap to multiple vertical layers, (ii) required a wrap to multiple horizontal layers, (iii) goes outside the layout rectangle, or (iv) identifies another predetermined condition. The branching flags may include a “does not fit across” which is set if all the items do not fit across the screen and used procedurally to enable the object to be laid out for displayed in an appropriate manner given the item size and the available screen size or virtual dimensions. A test and branch operation may be used to control layout of objects based on the branching flags. The method may further comprising step of using a test and branch operation to control layout of items based on predetermined display size and/or coordinate based calculation results.

Thin Low-Overhead Story Player Run-Time System and Method

The invention further provides a system, device, method, computer program, and computer program product for thin procedural multi-media player run-time engine having application program level cooperative multi-threading and constrained resource retry with anti-stall features.

Embodiments of the invention desirably provide a thin low-overhead multimedia procedural content player (for example, a StoryMail or story player) run-time system and method. Recall that in at least some embodiments, the story files are sequences of fixed length words (for example, 32-bit words) of the form “Instruction1, param1, param2, . . . , Instruction2, param1, param2, param3, . . . , InstructionN, param1, . . . , paramM”.

In one embodiment, the story playback engine apparatus and method operates on this sequence by fetching the next word in the sequence (for example “Instruction2”) and branches to or otherwise executes a function within the function library based on the value (or other indicia) of that word. The function then: (i) fetches the parameters that follow the instruction (for example, “param1, param2, “param3, . . . , etc.); (ii) performs the instruction using the function and parameters; (iii) advances the program counter past the parameters to the next instruction; and, (iv) returns a status code, for example, a status code indicating the successful completion or error status of the function.

The run-time module, program, system, and method are thin, that is require only a small amount of code and memory. In one embodiment, requiring fewer than 50 lines of ° C.” program language code. They are low-overhead relative to conventional run-time systems because no sophisticated parsing, threading, synchronization, memory allocation or garbage collection mechanisms are needed. Also multimedia functions that need to be performed may easily be optimized for each device or environment. Execution is quick and corresponding power requirements are low because the processor intensive functions such as inverse discrete cosine transforms (IDCTs) are performed with large sparse native processor code as part of an op-code's implementation, while all the control and navigation are performed in the very compact and very compressible story language instructions.

Because story language code is small and the run-time mechanism uses the same small functions over and over, large programs can be run without leaving the data and code caches of many CPUs and computers. In a conventional run-time system, there are many layers of abstract modules of functionality with complex algorithms that must be implemented. Example algorithms are: (1) Thread creation and round robin thread scheduling along with thread priority systems, (2) Memory allocation functions, (3) Memory garbage collection functions, (4) Interrupt system functions, (5) Picture decompression algorithms such as MPEG2, Multimedia playback system and user controls, video/audio synchronization algorithms Such implementations require at least 500K bytes of native code to implement, and often several megabytes of native code. In comparison all these functions can be implemented for the playback of multimedia application or messages in story format in less than 50K bytes.

The run-time model also desirably provides for cooperative multi-threading. The cooperative multi-threading also desirably includes constrained resource retry. Under this scheme, sequences of instructions for a thread are run as long as the instruction functions return a status code of success (or the equivalent successful status indicator). Then the next thread is executed as long as its instruction functions each return a status code of success. Any instruction that takes a long time to complete will return a yield (or equivalent) status code, so that the other threads will get a chance to run. This cooperation exists at the level of the application.

Thread synchronization is also provided. A wait until time (TIME_OP) type instruction will not complete until a set time. The set time may be defined in a variety of ways and may refer to a relative time, whether or not using indirection plus post operations, or to an absolute time. If it is not time for the instruction to be executed (or to complete) it will return a retry instruction type status (RETRY_INSTRUCTION_RETURN_CODE), causing the next thread to execute. Each time the TIME_OP containing thread starts again it will retry the same instruction until the set time. This is another feature of the cooperative multi-threading with resource constrained retry described elsewhere in this application. In this particular example, the constrained resource is time and the instruction is retried if the time is not the set time, or within some predetermined difference from the set time. Any instruction that needs a memory buffer will in similar manner, return RETRY_INSTRUCTION_RETURN_CODE if the buffer is not available. Global flags can also be used to synchronize threads using a wait for flag in a TIME_OP instruction. Informative status codes that provide more particularized information relative to an operation or process may also be provided in addition to the afore described success, error, yield, and retry status codes or indicators.

Having described some of the characteristics of the content player and playback engine and method, attention is now focused on exemplary embodiments of the inventive structure and method for the player run-time engine.

In one embodiment, a small low-overhead content playback engine comprising: a main or primary thread execution block that executes cooperative player engine threads in turn. Such in turn execution may be sequential or include non-sequential execution with branching, conditional testing, and the like. In one embodiment, the primary thread execution block is implemented in portable code, while in another embodiment the block is implemented using native processor code. Hardware implementation of the primary thread execution block is also supported as are hybrid hardware/software and hardware/firmware implementations.

The run-time playback engine also includes a boot-up sequence block that operates to assign an instruction input buffer to a startup thread, loads the first procedural multi-media player instructions, and starts the startup thread in a running state. An instruction dispatcher block fetches each instruction word of a thread in sequence or as directed by branching instructions, and calls a native code function or hardware block to execute each instruction word and the parameters that follow it in turn. A set of native code functions or hardware blocks which together carry out the functions of the multi-media player instruction words and parameters; and a hardware extraction layer implemented in native code functions or hardware blocks that marry the portable portions of the player engine to the parts that are specific to the application or device that makes use of the player are also provided in the run-time player structure. In a preferred embodiment, the run-time playback engine is adapted to playback content comprising a StoryMail story.

The inventive method for a multi-media procedural content player engine may utilize the afore described structure or other general purpose or specialized structures and is particularly adaptable due to the many hardware or device-neutral characteristics provided. In one embodiment, the method comprises. (a) receiving a file for playback comprising at least one sequence of fixed length words organized by having a plurality of instructions arranged as a linear sequence where parameters associated with a particular instruction immediately follow the particular instruction and wherein subsequent instructions follow the parameters associated with a previous instruction; (b) operating (such as in or by the playback engine) on the sequence of instructions and parameters. This instruction and parameter sequence processing including fetching the next word in the sequence, where the word includes an indicia of the function to be performed; executing the identified function; and when the identified function utilizes parameters, the function then: (i) fetching the parameters that follow the instruction; (ii) performing the instruction using the function and parameters; (iii) advancing a program counter past the parameters to the next instruction in the sequence; and, (iv) returning a status code for the instruction.

Different embodiments of the inventive system further define the inventive apparatus, system, method, and computer program to provide additional features and capabilities. Some of these are now briefly described.

The procedurally-based content player engine and method may optionally utilize a status code where the status code is selected from the set of status codes consisting of a success status code, an error status code, a yield status code, a informative status code, and a retry instruction status code.

The instruction and parameters may be arranged with sequential sets of instructions (Instruction) and parameters (param) where the parameters pertaining to a particular instruction sequentially follow the instruction to which it or they pertain and precede the next instruction in a scheme such as Instruction1, param1a, param1b, . . . , Instruction2, param2a, param2b, param2c, . . . , InstrutionN, paramNa, . . . , paramNm” for a sequence of N instructions.

In preferred embodiments of the invention, the files received for playback includes at least one sequence of the fixed length words. The fixed length words may desirably be selected from the set of fixed length word sizes consisting of 8-bit words, 16-bit words, 32-bit words, 40-bit words, 64-bit words, 96-bit words, 128-bit words, 256-bit words, 512-bit words, and any other fixed length word or byte size. In one embodiment, 32-bit words are conveniently used. Fixed word lengths need not be powers of 2. The fixed length words and parameters may be comprised of numeric and/or symbolic values in any combination. Instruction values identify individual functions within a library of functions, where some instruction values optionally identify one or more branch instructions.

In one embodiment, the run-time module program(s) is thin and implemented with fewer than between about 50 lines of code and about 200 lines of program code. In another embodiment the run-time module program(s) is (are) thin and implemented with fewer than about 50 lines of C language program code. In either case, the run-time module has a low-overhead relative to conventional run-time systems because no sophisticated parsing, threading, synchronization, memory allocation or garbage collection mechanisms are needed. Furthermore, execution speed is increased relative to conventional methods because processor intensive functions are performed with native processor code as part of an op-code's implementation, and all the control and navigation are performed in the very compact and very compressible story language instructions.

In at least some embodiments, the inventive system and method provides a run-time engine that eliminates the need to implement any of the following complex algorithm types: (i) thread creation and round robin thread scheduling with thread priority systems, (ii) native operating system or C library memory allocation functions, (iii) memory garbage collection functions, (iv) interrupt system functions, (v) picture decompression algorithms, (vi) multimedia playback system, (vii) user controls, and (viii) video and/or audio synchronization algorithms.

Furthermore, the size of the native code to perform playback of multimedia application or messages in story format is no more than from about 30 kilobytes to about 300 kilobytes, and in one implementation the size of the native code to perform playback of multimedia application or messages in story format is no more than about 50 kilobytes, while in another implementation is no more than about 100 kilobytes, in yet other embodiments having a greater feature set size of the native program or software/firmware code is less than about 500 kilobytes. Given these code sizes, it is clear that the size of native code is reduced by a factor of from about 5 to about 1000 as compared to conventional implementations that would attempt to provide generically similar operation (if even possible), and routinely the native code may be reduced by about a factor of 100 as compared to conventional implementations.

In preferred embodiments of the invention, the method and structure provide for a run-time module that supports cooperative multi-threading of various tasks, including but not limited to audio, visual, or audio/visual special effects.

In yet another embodiment, cooperative multi-threading occurs at the level of the application program as compared to multi-threading or multi-tasking that may occur at the level of the operating system. Preferable, the cooperative multi-threading procedure further includes a constrained resource retry procedure, wherein the cooperative multi-threading with constrained resource retry occurs at the level of the application program.

In a further embodiment, the run-time module program mechanism uses a common set of small functions over and over again to provide the functional capabilities of larger conventional programs so that tasks can be run within the data and code caches of at least some processors of conventional computers and information appliances. Desirably, and for purposes of energy conservation, heat dissipation reduction, and other efficiency and design factors, the method is electrical power conservative because processor intensive functions are performed with optimized native processor code as part of an op-code's implementation, and all or substantially all the control and navigation are performed in the very compact and very compressible story language instructions. In particular, one embodiment provides for processor intensive functions including inverse discrete cosine transforms (IDCTs).

The story language code is desirably small and the method is performed with fewer layers of abstraction functional modules and less complex algorithms than in conventionally used implementation strategies.

When multi-threaded with constrained resource retry procedure is implemented, one implementation includes the steps of: running sequences of instructions for a thread as long as the instruction functions return as status code of success, and then executing the sequences of instructions for the next thread for as long as the instruction functions return a status code of success; a yield status code being returned for any instruction or sequence of instructions that takes more than a predetermined time to complete so that other threads and their instructions will have an opportunity to run. The status code may be set to retry when a constrained resource blocks the execution of the instruction, thereby allowing other threads to run before the instruction is retried.

The resource constraint on which execution may depend may be broadly defined. For example the resource constraint may be selected from the set of constrains consisting of: time being greater than some predetermined value, time being less than some predetermined value, time being equal to some predetermined value, a buffer being available, a buffer not being available, a variable being less than a predetermined value, a variable being greater than a predetermined value, a variable being equal to a predetermined value, a variable having any predetermined logical or arithmetic relation to a reference value, a hardware device being ready, a hardware device not being ready, an electronic communication or protocol having been completed, an electronic communication or protocol not having been completed, combinations thereof, as well as any other temporal (time), parameter, hardware or software condition, value, or status.

Memory or buffer space or availability may also be used as a constrained resource and an instruction that needs a memory buffer will return a retry instruction status code if the needed memory buffer is not available.

The use of the retry instruction status reduces the possibility or likelihood of stalling the processor as a result of a resource not being available when needed. Thread synchronization is achieved using a “wait for” flag in a “wait until” time instruction, the “wait for” flag comprising a variable which may itself be an element of a memory buffer.

The inventive method may further provide for thread or media playback synchronization. Such synchronization may for example include one or more of synchronization of: input, video playback, audio playback, special effects of video, special effects of audio, or combinations thereof.

The execution of a “wait until time” type instruction being an instruction type that will start execution and/or not complete execution until a predetermined set time or set times. In one particular embodiment, the wait until time instruction comprising a TIME_OP story language instruction. When time is involved, the set time may be defined by a reference to a relative time, whether or not using indirection plus post operations, to an elapsed time difference, or to an absolute time reference. In some embodiments, the “wait until time” type instruction returns a retry instruction status if it is not time for the instruction to be executed and/or to complete execution, the return of the retry instruction status code causing execution of the next thread to execute. In this case, each time the “wait until time” instruction containing thread starts again it will retry the same instruction until the set time. This represents a situation where the set time is a constrained resource. When time is a constrained resource and the instruction constrained by time is retried if the time is not the set time or within some predetermined difference from the set time.

Therefore the invention provides a thin procedural media player run-time engine and method having application program type level cooperative multi-threading and constrained resource retry with processor anti-stall features.

Additional Description

Having described many different embodiments and aspects of the invention including numerous computer and computer systems, information appliances, program and data structures, methods for authoring or otherwise generating content including StoryMail story file content, and a mired array of techniques, procedures, and structures for generating and rendering stories and other content in an efficient and message intent preserving content, we briefly summarize selected embodiments that have particular significance. The highlighted embodiments that follow should not be interpreted as the only embodiments of importance as the large number and combination of structures and methods necessarily limits the practicality of describing them all here.

The invention provides a system, device, method, computer program, and computer program product for a hardware architecture neutral computer program language and structure and method for execution In a first embodiment of a hardware architecture neutral executable program structure for execution in a processor, the program structure comprising: a plurality of instruction threads selected from a library of possible instruction threads; a plurality of data parameters integrated among at least some of the instruction threads and influencing execution of the instruction threads; and at least some of the selected instruction threads being adapted for cooperative execution with other of the instruction threads by yielding ownership of the processor upon the occurrence of a predetermined condition.

This first program structure may be further defined in a second embodiment such that the instructions comprise operation codes representing commands executable in a processor. This first program structure may be further defined in a third embodiment such that the predetermined condition comprises the yielding instruction yielding after a predetermined time period of ownership. It may be further defined in a fourth embodiment such that the predetermined condition comprises the yielding instruction yielding upon determining that a required resource is constrained. This fourth embodiment may be further defined in a fifth embodiment such that the constrained resource is selected from the group consisting of a memory buffer, an input device, an output device, an input/output device, a digital audio processor, a display device, a communication link, a communication bus, a buffer, a data compression processor, a data decompression processor, a vertical refresh signal (so user does not see display screen refresh), a time limit being exceeded or not yet being exceeded, and combinations thereof. This fifth embodiment may be further defined in a sixth embodiment such that a characteristic of the constrained resource is the constraining condition associated with the resource. This sixth embodiment may be further defined in a seventh embodiment such that the characteristics are selected from the group characteristics consisting of: a buffer existing, a buffer not existing, a buffer being initialized, a buffer being uninitialized, a buffer holding a set of data, a buffer not holding a set of data, a buffer holding a subset of a set of data, a buffer not holding a subset of a set of data, and combinations thereof. This sixth embodiment may be further defined in an eighth embodiment such that the characteristics are selected from the group of an input device, output device, or input/output device signaling that it is available, not available, has text, selection, location, textural or other input data available or not available and combinations thereof. This sixth embodiment may be further defined in a ninth embodiment such that the characteristics are selected from the group of characteristics consisting of: a digital audio processor, display device, a communication link, a communication bus, a buffer, a data compression processor, a data decompression processor, a vertical refresh signal being in a ready state, a vertical refresh signal not being in a ready state, condition where capacity or features are assured or not assured, and combinations thereof.

The first embodiment may be further defined in a tenth embodiment such that the instruction thread is selected from the group of instruction threads that: perform a navigation; make a decision; scale a data item; decompress a data item; set a parameter; use a parameter; circulate a parameter; generate data; generate a parameter or instruction stream; parse a data item; format a data item; select a data item, test a data item, respond to an input; send messages; receive messages; receive responses to messages; request file from a server or other source; store data; perform calculations; perform an animation; perform signal or image processing; respond to a data or command from a user; send a message, request a file; request additional data in a data stream; request data and/or commands in a stream of data and/or commands; navigate; make a decision; scale; decompress; set, use, and calculate parameters; cause audio to be rendered, cause video to be rendered generate other data and/or procedural streams; parse, format, and select text and other media elements such as images, graphics, and audio, respond to item selection by a story player user; request further files during streaming, format XML (or XML extensions); format text; validate user input; perform calculations, simulations, animations, special effects, signal processing, run-time scaling and synchronization tasks; and combinations thereof.

This tenth embodiment may be further defined in an eleventh embodiment such that the data items are selected from the set of data items consisting of a digital image media data item, a digital audio media item, transition and special effects control data and combinations thereof. This tenth embodiment may be further defined in a twelfth embodiment such that the response to data or commands, or other input from a user comprises responding by causing a program subroutine or other computer program code to be executed on the thread in which the input, data, or commands are detected. This tenth embodiment may be further defined in a thirteenth embodiment such that the requesting additional data and/or commands in a stream of data and/or commands comprises requesting additional ones of the instruction threads integrated with the data parameters.

The first embodiment may be further defined in a fourteenth embodiment such that the cooperative execution is under programmatic control. The first embodiment may be further defined in a fifteenth embodiment such that the predetermined condition is either (i) yielding after a predetermined time period of ownership, or (ii) yielding upon determining that a required resource is constrained, or (iii) a combination of yielding after a predetermined time period of ownership, and yielding upon determining that a required resource is constrained. This fifteenth embodiment may be further defined in a sixteenth embodiment such that the resource being constrained comprises the resource being unavailable at the time access to the resource is required. This fifteenth embodiment may be further defined in a seventeenth embodiment such that a predetermined time period of ownership is established programmatically. This fifteenth embodiment may be further defined in an eighteenth embodiment such that a predetermined time period of ownership is provided as a parameter within the message. This sixteenth embodiment may be further defined in a nineteenth embodiment such that the operation codes comprise integers and an association between the integer and an operation is identified by a table look up procedure, the integers providing a compact representation of the operations.

The first embodiment may be further defined in a twentieth embodiment such that the program structure further including an instruction thread retry attribute associated with at least some of the possible instruction threads, the retry attribute causing the processor to repeatedly retry to execute an instruction thread that has yielded ownership of the processor either (i) after a predetermined time period of ownership, (ii) after running all of the active threads until each has yielded the processor, or (iii) upon determining that a required resource is constrained.

The first embodiment may be further defined in a twenty-first embodiment such that the instructions comprise operation codes representing commands executable in a processor; the predetermined condition comprises the yielding instruction yielding after a predetermined time period of ownership, or the yielding instruction yielding upon determining that a required resource is constrained; the constrained resource is selected from the group consisting of a memory, an input device, an output device, an input/output device, a digital audio processor, a display device, a communication link, a communication bus, a buffer, a data compression processor, a data decompression processor, a vertical refresh signal (so user does not see display screen refresh), a time limit being exceeded or not yet being exceeded, and combinations thereof, and the instruction thread is selected from the group of instruction threads that perform a function selected from the set of functions that: perform a navigation; make a decision, scale a data item; decompress a data item; set a parameter; use a parameter; circulate a parameter; cause audio to be rendered; cause video to be rendered; generate data; generate a parameter or instruction stream; parse a data item; format a data item; select a data item; test a data item, respond to an input; send messages; receive messages; receive responses to messages; request file from a server or other source, store data; perform calculations; perform an animation; perform signal or image processing; respond to a data or command from a user; send a message; request a file; request additional data in a data stream; request data and/or commands in a stream of data and/or commands; navigate; make a decision; scale; decompress; set, use, and calculate parameters; generate other data and/or procedural streams; parse, format, and select text and other media elements such as images, graphics, and audio; respond to item selection by a story player user; request further files during streaming, format XML (or XML extensions); format text; validate user input; perform calculations, simulations, animations, special effects, signal processing, run-time scaling and synchronization tasks; and any combination thereof.

In a twenty-second embodiment, the invention provides a method for cooperatively executing a plurality of code threads in a processor, the method comprising steps of: (a) communicating a plurality of code threads, including a first code thread and a second code thread, to a processor for execution; (b) setting a program counter for execution of the first code thread; (c) allocating ownership of the processor exclusively to execution of the first code thread and executing the first code thread until the first code thread completes execution, except stopping execution of the first code thread and yielding ownership of the processor by the first code thread during the execution to the second code thread upon the occurrence of a predetermined first code thread yield condition; (d) if execution of the first code thread has been stopped, then storing an indication that execution of the first code thread has been stopped, including a program counter value for the stopped first code thread, in a storage location; (e) setting the program counter for execution of the second code thread; (f) allocating ownership of the processor exclusively to execution of the second code thread and executing the second code thread until the second code thread completes execution, except stopping execution of the second code thread and yielding ownership of the processor by the second code thread to any other one of the plurality of code threads upon the occurrence of a predetermined second code thread yield condition; (g) reallocating ownership of the processor and re-executing the first code thread according to predetermined processor ownership reallocation rules; (h) retrying execution of the yielded first code thread including setting the program counter with the stored program counter for the stopped first code thread and re-executing the first code thread; and (i) repeating steps (b) through (g) for each of the plurality of code threads until each of the plurality of code threads has been executed.

This twenty-second embodiment may be further defined in a twenty-third embodiment such that the predetermined first code thread yield condition comprises yielding after a predetermined time period of processor ownership. This twenty-second embodiment may be further defined in a twenty-fourth embodiment such that the predetermined first code thread yield condition comprises yielding upon determining that a resource required for execution is constrained. This twenty-second embodiment may be further defined in a twenty-fifth embodiment such that the predetermined first code thread yield condition and the second code thread yield conditions are each selected from the group consisting of: (i) yielding after a predetermined time period of ownership, or (ii) yielding upon determining that a required resource is constrained, and a combination thereof.

This twenty-third embodiment may be further defined in a twenty-sixth embodiment such that the cooperative execution of the plurality of instruction threads is achieved by establishing the predetermined time period of ownership of at least selected ones of the plurality of threads as a instruction thread execution parameter communicated with the instruction thread.

In a twenty-seventh embodiment, the invention also provides a method for cooperatively executing a plurality of code threads in a processor, the method comprising steps of: sequentially executing a plurality of code threads until a predetermined code thread yield condition is detected for a particular code thread; stopping execution of the particular code thread for which the thread yield condition was detected; storing an indication that execution of the particular code thread was stopped before completion in a memory storage location; resuming sequential execution of the plurality of code threads at the next sequential code thread following the particular code thread; retrying execution of the particular code thread during the resumed sequential execution according to predetermined rules for preempting a next sequential code thread and retrying execution of the particular code thread in preference to a next sequential code thread.

This twenty-seventh embodiment may be further defined in a twenty-eighth embodiment such that the step of retrying includes storing an indicator for the preempted next code thread and retrieving the stored indicator for the particular code thread. This twenty-eighth embodiment may be further defined in a twenty-ninth embodiment such that the stored indicator for the preempted next code thread comprises a program counter value for the preempted next code thread, and the stored indicator for the particular code thread comprises a program counter value for the particular code thread that was yielded. This twenty-ninth embodiment may be further defined in a thirtieth embodiment such that the step of resuming the sequential execution of code threads after the particular code thread has been executed by retrieving the stored program counter value for the preempted next code thread. This twenty-seventh embodiment may be further defined in a thirty-first embodiment such that the code thread yield condition comprises yielding after a predetermined time period of processor ownership. This twenty-seventh embodiment may be further defined in a thirty-second embodiment such that the code thread yield condition comprises yielding upon determining that a resource required for execution is constrained. This twenty-seventh embodiment may be further defined in a thirty-third embodiment such that the predetermined first code thread yield condition and the second code thread yield conditions are each selected from the group consisting of: (i) yielding after a predetermined time period of ownership, or (ii) yielding upon determining that a required resource is constrained, and a combination thereof. This twenty-seventh embodiment may be further defined in a thirty-fourth embodiment such that cooperative execution of the plurality of instruction threads is achieved by establishing the predetermined time period of ownership of at least selected ones of the plurality of threads as a instruction thread execution parameter communicated with the instruction thread. This twenty-seventh embodiment may be further defined in a thirty-fifth embodiment such that cooperative execution of the program instruction threads is achieved by detecting a resource constraint and returning a code to the instruction dispatcher to set the program counter to point back to the same returned instruction before yielding to the next thread.

The invention provides a system, device, method, computer program, and computer program product for autonomous generation of customized file having procedural and data elements from non-procedural flat-file descriptors. In a first embodiment of a method for automatically and autonomously generating a customized combined data and procedural file from non-procedural flat file descriptions, the method comprising steps of. retrieving a plurality of flat file format content precursors from at least one storage location; segmenting the retrieved plurality of flat file format content precursors into segments comprising procedural representation sequences; generating linkage information sequences for the segments; binding the segments and linkage information sequences into a set of logical files; and packaging the set of logical files into a single story file.

This first embodiment may be further defined in a second embodiment such that the linkage information sequences are generated by a procedure selected from the set of procedures consisting of a segmentor procedure, a transcoder procedure, a combined segmentor and transcoder procedure, and combinations thereof. This first embodiment may be further defined in a third embodiment such that the step of binding further includes receiving inputs identifying story player device characteristics. This first embodiment may be further defined in a fourth embodiment such that the step of binding further includes receiving inputs identifying story player device user preferences. This second embodiment may be further defined in a fifth embodiment such that the transcoding includes receiving inputs identifying communication channel bandwidth characteristics. This second embodiment may be further defined in a sixth embodiment such that the transcoding includes receiving inputs identifying story player device characteristics, story player device user preferences, and communication channel bandwidth characteristics.

The first embodiment may be further defined in a seventh embodiment such that the step of binding further comprises selecting particular sequences of segments to concatenate into each logical file. This first embodiment may be further defined in an eighth embodiment such that the packaging further comprises assembling a plurality of the logical files into a single story file. This eighth embodiment may be further defined in a ninth embodiment such that a single story file comprises a plurality of logical files. This ninth embodiment may be further defined in a tenth embodiment such that each logical file component encapsulates control and/or content. This ninth embodiment may be further defined in an eleventh embodiment such that each logical file component encapsulates one or more of computer program instructions, control information, user input forms, validation procedures, and/or multi-media content. This ninth embodiment may be further defined in a twelfth embodiment such that the method further comprises compressing each component logical file, combining all of the compressed logical files, packaging the compressed logical files, and compressing the packaged and compressed file again to generate a single story file. This seventh embodiment may be further defined in a thirteenth embodiment such that the selected and concatenated sequences are packaged into a single story file. This ninth embodiment may be further defined in a fourteenth embodiment such that the logical files are encrypted. This ninth embodiment may be further defined in a fifteenth embodiment such that the logical files are digitally signed. This ninth embodiment may be further defined in a sixteenth embodiment such that the logical files are encrypted and/or digitally signed. This first embodiment may be further defined in a seventeenth embodiment such that the linkage information includes direct linkage information. This first embodiment may be further defined in an eighteenth embodiment such that the linkage information includes indirect linkage information. This first embodiment may be further defined in a nineteenth embodiment such that the linkage information includes recursive indirect linkage information. This ninth embodiment may be further defined in a twentieth embodiment such that the logical files are compressed. This first embodiment may be further defined in a twenty-first embodiment such that the packaging further includes performing a top-level of compression.

In a twenty-second embodiment the invention provides a system for automatically and autonomously generating a customized combined data and procedural file from non-procedural flat file descriptions, the system comprising: retrieving a plurality of flat file format content precursors from at least one storage location; a segmentor receiving a plurality of flat file format content precursors and segmenting the retrieved content precursors into segments comprising procedural representation sequences, a linker generating linkage information sequences for the segments; a binder binding the segments and linkage information sequences; and a packager packaging the bound segments and linkage information sequences into a story file.

In a twenty-third embodiment, the invention provides a computer program product for use in conjunction with a processor in a computer system or information appliance, the computer program product comprising a computer readable storage medium and a computer program mechanism embedded therein, the computer program mechanism, comprising: a program module that directs the computer system or information appliance, to function in a specified manner to automatically and autonomously generate a customized combined data and procedural file from non-procedural flat file descriptors, the program module including instructions for: receiving a plurality of flat file format content precursors from a source; segmenting the received plurality of flat file format content precursors into segments comprising procedural representation sequences; generating linkage information sequences for the segments, binding the segments and linkage information sequences; and packaging the bound segments and linkage information sequences into a story file.

The invention provides a system, device, method, computer program, and computer program product for intelligently scaling message procedural/data sets to adapt the procedural/data sets to receiver attributes and maintain message intent.

In a first embodiment of a method for scaling a data set, the method comprising steps of: performing a first attribute scaling of a message when preparing and before transmission of the message to a client device based on receiver client attributes and a priori sender knowledge of receiving client device and user preferences; performing a second procedural scaling of the message including executing capability determining procedures embedded within the message after message preparation, message transmission, and message receipt, that determine receiver client capability attributes and select a particular message expression from a plurality of message expressions and element selection available in the received message; and performing a third hardware abstraction layer scaling of the particular selected message expression to adapt the selected message expression for presentation on the client device.

This first embodiment may be further defined in a second embodiment such that the receiver client attributes are selected from the group consisting of: a message language preference, a message security preference, a message size constraint, connection speed, audio rendering capabilities, video rendering capabilities, device memory size, device memory availability, device CPU limitations, user nationality, playback engine version or capabilities; and combinations thereof.

This first embodiment may be further defined in a third embodiment such that the receiver client attributes include a communication link connection speed determined substantially during preparation of the message either (i) prior to transmission of the message, or (ii) after initiation of transmission but prior to completion of transmission of the message. This second embodiment may be further defined in a fourth embodiment such that the receiver client attributes further include a communication link connection speed determined substantially during preparation of the message either (i) prior to transmission of the message, or (ii) after initiation of transmission but prior to completion of transmission of the message. This first embodiment may be further defined in a fifth embodiment such that the receiver client attributes are selected from the group consisting of: a speed attribute of a processor within the client device, an available memory attribute of a memory device connected to the processor, an audio capability attribute, a video capability attribute, and combinations thereof. This fifth embodiment may be further defined in a sixth embodiment such that the video capability attribute includes attributes for screen size, monochrome or color display capability, number of monochrome gray scale levels, number of presentable colors, color palate, and combinations thereof.

This first embodiment may be further defined in a seventh embodiment such that the procedural determinations include, when an audio message expression is included within the plurality of message expressions, determining whether the client has specific audio presentation capabilities, and when the client does not have a suitable audio presentation capability, selecting a text message expression in place of the audio message expression. This first embodiment may be further defined in an eighth embodiment such that the procedural determinations include, when first message expression is included within the plurality of message expressions, determining whether the client has a first message type presentation capability, and when the client does not have the first message type presentation capability, selecting an alternate message type expression in place of the first message type expression while still maintaining the intent of the message. This eighth embodiment may be further defined in a ninth embodiment such that the alternate message type is selected from a plurality of alternate message types for the first message type according to predetermined rules and on the client message type presentation capabilities. This ninth embodiment may be further defined in a tenth embodiment such that the predetermined selection rules include selecting a text type alternative message when a client does not have any of an audio message type presentation capability, a video message type presentation capability, an audio-video message type presentation capability, a graphic message type presentation capability, or a photographic message type presentation capability. This ninth embodiment may be further defined in an eleventh embodiment such that the predetermined selection rules include a hierarchical selection preference that selects the message presentation type that provides a maximum available amount of information possible for the client device. This eleventh embodiment may be further defined in a twelfth embodiment such that the method further includes selecting the message presentation type using semantic information about the elements. This eleventh embodiment may be further defined in a thirteenth embodiment such that the hierarchical selection preference selects a message presentation type in the order of decreasing preference from highest preference to lowest preference as follows: (i) multi-media including audio and motion video content; (ii) multi-media having audio and still graphic imagery content; (iii) motion video without audio; (iv) still graphic without audio; (v) audio; and, (vi) text. This twelfth embodiment may be further defined in a fourteenth embodiment such that the hierarchical selection preference selects a message presentation type in the order of decreasing preference from highest preference to lowest preference as follows: (i) multi-media including audio and motion video content; (ii) multi-media having audio and still graphic imagery content; (iii) motion video without audio; (iv) still graphic without audio; (v) audio; and, (vi) text. This ninth embodiment may be further defined in a fifteenth embodiment such that the predetermined selection rules include a hierarchical selection preference that selects the message presentation type to be a text or symbolic message presentation type when the client device does not support other message presentation types. This ninth embodiment may be further defined in a sixteenth embodiment such that the hierarchical rules are altered by a user preference. This sixteenth embodiment may be further defined in a seventeenth embodiment such that the user preference includes a user preference identifying a user of the client device as sight impaired, and providing an audio message format type in preference to video, graphic, or text message presentation types.

This first embodiment may be further defined in an eighteenth embodiment such that the step of performing a third hardware abstraction layer scaling of the particular selected message expression comprises adapting a two-dimensional graphical display device having display device characteristics to display a graphical data set that does not exactly match the display device characteristics. This eighteenth embodiment may be further defined in a nineteenth embodiment such that the graphical data set has dimensions larger than can be simultaneously displayed by the graphical display device, and the adapting comprises reducing the graphical data set so that all elements of the graphical data set can be simultaneously displayed. This eighteenth embodiment may be further defined in a twentieth embodiment such that the graphical data set has dimensions smaller than will fill an available display dimension, and the adapting comprises magnifying the graphical data set so that available elements of the graphical data set fill at least one dimension of a two-dimensional display. This eighteenth embodiment may be further defined in a twenty-first embodiment such that the graphical data set has dimensions larger than can be simultaneously displayed by the graphical display device, and the adapting comprises providing at least the functionality of one scroll bar so that a user of the client device may sequentially scroll through different regions of the graphical data set. This twenty-first embodiment may be further defined in a twenty-second embodiment such that the at least one scroll bar includes the functionality of a horizontal scroll bar and a vertical scroll bar. This first embodiment may be further defined in a twenty-third embodiment such that the step of performing a third hardware abstraction layer scaling of the particular selected message expression comprises adapting an audio playback device having audio playback device characteristics to playback an audio data set that does not exactly match the audio playback device characteristics. This twenty-first embodiment may be further defined in a twenty-fourth embodiment such that the audio data set has a larger frequency range than can be reproduced by the audio playback device, and the adapting comprises reducing the frequency content of the audio data set so that the audio data set can be reproduced by the audio playback device. This first embodiment may be further defined in a twenty-fifth embodiment such that the step of performing a third hardware abstraction layer scaling of the particular selected message expression comprises adapting an audio characteristic to represent an audio data set that does not exactly match audio characteristics of the client device.

This twenty-fifth embodiment may be further defined in a twenty-sixth embodiment such that the adaptation is selected from the group of adaptations consisting of: speeding up playback while reducing frequency to maintain normal sound pitch characteristics; changing a mono audio characteristic to a stereo characteristic, changing a stereo characteristic to a mono characteristic, changing an n-dimensional audio characteristic to an m-dimensional sound characteristic where m and n are any integers, moving sound around spatially, creating three-dimensional (3D) sound or audio effects, generating particular predetermined or variable acoustic effects to simulate different sound or acoustical venues or environments, eliminating periods of audio silence, eliminated periods of particular predetermined audio characteristics, filtering and removing background noise, filtering to remove particular frequencies, filtering to enhance particular frequencies, speeding up audio reproduction, slowing down audio reproduction, adapting audio to a particular persons hearing range frequency and/or volume, blending audio or sounds, normalizing output level for hearing impaired person, filtering to enhance high-frequency components for older persons, generating special versions of voice, performing kareoke filtering to suppress voice components of audio but retain music, and any combination thereof.

This twenty-third embodiment may be further defined in a twenty-seventh embodiment such the adaptation comprises performing a sample rate conversion so that a device that does not supports all sample rates uses software and/or hardware to convert sample rate. This first embodiment may be further defined in a twenty-eighth embodiment such that the step of performing the hardware abstraction layer scaling comprises adapting the message expression to match the client device hardware characteristics. This eighteenth embodiment may be further defined in a twenty-ninth embodiment such that the graphical data set is a three color graphical data set and the graphical display device is a monochrome display device, and the adapting comprises transforming the three color graphical data set to match the number of gray scale levels of the monochrome graphical display device.

In a thirtieth embodiment of the invention, the invention provides a method for scaling a procedure/data set, the method comprising steps of: performing a first attribute scaling of a message when preparing and before transmission of the message to a client device based on receiver client attributes, performing a second procedural scaling of the message including executing capability determining procedures embedded within the message after message preparation, message transmission, and message receipt, that determine receiver client capability attributes and select a particular message expression from a plurality of message expressions available in the received message; and performing a third hardware abstraction layer scaling of the particular selected message expression to adapt the selected message expression for presentation on the client device; the receiver client attributes are selected from the group consisting of: a message language preference; playback engine software version number; software playback engine capabilities; a message security preference; a message size constraint; a speed attribute of a processor within the client device; an available memory attribute of a memory device connected to the processor; an audio capability attribute; a video capability attribute including video attributes for screen size, monochrome or color display capability, a number of monochrome gray scale levels or a number of presentable colors and color palate; a communication link connection speed determined substantially during preparation of the message either (i) just before preparation while the communication link is still open; (ii) prior to transmission of the message, or (iii) after initiation of transmission but prior to completion of transmission of the message; and combinations thereof; and the procedural determinations include, when first message expression is included within the plurality of message expressions, determining whether the client has a first message type presentation capability, and when the client does not have the first message type presentation capability, selecting an alternate message type expression in place of the first message type expression while still maintaining the intent of the message; the alternate message type is selected from a plurality of alternate message types for the first message type according to predetermined rules and on the client message type presentation capabilities; the predetermined selection rules include a hierarchical selection preference that selects the message presentation type that provides a maximum available amount of information possible for the client device; the hierarchical selection preference selects a message presentation type in the order of decreasing preference from highest preference to lowest preference as follows: (i) multi-media including audio and motion video content; (ii) multi-media having audio and still graphic imagery content; (iii) motion video without audio; (iv) still graphic without audio; (v) audio; and, (vi) text.

This thirtieth embodiment may be further defined in a thirty-first embodiment such that the hierarchical rules are overridden by a user preference. This thirty-first embodiment may be further defined in a thirty-second embodiment such that the user preference includes a user preference identifying a user of the client device as sight impaired, and providing an audio message format type in preference to video, graphic, or text message presentation types. This thirty-first embodiment may be further defined in a thirty-third embodiment such that for hearing impaired person audio is converted into text and the text is may be rendered so that the text flashes on the screen all at once, so that the text appears sequentially on the screen or scrolls on the screen, or so that the text is animated in some way to moves around the screen in some way and thereby avoid covering other text or information on the screen. This thirtieth embodiment may be further defined in a thirty-fourth embodiment such that the step of performing the hardware abstraction layer scaling comprises adapting the message expression to match the client device hardware characteristics. This thirtieth embodiment may be further defined in a thirty-fifth embodiment such that the step of performing a third hardware abstraction layer scaling of the particular selected message expression comprises adapting a two-dimensional graphical display device having display device characteristics to display a graphical data set that does not exactly match the display device characteristics. This thirty-fifth embodiment may be further defined in a thirty-sixth embodiment such that the graphical data set has dimensions larger than can be simultaneously displayed by the graphical display device, and the adapting comprises either: (i) reducing the graphical data set so that all elements of the graphical data set can be simultaneously displayed, or (ii) providing at least the functionality of one scroll bar so that a user of the client device may sequentially scroll through different regions of the graphical data set. This thirtieth embodiment may be further defined in a thirty-seventh embodiment such that the graphical data set is a three color graphical data set and the graphical display device is a monochrome display device, and the adapting comprises transforming the three color graphical data set to match the number of gray scale levels of the monochrome graphical display device.

In a thirty-eighth embodiment, the invention provides a method for scaling a data set, the method comprising steps of: performing a client attribute scaling of a message when preparing the message before communicating the message to a client device based on receiver client attributes; and performing a procedural scaling of the message within the client device including executing capability determining procedures embedded within the message after message preparation, message communication, and message receipt by the client, that determine receiver client capability attributes and selecting a particular message expression from a plurality of message expressions available in the received message. This thirty-eighth embodiment may be further defined in a thirty-ninth embodiment such that the method further comprising step of: performing a third hardware abstraction layer scaling of the particular selected message expression to adapt the selected message expression for presentation on the client device.

In a fourtieth embodiment, the invention provides a method for optimizing content sent to a client device for a user that minimizes transmission bandwidth while maintaining the intent of the content, the method comprising: scaling the content (story) by the producer (composer engine) producing the content so that the data and procedural aspects of the content are scaled to match anticipated attributes of the target client device and user preferences at the time of composing the content; scaling the content by the story during execution of procedural content (instructions) to match the capability of the client device after the content is received by the client device; and scaling the content by the hardware abstraction layer to match client device specific characteristics to enable playback of the content on the client device.

This fortieth embodiment may be further defined in a forty-first embodiment such that the hardware extraction layer scaling includes the steps of: comparing the hardware resources required to perform an action requested by the story procedure executing in the client with the hardware resources available in the client device; and performing a substitute action for the requested action if the available hardware does not permit performing the requested action. This forty-first embodiment may be further defined in a forty-second embodiment such that the substitute action is selected from the group of actions consisting of: (a) substituting an alternative content of a different content type for the requested content; (b) modifying the manner in which the requested content is presented to the user; (c) modifying the requested content so that it can be presented to the user in its modified form; and (d) combinations thereof.

This forty-second embodiment may be further defined in a forty-third embodiment such that the content is a digital image and the digital image is too large to be displayed as a single image on the client device; and the substitute action is selected from the group consisting of: substituting a text description of the image for the image, displaying a portion of the image and providing the functionality of scroll bars so that the user may interactively scroll to different portions of the image viewing only a portion of the image at a time, decimating pixels of the image to reduce the size of the image to fit within the display area of the device display, processing the image to reduce the size of the image to fit within the display area of the display device, substituting a smaller image, and combinations thereof. This forty-third embodiment may be further defined in a forty-fourth embodiment such that the content is an audio content and the client device does not provide audio content playback capabilities, the substitute action comprises substituting a text description of the audio content. This forty-third embodiment may be further defined in a forty-fifth embodiment such that the content is an image or video content and the client device does not provide imagery or video content playback capabilities, the substitute action comprises substituting a text description of the imagery or video content. This forty-third embodiment may be further defined in a forty-sixth embodiment such that the content is a text content and attributes of the client or the user indicate that the user is a blind individual and the client device provides audio output and text-to-speech conversion, the substitute action comprises performing a text-to-speech conversion of the text description to generate an audio content.

In a forty-seventh embodiment, the invention provides a computer program product for use in conjunction with a computer system, the computer program product comprising a computer readable storage medium and a computer program mechanism embedded therein, the computer program mechanism, comprising: a program module that directs components of the computer system to scale a data set, the program module including instructions for: performing an attribute scaling of a message when preparing and before transmission of the message to a client device based on receiver client attributes and a priori sender knowledge of receiving client device and user preferences.

This forty-seventh embodiment may be further defined in a forty-eighth embodiment such that the program module further includes instructions for performing a procedural scaling of the message including executing capability determining procedures embedded within the message after message preparation, message transmission, and message receipt, that determine receiver client capability attributes and select a particular message expression from a plurality of message expressions and element selection available in the received message.

In a forty-ninth embodiment, the invention provides a computer program product for use in conjunction with a computer system, the computer program product comprising a computer readable storage medium and a computer program mechanism embedded therein, the computer program mechanism, comprising: a program module that directs components of the computer system to scale a data set, the program module including instructions for: performing a procedural scaling of a message including executing capability determining procedures embedded within the message after message preparation, message transmission, and message receipt, that determine receiver client capability attributes and select a particular message expression from a plurality of message expressions and element selection available in the received message.

In a fiftieth embodiment, the invention provides a computer program product for use in conjunction with a computer system, the computer program product comprising a computer readable storage medium and a computer program mechanism embedded therein, the computer program mechanism, comprising: a program module that directs components of the computer system to scale a data set, the program module including instructions for: performing a hardware abstraction layer scaling of the particular selected message expression to adapt the selected message expression for presentation on the client device.

In a fifty-first embodiment, the invention provides a computer program product for use in conjunction with a computer system, the computer program product comprising a computer readable storage medium and a computer program mechanism embedded therein, the computer program mechanism, comprising: a program module that directs components of the computer system to scale a data set, the program module including instructions for: performing a client attribute scaling of a message when preparing the message before communicating the message to a client device based on receiver client attributes; and performing a procedural scaling of the message within the client device including executing capability determining procedures embedded within the message after message preparation, message communication, and message receipt by the client, that determine receiver client capability attributes and selecting a particular message expression from a plurality of message expressions available in the received message.

In a fifty-second embodiment, the invention provides a computer program product for use in conjunction with a computer system, the computer program product comprising a computer readable storage medium and a computer program mechanism embedded therein, the computer program mechanism, comprising: a program module that directs components of the computer system to optimize content sent to a client device for a user that minimizes transmission bandwidth while maintaining the intent of the content, the program module including instructions for: scaling the content by the producer producing the content so that the data and procedural aspects of the content are scaled to match anticipated attributes of the target client device and user preferences at the time of composing the content; scaling the content by the story during execution of procedural content to match the capability of the client device after the content is received by the client device; and scaling the content by the hardware abstraction layer to match client device specific characteristics to enable playback of the content on the client device.

In a fifty-third embodiment, the invention provides a system for scaling a message data set, the system comprising: an attribute scaler performing a first attribute scaling of a message when preparing and before transmission of the message data set to a client device based on receiver client attributes and a priori sender knowledge of receiving client device and user preferences; a procedural scalar performing a second procedural scaling of the message data set including means for executing capability determining procedures embedded within the message after message preparation, message transmission, and message receipt, to determine receiver client capability attributes and to select a particular message expression from a plurality of message expressions and element selection available in the received message; and a hardware abstraction layer scalar scaling the particular selected message expression to adapt the selected message expression for presentation on the client device.

This fifty-third embodiment may be further defined in a fifty-fourth embodiment such that the attribute scalar comprises computer program code executing within a processor and memory coupled to the processor in a general purpose computer. This fifty-third embodiment may be further defined in a fifty-fifth embodiment such that the procedural scalar comprises computer program code executing within a processor and memory coupled to the processor in a client information appliance. This fifty-third embodiment may be further defined in a fifty-sixth embodiment such that the hardware abstraction layer scalar comprises computer program code executing within a processor and memory coupled to the processor in a client information appliance.

The invention provides a system, device, method, computer program, and computer program product for an intent preserving message adaptation and conversion system and method for communicating with sensory and/or physically challenged persons.

In a further aspect of the invention, the invention provides a first embodiment of a method for communicating an idea to a user including to a sensory or physically challenged user, the method comprising the steps of: identifying an idea to be communicated to a user; collecting and storing a plurality of alternative expressions for the idea, each the alternative expression being associated with a different one of a plurality of possible outputs generated by a client device, each the output intended to stimulate a different sense of a user; composing an electronic content encompassing the idea from selected ones of the plurality of alternative expressions; communicating the electronic content to the client device for presentation to the user; selecting a particular output to generate from among the plurality of possible outputs; and executing instructions in the client device to generate the selected output so as to stimulate a particular one of the user senses.

This first embodiment may be further defined in a second embodiment such that the method further comprising: soliciting user input in one or more of a plurality of manners selected from the set consisting of: enumerating the available user input sources and selected from one of the enumerated input sources, from one of the enumerated inputs entering choices in words where the manner of input is a combinations of words, characters, letters, numbers, numbers, sentences, paragraphs, sets of paragraphs, so as to provide an input for filling out forms.

This first embodiment may be further defined in a third embodiment such that the user senses are selected from the group consisting of sight, hearing, touch, smell, taste, and combinations thereof. This first embodiment may be further defined in a fourth embodiment such that the client device possible outputs include: a display device for presenting symbols, text, graphics, and pictures or motion video sensible by a users eyes; an audio output device for presenting a sound sensible by a users ears; a tactile output device sensible by a users touch at or through a skin surface; an electronic signal for coupling to a user skin surface mounted or internally implanted sensory transducer device adapted to produce a sensory experience for the user. This first embodiment may be further defined in a fifth embodiment such that the step of selecting comprises the step of being selected by the user when the content is received. This first embodiment may be further defined in a sixth embodiment such that the step of selecting comprises the step of being selected in response to an indicator received with the content. This first embodiment may be further defined in a seventh embodiment such that the step of selecting comprises the step of being selected in response to user preferences identified prior to receipt of the content. This first embodiment may be further defined in an eighth embodiment such that the step of selecting comprises the step of being selected in response to client device characteristics. This eighth embodiment may be further defined in a ninth embodiment such that the client device characteristics are selected from the group consisting of: client device hardware characteristics, client device software device characteristics, client device firmware characteristics, client device programmatic characteristics, client device data characteristics, and combinations thereof.

This second embodiment may be further defined in a tenth embodiment such that inputs are selected from the group consisting of: eye movements, direct sensing of brain signals with electrodes, direct sensing of neuromuscular signals, sensing of skin characteristics, and combinations thereof.

This first embodiment may be further defined in an eleventh embodiment such that the tactile output device generates a Braille tactilely sensible indicia. This first embodiment may be further defined in a twelfth embodiment such that the plurality of alternative expressions for the idea includes symbolic expression. This first embodiment may be further defined in a thirteenth embodiment such that the plurality of alternative expressions for the idea includes a text expression for each content item including a description of all audio and graphical content. This first embodiment may be further defined in a fourteenth embodiment such that the sensory challenged user is a sight impaired user, a hearing impaired user, a sight and hearing impaired user. This first embodiment may be further defined in a fifteenth embodiment such that semantic information contained in the message is associated with the message and used in conjunction with the solicited user input. This first embodiment may be further defined in a sixteenth embodiment such that user input solicitation and enumeration is performed by moving a single button which causes the selection to be sequentially highlighted or sequentially articulated or tactilely identified. This sixteenth embodiment may be further defined in a seventeenth embodiment such that the user input solicitation and enumeration if performed by an act selected from the set of acts consisting of: select from articulated text, selection from items enumerated by voice, button pressing, double mouse clicks, and combinations thereof. This first embodiment may be further defined in an eighteenth embodiment such that the enumeration comprises articulated text. This first embodiment may be further defined in a nineteenth embodiment such that a semantic flag mechanism provides multi-sensor capability.

In a twentieth embodiment, the invention provides a multi-sensory electronic content package for communicating with sensory impaired users; the package comprising procedural portions and data portions. This twentieth embodiment may be further defined in a twenty-first embodiment such that user input solicitation and enumeration is performed from input voice commands. The first embodiment may be further defined in a twenty-second embodiment such that user input solicitation and enumeration is performed by double clicking a mouse or button.

The invention provides a system, device, method, computer program, and computer program product for searching and selecting data and control elements in message procedural/data sets for automatic and complete portrayal of message to maintain message intent.

In a first embodiment of the inventive method for identifying information belonging to one or more classes, the method comprising steps of: associating a semantic identifier with each information item in a data set to be distinguished from other information items in the data set; and searching through the data set to select information items having at least one particular semantic identifier.

This first embodiment may be further defined in a second embodiment such that the semantic identifier comprises a semantic flag. This second embodiment may be further defined in a third embodiment such that the semantic flag comprises at least one binary flag bit. This third embodiment may be further defined in a fourth embodiment such that a plurality of the semantic flags are provided to identify a plurality of different story information characteristics for each item. This fourth embodiment may be further defined in a fifth embodiment such that the plurality of different story information items comprise a first level complete story overview information and a second level complete story overview information. This fifth embodiment may be further defined in a sixth embodiment such that the plurality of different story information items further comprise multiple display screen information items. This second embodiment may be further defined in a seventh embodiment such that each information item has an associated semantic flag or set of semantic flags contained in the file with the information item, and the semantic flags identify the information items as being of different information items types, the information item types being selected from the group of information item types consisting of: contains text, contains audio, and contains video.

This second embodiment may be further defined in an eighth embodiment such that each information item has an associated semantic flag contained in the file with the information item, and the semantic flags identify the information items as being of different information items types, the information item types being selected from the group of information item types consisting of: contains text, contains audio, contains video, contains text backing, contains audio backing, contains video backing, information item is selectable, information item is visible, is selection action description, is played back as audio for this screen, can be omitted without losing intent of message, suitable for hearing impaired, suitable for visually impaired, suitable for people with disabilities of movement, describes what happens when selection is made, describes complete list of currently selectable items, is complete text containing the entire intent of message, is objectionable for rendering for children under 12 years of age, is objectionable for rendering for children under 18 years of age, is objectionable to predetermined group of people, is objectionable for rendering for children under 21 years of age, contains religion related content, contains Christian related content, contains Jewish related content, contains Muslim related content, contains Hindi related content, contains Buddhist related content, contains Atheist related content, contains material objectionable to men, contains material objectionable to women, contains content material objectionable to an identified predetermined group of persons.

This second embodiment may be further defined in a ninth embodiment such that the semantic flags are provided in association with every logical information item unit. This ninth embodiment may be further defined in a tenth embodiment such that the logical information item units are selected from the group consisting of picture, audio, text, video clip, and combinations thereof.

In an eleventh embodiment, the invention provides a method for communicating an idea to a sensory or physically challenged user, the method comprising steps of: (a) identifying an idea to be communicated to a user; (b) collecting and storing a plurality of alternative expressions for the idea, each the alternative expression being associated with a different one of a plurality of possible outputs generated by a client device, each the output intended to stimulate a different sense of a user; (c) composing an electronic content encompassing the idea from selected ones of the plurality of alternative expressions; (d) communicating the electronic content to the client device for presentation to the user; (e) selecting a particular output to generate from among the plurality of possible outputs; and (f) executing instructions in the client device to generate the selected output so as to stimulate a particular one of the user senses.

In a twelfth embodiment, the invention provides a method for identifying and portraying information elements from a data set, the method comprising steps of: assigning semantic flags to predetermined information elements within the story data set; searching the story data set to identify the semantic flags within the story data set; associating the identified semantic flags with procedures for utilizing the information elements; and utilizing the information elements in accordance with predetermined procedures. This twelfth embodiment may be further defined in a thirteenth embodiment such that the assigning, searching, associating, and utilizing enables substantially all information elements that can be portrayed automatically to be automatically portrayed and portrays substantially all of the information that needs to be communicated to retain the intent of a message to be communicated by the story data set This twelfth embodiment may be further defined in a fourteenth embodiment such that the information elements are selected from the group of elements consisting of navigation type information elements, and content type information elements.

In a fifteenth embodiment, the invention provides a semantic flag method for identifying content items in a data set, the method characterized in that the semantic flags provide multi-information that identifies and enumerates content items according to their meanings and relationships to other items to be communicated as part of the message intent-sensor capability.

The invention provides a system, device, method, computer program, and computer program product for adapting content for sensory and physically challenged persons using embedded semantic elements in a procedurally based message file.

In a first embodiment of a method for communicating a message to a client device for interaction with a sensory or physically challenged recipient, the method comprising steps of: (i) identifying an idea to be communicated to the sensory or physically challenged user recipient, the idea including a message intent which influences the content of the message; (ii) collecting and storing a plurality of alternative expressions for the message each the alternative expression being associated with a different one of a plurality of possible outputs generated by a client device, at least some of the outputs intended to stimulate a different sense of the user; (iii) composing a content information set encompassing the message with the message intent from selected ones of the plurality of alternative expressions the message including procedural components, data components and semantic components identifying the context for which ones or the procedural components and data components will be presented to the recipient, the presentation including executing ones of the procedural components and rendering of the data components; (iv) communicating the content information to the client device for presentation to the recipient; (v) automatically selecting a particular output to generate from among the plurality of possible outputs; and (vi) executing instructions in the client device to generate the selected output so as to stimulate a particular one of the user senses.

This first embodiment may be further defined in a second embodiment such that the semantic components comprise semantic identifiers. This second embodiment may be further defined in a third embodiment such that the semantic identifiers comprise semantic flags. This second embodiment may be further defined in a fourth embodiment such that the semantic components comprise single binary bit identifiers used in association with a multi-bit semantic flag mask. This second embodiment may be further defined in a fifth embodiment such that the semantic components comprise multi-bit identifiers used in association with a multi-bit semantic flag mask. This second embodiment may be further defined in a sixth embodiment such that the content information comprises a StoryMail story, and the semantic elements comprise semantic flags embedded within the story. This sixth embodiment may be further defined in a seventh embodiment such that the semantic flag elements are selected from the group of elements consisting of navigation type information elements, and content type information elements.

This sixth embodiment may be further defined in an eighth embodiment such that the method further comprises steps of: (a) searching through the story by a procedure executing within a story playback engine within the receiving client device to identify procedural components and data components having one or more associated semantic flags; and (b) processing each the content information received according to the existence or non-existence of an associated semantic flag, and the type of information identified by the semantic flags. This eighth embodiment may be further defined in a ninth embodiment such that the semantic flags identify a navigation type, and a content type.

This first embodiment may be further defined in a tenth embodiment such that the method further comprising step of: soliciting and receiving user input in one or more of a plurality of manners selected from the set consisting of: enumerating the available user input sources and selecting from one of the enumerated input sources, entering choices in words where the manner of input is a combinations of words, characters, letters, numbers, sentences, paragraphs, sets of paragraphs, articulated text, so as to provide an input for filling out forms. This tenth embodiment may be further defined in an eleventh embodiment such that the user senses can be selected from the group of senses consisting of sight, hearing, touch, smell, taste and combinations thereof.

This first embodiment may be further defined in a twelfth embodiment such that client device possible outputs can include: a display device for presenting symbols, text, graphics, and pictures sensible by a user's eyes; an audio output device for presenting a sound sensible by a users ears; a tactile output device sensible by a users touch at or through a skin surface; an electronic signal for coupling to a user skin surface mounted or internally implanted sensory transducing device adapted to produce a sensory experience for the user.

This first embodiment may be further defined in a thirteenth embodiment such that the step of selecting a particular output to generate from among the plurality of possible outputs includes: (i) the selection by the user when the content is received; (ii) the selection being selected in response to an indicator received with the content; (iii) the selection being selected in response to user preferences identified prior to receipt of the content; and (iv) the selection being selected in response to client device characteristics. This thirteenth embodiment may be further defined in a fourteenth embodiment such that client device characteristics are selected from the group consisting of: client device hardware characteristics, client device software device characteristics, client device firmware characteristics, client device programmatic characteristics, client device data characteristics, and combinations thereof.

This tenth embodiment may be further defined in a fifteenth embodiment such that when user inputs are solicited, such user inputs are be selected from the group of inputs consisting of eye movements, direct sensing of brain signals with electrodes, direct sensing of neuromuscular signals, sensing of skin characteristics, and combinations thereof. This twelfth embodiment may be further defined in a sixteenth embodiment such that the tactile output device generates a Braille encoded tactilely sensible indicia.

This first embodiment may be further defined in a seventeenth embodiment such that the plurality of alternative expressions for the idea includes symbolic expression. This seventeenth embodiment may be further defined in an eighteenth embodiment such that the plurality of alternative expressions for the idea may also include a text expression for each content item including a description of all audio and graphical content.

This first embodiment may be further defined in a nineteenth embodiment such that the sensory challenged user is selected from the group consisting of a sight impaired user, a hearing impaired user, a sight and a hearing impaired user.

This tenth embodiment may be further defined in a twentieth embodiment such that the semantic information contained in the message can be associated with the message and used in conjunction with the solicited user input. This tenth embodiment may be further defined in a twenty-first embodiment such that the user input solicitation and enumeration can be performed by moving a single button to cause the selection to be sequentially highlighted or sequentially articulated or tactilely identified. This tenth embodiment may be further defined in a twenty-second embodiment such that the user input solicitation and enumeration are performed by an act selected from the set of acts consisting of—select from articulated text, selection from items enumerated by voice, button pressing, double mouse button clicks, selection based on button press during an automated continuous sequential enumeration of the available selectable items, selection based on button presses that cause the individual enumeration of selectable items in an order based on which buttons are pressed and with an additional button press to perform the actual selection and combinations thereof.

This first embodiment may be further defined in a twenty-first embodiment such that the content adaptation and scaling uses story element semantics, and provides a multi-sensory electronic content package for communicating with sensory impaired users, the package comprising procedural portions and data portions. This second embodiment may be further defined in a twenty-fourth embodiment such that there are semantic flags and text behind at least a subset of the logical elements of the message to be communicated. This second embodiment may be further defined in a twenty-fifth embodiment such that the semantic flags allow for automated procedural enumeration of the elements needed to communicate the intent of the message and user interaction methods for presentations in a manner conforming to the selection of a given set of flags of interest and the values that the flags of interest must have if each element is to included in the enumeration.

This second embodiment may be further defined in a twenty-sixth embodiment such that the semantic flags' meanings indicate one or more of the following with respect to identified content: first level complete story message overview, second level complete story overview, first level single screen overview, second level single screen overview, contains text, contains audio, contains video, contains text backing, contains audio backing, contains video backing, is selectable, is visible, selection action description, is played back as audio for this screen, can be omitted without losing intent of message, suitable for hearing impaired, suitable for visually impaired, suitable for people with disabilities of movement, describes what happens when selection is made, describes complete list of currently selectable items, is complete text containing the entire intent of message.

This second embodiment may be further defined in a twenty-seventh embodiment such that the semantic flags' meanings indicate one or more of the following with respect to identified content: is objectionable for rendering for children under 12 years of age, is objectionable for rendering for children under 18 years of age, is objectionable for rendering for children under 21 years of age. This second embodiment may be further defined in a twenty-eighth embodiment such that the semantic flags' meanings indicate one or more of the following with respect to identified content: contains religion related content, contains Christian related content, contains Jewish related content, contains Muslim related content, contains Hindi related content, contains Buddhist related content, contains Atheist related content, contains material objectionable to men, contains material objectionable to women, and the like. These are merely exemplary and any other indicator for particular content type may be applied and coded.

This second embodiment may be further defined in a twenty-ninth embodiment such that semantic flags from additional second group of semantic flags are added to a first group of semantic flags to further refine the meaning of the first group of semantic flags, the second semantic flags being selected from the set consisting of: as being of a certain priority, as being of a certain level, or pertaining to a certain order with respect to the other the semantic flags which may be set for an element or set of elements. This second embodiment may be further defined in a thirtieth embodiment such that semantic flags are hierarchically structured. This second embodiment may be further defined in a thirty-first embodiment such that semantic flags are nested. This second embodiment may be further defined in a thirty-second embodiment such that semantic flags are hierarchically structured and nested.

This tenth embodiment may be further defined in a thirty-third embodiment such that a given set of semantic flags of interest are isolated and identified by the process of performing the equivalent logical operation of a binary logical AND operation of the set of binary flags, with a mask value identifying the given set of semantic flags of interest. This thirty-third embodiment may be further defined in a thirty-fourth embodiment such that the result of the logical AND operation is compared to a set of required binary values to determine if the element or elements associated the semantic flags meet the criteria for inclusion in the enumeration of selected elements. This thirty-third embodiment may be further defined in a thirty-fifth embodiment such that the semantic flags meet the criteria if the result is found to be equal to the required binary values. This thirty-third embodiment may be further defined in a thirty-sixth embodiment such that the semantic flags meet the criteria if the result is found to be not equal to the required binary values. This thirty-third embodiment may be further defined in a thirty-seventh embodiment such that the semantic flags meet the criteria if the result is found to contain a number of set flag bits having predetermined relation to a reference criteria, the relation being selected from the set consisting of. the result being above a given threshold, the result being above or equal to a given threshold, the result being below a given threshold, the result being below or equal to a given threshold or equal to a given number, the result being of any predetermined logical or mathematical relation to the reference criteria. This thirty-third embodiment may be further defined in a thirty-eighth embodiment such that the semantic flags can be further refined as to their respective meaning(s), the further identifying including the semantic flag indicating that identified content can be used on a particular device, that identified content can be used on a particular operating environment or set of operating system environments, that identified content can be used on particular playback engine version or versions, and/or that identified content can be used on or in conjunction with a particular software application.

The invention provides a system, device, method, computer program, and computer program product for forward and backward content based version control for automated autonomous playback on client devices having diverse hardware and software.

In a first embodiment of a system for forward and backward content based version control for automated autonomous playback on client devices having diverse hardware and software, the system procedurally assuring that message intent is preserved and substantially optimized on players both older and newer than the story or other content. This first embodiment may be further defined in a second embodiment such that semantic information associated with story access elements built into the story message are used to procedurally substantially optimize the message for the playback capabilities while preserving the message intent in its rendering.

In a third embodiment, the invention provides a method for procedurally assuring that message intent is preserved and substantially optimized on players both older and newer than the story content; the method including providing semantic information associated with story access elements built into the story message that are used to procedurally substantially optimize the message for the playback capabilities while preserving the message intent in its rendering.

In a fourth embodiment, the invention provides a method for maintaining playback capability between message content and client device versions, the method comprising steps of: receiving a message content having a plurality of alternate presentations of the message each of which alternatives communicating the intent of the message, the alternative presentations including a text or symbolic representation that is compatible with all players; providing procedural elements within each message content that query characteristics of the client device to determine compatibility of the client device with the alternative presentations of the message; and executing the procedural elements to adapt a received message content to compatible characteristics of the client device; whereby any message content is playable on any version of any client device.

This fourth embodiment may be further defined in a fifth embodiment such that the message content comprises a story and the client device includes a story player. This fourth embodiment may be further defined in a sixth embodiment such that the plurality of alternate presentations comprise presentations having different media richness levels. This sixth embodiment may be further defined in a seventh embodiment such that the different media richness levels are hierarchically organized from highest media richness to lowest media richness, and wherein the lowest richness level is a text, character, or symbol based representation. This seventh embodiment may be further defined in an eighth embodiment such that the text, character, or symbol based representation is renderable by a text-to-speech conversion engine. This fourth embodiment may be further defined in a ninth embodiment such that stories have procedural foundations in which instructions or commands are provided to adapt an old story to a new feature or version of a story player, or to adapt a new story to an old set of story features or earlier version of a story player.

This fourth embodiment may be further defined in a tenth embodiment such that all stories ever created will run in all hardware, software, and operating version environments that are ever made appropriate for stories. This fourth embodiment may be further defined in an eleventh embodiment such that the recognition that an instruction is not compatible and will not be understood is based on internal programmatic comparison between known instruction opcodes or other instruction indicators. This fourth embodiment may be further defined in a twelfth embodiment such that the recognition that an instruction is not compatible and will not be understood is based on internal programmatic comparison of an explicit version number identified in the received story file as compared to the version of the story player. This fourth embodiment may be further defined in a thirteenth embodiment such that version information if provided by semantic elements within the story. This fourth embodiment may be further defined in a fourteenth embodiment such that each message content has a hierarchical richness organization where the lowest richness message or content is a text, character, or other symbolic message or content; each version of all players by convention supporting text, character, or other symbol-based message or content so that at least a text based message or content will be interpretable and playable in all versions of stories and on all story players.

This fifth embodiment may be further defined in a fifteenth embodiment such that by convention or otherwise the story player ignores any commands, instructions, or opcodes it does not understand and plays the text message. This fifth embodiment may be further defined in a sixteenth embodiment such that compatible procedures are communicated in the story files and playable within the story players. This fifth embodiment may be further defined in a seventeenth embodiment such that the story player recognizes the receipt of a story file that is compatible with and contains features of a newer version of the story player and provides the user with an opportunity to download or otherwise acquire the updated story player software or firmware, either prior to playing the received story file or at a later time. This fifth embodiment may be further defined in an eighteenth embodiment such that each story comprises procedural components, and if the story procedurally determines that the device doesn't have some capability needed to execute parts of the story, then it will execute other parts that the device does recognize and implement. This fifth embodiment may be further defined in a nineteenth embodiment such that story players can be very thin or very light as a result of the intelligent selection of playback richness being implemented within each story itself. This fifth embodiment may be further defined in a twentieth embodiment such that a basic set of features and limited richness support is provided in a story player core software or firmware having a size of from about 2 kilobytes to about 8 kilobytes including an entire run-time module engine. This fifth embodiment may be further defined in a twenty-first embodiment such that a basic set of features and limited richness is provided in core software or firmware having a size of less than 100 kilobytes including an entire run-time module engine.

This twelfth embodiment may be further defined in a twenty-second embodiment such that the method further comprises step of: determining the receiving client device content player version by a procedure contained in the received content. This twelfth embodiment may be further defined in a twenty-third embodiment such that the version determination is made when the content is received. This twelfth embodiment may be further defined in a twenty-fourth embodiment such that the content comprises a StoryMail story. This twelfth embodiment may be further defined in a twenty-fifth embodiment such that the content player procedure includes a software version. This fifth embodiment may be further defined in a twenty-sixth embodiment such that the content player procedure includes a hardware version. This twelfth embodiment may be further defined in a twenty-seventh embodiment such that the content player procedure includes a hardware version and a software or firmware version and the story is compared to all the versions.

This fifth embodiment may be further defined in a twenty-eighth embodiment such that when a new story file is received, a determination is made by the story procedure itself as to the player version number or other version indicia. This fourth embodiment may be further defined in a twenty-ninth embodiment such that executable procedures within the content received determine which version of player software, firmware, and/or hardware are present. This fourth embodiment may be further defined in a thirtieth embodiment such that if the version of the content player that the content is playing on is not right, the executable procedure itself within the content includes procedural tests and branches to branch to or otherwise execute different alternative procedures within the same content that are correct for the version of the content player that will are playing the received content. This fourth embodiment may be further defined in a thirty-first embodiment such that the content is a story and the alternate executable procedures are contained within a single story. This fifth embodiment may be further defined in a thirty-second embodiment such that the story procedure determines the version information and executes portions of itself that are compatible with the player version information. This fifth embodiment may be further defined in a thirty-third embodiment such that a story contains several complete message intent representations at different richness level representations, and the story includes indica at the head of each richness level representation that are compatibility procedures that execute and determine whether the playback device has the capabilities to render the representation at the intended richness level.

This thirty-third embodiment may be further defined in a thirty-fourth embodiment such that the compatibility procedures utilize instructions that are known to be part of a predetermined set of playback engines This thirty-fourth embodiment may be further defined in a thirty-fifth embodiment such that the predetermined set of playback engines comprises every playback engine version ever made. This fifth embodiment may be further defined in a thirty-sixth embodiment such that the determination includes checking for client device support of the opcodes contained in the story. This fifth embodiment may be further defined in a thirty-seventh embodiment such that if the playback engine and client device support the opcodes and other functional capabilities in the indica at the head of each richness level representation, executing the procedures' rich media representation procedures at the maximum richness supported, and if the play back engine or device does not have the functionality and capabilities needed to run a particular rich media representation in the story, then branching to the header procedure for the next lower-richness media representation. This thirty-seventh embodiment may be further defined in a thirty-eighth embodiment such that the determination and/or branching may be direct or iterative. This thirty-eighth embodiment may be further defined in a thirty-ninth embodiment such that the direct determination uses information to match a richness level of the story content to the richness level appropriate to the player in one step.

This thirty-seventh embodiment may be further defined in a fortieth embodiment such that the iterative approach progressively compares the different richness levels in the story to the richness level that can be rendered, starting at the highest richness level, and progressing to lower richness levels. This fortieth embodiment may be further defined in a forty-first embodiment such that the lowest richness level is displaying text or other character or symbolic information. This forty-first embodiment may be further defined in a forty-second embodiment such that the lowest level text or other character of symbolic information is converted to speech using a text-to-speech conversion engine. This forty-second embodiment may be further defined in a forty-third embodiment such that the version indicia comprises a playback engine version number.

This fifth embodiment may be further defined in a forty-fourth embodiment such that the story is constructed so that the playback engine never encounters instructions that it does not know about or does not understand even if newer instructions and capabilities are actually contained in parts of the story. This fifth embodiment may be further defined in a forty-fifth embodiment such that if the story player is a new version, the new instructions included in the new version story are executed or otherwise used so that the enhanced newer features associated with the newer version stories are accessible; but if the if the story player receiving the new version story is an old player, then the story procedure will detect this and not branch to or execute any procedures containing new instructions not supported by the old player. This fifth embodiment may be further defined in a forty-sixth embodiment such that all stories can be played in all story players for all time to thereby reduce obsolescence of old players and increases the likelihood that the intent of a story message will be maintained substantially independent of the story player on which it is ultimately received and played.

The invention provides a system, device, method, computer program, and computer program product for reducing unauthorized access by procedural messages executing in a computer system to computer system or memory or programs or data stored therein.

In a first embodiment of a method of maintaining anti-hacking security in a computer system, such as a system that executes procedural messages using native code to carry out the procedures of the message, the method comprising the steps of: native code carrying out the procedures of the message allocating, in a single operation, one contiguous memory block range having a single memory boundary position as a buffer for storage; protecting the allocated storage buffer from overflow by: reducing the number of operations the native code uses to carry out the procedures of the message that obtain memory pointers to the allocated buffer; and checking attempts to access a memory locations outside of the allocated single memory block range only against the single memory boundary position of the single buffer memory block range, so that the likelihood that a computer system hacker can create a buffer overflow and thereby obtain access to other memory ranges to gain entry or control over functions or data of the computer system is reduced.

This first embodiment may be further defined in a second embodiment such that the computer system includes a story player device. This first embodiment may be further defined in a third embodiment such that computer code to perform memory checking is uniform and compact. This first embodiment may be further defined in a fourth embodiment such that a common core of instructions operate on memory. This first embodiment may be further defined in a fifth embodiment such that a hacker attempting to produce a memory buffer stack overflow in order to introduce executable code into the system is substantially prevented by the single memory range allocation and checking. This first embodiment may be further defined in a fifth embodiment such that the computer system provides more stable operation as a result of the predictable memory operating environment than would be available with conventional memory operating environments. This first embodiment may be further defined in a seventh embodiment such that the message procedures include instructions which sub-allocate all memory regions from the single memory block. This first embodiment may be further defined in an eighth embodiment such that the message procedures include instructions which can cause the single memory block to be destroyed and reallocated when different parts of the message are executed, thereby providing procedural flexibility while avoiding the complexities normally associated with memory garbage collection algorithms. This eighth embodiment may be further defined in a ninth embodiment such that the message procedures include at least one instruction which can preserve some or all parts of the data stored in the single memory block in a second allocated memory block, which is itself also checked to make sure accesses outside of the second allocated memory block are never made while the single memory block is being reallocated. This ninth embodiment may be further defined in a tenth embodiment such that the second allocated memory block is always available during execution of the procedural messages and accesses are checked to be contained within one of the two allocated memory blocks.

In a first embodiment of a method of maintaining anti-hacking security in a computer system, such as a system that executes procedural messages using native code to carry out the procedures of the message, the method comprising the steps of: native code carrying out the procedures of the message allocating, in a single operation, one contiguous memory block range having a single memory boundary position as a buffer for storage; protecting the allocated storage buffer from overflow by: reducing the number of operations the native code uses to carry out the procedures of the message that obtain memory pointers to the allocated buffer; and checking attempts to access a memory locations outside of the allocated single memory block range only against the single memory boundary position of the single buffer memory block range; so that the likelihood that a computer system hacker can create a buffer overflow and thereby obtain access to other memory ranges to gain entry or control over functions or data of the computer system is reduced.

In an eleventh embodiment, the invention provides a computer program and computer program product for use in conjunction with a computing machine and including a program module stored on a tangible medium, said program module including instructions for directing operating of the computing device to maintain security in a computer system that executes procedural messages using native code to carry out the procedures of the message, said instructions including instructions for: native code carrying out the procedures of the message allocating, in a single operation, one contiguous memory block range having a single memory boundary position as a buffer for storage; protecting the allocated storage buffer from overflow by: reducing the number of operations the native code uses to carry out the procedures of the message that obtain memory pointers to the allocated buffer; and checking attempts to access a memory locations outside of the allocated single memory block range only against the single memory boundary position of the single buffer memory block range; so that the likelihood that a computer system hacker can create a buffer overflow and thereby obtain access to other memory ranges to gain entry or control over functions or data of the computer system is reduced. In a twelfth embodiment, the invention provides a data structure implementing the above described security features. In a thirteenth embodiment, the invention provides an information appliance or computing device incorporating the inventive method.

The invention provides a system, device, method, computer program, and computer program product for self-directed loading of an input buffer with procedural messages from a stream of sub-files containing sets of logical files.

In a first embodiment of an information appliance, computer, or computing device, the invention provides a method for self-directed loading of a buffer from an input stream containing at least one procedural thread having at least one executable instruction and optionally including parameters associated with the executable instruction, the method comprising steps of: initializing a first story thread state to a running state; assigning a particular input memory buffer from among a plurality of available memory buffers within the device to the first thread; setting the first thread input memory buffer to be associated with the logical file in the input stream having content ID zero (CID=0) and current file number zero (CFN=0) so that at story playback startup the device loads from the first content portion (CID=0) of CFN=0=content file number; beginning execution with the first logical file in the first sub-file with CFN=0 and CID=0; and accessing subsequent logical files within other subfiles that have arrived at the information appliance device or are yet to be streamed into the information appliance device, so that playback can begin according to predetermined criteria or preferences or instruction before all the sub-files and their constituent logical files have been received; the first thread starting the processing of the procedures and other threads comprising the rendering of the message; performing substantially all loading of succeeding procedural and data elements of the messages by explicit procedural load instructions; then performing one execution of all threads having the state of running including first performing one execution of the first thread having CFN=0 and CID=0; and repeating the step of performing executions of threads until all of the threads have transitioned from a running state to a non-running state, each non-running thread transitioning from a running state to another state; when the step of performing is performed the first time after initialization, opening logical file having CID=0 and CFN=0, and reading into a buffer a first predetermined number of words, each the word having a predetermined word size; the predetermined number of words either containing an entire story procedure or containing a load operation for loading any portion of the story procedure not contained in the predetermined number of words.

This first embodiment may be further defined in a second embodiment such that explicit message procedure load instructions are the only method of procedural and data input words of the message, once the initial words of CID=O and CFN=0 have been loaded at startup. This first embodiment may be further defined in a third embodiment such that the first message thread is number 0 or any other predetermined number. This first embodiment may be further defined in a fourth embodiment such that the running state further comprising a state selected from the set consisting of a running state, a suspended thread state, and an uninitialized thread state. This second embodiment may be further defined in a fifth embodiment such that a second descendant thread is created, associated with input buffers and have their states set as a direct result of procedures executed on thread 0 starting with the initial loading of words from the logical file with CID=0 and CFN=0. This fifth embodiment may be further defined in a sixth embodiment such that all other threads are created, associated with input buffers and have their states set as a direct result of procedures running on the descendant threads or descendants of these threads. This sixth embodiment may be further defined in a seventh embodiment such that any thread in a running state can set or reset any or all attributes of any other thread or its own attributes.

This first embodiment may be further defined in an eighth embodiment such that the threads comprising StoryMail story threads. This first embodiment may be further defined in a ninth embodiment such that the step of performing execution is implemented with a story playback cycle function, and the step of repeatedly performing execution is implemented by repeatedly calling the story playback cycle function. This first embodiment may be further defined in a tenth embodiment such that the first predetermined number of words is a fixed number of words. This tenth embodiment may be further defined in an eleventh embodiment such that the fixed number of words is 32 words. This tenth embodiment may be further defined in a twelfth embodiment such that the fixed number of words is a fixed number of words between 16 words and 512 words. This tenth embodiment may be further defined in a thirteenth embodiment such that the predetermined word size is a 16-bit word size. This tenth embodiment may be further defined in a fourteenth embodiment such that the predetermined word size is a 32-bit word size. This tenth embodiment may be further defined in a fifteenth embodiment such that the predetermined word size is a 64-bit word size. This tenth embodiment may be further defined in a sixteenth embodiment such that the predetermined word size is a 96-bit word size. This tenth embodiment may be further defined in a seventeenth embodiment such that the predetermined word size is a 128-bit word size.

This first embodiment may be further defined in an eighteenth embodiment such that the explicit procedural load operations are implemented with a LOAD_OP instruction. This first embodiment may be further defined in an eighteenth embodiment such that information contained in the input stream is deterministically and explicitly loaded into the input buffer in response to execution of the load operations contained within the input stream. This first embodiment may be further defined in a twentieth embodiment such that the input buffer loading accomplished in predetermined fixed-length blocks. This first embodiment may be further defined in a twenty-first embodiment such that the load operation specifies a particular location in an input memory buffer to load the newly received logical file or portions thereof. This first embodiment may be further defined in a twenty-second embodiment such that the method further comprises executing an instruction causing data in an input buffer to be moved to another location before new data is placed into the input memory buffer. This first embodiment may be further defined in a twenty-third embodiment such that the instruction causing data in the input buffer to be moved comprises a buffer data move instruction. This first embodiment may be further defined in a twenty-fourth embodiment such that the load operation instruction further causing data in an input buffer to be moved to another location before new data is placed into the input memory buffer. This first embodiment may be further defined in a twenty-fifth embodiment such that the input buffer loading procedural components within the logical files explicitly and deterministically use instructions in the playback stream itself for directing input buffer loading. This first embodiment may be further defined in a twenty-sixth embodiment such that the procedural components are self-loading. This first embodiment may be further defined in a twenty-seventh embodiment such that the method further comprising constructing the input stream to ensure that each load operation instruction contained within the stream loads enough of the stream to that another load operation instruction will be encountered and executed before any code not in the input memory buffer is needed. This first embodiment may be further defined in a twenty-eighth embodiment such that the method further comprising bootstrap loading a first portion of procedural code into the input memory buffer when starting a new story playback. This twenty-eighth embodiment may be further defined in a twenty-ninth embodiment such that the bootstrap loading comprises loading a procedure to initiate loading of the stream into the input buffer.

In a thirtieth embodiment, the invention further provides a method for building an information stream for self-directed loading and playback in an information appliance; the method comprising steps of: constructing a single physical or virtual file as a concatenation of a plurality of sub-files, which contain sets of logical files; and constructing each sub-file to include at least one procedural thread having at least one executable instruction and optionally including parameters associated with the instruction. This thirtieth embodiment may be further defined in a thirty-first embodiment such that the information stream comprises a StoryMail content information stream.

The invention provides a system, device, method, computer program, and computer program product for device-neutral procedurally-based content display layout and content playback.

In a first embodiment of the inventive procedure for layout of a display screen using rectangular regions, the method for procedural layout of a display screen using rectangular regions comprising steps of: assigning a display descriptor element of a display descriptor array buffer to each item to be rendered on the display; each the display descriptor element includes a display content buffer number, a screen rectangle, and a hotspot descriptor array; the display content buffer number identifies the item to be displayed; the screen rectangle identifies the area of the screen on which to display the item; the hotspot descriptor array contains hotspot elements which each contain semantic flags, information, and buffer numbers which can be used to control, find or select other alternative media representations or informative media associated with the item; assigning a layout rectangle to layout zero or more items spatially with respect to each other and the layout rectangle; intelligently setting a bounding rectangle as items are laid out; carrying out farther layout operations based on the bounding rectangle results of previous layout operations and/or based on status and branching flags set or reset while laying out the items; and as long as there are more items to be laid out, then repeatedly applying the set of rectangle based operations for each item or set of items to be laid out.

This first embodiment may be further defined in a second embodiment such that the display descriptor assignment is performed using a display descriptor operation. This second embodiment may be further defined in a third embodiment such that the display descriptor operation can include zero or more optional steps selected from the steps consisting of: the setting descriptor flags, setting the display item's buffer number, setting the screen rectangle, setting the hotspot array buffer number, and any combination or selection of a subset of these steps. This first embodiment may be further defined in a fourth embodiment such that the layout rectangle is defined using a set rectangle operation. This first embodiment may be further defined in a fifth embodiment such that the layout operation is a LAYOUT OP operation. This first embodiment may be further defined in a sixth embodiment such that separate branching flags are set as a result of a layout operation determining that an item or set of items to be displayed does not fit inside the layout rectangle in any of a number of ways. This fifth embodiment may be further defined in a seventh embodiment such that the flags are set or reset when the item or items do or do not fit horizontally inside the layout rectangle. This fifth embodiment may be further defined in an eighth embodiment such that the flags are set or reset when the item or items to be laid out do or do not fit vertically when wrapped into the display rectangle. This first embodiment may be further defined in a ninth embodiment such that a layout operation is used to place the list of display descriptors inside the layout rectangle. This ninth embodiment may be further defined in a tenth embodiment such that laying out the item or set of items using a first horizontal center then a vertical center procedure This ninth embodiment may be further defined in a eleventh embodiment such that laying out the item or set of items using a first vertical center then a horizontal center procedure. This ninth embodiment may be further defined in a twelfth embodiment such that the display descriptor element contains a picture buffer number. This twelfth embodiment may be further defined in a thirteenth embodiment such that the picture buffer number defines a picture in RGB, RGBA, YUV, YcbCr, or Y format. This ninth embodiment may be further defined in a fourteenth embodiment such that the display descriptor element includes a text buffer number.

This first embodiment may be further defined in a fifteenth embodiment such that the picture buffer number defines the text in ASCII, UNICODE, or multi-byte character format. This first embodiment may be further defined in a sixteenth embodiment such that conditional jump operation instructions are used to perform complex procedural layout functions, the jump operation instructions directing procedures to perform intelligent operations according to the layout operations' results or flag settings. This sixteenth embodiment may be further defined in a seventeenth embodiment such that the conditional jump operation comprises a JUMP_OP instruction operation.

This first embodiment may be further defined in an eighteenth embodiment such that the layout method is procedurally based to layout and display information on a display device. This eighteenth embodiment may be further defined in a nineteenth embodiment such that the information is selected from the set of information items consisting of graphical information, textual information, character information, symbolic information. This eighteenth embodiment may be further defined in a twentieth embodiment such that the information includes written language in any alphabet, character set, or other language representation.

This first embodiment may be further defined in a twenty-first embodiment such that the procedurally based layout and display comprising layout mode type operations, including operations selected from the set of operations consisting of: horizontal only, horizontal evenly spaced, vertically only, vertically then horizontal, centered, items spaced a fixed distance apart horizontally, items spaced a fixed distance apart vertically, and combinations thereof. This first embodiment may be further defined in a twenty-second embodiment such that the procedurally-based layout and display operations permit content to be successfully authored to display in an acceptable manner without prior knowledge of the particular hardware characteristics of the device on which the content will be displayed. This first embodiment may be further defined in a twenty-third embodiment such that the content comprises a StoryMail story. This first embodiment may be further defined in a twenty-fourth embodiment such that the procedurally-based layout and display operations permit content to be more easily authored for display on a variety of display devices. This first embodiment may be further defined in a twenty-fifth embodiment such that the procedurally-based layout and display operations permit content to be authored in a display hardware neutral manner without regard for particular display device hardware and/or display device driver characteristics. This first embodiment may be further defined in a twenty-sixth embodiment such that the procedurally-based layout and display permitting content playback to be customized during its run-time on the player. This twenty-sixth embodiment may be further defined in a twenty-seventh embodiment such that the customization is performed by the Hardware Abstraction Layer (HAL). This twenty-seventh embodiment may be further defined in a twenty-eighth embodiment such that the customization is performed in response to user commanded preferences. This first embodiment may be further defined in a twenty-ninth embodiment such that the procedurally-based layout and display permits content to be authored in a display hardware neutral manner even when hardware characteristics are known in advance of authoring the content without regard for particular display device hardware and/or display device driver characteristics.

In a thirtieth embodiment, the invention further provides a method for laying out two-dimensional items on a display screen having fixed physical dimensions and width and height dimension that are logically unbounded, where at least one of the items to be displayed may require more display screen area that in physically available, the method comprising steps of: providing means for logically extending the height dimension for display of objects in a first screen direction, the first screen extended dimension representing a virtual screen dimension; generating on-screen or visible rectangle of physical picture elements (pixels) having width (W) and height (H); and generating a logical or layout rectangle allocated to a particular display task for placing spaced multiple items within the visible screen, the layout rectangle having the possibility of being either smaller than, larger than, or equal in dimension to the visible rectangle owing to the presence of the logical display extension means; specifying the layout rectangle with instructions that specify (i) a layout rectangle width (LW), a layout rectangle height (LH), and the location or coordinate of a corner of the layout rectangle with respect to the visual screen rectangle, generating layout resultant bounding rectangle having size RW×RH where RW defines the outside width limits of a set of laid out items; and laying out the items using the bounding rectangles in combination with procedural instructions to layout, position, set layout rectangles, and define which items are to contribute to the bounding rectangles used to re-layout an item or set of items, or lay out an additional item or set of items.

This thirtieth embodiment may be further defined in a thirty-first embodiment such that the means for logically extending comprising a scroll mechanism and scroll bars. This thirtieth embodiment may be further defined in a thirty-second embodiment such that the means for logically extending comprising a paging mechanism. This thirtieth embodiment may be further defined in a thirty-third embodiment such that the corner is the upper left corner, a lower left corner, an upper right corner, a lower right corner, any screen reference location.

This thirtieth embodiment may be further defined in a thirty-fourth embodiment such that any laid out items contributing to a resultant bounding rectangle may be subtracted from the resultant bounding rectangle prior to the final layout of additional items. This thirty-fourth embodiment may be further defined in a thirty-fifth embodiment such that new items may be added to items laid out to be displayed in the resultant bounding rectangle in prior operations. This thirty-fourth embodiment may be further defined in a thirty-sixth embodiment such that new items may be combined with existing items in the resultant bounding rectangle according to predetermined logical or mathematical procedures. This thirtieth embodiment may be further defined in a thirty-seventh embodiment such that additional items are laid out in the resultant bounding box window using the layout operation instruction. This third embodiment may be further defined in a thirty-eighth embodiment such that the layout operation instruction comprises the LAYOUT_OP instruction. This thirty-sixth embodiment may be further defined in a thirty-ninth embodiment such that the layout operation instruction comprises the LAYOUT_OP instruction.

This thirty-eighth embodiment may be further defined in a fortieth embodiment such that the method further comprising setting branching flags to indicate when the layout of an item or set of items (i) required a wrap to multiple vertical layers, (ii) required a wrap to multiple horizontal layers, (iii) goes outside the layout rectangle, or (iv) identifies another predetermined condition. This thirty-eighth embodiment may be further defined in a forty-first embodiment such that the branching flags including a “does not fit across” which is set if all the items do not fit across the screen and used procedurally to enable the object to be laid out for displayed in an appropriate manner given the item size and the available screen size or virtual dimensions. This thirty-eighth embodiment may be further defined in a forty-second embodiment such that the method further comprising step of using a test and branch operation to control layout of objects based on the branching flags. This thirty-eighth embodiment may be further defined in a forty-third embodiment such that the method further comprising step of using a test and branch operation to control layout of items based on predetermined display size and/or coordinate based calculation results.

The invention provides a system, device, method, computer program, and computer program product for thin procedural multi-media player run-time engine having application program level cooperative multi-threading and constrained resource retry with anti-stall features.

In a first embodiment of the content (story) playback engine (PBE), the invention provides a small low-overhead content playback engine comprising: a main procedure implemented in portable code, native processor code or hardware blocks that executes cooperative player engine threads in turn; a boot-up sequence to assign an instruction input buffer to a startup thread, loads the first procedural multi-media player instructions, and starts the startup thread in a running state; a instruction dispatcher that fetches each instruction word of a thread in sequence or as directed by branching instructions, and calls a native code function or hardware block to execute each instruction word and the parameters that follow it in turn; a set of native code functions or hardware blocks which together carry out the functions of the multi-media player instruction words and parameters; and a hardware extraction layer implemented in native code functions or hardware blocks that marry the portable portions of the player engine to the parts that are specific to the application or device that makes use of the player.

In a second embodiment of the content (story) playback engine (PBE), the invention provides a method for a thin low-overhead multi-media procedural content player engine, the method comprising steps of: receiving a file for playback comprising at least one sequence of fixed length words organized by having a plurality of instructions arranged as a linear sequence where parameters associated with a particular instruction immediately follow the particular instruction and wherein subsequent instructions follow the parameters associated with a previous instruction; operating, by the playback engine, on the sequence of instructions and parameters, the operating including: fetching the next word in the sequence, the word including an indicia of the function to be performed; executing the identified function; and when the identified function utilizes parameters, the function then: (i) fetching the parameters that follow the instruction; (ii) performing the instruction using the function and parameters; (iii) advancing a program counter past the parameters to the next instruction in the sequence; and, (iv) returning a status code for the instruction.

This second embodiment may be further defined in a third embodiment such that the status code being selected from the set of status codes consisting of a success status code, an error status code, a yield status code, a informative status code, and a retry instruction status code. This second embodiment may be further defined in a fourth embodiment such that the instruction and parameters are arranged according to the scheme Instructions, param1a, param1b, Instruction2, param2a, param2b, param2c, . . . , InstrutionN, paramNa . . . , paramNm.

This second embodiment may be further defined in a fifth embodiment such that the content player comprises a StoryMail story player. This second embodiment may be further defined in a sixth embodiment such that the status code being selected from the set of status codes consisting of a success status code, an error status code, a yield status code, a informative status code, and a retry instruction status; and the instruction and parameters are arranged according to the scheme Instruction1, param1a, param1b, . . . , Instruction2, param2a, param2b, param2c, . . . , InstrutionN, paramNa . . . , paramNm; and the content player comprises a StoryMail story player. This second embodiment may be further defined in a seventh embodiment such that the fixed length words being 32-bit words. This second embodiment may be further defined in an eighth embodiment such that the fixed length words being selected from the set of fixed length word sizes consisting of 8-bit words, 16-bit words, 32-bit words, 40-bit words, 64-bit words, 96-bit words, 128-bit words, 256-bit words, 512-bit words, and any other fixed length word or byte size. This second embodiment may be further defined in a ninth embodiment such that receiving a file for playback comprising at least one sequence of the fixed length words. This second embodiment may be further defined in a tenth embodiment such that the fixed length words and parameters are comprised of numeric and/or symbolic values in any combination. This second embodiment may be further defined in an eleventh embodiment such that the instruction values identify individual functions within a library of functions. This eleventh embodiment may be further defined in a twelfth embodiment such that the instruction values identifies one or more branch instructions.

This second embodiment may be further defined in a thirteenth embodiment such that the run-time module program(s) is thin. This second embodiment may be further defined in a fourteenth embodiment such that the run-time module program(s) is thin and implemented with fewer than about 200 lines of program code. This second embodiment may be further defined in a fifteenth embodiment such that the content comprises a StoryMail story.

This second embodiment may be further defined in a sixteenth embodiment such that the run-time module program(s) is thin and implemented with fewer than about 100 lines of program code. This second embodiment may be further defined in a seventeenth embodiment such that the run-time module program(s) is thin and implemented with fewer than about 50 lines of program code. This second embodiment may be further defined in an eighteenth embodiment such that the run-time module program(s) is thin and implemented with fewer than about 50 lines of C language program code. This second embodiment may be further defined in a nineteenth embodiment such that the run-time module has a low-overhead relative to conventional run-time systems because no sophisticated parsing, threading, synchronization, memory allocation or garbage collection mechanisms are needed. This second embodiment may be further defined in a twentieth embodiment such that execution speed is increased relative to conventional methods because processor intensive functions are performed with native processor code as part of an op-code's implementation, and all the control and navigation are performed in the very compact and very compressible story language instructions. This second embodiment may be further defined in a twenty-first embodiment such that the method and apparatus performing or implementing the inventive method is electrical power conservative because processor intensive functions are performed with optimized native processor code as part of an op-code's implementation, and all the control and navigation are performed in the very compact and very compressible story language instructions. This twenty-first embodiment may be further defined in a twenty-second embodiment such that the processor intensive functions include inverse discrete cosine transforms (IDCTs). This twenty-first embodiment may be further defined in a twenty-third embodiment such that the story language code is small. This second embodiment may be further defined in a twenty-fourth embodiment such that the run-time module program mechanism uses a common set of small functions over and over again to provide the functional capabilities of larger conventional programs so that tasks can be run within the data and code caches of at least some processors of conventional computers and information appliances. This twenty-first embodiment may be further defined in a twenty-fifth embodiment such that the method is performed with fewer layers of abstraction functional modules and less complex algorithms.

This second embodiment may be further defined in a twenty-sixth embodiment such that the method provides a run-time system that eliminates the need to implement any of the following complex algorithm types: (i) thread creation and round robin thread scheduling with thread priority systems, (ii) native operating system or C library memory allocation functions, (iii) memory garbage collection functions, (iv) interrupt system functions, (v) picture decompression algorithms, (vi) multimedia playback system, (vii) user controls, and (viii) video and/or audio synchronization algorithms. This second embodiment may be further defined in a twenty-seventh embodiment such that the size of the native code to perform playback of multimedia application or messages in story format is no more than from about 30 kilobytes to about 300 kilobytes. This second embodiment may be further defined in a twenty-eighth embodiment such that the size of the native code to perform playback of multimedia application or messages in story format is no more than about 50 kilobytes. This second embodiment may be further defined in a twenty-ninth embodiment such that the size of the native code to perform playback of multimedia application or messages in story format is no more than about 100 kilobytes. This second embodiment may be further defined in a thirtieth embodiment such that the size of native code is reduced by a factor of about 100 as compared to conventional implementations. This second embodiment may be further defined in a thirty-first embodiment such that the size of native code is reduced by from by a factor of about 5 times to a factor of about 1000 times as compared to conventional implementations. This second embodiment may be further defined in a thirty-second embodiment such that the size of the native code to perform playback of multimedia application or messages in story format is less than 500 kilobytes.

This second embodiment may be further defined in a thirty-third embodiment such that the run-time module provides cooperative multi-threading of various visual or audio special effects. This second embodiment may be further defined in a thirty-fourth embodiment such that the cooperative multi-threading occurs at the level of the application program. This second embodiment may be further defined in a thirty-fifth embodiment such that the cooperative multi-threading procedure further includes a constrained resource retry procedure. This second embodiment may be further defined in a thirty-sixth embodiment such that the cooperative multi-threading with constrained resource retry occurs at the level of the application program.

This thirty-sixth embodiment may be further defined in a thirty-seventh embodiment such that the multi-threaded with constrained resource retry procedure includes steps of: running sequences of instructions for a thread as long as the instruction functions return as status code of success, and then executing the sequences of instructions for the next thread for as long as the instruction functions return a status code of success; a yield status code being returned for any instruction or sequence of instructions that takes more than a predetermined time to complete so that other threads and their instructions will have an opportunity to run. This thirty-seventh embodiment may be further defined in a thirty-eighth embodiment such that the status code is set to retry when a constrained resource blocks the execution of the instruction, thereby allowing other threads to run before the instruction is retried.

This thirty-sixth embodiment may be further defined in a thirty-ninth embodiment such that the resource constraint is selected from the set of constrains consisting of: time being greater than some predetermined value, time being less than some predetermined value, time being equal to some predetermined value, a buffer being available, a buffer not being available, a variable being less than a predetermined value, a variable being greater than a predetermined value, a variable being equal to a predetermined value, a variable having any predetermined logical or arithmetic relation to a reference value, a hardware device being ready, a hardware device not being ready, an electronic communication or protocol having been completed, an electronic communication or protocol not having been completed, and combinations thereof. This thirty-ninth embodiment may be further defined in a fortieth embodiment such that the method further provides thread or media playback synchronization.

This fortieth embodiment may be further defined in a forty-first embodiment such that the thread synchronization including input, video playback, audio playback, special effects of video, special effects of audio, or combinations thereof. This thirty-ninth embodiment may be further defined in a forty-second embodiment such that executing a “wait until time” type instruction that will start execution and/or not complete execution until a predetermined set time or set times. This forty-second embodiment may be further defined in a forty-third embodiment such that the wait until time instruction comprises a time related instruction such as a TIME_OP instruction. This forty-third embodiment may be further defined in a forty-fourth embodiment such that the set time being defined by a reference to a relative time, whether or not using indirection plus post operations, to an elapsed time difference, to an absolute time reference. This forty-second embodiment may be further defined in a forty-fifth embodiment such that the wait until time type instruction returning a retry instruction status if it is not time for the instruction to be executed and/or to complete execution, the return of the retry instruction status code causing execution of the next thread to execute. This forty-fifth embodiment may be further defined in a forty-sixth embodiment such that each time the “wait until time” instruction containing thread starts again it will retry the same instruction until the set time. This forty-sixth embodiment may be further defined in a forty-seventh embodiment such that the set time comprises a constrained resource. This forty-seventh embodiment may be further defined in a forth-eighth embodiment such that the constrained resource is time and the instruction constrained by time is retried if the time is not the set time or within some predetermined difference from the set time. This thirty-ninth embodiment may be further defined in a forty-ninth embodiment such that a memory buffer is a constrained resource and an instruction that needs a memory buffer will return a retry instruction status code if the needed memory buffer is not available. This thirty-ninth embodiment may be further defined in a fiftieth embodiment such that use of the retry instruction status reducing the likelihood of stalling the processor as a result of a resource not being available when needed. This thirty-ninth embodiment may be further defined in a fifty-first embodiment such that synchronization of threads is achieved using a wait for flag in a wait until time instruction, the wait for flag comprising a variable which is itself an element of a memory buffer.

The invention provides a system, device, method, computer program, and computer program product for streaming multimedia-rich interactive experiences over a communications channel.

In a first embodiment of a method for streaming electronic content, the invention provides a method for streaming electronic content from a sender to a receiver over a communication link, the method comprising the steps of: forming a single virtual story file comprising substantially the complete electronic content of comprising: a set of logical files, each logical file including a header indicating that the first logical file procedural/data content offset is 0 and that the last procedural/data element offset is the size of the logical file procedural/data content less one atomic element; automatically and intelligently reforming the single virtual story file into a plurality of sequentially arrayed subfiles, each subfile including: (i) a header identifying a first subfile offset from a reference location in the single virtual file and containing a substantially complete story for a predetermined playback period or playback functionality; (ii) a currently executable portion with each the subfile that executes when the subfile is opened after receipt, and (iii) a control portion that controls loading and execution of other subfiles; communicating the single virtual file over the communication link in a data stream at a data rate commensurate with available bandwidth and characteristics of the communication link, the physical file being received by the receiver as sequential portions of the single virtual file in the form of individual subfiles; and the opening of a later received subfile being controlled by a previously received subfile such that each the currently executable portion of each of the subfiles is executed only upon the direction of an earlier executing subfile.

This first embodiment may be further defined in a second embodiment such that a leading and previously received subfile holds and controls execution of a trailing and subsequently received subfile. This first embodiment may be further defined in a third embodiment such that each subfile includes a control portion that instructs the playback engine to search for and open and execute procedures and data from a preceding or trailing subfile or set of preceding or trailing subfiles. This first embodiment may be further defined in a fourth embodiment such that one or a number of subfiles is requested to be transmitted by a starting subroutine as each logical file is opened for use by the story being played. This first embodiment may be further defined in a fifth embodiment such that each subfile received is executed until all subfiles for the single virtual file have been received and executed. This first embodiment may be further defined in a sixth embodiment such that there can be branching forward and backward to any number of points between sub-files because of navigation. This first embodiment may be further defined in a seventh embodiment such that if a trailing subfile identified by the control portion of a leading subfile logical file has not been received, the control portion retrying opening the trailing subfile until it is received so that the quality of the stream is not degraded. This first embodiment may be further defined in an eighth embodiment such that if a trailing subfile directed to be sent and received during the execution of the control or main procedural parts of a previous subfile is not yet completely received at the time control is transferred to the trailing subfile, the procedure transferring control will recognize this as a resource constraint and automatically retry the story instruction or instructions that require the presence of the complete trailing subfile. This first embodiment may be further defined in a ninth embodiment such that the method comprises a non-real-time streaming method. This first embodiment may be further defined in a tenth embodiment such that the method provides a real-time streaming method. This first embodiment may be further defined in an eleventh embodiment such that the electronic content comprises an electronic coupon for a product. This first embodiment may be further defined in a twelfth embodiment such that the electronic content comprises an electronic advertisement for an item, goods, or service. This first embodiment may be further defined in a thirteenth embodiment such that the electronic content comprises an electronic commerce content. This first embodiment may be further defined in a fourteenth embodiment such that the electronic content comprises an electronic catalog. This first embodiment may be further defined in a fifteenth embodiment such that the electronic content comprises an electronic greeting card. This first embodiment may be further defined in a sixteenth embodiment such that the electronic content comprises an electronic content selected from the group consisting of real-time transmission of video and audio of events and non-real time audio and video of events, real-time and non-real-time transmission of navigation, and combinations thereof. This first embodiment may be further defined in a seventeenth embodiment such that the electronic story content is larger than device can store at one time.

This first embodiment may be further defined in an eighteenth embodiment such that a high-bandwidth connection connects the sender and the receiver but memory in the receiving device is not of sufficient size to simultaneously store the entire story, the story being received as a plurality of subfiles as they are requested, sufficient memory being reserved for execution of subfiles already received, the story never residing in the memory of the device in its entirety at the same time.

This first embodiment may be further defined in a nineteenth embodiment such that the system and method allows for forward, backward, and random access of various ones of the story subfiles as navigation occurs. This first embodiment may be further defined in a twrntieth embodiment such that the story subfiles are executed non-sequentially, and permitting non-sequential execution of subfiles in response to navigational decision inputs to the device.

This first embodiment may be further defined in a twenty-first embodiment such that: a leading and previously received subfile holds and controls execution of a trailing and subsequently received subfile; each subfile includes a control potion that instructs the playback engine to search for and open and execute procedures and data from a preceding or trailing subfile or set of preceding or trailing subfiles; one or a number of subfiles is requested to be transmitted by a starting subroutine as each logical file is opened for use by the story being played; each subfile received is executed until all subfiles for the single virtual file have been received and executed; there can be branching forward and backward to any number of points between sub-files because of navigation; if a trailing subfile identified by the control portion of a leading subfile logical file has not been received, the control portion retrying opening the trailing subfile until it is received so that the quality of the stream is not degraded; if a trailing subfile directed to be sent and received during the execution of the control or main procedural parts of a previous subfile is not yet completely received at the time control is transferred to the trailing subfile, the procedure transferring control will recognize this as a resource constraint and automatically retry the story instruction or instructions that require the presence of the complete trailing subfile; the electronic content comprises an electronic content selected from the group consisting of real-time transmission of video and audio of events and non-real time audio and video of events, real-time and non-real-time transmission of navigation, and combinations thereof.

This twenty-first embodiment may be further defined in a twenty-second embodiment such that a high-bandwidth connection connects the sender and the receiver but memory in the receiving device is not of sufficient size to simultaneously store the entire story, the story being received as a plurality of subfiles as they are requested, sufficient memory being reserved for execution of subfiles already received, the story never residing in the memory of the device in its entirety at the same time.

In a twenty-third embodiment, the invention provides a method for streaming electronic content over a communication link, the method comprising the steps of: communicating the single virtual file over the communication link in a data stream at a data rate commensurate with available bandwidth and characteristics of the communication link, the virtual file being received by the receiver as sequential portions of the single physical file; and controlling the opening of a later received subfile portion of the physical file being by a previously received subfile portion such that a currently executable portion of each of the subfiles is executed upon the direction of an earlier executing subfile.

This twenty-third embodiment may be further defined in a twenty-fourth embodiment such that the method further comprises step of forming the single physical file; and the single physical file comprising. a plurality of sequentially arrayed logical subfiles; a currently executable portion within each the logical subfile that executes when the logical subfile is opened after receipt; and a control portion that controls loading and execution of another logical subfile.

This twenty-third embodiment may be further defined in a twenty-fifth embodiment such that the method further comprises step of forming the single virtual file; and the single virtual file comprising: a plurality of sequentially arrayed logical subfiles, each logical subfile including a header identifying a first subfile offset from a reference location in the single virtual file and containing a substantially complete story for a predetermined playback period or playback functionality; a currently executable portion with each the logical subfile that executes when the logical subfile is opened after receipt; and a control portion that controls loading and execution of another logical subfile.

In a twenty-sixth embodiment, the invention provides a computer program and computer program product for use in conjunction with a computer system, the computer program product comprising a computer readable storage medium and a computer program mechanism embedded therein, the computer program mechanism, comprising: a program module that controls the streaming of data over a communications link, the program module including instructions for: communicating a single virtual file having at least one executable portion over the communication link in a data stream at a data rate commensurate with available bandwidth and characteristics of the communication link, the physical file being received by the receiver as sequential portions of the single virtual file; control of the opening of a later received portion of the virtual file being by a previously received portion of the virtual file such that a currently executable portion of each of the received portions is executed only upon the direction of an earlier executing received portion.

This twenty-sixth embodiment may be further defined in a twenty-seventh embodiment such that the program module further including instructions for forming the single virtual file. This twenty-sixth embodiment may be further defined in a twenty-eighth embodiment such that the program module further includes instructions for forming the single virtual file, and wherein the single virtual file comprises: comprising: (i) a plurality of sequentially arrayed logical subfiles, each logical subfile including a header identifying a first subfile offset from a reference location in the single physical file and containing a substantially complete story for a predetermined playback period or playback functionality; (ii) a currently executable portion with each the logical subfile that executes when the logical subfile is opened after receipt; and (iii) a control portion that controls loading and execution of another logical subfile.

In a twenty-ninth embodiment, the invention provides a system for streaming electronic content over a communication channel linking at least one sender and at least one receiver, the system comprising: a file maker within the sender for constructing a single virtual or physical file having predefined virtual file attributes; a detector within the sender detecting at least a bandwidth characteristic of the communication channel; a transmitter within the sender communicating the single virtual file over the communication link in a data stream at a data rate commensurate with available bandwidth and characteristics of the communication link, the virtual file being received by the receiver as sequential portions of the single subfiles; and a controller within the receiver controlling the opening of a later received subfile portion of the virtual file being by a previously received subfile portion such that a currently executable portion of each of the subfiles is executed upon the direction of an earlier executing subfile.

This twenty-ninth embodiment may be further defined in a thirtieth embodiment such that the file maker includes a data structure builder for forming the single physical or virtual file; and the single physical or virtual file comprising: a plurality of sequentially arrayed logical subfiles, each logical subfile including a header identifying a first subfile offset from a reference location in the single physical file and containing a substantially complete story for a predetermined playback period or playback functionality; a currently executable portion with each the logical subfile that executes when the logical subfile is opened after receipt; and a control portion that controls loading and execution of another logical subfile.

The invention provides a system, device, method, computer program, and computer program product for cooperative application-level multi-thread execution including instruction retry feature upon identifying constrained system resource.

In a first embodiment, the invention provides a method for cooperatively executing a plurality of code threads in a processor, the method comprising steps of: (a) communicating a plurality of code threads, including a first code thread and a second code thread, to a processor for execution; (b) setting a program counter for execution of the first code thread; (c) allocating ownership of the processor exclusively to execution of the first code thread and executing the first code thread until the first code thread completes execution, except stopping execution of the first code thread and yielding ownership of the processor by the first code thread during the execution to the second code thread upon the occurrence of a predetermined first code thread yield condition; (d) if execution of the first code thread has been stopped, then storing an indication that execution of the first code thread has been stopped, including a program counter value for the stopped first code thread, in a storage location; (e) setting the program counter for execution of the second code thread; (allocating ownership of the processor exclusively to execution of the second code thread and executing the second code thread until the second code thread completes execution, except stopping execution of the second code thread and yielding ownership of the processor by the second code thread to any other one of the plurality of code threads upon the occurrence of a predetermined second code thread yield condition; (g) reallocating ownership of the processor and re-executing the first code thread according to predetermined processor ownership reallocation rules; (h) retrying execution of the yielded first code thread including setting the program counter with the stored program counter for the stopped first code thread and re-executing the first code thread; and (i) repeating steps (b) through (g) for each of the plurality of code threads until each of the plurality of code threads has been executed.

This first embodiment may be further defined in a second embodiment such that the predetermined first code thread yield condition comprises yielding after a predetermined time period of processor ownership. This first embodiment may be further defined in a third embodiment such that the predetermined first code thread yield condition comprises yielding upon determining that a resource required for execution is constrained. This first embodiment may be further defined in a fourth embodiment such that the predetermined first code thread yield condition and the second code thread yield conditions are each selected from the group consisting of: (i) yielding after a predetermined time period of ownership, or (ii) yielding upon determining that a required resource is constrained, and a combination thereof. This first embodiment may be further defined in a fifth embodiment such that the cooperative execution of the plurality of instruction threads is achieved by establishing the predetermined time period of ownership of at least selected ones of the plurality of threads as a instruction thread execution parameter communicated with the instruction thread.

In a sixth embodiment, the invention provides a method for cooperatively executing a plurality of code threads in a processor, the method comprising steps of: sequentially executing a plurality of code threads until a predetermined code thread yield condition is detected for a particular code thread; stopping execution of the particular code thread for which the thread yield condition was detected; storing an indication that execution of the particular code thread was stopped before completion in a memory storage location; resuming sequential execution of the plurality of code threads at the next sequential code thread following the particular code thread; and retrying execution of the particular code thread during the resumed sequential execution according to predetermined rules for preempting a next sequential code thread and retrying execution of the particular code thread in preference to a next sequential code thread.

This sixth embodiment may be further defined in a seventh embodiment such that the step of retrying includes storing an indicator for the preempted next code thread and retrieving the stored indicator for the particular code thread. This seventh embodiment may be further defined in an eighth embodiment such that the stored indicator for the preempted next code thread comprises a program counter value for the preempted next code thread, and the stored indicator for the particular code thread comprises a program counter value for the particular code thread that was yielded. This eighth embodiment may be further defined in a ninth embodiment such that the method further comprising the step of resuming the sequential execution of code threads after the particular code thread has been executed by retrieving the stored program counter value for the preempted next code thread. This sixth embodiment may be further defined in a tenth embodiment such that the code thread yield condition comprises yielding after a predetermined time period of processor ownership. This sixth embodiment may be further defined in an eleventh embodiment such that the code thread yield condition comprises yielding upon determining that a resource required for execution is constrained. This sixth embodiment may be further defined in a twelfth embodiment such that the predetermined first code thread yield condition and the second code thread yield conditions are each selected from the group consisting of: (i) yielding after a predetermined time period of ownership, or (ii) yielding upon determining that a required resource is constrained, and a combination thereof.

This sixth embodiment may be further defined in a thirteenth embodiment such that cooperative execution of the plurality of instruction threads is achieved by establishing the predetermined time period of ownership of at least selected ones of the plurality of threads as a instruction thread execution parameter communicated with the instruction thread. This sixth embodiment may be further defined in a fourteenth embodiment such that cooperative execution of the program instruction threads is achieved by detecting a resource constraint and returning a code to the instruction dispatcher to set the program counter to point back to the same returned instruction before yielding to the next thread.

In a fifteenth embodiment, the invention provides a hardware architecture neutral executable program structure for execution in a processor, the program structure comprising: a plurality of instruction threads selected from a library of possible instruction threads; a plurality of data parameters integrated among at least some of the instruction threads and influencing execution of the instruction threads; and at least some of the selected instruction threads being adapted for cooperative execution with other of the instruction threads by yielding ownership of the processor upon the occurrence of a predetermined condition. This fifteenth embodiment may be further defined in a sixteenth embodiment such that the instructions comprise operation codes representing commands executable in a processor. This fifteenth embodiment may be further defined in a seventeenth embodiment such that the predetermined condition comprises the yielding instruction yielding after a predetermined time period of ownership. This fifteenth embodiment may be further defined in an eighteenth embodiment such that the predetermined condition comprises the yielding instruction yielding upon determining that a required resource is constrained. This eighteenth embodiment may be further defined in a nineteenth embodiment such that the constrained resource is selected from the group consisting of a memory buffer, an input device, an output device, an input/output device, a digital audio processor, a display device, a communication link, a communication bus, a buffer, a data compression processor, a data decompression processor, a vertical refresh signal (so user does not see display screen refresh), a time limit being exceeded or not yet being exceeded, and combinations thereof.

This fifteenth embodiment may be further defined in a twentieth embodiment such that the instruction thread is selected from the group of instruction threads that: perform a navigation; make a decision; scale a data item; decompress a data item; set a parameter; use a parameter; circulate a parameter; generate data; generate a parameter or instruction stream; parse a data item; format a data item, select a data item; test a data item; respond to an input; send messages; receive messages; receive responses to messages; request file from a server or other source; store data; perform calculations; perform an animation; perform signal or image processing; respond to a data or command from a user; send a message; request a file; request additional data in a data stream; request data and/or commands in a stream of data and/or commands; navigate; make a decision; scale; decompress; set, use, and calculate parameters; cause audio to be rendered, cause video to be rendered generate other data and/or procedural streams; parse, format, and select text and other media elements such as images, graphics, and audio; respond to item selection by a story player user; request further files during streaming, format XML (or XML extensions); format text; validate user input; perform calculations, simulations, animations, special effects, signal processing, run-time scaling and synchronization tasks; and combinations thereof.

This twentieth embodiment may be further defined in a twenty-first embodiment such that the data items are selected from the set of data items consisting of a digital image media data item, a digital audio media item, and combinations thereof. This twentieth embodiment may be further defined in a twenty-second embodiment such that the response to a data or command prom a user comprises responding to a command or data generated by a user button press from a device incorporating the processor. This twentieth embodiment may be further defined in a twenty-third embodiment such that the requesting additional data and/or commands in a stream of data and/or commands comprises requesting additional ones of the instruction threads integrated with the data parameters. This fifteenth embodiment may be further defined in a twenty-fourth embodiment such that the cooperative execution is under programmatic control. This fifteenth embodiment may be further defined in a twenty-fifth embodiment such that: the predetermined condition is either (i) yielding after a predetermined time period of ownership, or (ii) yielding upon determining that a required resource is constrained, or (iii) a combination of yielding after a predetermined time period of ownership, and yielding upon determining that a required resource is constrained. This fifteenth embodiment may be further defined in a twenty-sixth embodiment such that the resource being constrained comprises the resource being unavailable at the time access to the resource is required. This twenty-fifth embodiment may be further defined in a twenty-seventh embodiment such that the predetermined time period of ownership is established programmatically. This twenty-fifth embodiment may be further defined in a twenty-eighth embodiment such that a predetermined time period of ownership is provided as a parameter within the message. This twenty-sixth embodiment may be further defined in a twenty-ninth embodiment such that the operation codes comprise integers and an association between the integer and an operation is identified by a table look up procedure, the integers providing a compact representation of the operations.

This fifteenth embodiment may be further defined in a thirtieth embodiment such that the program structure further including an instruction thread retry attribute associated with at least some of the possible instruction threads, the retry attribute causing the processor to repeatedly retry to execute an instruction thread that has yielded ownership of the processor either (i) after a predetermined time period of ownership, (ii) after running all of the active threads until each has yielded the processor, or (iii) upon determining that a required resource is constrained.

This fifteenth embodiment may be further defined in a thirty-first embodiment such that: the instructions comprise operation codes representing commands executable in a processor; the predetermined condition comprises the yielding instruction yielding after a predetermined time period of ownership, or the yielding instruction yielding upon determining that a required resource is constrained; the constrained resource is selected from the group consisting of a memory, an input device, an output device, an input/output device, a digital audio processor, a display device, a communication link, a communication bus, a buffer, a data compression processor, a data decompression processor, a vertical refresh signal (so user does not see display screen refresh), a time limit being exceeded or not yet being exceeded, and combinations thereof; and the instruction thread is selected from the group of instruction threads that: perform a navigation; make a decision; scale a data item; decompress a data item; set a parameter; use a parameter; circulate a parameter; cause audio to be rendered; cause video to be rendered, generate data; generate a parameter or instruction stream; parse a data item; format a data item; select a data item; test a data item; respond to an input; send messages; receive messages; receive responses to messages; request file from a server or other source; store data; perform calculations; perform an animation; perform signal or image processing; respond to a data or command from a user; send a message; request a file; request additional data in a data stream; request data and/or commands in a stream of data and/or commands; navigate; make a decision; scale; decompress; set, use, and calculate parameters; generate other data and/or procedural streams; parse, format, and select text and other media elements such as images, graphics, and audio; respond to item selection by a story player user; request further files during streaming, format XML (or XML extensions); format text; validate user input; perform calculations, simulations, animations, special effects, signal processing, run-time scaling and synchronization tasks; and combinations thereof.

The invention also provides embodiments of the invention including all of the above described methods and procedures. For example, in one embodiment, the intention provides system and method comprising: means for hardware architecture neutral computer program language, structure and method for execution; means for autonomous generation of customized file having procedural and data elements from non-procedural flat-file descriptors; means for intelligently scaling message procedural/data sets to adapt the procedural/data sets to receiver attributes and maintain message intent; means for an intent preserving message adaptation and conversion system and method for communicating with sensory and/or physically challenged persons; means for searching and selecting data and control elements in message procedural/data sets for automatic and complete portrayal of message to maintain message intent; means for adapting content for sensory and physically challenged persons using embedded semantic elements in a procedurally based message file; means for forward and backward content based version control for automated autonomous playback on client devices having diverse hardware and software, means for reducing unauthorized access by procedural messages executing in a computer system to computer system or memory or programs or data stored therein; means for self-directed loading of an input buffer with procedural messages from a stream of sub-files containing sets of logical files; means for device-neutral procedurally-based content display layout and content playback; means for thin procedural multi-media player run-time engine having application program level cooperative multi-threading and constrained resource retry with anti-stall features; means for streaming multimedia-rich interactive experiences over a communications channel; and means for cooperative application-level multi-thread execution including instruction retry feature upon identifying constrained system resource.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best use the invention and various embodiments with various modifications as are suited to the particular use contemplated. It is intended that the scope of the invention be defined by the claims appended hereto and their equivalents.

All publications, patents, and patent applications mentioned in this specification are herein incorporated by reference to the same extent as if each individual publication or patent application was specifically and individually indicated to be incorporated by reference.

APPENDIX I
Playback Engine Partial Exemplary Code

Although aspects of the invention have been described in considerable detail, Appendix I
provides a sample of exemplary code so that some additional insight may be gained as to its
structure and operation.
/*
These are example functions from a Story playback engine which illustrate one possible software
implementation of a remarkably lightweight Story operating environment.
These functions illustrate most all the functionality needed for the story multi-threading, media
synchronization and runtime model for Story playback.
The first two functions perform the functions of implementing a round-robin, multi-threaded operating
system.
The second two functions illustrate functions that implement actual Story op-code execution.
*/
/*
StoryPlaybackCycle should be called continually in a loop on a single host operating system thread.
This functions executes all the threads once in order, until each thread gives up control, then returns.
Possible return code #defines can be found in pStory.h and end with the suffix, “_RETURN_CODE”
When the return value is negative, then execution of the calling loop should end.
*/
S32 FUNC_PREFIX StoryPlaybackCycle(void)
{

SU32 u32_NumberOfActiveThreads=0;
SU32 u32_NumberOfThreadsLeft=p.c.u32_NumberOfInitializedThreads;/*

number of initialized threads */

p.c.u32_StoryPlaybackCycleNumber++;
p.c.u32_StoryThreadIndex=0;
while (u32_NumberOfThreadsLeft)
{

p.c.context=p.c.contexts[p.c.u32_StoryThreadIndex++];
if (p.c.context.u32_State!=RUNNING_CONTEXT_STATE)
{

u32_NumberOfThreadsLeft−=(p.c.context.u32_State!=UNINITIALIZED_CONTEXT_STATE
);

continue; /* this thread is not running so do next thread */

}
u32_NumberOfActiveThreads++
if (InputAvailable( ))
{

do
{

ProcessInstruction( );

}while

(p c.s32_ProcessInstructionReturnCode==SUCCESS_RETURN_CODE);

if (p.c.s32_ProcessInstructionReturnCode<0)
{

break;

}

}
p.c.contexts[p.c.u32_StoryThreadIndex−1]=p.c.context;
u32_NumberOfThreadsLeft--;

}
if (u32_NumberOfActiveThreads==0)
{

p.c.s32_ProcessInstructionReturnCode=NO_ACTIVE_THREADS_RETURN_CODE;

}
return(p.c.s32_ProcessInstructionReturnCode);

}
/*
This function fetches an opcode from the input buffer and calls the function that implements the
opcode. It also handles instruction retry by:
Setting the default status returned from the opcode function to
SUCCESS_RETURN_CODE
Storing the pointer to the opcode
Calling the function for the opcode
Inspecting the return code when the opcode function returns
If the return code is RETRY_INSTRUCTION_RETURN_CODE then the instruction pointer is reset to
point back to the opcode by restoring the saved value.
*/
void FUNC_PREFIX ProcessInstruction(void)
{

PSU32 pu32_SavedNextInput,
pu32_SavedNextInput=p c context inputBufferInfo.pu32_NextInput;
p.c u32_CurrentOpcode=GetSU32_FromInput( );
p c s32_ProcessInstructionReturnCode=SUCCESS_RETURN_CODE;
(controlFunctionAddressArray[p c.u32_CurrentOpcode])( );
if (p c.s32_ProcessInstructionReturnCode==RETRY_INSTRUCTION_RETURN_CODE)
{

//Instruction could not proceed, so try again next time
p c.context.inputBufferInfo.pu32_NextInput=pu32_SavedNextInput;

}
return;

}
/*
Stop execution of this thread until all the other threads have had a chance to run. The return code,
YIELD_TO_NEXT_THREAD_RETURN_CODE, has a different value than a
SUCCESS_RETURN_CODE
This will cause the main cycle function to move on to executing the next thread.
When the cycle function gets back to executing this thread, execution will proceed starting with the
instruction following the YIELD_OP instruction.
*/
void FUNC_PREFIX YieldOp(void)
{

p.c.s32_ProcessInstructionReturnCode=YIELD_TO_NEXT_THREAD_RETURN_CODE,
return;

}
/*
End ops are used to end subroutines and disable threads.
Note that after the last running thread ends, then the story playback will automatically end.
*/
void FUNC_PREFIX EndOp(void)
{

RETURN_ADDRESS_STACK_ELEMENT_TYPE rase;
SU32 u32_i;
if (p.c.context.u32_SubroutineNestingLevel)
{

p c.context.u32_SubroutineNestingLevel−;
Pop((PSU8)&rase, sizeof(rase));
p.c.context.inputBufferInfo=rase.inputBufferInfo;
p.c.context pu32_Parameters=rase.pu32_Parameters;
p.c.context.pFileInfo=rase.plnputFileInfo;
for

(u32_i=0;u32_<rase.u32_NumberOfElementsOnStackToPopUponReturn,u32_i++)

{

Pop(NULL,0);

}

}
else
{ /* Thread Ended its own Execution */

p.c.context.u32_State=SUSPENDED_CONTEXT_STATE;

p.c.s32_ProcessInstructionReturnCode=YIELD_TO_NEXT_THREAD_RETURN_CODE:

}
return;

}

END OF APPENDIX I

We claim:

1. A computer program product for use in conjunction with a computer system having a server and a client, the computer program product comprising a computer readable storage medium and a computer program mechanism embedded therein, the computer program mechanism, comprising: a program module that directs the computer system and/or components thereof including at least one or the client or server, to function in a specified manner to provide message communications, the message communications occurring in a computer system hardware architecture neutral and operating system neutral and network transport protocol neutral manner for secure certificate issuing by an Issuer to a Client requesting the certificate, the program module including instructions for:
A. extracting, by a certificate requesting client, a network address for the Issuer from a trusted source or storage means;
B. extracting, by the client, a Resource Tag related to its own Subject Name from a message that was received from a Server;
C. extracting, by the client, a public and private key and certificate chain from a trusted source;
D. using the extracted information to create a secure session with the Issuer that authenticates the issuer using the same protocol;
E. sending, by the client, as the client's first Data message after any session setup messages, a data structure that has a common header with fields for Type, Version and Content-Length, and contents that include the Resource Tag, the Client's Subject Name, and optionally one or more public keys that the Client has generated;
F. verifying, by the certificate issuer, that a valid Server issued the Resource Tag and that the Resource Tag is valid for the given received Subject Name;
G. creating, by the issuer, a Compact Certificate with one or more public keys and with the Client's Subject Name;
H. digitally signing, by the issuer, the certificate with the Issuer's private key; and
I. sending, by the certificate issuer, a message back to the Client over the secure channel, where the message includes the Compact Certificate and if the Issuer generated the public key(s), the message includes the matching private key(s).

2. A hardware architecture neutral and operating system neutral and network transport neutral method for secure certificate issuing by an Issuer to a Client requesting the certificate using less software code and network bandwidth than conventional systems, said method comprising the steps of:
A. extracting, by a certificate requesting client, a network address for the Issuer from a trusted source or storage means;
B. extracting, by the client, a Resource Tag related to its own Subject Name from a message that was received from a Server;
C. extracting, by the client, a public and private key and certificate chain from a trusted source;
D. using the extracted information to create a secure session with the Issuer that authenticates the issuer using the same protocol;
E. sending, by the client, as the client's first Data message after any session setup messages, a data structure that has a common header with fields for Type, Version and Content-Length, and contents that include the Resource Tag, the Client's Subject Name, and optionally one or more public keys that the Client has generated;
F. verifying, by the certificate issuer, that a valid Server issued the Resource Tag and that the Resource Tag is valid for the given received Subject Name;
G. creating, by the issuer, a Compact Certificate with one or more public keys and with the Client's Subject Name;
H. digitally signing, by the issuer, the certificate with the Issuer's private key; and
I. sending, by the certificate issuer, a message back to the Client over the secure channel, where the message includes the Compact Certificate and if the Issuer generated the public key(s), the message includes the matching private key(s).

3. The method in claim 2, further comprising: the client placing the Compact Certificate and keys into its trusted source or storage means.

4. The method in claim 2, wherein the one or more public key(s) are generated by the Issuer or send to the Issuer by the Client who generated them.

5. The method in claim 2, wherein where the one or more public key(s) are sent to the Issuer by the Client who generated them.

6. The method in claim 2, wherein the trusted source or storage means is data compiled into the Client software.

7. The method in claim 2, wherein the trusted source or storage means is data received from communicating with a Server via a secure session.

8. The method in claim 2, wherein the trusted source comprises a trusted storage.

9. The method in claim 2, wherein the network address comprises a URL.

10. The method in claim 2, wherein the Resource Tag comprises a message tag.

11. The method in claim 2, wherein the Subject Name comprises an e-mail address.

12. The method in claim 2, wherein the public and private key operations are performed by any asymmetric cryptosystems.

13. The method in claim 12, wherein the asymmetric cryptosystem is selected from the group consisting of RSA, Elliptic Curve, and NTRU.

14. The method in claim 2, wherein the public and private key extracted by the client are fixed public and private keys.

15. The method in claim 2, wherein the public and private key and certificate chain extracted by the client are fixed public and private keys and certificate chain.

16. A method for secure certificate issuing by an issuer to an entity requesting the certificate, said method comprising:
extracting, by the entity, a network address for the certificate issuer from a trusted source;
extracting, by the entity, information including a resource tag related to its own subject name from a message that was received from a server, and a public key and a private key and certificate chain from a trusted source;
using, by the entity, the extracted information to create a secure session with the issuer that authenticates the issuer; and
sending, by the entity, as a component of the entity's first data message after any session setup messages, a data structure that includes the resource tag and subject name.

17. The method of claim 16, further comprising:
verifying, by the issuer, that a valid server issued the resource tag and that the resource tag is valid for the given received subject name;
creating, by the issuer, a certificate with one or more public keys and with the entity's subject name;
digitally signing, by the issuer, the certificate with the issuer's private key; and
sending, by the issuer, a message back to the entity over the secure channel, where the message includes the certificate.

18. The method of claim 17, further comprising: receiving the certificate by the requesting entity.

19. The method of claim 17, wherein the requesting entity comprises a requesting client.

20. The method of claim 16, wherein the requesting entity comprises a requesting client.

21. The method of claim 17, wherein if the issuer generated the public key(s), the message sent back to the entity includes the matching private key(s).

22. The method of claim 17, wherein the requesting entity comprises a requesting client.

23. The method of claim 17, wherein the data structure includes a common header with fields for type, version, and content-length, and contents that include the resource tag, the entity's subject name.

24. The method of claim 23, wherein the data structure further optionally includes one or more public keys that the entity has generated.

25. The method of claim 24, wherein the entity comprises a client.

26. The method of claim 2, wherein the trusted source or storage means comprises a Compact Certificate as explained earlier, or chain of Compact Certificates leading to a trusted root public key.
